(19) United States
(12) Patent Application Publication
(10) Pub. No.: US 2012/0101883 A1
(43) Pub. Date: Apr. 26, 2012

(54) System and Method for Rewarding Smart Phone Users Personal Companion

(76) Inventors: Pervez Akhter, Sayerville, NJ (US); Faisal Akhtar, Sayerville, NJ (US)

(21) Appl. No.: 13/287,681

(22) Filed: Nov. 2, 2011

Related U.S. Application Data
(63) Continuation-in-part of application No. 13/100,049, filed on May 3, 2011.
(60) Provisional application No. 61/365,832, filed on Jul. 20, 2010.
(60) Provisional application No. 61/330,981, filed on May 4, 2010.

(51) Int. Cl. G06Q 30/02

(52) U.S. Cl. 705/14.17

(57) ABSTRACT

A method of advertizing using a device called Personal Companion. The Personal Companion is a specially designed device or existing Smart Phone linked to cloud based servers via Communication Careers. The device and other enabling gadgets and services are distributed free of charge to members of the public in return for a continuous, uninterruptible flow of consented advertisements. Watching these adverts will typically result in compensation accruing to the user. Users may, however, opt to stop flow of ad, but may forfeit that compensation. The ad server distributes marketing data to the device based on it's physical location, amongst other factors. Preferably, the geographical coordinates of the navigation device are fed to the ad server, which then returns advertisements from businesses operating within those coordinates. The navigation device receives and outputs navigational or entertainment information, in conjunction with marketing data.

### CLAIM OF PRIORITY

This application is a continuation in part (CIP) application based on U.S. Utility Patent Application No. 13/100,049, filed on May 3, 2011, which claims priority to U.S. Provisional Patent Application No. 61/330,981 filed on May 4, 2010, and to U.S. Provisional Patent Application No. 61/365,832 filed on Jul. 20, 2010, the contents of all previous applications h are hereby fully incorporated herein by reference.

### FIELD OF THE INVENTION

The invention relates to a system and method for providing rewards to smart phone users, and more particularly, to rewarding smart phone users via sharing proceeds from advertising, charitable donations and carbon credits etc.

The advertising method may utilize a Handheld Computing Device such as, but not limited to, a Smart Phone or similar device suitably enabled for user interaction with delivered content, such as, but not limited to, an Interactive TV or a display for a web browser, that may be used to obtain public attention to a message by means of a network such as, but not limited to, an Internet Connection or other electronic medium that can be used to get public attention to one or more conveyed messages. Messages may be acknowledged and the public may be compensated for paying attention to the messages and advertisers may see the value added and be willing to pay the general public viewing the adverts as well as the company providing the advertising platform.

### BACKGROUND OF THE INVENTION

Note: Throughout this document, the words ‘UH’, ‘UHO’, ‘TCC’ are intended to interchangeably mean ‘The Company Who Will Sponsor the Invention’. This may, for instance, be any entity that may own the invention at the time of the product launch.

The invention relates to a novel marketing method that is enabled by a system and method for providing rewards to computing device users, especially smart phone users. The invention also relates to a combination of devices that implement this marketing method.

The current invention of novel marketing method may utilize computing device including but not limited to Smart Phone, Tablet PC, Laptop, Internet TV or desktop computer device. In particular, the novel marketing method may utilize handheld devices, such as, but not limited to, a Smart Phone, an iPad, an Interactive TV, a display for a Web Browser or an iPhone etc. The handheld devices may also be equipped to function as global positioning systems (GPS), providing further useful ways that may help pay for the upfront cost and maintenance of the device as well as other attachments or applications that may enable the general public to respond to general or targeted commercial messages. The computing device, and in particular the handheld device, which may also be called a Personal Companion, may be well suited for displaying promotional messages as it may interactively attract the focus of The User, or vehicle occupants, who may be using the handheld device for general computing needs such as, but not limited to, finding directions. The handheld device, or personal companion, may be used in many other innovative ways to attract and retain the attention of the user, thereby making it a suitable place to advertise. The device may be used in many innovative ways that may help pay for the device, its maintenance and for other attachable gadgets, thereby enabling it to be given to general public for free, in return for using the device in natural everyday situations as well as for earning points, or other remuneration, for watching advertisements. The handheld device may also be used for other activities discussed in detail later in the document. Note: All thorough the document words ‘UH’, ‘UHO’, ‘TCC’ are used interchangeably to mean ‘The Company Who Will Sponsor the Invention’ It may be any entity that may own the invention at the time of the product launch.

GPS devices and Smart Phones are well known in the art, and their functionality has been widely developed. However, the marketing industry does not yet utilize them in a significant way, due in large part to their being used by only a small fraction of the global population because existing technology is too expensive to be afforded by the average person, especially in underdeveloped or developing countries.

Until now, subscription to promotional or informational data has been almost exclusively voluntary with little or no participation incentives for the receiver. Therefore, marketers largely ignored this informational niche. The system of the present invention removes a large portion of user discretion in exchange for free device, a reimbursement for a purchased device or free services. However, the user may take back some of the control by paying the full or in part for the device rather than opting to watch the advertisements. The subscription to marketing data and user's participation may be managed centrally, which may also enable such novel and useful features as remote device control and location, passive usage monitoring, active preference gathering, the ability to cast votes and the ability to use the device for functions such as, but not limited to, a Passport, a Driver's License or a Census Input Provider. Such uses may result in significant energy and cost savings.

Description of the Related Art

US Patent Application No. 20090204484 describes a system for displaying targeted digital electronic advertising on mobile display systems based upon GPS coordinates and demographic data correlated to those GPS coordinates and current time. The display can “intelligently” download and project relevant and targeted advertising based upon (1) the displays known location, (2) current time, and (3) demographic data of people known to share the display's location at that time. Displayed content can thereby change in a dynamic fashion and with relatively unlimited frequency. Advertising content and demographic data can be stored local to the display device (“onboard”) or obtained in real time using any number of wireless networking technologies as the display moves through space and time. Further, total display times of a given advertisement can be calculated and stored as means to determine advertising fees.

US Patent Application No. 20090006194 described a technology by which an advertisement is selected for output on a mobile (e.g., vehicle navigation) system based on contextual data, including current state data from a location-sensing (e.g., GPS) device. The advertisement may be an image displayed at a location on a map corresponding to a physical location of the advertiser. The contextual data may include location, direction and destination data, user preference data and user-provided data such as calendar, task and/or contacts data. Examples of other contextual data include age data, gender data, number of vehicle occupants data, vehicle make data, vehicle model data, and/or vehicle style data. In one aspect, the user may interact with the advertisement, e.g., to communicate an order for a product or service corresponding to the advertisement.

Various implements are known in the art, but fail to address all of the problems solved by the invention described herein. One embodiment of this invention is illustrated in the accompanying drawings and will be described in more detail herein below.

### SUMMARY OF THE INVENTION

The invention discloses a system and method for providing rewards to smart phone users by sharing with them proceeds from sources such as, but not limited to, advertising, charitable donations and carbon credits, in return for their participation in various activities, such as, but not limited to, viewing advertisements.

The advertising may be delivered to the user by means of a suitably programmed hand held computing device, also known as a Personal Companion. The Personal Companion may also include a computerized navigation module, a camera and it may be linked to an ad server. The device is preferably distributed to members of the public free of charge in return for a continuous, but not mandatory, flow of advertisements. By choosing to view the advertisements, the user may receive monetary compensations that are deposited to an account associated with the computing device through an identifier. The monetary compensations may be used to pay for the computing device, the price of which is recorded in the account. Account here refers to a virtual information space that may be used to store the details of the earnings or rewards for a user. User/s may redeem the money for smart phone bills or any other relevant purposes duly approved by the inventor/s organization.

Users may, however, have the option to stop the flow of ads if they so desire. The ad server may distribute marketing data to the hand held computing device based on factors such as, but not limited to, weather, the time of day, a user's mood, a user's personal interests, the prevailing economic conditions, prevailing social and political factors and also on the physical location of the hand held computing device at the time the marketing data is distributed, and on events, structures or people in a vicinity of the current location of the hand held computing device. Here, an App or an Application means a computer application either downloaded especially or a code that works through the web or other similar medium. The Applications disclosed herein will be described in detail in the figures.

The geographical coordinates of the navigation device may, for instance, be fed back to the ad server, which may then return advertisements from businesses operating within a predetermined vicinity of those coordinates. The hand held computing device may receive and output navigational or entertainment information in conjunction with the marketing data.

Therefore, the present invention succeeds in conferring the following, and others not mentioned, desirable and useful benefits and objectives.

After the method disclosed herein is implemented, many individuals may have a free device, duly supported by our innovative applications that help pay subsidies for the device, more so, by the fact that such subsidies would not be possible without a subsidzed device.

The following factors can and may also be used to finance the free device/s and service/s:

a—Paper wastes.

b—Advertising wastes.

c—Vertical decline in the prices of smart phones and other similar devices and services.

d—Mass production and mass buying factors.

This business method may save trees globally by making printing become redundant at global scale by spreading free or very cheap technology across the globe. Since prices of computing devices and similar functioning computers have fallen by a factor of about 20,000 in the last forty two years, they may continue to fall in the next twenty years that our patent may be effective. Even if prices fell by a factor of only 10 in the next ten years then smart phones may cost around US$6 per month and that may be even easier to subsidize the entire cost of ownership of the smart phones to the users globally.

Our applications may help fight population explosion and sexually transmitted diseases by educating people on the subject using our applications. Furthermore, our applications may make USA a known and loveable entity for getting the device in every hand. In addition, decreasing size and weight of the devices may enable to transport old and used devices to third world countries at very low cost and our applications may enable people to give away working phones in less than two years and those phones can then be in hands of less fortunate people. The poorer people are also consumers of political content and others, if not expensive goods, and that our applications gives them importance that they deserve.

Through out applications, it is possible to make smart phones free by partnering with phone manufacturers, carriers, banks and the businesses who may want to use the device and our application/s for their advantage. A universal network of connected devices can be established that can be used by any entity by using a ‘cost per use’ model. For example driver's licenses, passports, voting, Census data collections etc. can use the devices in cost subsiding ways discussed in the patent application. This is analogous with one travelling by bus and only paying fraction of the total cost. A huge number of new entrants can be brought to digital world and The Digital Divide can be closed.

Our innovative use of following applications and further applications envisioned by developers globally may emerge out of our patented approach and may help reduce the cost of smart phones, internet services, etc. to zero for the general public.

Coupons, GPS, Alarm Clock, Surveys, Product Catalogs, Opinion Polls, Movies, Loyalty Cards, Jobs and portals, Email, Credit Cards, Commercial Pages, Blood Donations, Ad-Inbox, UP Pay, TV, Signup, Passport, Mass Bargain, Library, Drivers License, Compliance, Census, Billing, Social Network, Planned parenthood, Newspapers and Magazines, Matrimonial, Give Aways, Elections. App Store, Social Gaming, Search, Global Contact Book, Music Store, Texting, Ringtone, Attendance, Fire Safety, Auctions, Photoshare, Referrals, Ad Me, Point of Sale, Smartphone Sales, Document Repository, Employer Phone, Hajj, Umrah, Boarding Pass, Protection from Abuse, Cooking, Health and Wellness, Electronic Leash, Smart Phone Exchange, Smart Phone sales, Concert, Credit Account, Internet for Everyone, STD, Dictionary, Calendar, Greeting Cards, Customer Acquisition, Purchase Replenishment, Ad Agency, Wrist Watch, 911, Commercial Voicemail, Call Waiting, Video Share.

This invention may help bandwidth problem by reducing the need to talk using voice by paying for texting public. The user expense of Voice Plan can be ended by using the data pipe as voice medium through innovative applications.

It is an object of the present invention to open a newadvertising venue for merchants in USA and across the globe as needed, while providing a free Electronic Device for consumers.

It is an object of the present invention to provide a Free Device, besides other numerous advantages that today's technologies offer that can serve as an information and entertainment center as well as huge positive environmental impacts and energy savings that were not possible due to inability of general public to afford such a versatile gadget.

It is another object of the present invention to provide a navigation device capable of supplying marketing and Business Intelligence data for and from merchants based on the physical location of the device.

Still another object of the present invention is to provide an electronic device that is capable of storing all data locally.

Still another object of the present invention is to provide an electronic device capable of communicating with a central ad service as well as with government databases in all countries for huge public benefits.

Yet another object of the present invention is to provide an electronic device that is capable of communicating with orbiting satellites.

Still another object of the present invention is to provide an electronic device that is capable of providing walking directions, driving directions, hiking directions of navigation for a variety of other transit means.

It is another object of the present invention is to provide the largest conceivable implementation of a central server; including but not limited to, IBM Websphere Application Server and relevant utilities like Ecommerce etc.

Still another object of the present invention is to provide the largest possible network of IP connected devices talking to the central server installed and maintained by a service entity; including but not limited to, IBM, Google or Microsoft.

Still another object of the present invention is to provide the largest collection of data that can be used to monitor human behavior globally using Business Intelligence tools.

### BRIEF DESCRIPTION OF THE DRAWINGS

FIG. 1 is a flowchart of the preferred embodiment of the advertising method.

FIG. 2 is a flow chart of advertising points scoring method, that eventually enable free distribution of the device.

FIG. 3 is a flowchart that demonstrates the method of utilizing a navigation device.

FIG. 4 is a flow chart that demonstrates the coupon distribution method.

FIG. 5 is a schematic representation of the United Humanity Organization (UHO).

FIG. 6 illustrates Flow Chart outlining a UH Wake-Up Alarm Application Method.

FIG. 7 illustrates Flow Chart outlining UH Surveys Method.

FIG. 8 illustrates a Flow Chart Outlining UH Product Catalogs Method.

FIG. 9 illustrates Flow Chart outlining UH Opinion Polls Method.

FIG. 10 illustrates Flow Chart outlining UH Movies Method.

FIG. 11 illustrates Flow Chart outlining Loyalty Cards Method.

FIG. 12 illustrates Flow Chart of UH Job Portal Method.

FIG. 13 illustrates Flow Chart of UH GPS Method.

FIG. 14 illustrates Flow Chart of UH Email Method.

FIG. 15 illustrates Flow Chart of Credit Card Method.

FIG. 16 illustrates Flow Chart of UH Commercial Pages Method.

FIG. 17 illustrates Flow Chart of Blood Donation Method.

FIG. 18 illustrates Flow Chart of Ad In Box App Method.

FIG. 19 illustrates Flow Chart of UH Pay App Method

FIG. 20 illustrates Flow Chart of World Wide Democracy App Method.

FIG. 21 illustrates Flow Chart of UH TV App Method.

FIG. 22 illustrates Flow Chart of UH Signup App Method.

FIG. 23 illustrates Flow Chart of UH Electronic Passport App Method.

FIG. 24 illustrates Flow Chart of UH NCLB (No Child Left Behind) App Method.

FIG. 25 illustrates Flow Chart of Mass Bargain App Method.

FIG. 26 illustrates Flow Chart of Libraries App Method.

FIG. 27 illustrates Flow Chart of Libraries App Method.

FIG. 28 illustrates Flow Chart of Free Food App Method.

FIG. 29 illustrates Flow Chart of Driver's License App Method.

FIG. 30 illustrates Flow Chart of Compliance App Method.

FIG. 31 illustrates Flow Chart of Census App Method.

FIG. 32 illustrates Flow Chart of Billing App Method.

FIG. 33 illustrates Flow Chart of UH Social Network App Method.

FIG. 34 illustrates Flow Chart of UH Planned Parenthood App Method.

FIG. 35 illustrates Flow Chart of UH Newspapers and Magazines App Method.

FIG. 36 illustrates Flow Chart of UH Matrimonial App Method.

FIG. 37 illustrates Flow Chart of UH Literacy App Method.

FIG. 38 illustrates Flow Chart of UH Medical History App Method.

FIG. 39 illustrates Flow Chart of UH Give Aways App Method.

FIG. 40 illustrates Flow Chart of UH Elections App Method.

FIG. 41 illustrates Flow Chart of UH Classified Ads App Method.

FIG. 42 illustrates Flow Chart of UH BLOG App Method.

FIG. 43 illustrates and explains UH LOGO.

FIG. 44 illustrates and explains UH Web Site.

FIG. 45 illustrates Flow Chart of UH App Store Method.

FIG. 46 illustrates Flow Chart of UH Parcel Service Method.

FIG. 47 illustrates Flow Chart of UH App Store Method.

FIG. 48 illustrates Flow Chart of UH Search Method.

FIG. 49 illustrates Flow Chart of UH Conference Call Method.

FIG. 50 illustrates Flow Chart of UH Prescription Refill Method.

FIG. 51 illustrates Flow Chart of UH Motorists Club App Method.

FIG. 52 illustrates Flow Chart of UH Car Pool App Method.

FIG. 53 illustrates Flow Chart of UH Global Contact Book App Method.

FIG. 54 illustrates Flow Chart of UH Phone Listing App Method.

FIG. 55 illustrates Flow Chart of UH Traffic Control App Method.

FIG. 56 illustrates Flow Chart of UH Private Tutor App Method.

FIG. 57 illustrates Flow Chart of UH Music Store Method.

FIG. 58 illustrates Flow Chart of UH Cold Calling Method.

FIG. 59 illustrates Flow Chart of UH Real Estate Method.

FIG. 60 illustrates Flow Chart of UH Money Transfer Method.

FIG. 61 illustrates Flow Chart of UH Donations Method.

FIG. 62 illustrates Flow Chart of UH Training Method.

FIG. 63 illustrates Flow Chart of UH Weather App Method.

FIG. 64 illustrates Flow Chart of UH Read App Method.

FIG. 65 illustrates Flow Chart of UH Text App Method.

FIG. 66 illustrates Flow Chart of UH Ringtone App Method.

FIG. 67 illustrates Flow Chart of UH Checkin App Method.

FIG. 68 illustrates Flow Chart of UH Local TV App Method.

FIG. 69 illustrates Flow Chart of UH Video Chat App Method.

FIG. 70 illustrates Flow Chart of UH Attendance App Method.

FIG. 71 illustrates Flow Chart of UH Fire Safety App Method.

FIG. 72 illustrates Flow Chart of UH Instant Feedback App Method.

FIG. 73 illustrates Flow Chart of UH Sales Commission App Method.

FIG. 74 illustrates Flow Chart of UH NEWS App Method.

FIG. 75 illustrates Flow Chart of UH Crowdsourcing App Method.

FIG. 76 illustrates Flow Chart of UH Listing Service App Method.

FIG. 77 illustrates Flow Chart of UH Tourism App Method.

FIG. 78 illustrates Flow Chart of UH Auctions App Method.

FIG. 79 illustrates Flow Chart of UH Bedtime Story App Method.

FIG. 80 illustrates Flow Chart of UH Partnership App Method.

FIG. 81 illustrates Flow Chart of UH Theft Proofing App Method.

FIG. 82 illustrates Flow Chart of UH Photo Share App Method.

FIG. 83 illustrates Flow Chart of UH Consumer Feedback App Method.

FIG. 84 illustrates Flow Chart of UH Reminders App Method.

FIG. 85 illustrates Flow Chart of UH Referrals App Method.

FIG. 86 illustrates Flow Chart of UH College Books App Method.

FIG. 87 illustrates Flow Chart of UH Super Market App Method.

FIG. 88 illustrates Flow Chart of UH Digital Privacy App Method.

FIG. 89 illustrates Flow Chart of UH AD Me App Method.

FIG. 90 illustrates Flow Chart of Rental Car and Truck App Method.

FIG. 91 illustrates Flow Chart of Point of Sale App Method.

FIG. 92 illustrates Flow Chart of Smartphone Sales App Method.

FIG. 93 illustrates Flow Chart of Causes App Method.

FIG. 94 illustrates Flow Chart of Book Rentals App Method.

FIG. 95 illustrates Flow Chart of Document Repository App Method.

FIG. 96 illustrates Flow Chart of Radio App Method.

FIG. 97 illustrates Flow Chart of Spread The Word App Method.

FIG. 98 illustrates Flow Chart of Employer Phone App Method.

FIG. 99 illustrates Flow Chart of Shopping App Method.

FIG. 100 illustrates Flow Chart of Family App Method.

FIG. 101 illustrates Flow Chart of CRM App Method.

FIG. 102 illustrates Flow Chart of ERP App Method.

FIG. 103 illustrates Flow Chart of Hajj App Method.

FIG. 104 illustrates Flow Chart of Umrah App Method.

FIG. 105 illustrates Flow Chart of Boarding Pass App Method.

FIG. 106 illustrates Flow Chart of Protection From Abuse (PFA) App Method.

FIG. 107 illustrates Flow Chart of Cooking App Method.

FIG. 108 illustrates Flow Chart of Health and Wellness App Method.

FIG. 109 illustrates Flow Chart of Travel Promotion App Method.

FIG. 110 illustrates Flow Chart of Electronic Leash App Method.

FIG. 111 illustrates Flow Chart of Pass Time App Method.

FIG. 112 illustrates Flow Chart of Ad Hoc Help App Method.

FIG. 113 illustrates Flow Chart of School App Method.

FIG. 114 illustrates Flow Chart of Home School App Method.

FIG. 115 illustrates Flow Chart of Smart Phone Exchange App Method.

FIG. 116 illustrates Flow Chart of Smart Phone Sales App Method.

FIG. 117 illustrates Flow Chart of Concert App Method.

FIG. 118 illustrates Flow Chart of Smart Phone Exchange App Method.

FIG. 119 illustrates Flow Chart of Credit Account App Method.

FIG. 120 illustrates Flow Chart of Internet for Everyone App Method.

FIG. 121 illustrates Flow Chart of STD Education App Method.

FIG. 122 illustrates Flow Chart of Retailer App Method.

FIG. 123 illustrates Flow Chart of Dictionary App Method.

FIG. 124 illustrates Flow Chart of Calendar App Method.

FIG. 125 illustrates Flow Chart of Calendar App Method.

FIG. 126 illustrates Flow Chart of Cloud App Method.

FIG. 127 illustrates Flow Chart of Customer Acquisition App Method.

FIG. 128 illustrates Flow Chart of Lobbying App Method.

FIG. 129 illustrates Flow Chart of Mobile Commerce App Method.

FIG. 130 illustrates Flow Chart of Gift Card App Method.

FIG. 131 illustrates Flow Chart of Purchase Replenishment App Method.

FIG. 132 illustrates Flow Chart of My Car App Method.

FIG. 133 illustrates Flow Chart of Ad Agency App Method.

FIG. 134 illustrates Flow Chart of Kids Ads App Method.

FIG. 135 illustrates Flow Chart of Wrist Watch App Method.

FIG. 136 illustrates Flow Chart of Fan App Method.

FIG. 137 illustrates Flow Chart of 911 App Method.

FIG. 138 illustrates Flow Chart of Commercial Voice Mail App Method.

FIG. 139 illustrates Flow Chart of Call Waiting App Method.

FIG. 140 illustrates Flow Chart of Ring Back App Method.

FIG. 141 illustrates Flow Chart of Video Share App Method.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

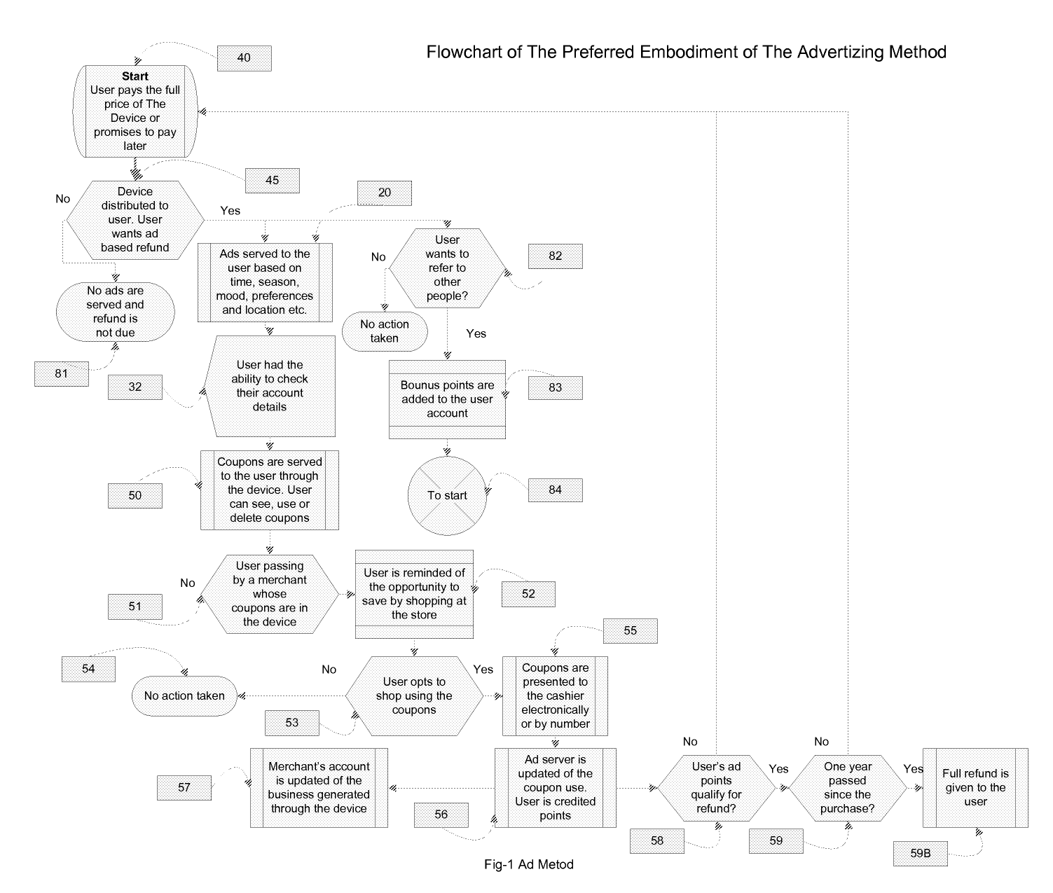

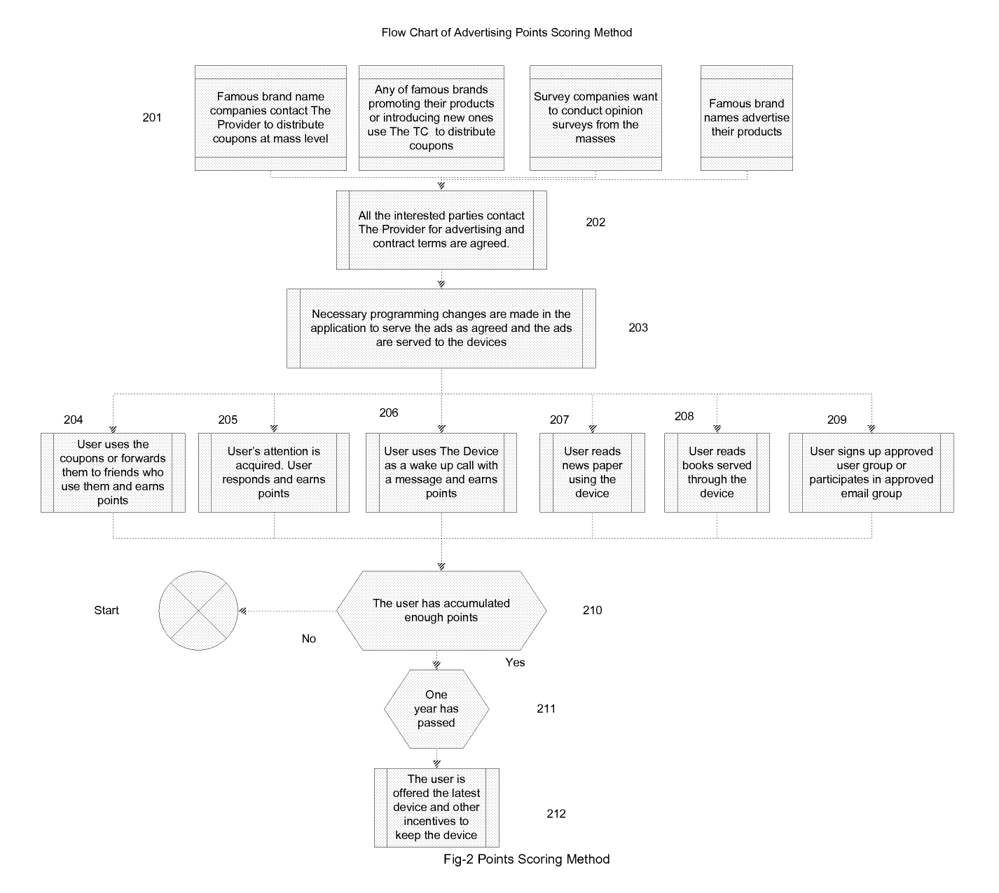

FIGS. 1 and 2 illustrate the steps of the claimed marketing method. The Personal Companion, also known as the navigation device (ND), may be linked to an ad server in step 20. The ad server is preferably centrally located and may include a single computer server or a plurality of computer servers. One skilled in the art will appreciate that such an ad server may communicate with an ND using a wireless Internet protocol, which may require the use of a satellite link The server or servers may run any commercially available operating systems such as, but not limited to, “Windows”, “Unix”, or “Linux.” Such an ad server may, for instance, be managed by a Personal Companion company (PCC), which may solicit and receive marketing data from merchants and send this data in form of advertisements and promotions to the subscribing NDs 120. A Personal Companion Company, also called UH or UHO, may also utilize the ad servers or a specialized receiving server to track whether a user of the smart phone/ND 120 is utilizing the device 120 and the marketing data that it receives or contains.

Alternatively, the linking step 20 may be accomplished using portable memory devices. The portable memory device may, for instance, contain marketing data in a format that may be readable by an ND 120. Presently, NDs are typically preloaded with road maps. These maps may be updated through portable memory devices. The present invention may supplement the map or navigational data with marketing data, which may be displayed or announced to the user at appropriate time intervals, or when the user is within the vicinity of theadvertising merchant. The smart phone/ND 120 may keep track of the usage of the marketing data by the user and may prompt the user at predefined intervals to exchange the portable memory device for an updated version. The PCC may then keep track of the marketing data usage by reading the information on the portable memory device that was returned by the user of the smart phone/ND. Such monitoring may also occur over a specific period of time, for example over the course of a year.

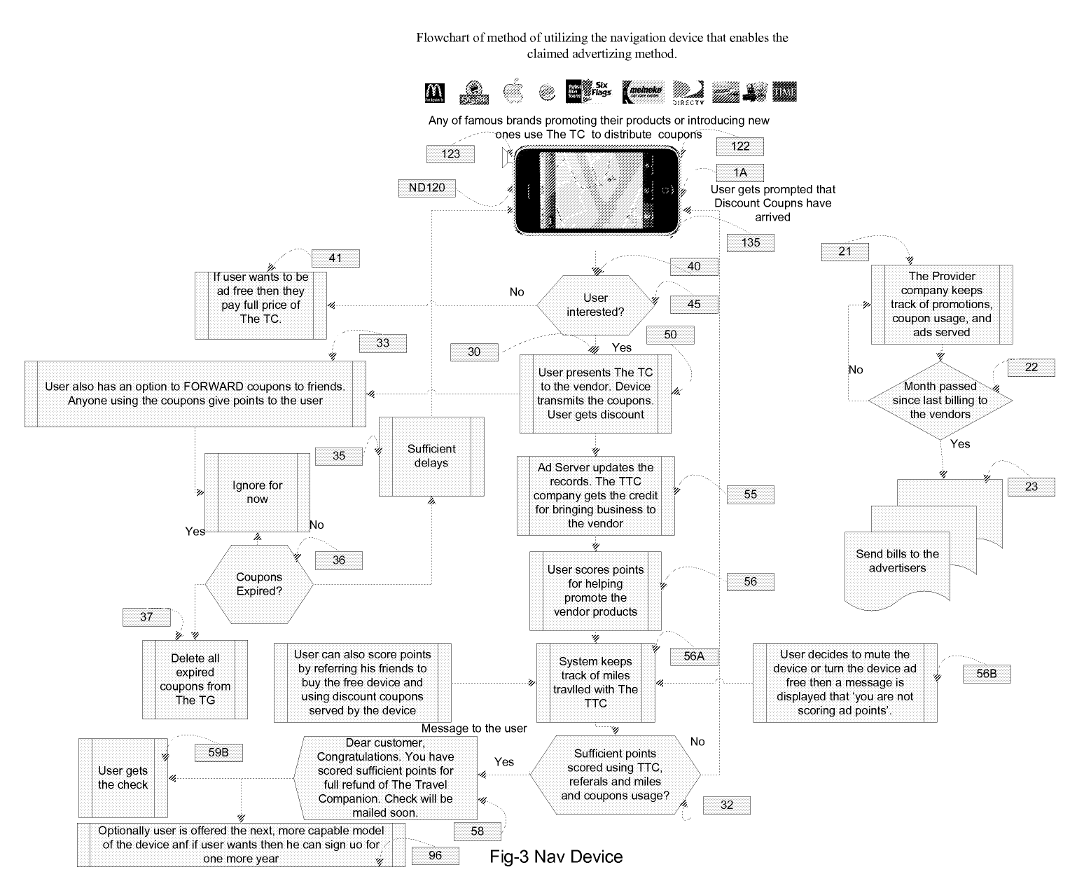

In step 40 the smart phone/ND may be distributed to users. The smart phone/ND 102 (FIG. 3) may be distributed to users free of charge, provided that users agree to preconditions such as, but not limited to, to receive marketing data in the form of coupons and other promotional materials. Note that a user may first acquire the device for its retail price (FIG. 2) and may later choose to participate in the method embodied by the invention, by, for instance, subscribing to the marketing data.

The user may consent to receive marketing data in step 40. The consent may be implied through the user's receiving of the smart phone/ND from the PCC or the UH and subsequently using it. The consent may be expressly solicited by displaying messages on the smart phone/ND or through another means such as telephone, e-mail, interactive web-site or postal communication. If a user declines to receive the marketing data, then he or she may be required to pay for the smart phone/ND, return it to the PCC, or receive no credit for a prior purchase of the smart phone/ND as illustrated in step 41.

The marketing data distributed to an ND 120 can preferably be traced back to each individual ND through use of serial numbers or other unique identifiers. The purpose of tracking marketing data may be to enable the ad server or the PCC to track marketing data usage and run business intelligence reports by each individual ND 120. Thus, if a usage level is consistent with a subscription agreement between the PCC and the user, a refund may be issued for the smart phone/ND 120 after a prescribed period of time, or the user's obligation to pay for the distributed device may be waived.

The marketing data may be distributed to the navigation device in step 30. The distribution is based on the physical location of the particular ND 120 and other determining factors such as, but not limited to, a user's taste or buying habits. For example, if user “A” is traveling along interstate “1”, A's ND 120 may receive a pop-up or an audio message containing promotional information or coupons from any merchant within a predetermined distance, for instance within a ten mile radius of user “A” current location. Any distance may be specified, however, a distance that may be easily reached within several minutes of travel may be preferred by the merchants, who can also specify their desired target region. The advertisements may be stored centrally on an ad server or locally on the smart phone/ND. A merchant may be able to select which users should be targeted. For example, a local auto parts store may wish to only target parts delivery services or mechanics, while an upscale restaurant may only wish to target consumers of certain age, income level, or make and year of their vehicles. All this information may be stored on the smart phone/ND or managed centrally by the ad server. The smart phone/ND 120 is preferably capable of altering navigational directions by adding detours and alternative routes, if the user chooses to follow up on the displayed promotion (step 55).

Marketing data received by the smart phone/ND 120 may then outputted along with all navigational or entertainment data in step 50. The output may occur in form of a popup, as illustrated in FIG. 3 step 1A, or over an audio device on the smart phone/ND 120. The smart phone/ND 120 may have a connection with the audio system of a user's vehicle, in which case, marketing and navigational data may be broadcasted by using the vehicle's speakers. One skilled in the art will appreciate that navigational data may be substituted with entertainment data such as, but not limited to video games, movies, tour guide presentations, news services, lectures etc. The smart phone/ND 120 may be equipped with an ability to access the Internet, in which case the marketing data may be displayed based on websites visited by the user or based on the user's pattern of interest in ads.

The outputting of the marketing data on the smart phone/ND in step FIG. 1 step 50 may include additional steps illustrated in FIG. 1, as well as other tasks not specifically detailed herein. In step 51 the device or the ad server may continuously, or quasi-continuously, poll the physical coordinates of the smart phone/ND. The coordinates may be compared against the marketing data on the ad server or on the smart phone/ND to determine whether any merchants are within a predetermined range of the user's device 120. If any such merchants are found, their advertisements and coupons may be displayed in step 52. If more than one merchant is found, their coupons may cycle and may be recalled by the user from memory cache as desired. The advertisement may be presented repeatedly as the smart phone/ND travels closer or further away from the advertising merchant. In step 53 the user may utilize the coupons when shopping or acquiring advertised produces or services. The smart phone/ND 120 may be able to accept interactive user input using voice recognition technology, by utilizing a touch screen, or any other type of input device. Such an embodiment enables presentation of the coupons electronically in step 55. Step 55 also incorporates other possible actions by the user such as, but not limited to, placing orders or reservations directly from the smart phone/ND 120. The user may use the coupons by directly interacting with a merchant's point of sale system, or by presenting the displayed coupon to a merchant using a numbering or codified tracking identifier. This makes the device very attractive to the user as they do not have to shuffle through the bunch of coupons. Many such identifiers are widely used in the art and their variations will be appreciated by one skilled in the art. The user may chose to ignore the coupon in step 54, in which case the user may or may not get any credit for viewing the advertisement.

Step 55 leads to step 56, where the ad server (PCC) or the smart phone/ND may track the usage of the marketing data on the smart phone/ND. The usage may, for instance, be tracked using a system such as, but not limited to, a point system, a distance traveled to redeem the coupons, or by dollar value of the actions taken in step 55 or a combination thereof. The user may receive periodic updates of his or her usage progress in step 32. Additionally, the advertising merchant may be billed by PCC in step 57 for the usage activity that occurred in step 55.

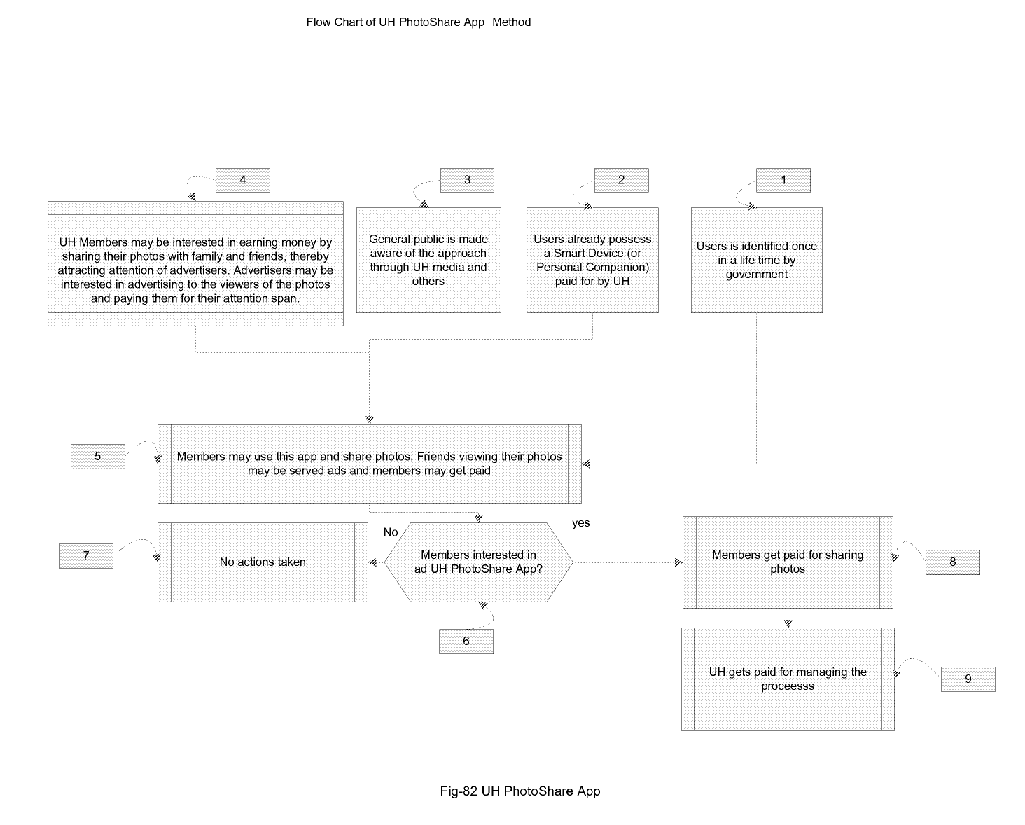

The user may receive points for referring other users to the PCC provider in step FIG. 1-82. To qualify for points, the user may refer other users of GPS devices to an ad server (PCC). If these users agree to subscribe to marketing information, the referring user will receive a credit in form of bonus points in FIG. 1 step 83, a dollar figure, or a credit toward the value of the received device.

In FIG. 1 step 58 the user's points may be periodically tallied or the subscription may be evaluated at the end of a prescribed period in FIG. 1 step 59. If the user purchased the device in step 40 (Fig-1) then the user may receive credit for adequate usage in of the marketing data in step 59B or may have to continue to score points as usual.

The purchased ND may not initially be linked to an ad service. However, the user may wish to recoup the funds expanded in purchasing the smart phone/ND in FIG. 1 step 80. Such a user may have a choice of agreeing to receive a distribution of the marketing data in FIG. 3 step 30 or referring other users to the ad server in FIG. 1 step 82. To enable FIG. 3 step30, the marketing data may be made compatible with most known ND types by, for instance installing a compatibility module on the smart phone/ND. The ad server may also be capable of supporting a range of ND models. One will also appreciate that for the purposes of the present invention, the term ND may apply to other personal electronic devices such as, but not limited to telephones, pocket organizers, and mini-entertainment devices such as an iPod® device.

If a user fails to meet usage expectations over a specified period of time, they may, at the discretion of the NCC, receive no credit, or an incomplete refund, as detailed in FIG. 1 step 59B. The user may also decline a subscription and not refer any other users to the ad server, in which case they may be issued no credit in FIG. 1 step 81.

FIG. 3 describes the same navigation device 120 (ND). The smart phone/ND 120 preferably has a display component 122, a built-in audio component 123 and at least one connectivity interface 135. The display component 122 may, for instance, be a speaker having a width in a range of approximately two to four inches. The display component 122 may also have wide screen with a touch enabled capability. The audio component 123 may be a speaker included with the smart phone/ND 120 or may be a separately attached speaker, head phones or a vehicle's audio system. The connectivity interface 135 may be a wireless antenna for connecting to an ad server, to an orbiting satellite or to both. The connection to the ad server may be accomplished over the internet or through a private network. A private connection may also be established over the public internet though the use of tunneling protocols and encryption.

The ad server in FIG. 3 step 21, also known as a Personal Companion company (PCC or UH), may communicate with the device in FIG. 1 step 20. The communication may be for uploading marketing data unto the smart phone/ND FIG. 3, 120, or for retrieving the physical coordinates of the smart phone/ND 120 so that relevant marketing data may be outputted onto the display component 122. The smart phone/ND may contain an onboard storage capability in form of internal RAM. One skilled in the art may appreciate that the smart phone/ND 120 may additionally contain an image recording device such as a photo or video camera. The photo camera may, for instance, store images internally or sent them remotely to a location selected the by user or as directed by the PCC.

The ad server may utilize the connectivity interface 135 to control the smart phone/ND 120. For example, the ad server may be capable of upgrading or installing software running on the smart phone/ND 120 or of uploading navigational or entertainment data. The ad server may be capable of disabling the smart phone/ND 120, if for example, the user blocks or interferes with the stream of marketing data stored locally on the smart phone/ND 120 or downloaded regularly in FIG. 1 step 20. The subscription to the marketing data may not be capable of being turned off without forfeiting some or all of the refund for the smart phone/ND 120. The subscription may, however, be capable of being modified for a price, as a described at length herein.

In FIG. 3, the device 120 is shown displaying driving directions. However, the smart phone/ND 120 may be used in other settings as well. For example, the smart phone/ND may be used as a navigational device for other vehicles such as, but not limited to, a boat. The ad server may be capable of furnishing navigational information to such a device by uploading waterway, harbor and docking information. The marketing data in this embodiment may include services offered at closest marinas, beach side hotels, fuel stations, residences, and other tourist and boat servicing attractions. Other settings may be possible as well, such as, but not limited to a walking guide for urban areas or for hiking trails. In such embodiments the advertisers would be selected from merchants servicing pedestrian traffic or hikers, respectively. The user may be capable of setting the device ND 120 to a specific mode of travel, with the ad server adjusting the navigational, entertainment and marketing content accordingly.

FIG. 3 demonstrates one possible way in which the merchants furnish advertisement data to the PCC. The advertisement data may then become part of the marketing data sent to an ND 120. FIG. 3 step 21 utilizes tracking data generated in FIG. 3 steps 56 and 56A to determine the usage level of the marketing data sent to the smart phone/ND in step 20. The usage level may create additional charges or may justify charges applied to merchants in FIG. 3 step 22, with an invoice generated in FIG. 3 step 23. An automatic, periodic or any other billing structure common to the art may be used as well.

FIG. 3 demonstrates how the steps described in FIGS. 1 and 2 relate to the device 120. The user of the device 120 may be prompted to consent to the flow of marketing data in step 45. If the user declines in FIG. 3 step 41, the smart phone/ND may be disabled until a user pays for it in full, or it may function as any other navigational device, with the user not receiving any credit for the purchase of the device in FIG. 3 step 40.

If consent is obtained, the user may receive a steady stream of marketing data in step 30 that may be outputted to the user device in FIG. 3 step 50. The user may be able to forward the promotional information to another ND user in Fi 3 step 33. This action may be viewed as a referral 82 (FIGS. 1 and 2). A fully functional web-based interface may be provided to the user so that they can view, change settings or transfer points scored etc. The user may also have the capability to view or delete coupons, change preferences etc. using a browser of their choice.

Either the ad server or the smart phone/ND 120 may be capable of sorting and managing the marketing data stored locally or downloaded from the ad server or served dynamically. For example, in FIG. 3 step 36, the coupons and advertisements may be evaluated to determine their currency. In FIG. 3 step 35, the delays between displaying various advertisements may be adjusted manually or automatically. For example, in heavy traffic, the variation of ad content is preferably less rapid; but each individual ad may remain on the screen for longer. Also, in a region with few roads or with multiple geographic obstacles, the smart phone/ND 120 or the ad server may be able to determine that a particular merchant is actually out of range despite being physically near the device 120. In FIG. 3 step 37, the smart phone/ND 120 may have a choice between deleting outdated coupons, renewing them or replacing them with current versions.

If a user takes a requested action in FIG. 3 step 55, he or she may score points that are recorded in FIG. 3 step 56. If a user attempts to take an action but does not complete it, a credit may nonetheless be given, by calculating the miles driven toward the advertised location in step 56A. Other reward types may be used as well.

The user's usage of market data may be poled in FIG. 3 step 32 at predetermined intervals. If a sufficient level is reached, the user may be notified in FIG. 3 step 58, with a pre-agreed upon reward delivered to the user in FIG. 3 step 59B. Such a reward may be a dollar amount for using the marketing data, a dollar amount constituting a refund for the cost of the smart phone/ND 120 or another form of reward, such a better model of ND 120 FIG. 3 step 96.

If the user decides to mute the device he/she may receive a message in step 56B that they are not scoring any ad points.

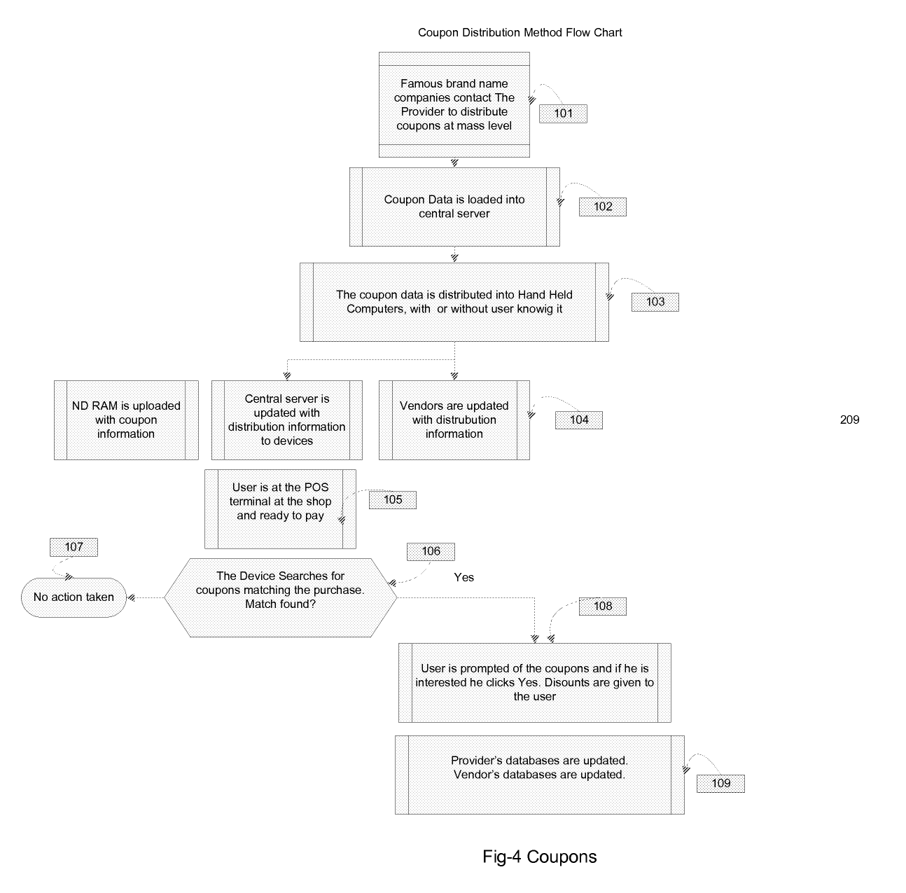

FIG. 4 illustrates the flow chart model of coupon distribution. In FIG. 4 step 101 famous brands may contact TTC to distribute their promotional coupons to the huge base of users available over the UH network. The data may be loaded into the ad server's coupon database, which may be distributed to the smart phone/ND 120s in FIG. 4 step 103.

Three things may be done in step 103.

1. An ND's memory may be loaded with coupons that become accessible to the user, and timely reminders can now be sent about their presence to the user.

2. A Central Server may keep track of the coupon distribution.

3. Vendors may then be updated to inform them that their coupons are already in the devices and not just sitting in mailboxes, waiting to be distributed.

When a user enters a shop or passes nearby, the smart phone/ND may know of potentially relevant coupons in FIG. 4 step 105 and may check for relevance of those coupons to the vendor/s in the immediate vicinity of the smart phone/ND in step 106. If no matches are found, no action may be taken in FIG. 4 step 107. If matches are found then the user may be prompted in FIG. 4 step 108 and if the user uses coupons then the appropriate discounts may be applied. The PCC databases may be updated and billing may now be undertaken, point tables updated and billing to vendors may also now be performed.

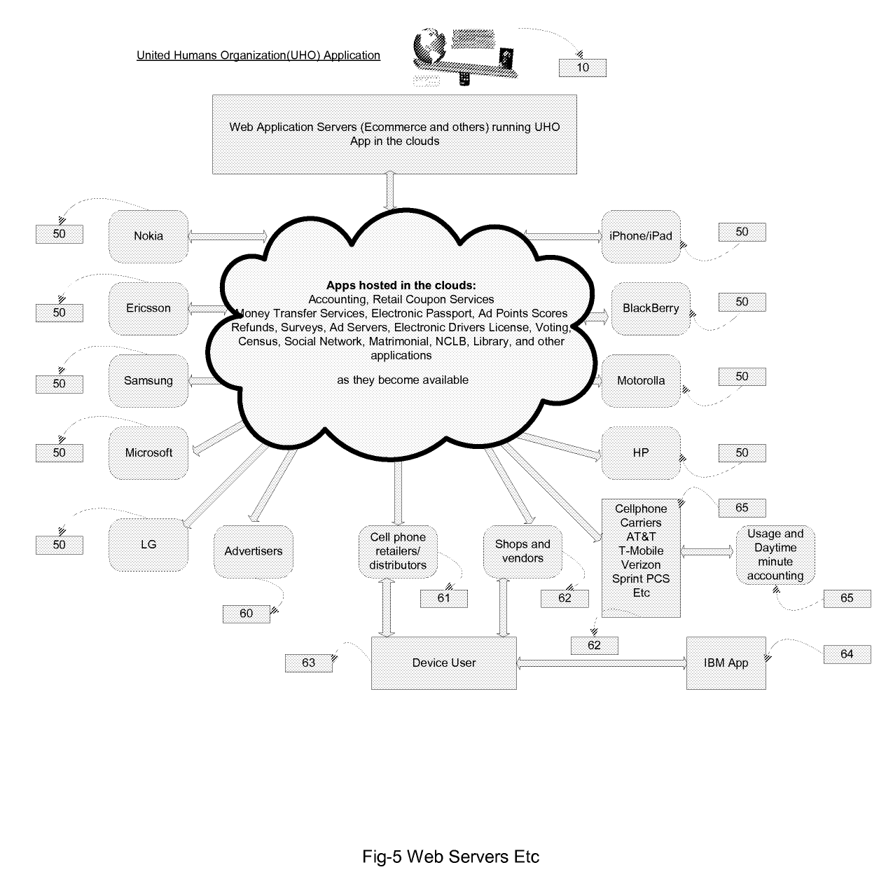

FIG. 5 illustrates some of the steps in a Flow Chart outlining Web Servers etc. The flow chart and the associated explanation of the flow chart is as follows:

FIG. 5 Step 10 illustrates the logo

FIG. 5 Step 50 illustrates the names of major smart phones manufacturers

FIG. 5 Step 60 illustrates that advertisers may interact with any manufacturer

FIG. 5 Step 61 illustrates that retailers and distributors of smart phones may interact other players

FIG. 5 Step 62 illustrates that signal carriers/shops and vendors may interact with other players

FIG. 5 Step 63 illustrates that device users may interact with other players

FIG. 5 Step 64 illustrates that major computer manufacturer like IBM may also interact with other players

FIG. 5 Step 65 illustrates that usage and daytime minute accounting may be done in real time

### POINTS CRITERIA SCORING

A user may score points (or equivalent money in local currency in the country of operation).

The Points Scoring System and compensation to the user may work with the TG that may qualify The User for the agreed refund. The refund frequency and mode may be implicitly agreed upon upfront with The User. The refund may first and foremost be towards the bills of Internet, ND, ND Accessories, relevant product insurances and any other services that user may have acquired using the available credits. Other possible point systems may also be developed as the need arises. The points scoring criteria for each activity will be discussed separately.

Additional Incentives and applications will now be discussed. Each application may be designed so that The User may score points for performing activities that were only enabled for him due to the fact that he or she now owns The Device (ND) and relevant software and has access to the appropriate communication services provided by, for instance, the UH.

### DESCRIPTION OF OTHER PREFERRED EMBODIMENTS

The preferred embodiments of the present invention will now be described with reference to the drawings. Identical elements in the various figures are identified with the same reference numerals.

Such embodiments are provided by way of explanation of the present invention, which is not intended to be limited thereto. In fact, those of ordinary skill in the art may appreciate upon reading the present specification and viewing the present drawings that various modifications and variations can be made thereto.

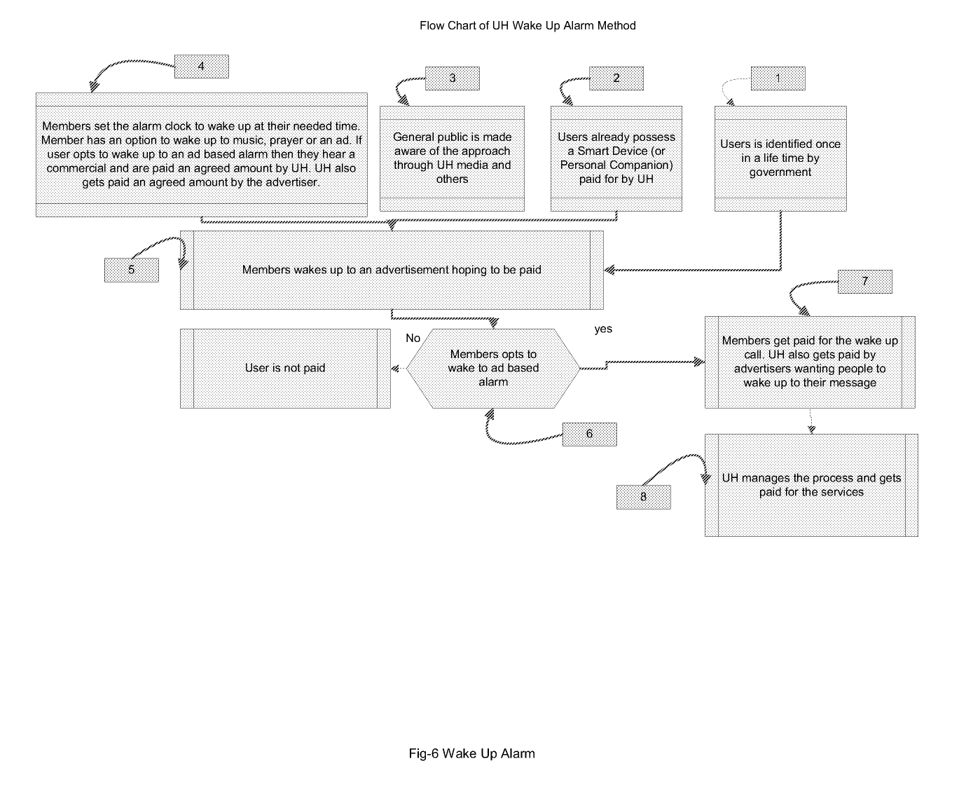

FIG. 6 illustrates some of the steps in a Flow Chart outlining processes in a UH Wake Up Alarm smart-phone application. The flow chart and the associated explanation of the flow chart, illustrate exemplary ways in which a user may receive compensation for the use of a UH smart-phone/ND application.

A smart phone FIG. 1, having a GPS module 120 and a camera operating module 130 such as, but not limited to, a Personal companion or an automated Navigation Device (ND), may initially be linked to a government identity management server in order to establish the identity of a user of the smart phone 110.

In step 6.1, the user may, for instance, be identified by a relevant government agency when accessing the UH system for the first time. Identification may, for instance, be accomplished using available IDs such as, but not limited to, government or state issued drivers licenses, passports and other documentation, or by other suitable documentation such as credit cards, bank account statements, company identity cards. To help prevent fraud, the identification may, for instance, rely on the cumulative evidence of a number of documents, rather than on any single document. Once a user's identity has been verified, the relevant facts and documents related to that identification may be stored in a suitably secure location such as, but not limited to, a UH Cloud Based Server. Such a server may, for instance, may be utilized by the UH organization as well as by governments, suitable NGO's or other suitable organizations. The documents stored on the server may, for instance, include appropriate biometric identification data such as, but not limited to, photographs, finger prints, voice samples and DNA analysis.

In step 6.2, a user who does not already possess a suitable smart phone/ND may obtain one free of change from a UH source such as, but not limited to, a UH representative or website. In order to obtain the free smart phone, a user may be required to demonstrate eligibility for, and agree to participate at their convenience in, one or more suitable reimbursable mode options 170. These reimbursable mode options may, for instance, include options such as, but not limited to, a charity mode option, an advertising mode option and a carbon micro-credit mode option. In the advertising mode option the user may, for instance, agree to allow uninterrupted flow of commercial Ads to themselves.

In step 6.3, a user who may be unaware of the existence of the free smart phones 110 provided by the UH, may be informed of the potential benefits to them of by various media channels such as, but not limited to, UH advertising, infomercials and other information dissemination methods.

In step 6.4 a user may set their smart phone or ND to operate a UH alarm clock application to wake up them at a predetermined time. Users may, for instance, have an option to wake up to their choice of music, a prayer or an advertisement or a combination thereof. If users opt to wake up to an ad based alarm then they may hear a commercial for a wake up call and may be paid, or credited an agreed monetary amount by the UH organization. The UH organization may also be paid by the advertiser. In order to maintain the organization, the amount received by the UH organization is preferably more is the UH organization may be obligated to pay to the user.

In Step 5 a user may wake up to an advertisement with the expectation of being paid for listening to the advertisement.

In Step 6.6, a user's settings may be checked in order to ensure that they opted to wake up to an advertisement. Based on the detected settings of the user's smart phone/ND, a decision a decision may be made by the UH organization, or their agents, to pay the user.

In Step 6.7, a user may be paid for having selected an advertisement to be played as a part of their wakeup call. The UH organization may also get paid by advertisers wanting people to wake up to their message. The money paid by the advertiser may be used, in part or in full, to pay for the provision of free, or heavily subsidized, smart phones, and/or free or heavily subsidized service provision for the use of the smart phones.

In Step 6.8, the UH organization may manage the process of providing services such as, but not limited to, providing free smart phones and providing compensation for the use of smart-phone applications. The UH organization may be compensated for providing such services.

Further Innovative Applications will now be described in detail.

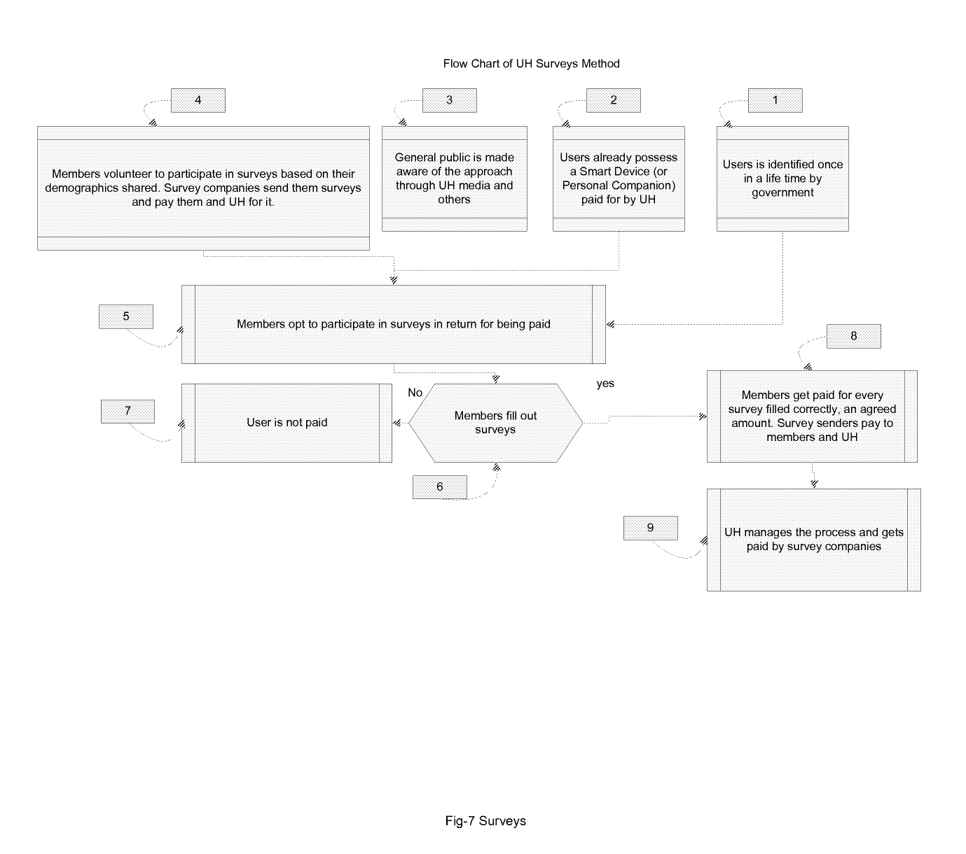

FIG. 7 Illustrates Flow Chart outlining UH Surveys Method:
Steps 7.1, 7.2 and 7.3 are analogous to the correspondingly numbered steps described in reference to FIG. 6 above.

In Step 7.4, members may volunteer to participate in surveys based on the demographics they may have shared when initially agreeing to participate in the UH organization's program to receive compensation for using smart-phone application.

Survey companies may send the users surveys and compensate them and the UH organization for the user's participation in the surveys. The amount paid to members and to the UH organization may, for instance, be determined using market forces such as, but not limited to, competitive auctions. Survey companies may be provided the demographic information of participants but in a preferred embodiment may NOT be provided with personal details without the explicit consent of the member.

In Step 7.5, members may consent to participate in one or more surveys that may be furnished to them through the UH organization. The participants may, for instance, be selected to receive a particular survey based on the demographic information they previously provided to the UH. In this way, the surveys may be made relevant to the user based on, for instance, factors such as, but not limited to their qualifications and buying behavior etc. This relevancy may make the survey results more attractive, and therefore potentially of more value, to the companies requesting they be performed.

In Step 7.6, a member may decline to participate in any particular survey. In a preferred embodiment, opting out of a survey may mean not participating in any UH revenue generated by that survey.
In Step 7.7, the member may fill out a survey.
In Step 7.8, the accuracy and completeness of the completed surveys may be verified by, for instance, an automated program running on the UH server. The user may then be informed of the amount of compensation that has or will be credited to their account.
In Step 7.9 the UH organization may bill the relevant surveying company and, in a preferred embodiment, may be paid as agreed.

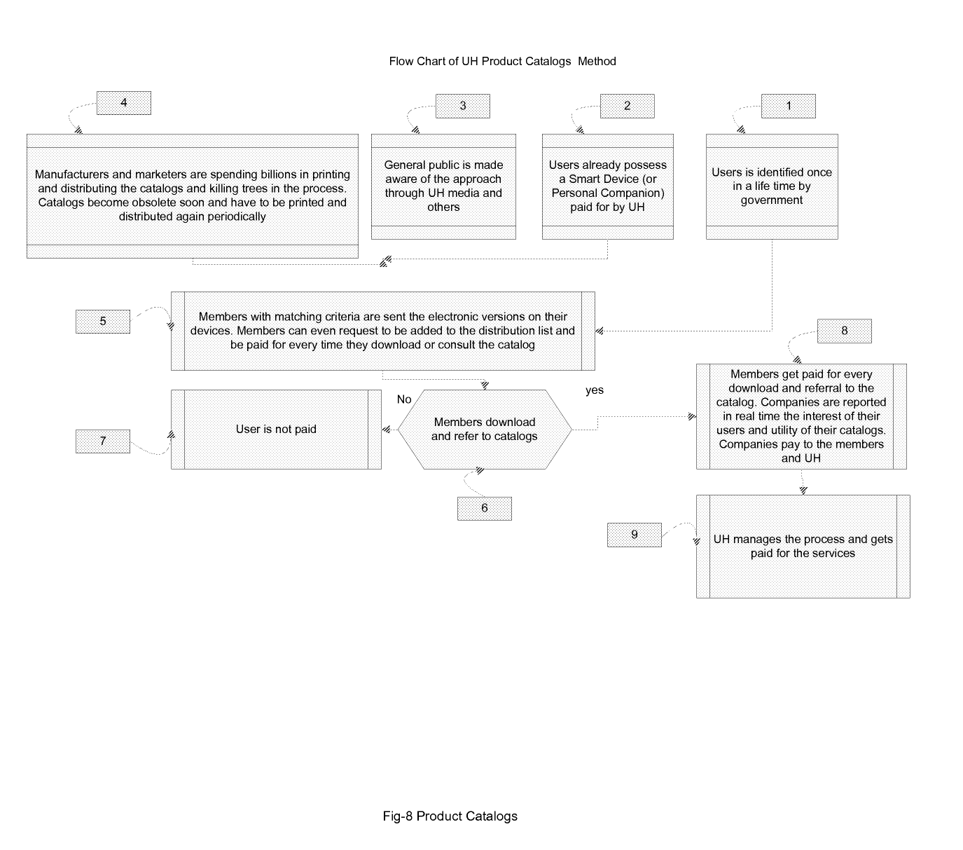

### FIG. 8 Illustrates a Flow Chart Outlining UH Product Catalogs Method.

This application is intended to help eliminate the huge and costly waste of paper and energy associated with producing and distributing catalogs such as, but not limited to parts catalogs, product catalogs, and reference catalogs Etc. The savings realized by eliminating the printed catalogs and instead providing them via the smart phones distributed by the UH organization, may be directed towards coving the cost of providing the smart phones and paying the service charges associated with using the smart phones.

Steps 8.1, 8.2 and 8.3 are analogous to the correspondingly numbered steps described in reference to FIG. 6 above.

In Step 8.4, a user may be informed of how manufacturers and marketers may be spending billions in printing and distributing catalogs, typically wasting energy and unnecessarily destroying trees and other limited recourses in the process. The user may also be made aware of other shortcomings of paper catalogs such as, but not limited to, how they become rapidly obsolete, necessitating frequent re-printing and re-distribution. Typically changes to a printed catalogue take about six months to reach the end user, whereas alterations to on-line catalogues that may be available via the UH distributed free smart phones or web based software, allows for real time updating of the catalogue.

In Step 8.5, members matching appropriate criteria may be sent offers to download electronic catalogues, or the necessary information to allow them to access the electronic versions using their smart phone devices. A log may be kept of who downloaded the catalog and how much money was paid towards the free device also called ND. Members may, for instance, request to be added to the distribution list of particular catalogues, and may be compensated each time they download a catalogue or a portion of a catalogue. Members may also be paid a small amount each time they consult the electronic catalog. In addition to providing the information required by the user, the payment for obtaining that information may give them an additional incentive to return to that particular catalogue. Such an incentive may be an effective way for the catalogue provider to build brand loyalty.

In Step 8.6, the member may decide if they want to be paid. If they opt to be paid then they may download one or more of the catalogs on offer from participating manufacturers and other agencies.

In Step 8.7 the member is not paid as they are not interested in participating.

In Step 8.8, Members may get paid for every download and referral to the catalog. Companies may receive real time reports detailing the users interests other metrics that may provide insights regarding factors such as, but not limited to, the utility of their catalogs. Companies may pay the members for accessing their catalogues, and the UH organization for providing the electronic distribution platform. The payments may be according to a schedule that may be negotiated and agreed to prior to the electronic distribution of the catalogues.

In Step 8.9, the UH organization may manage the entire process and may receive additional compensation for providing such services.

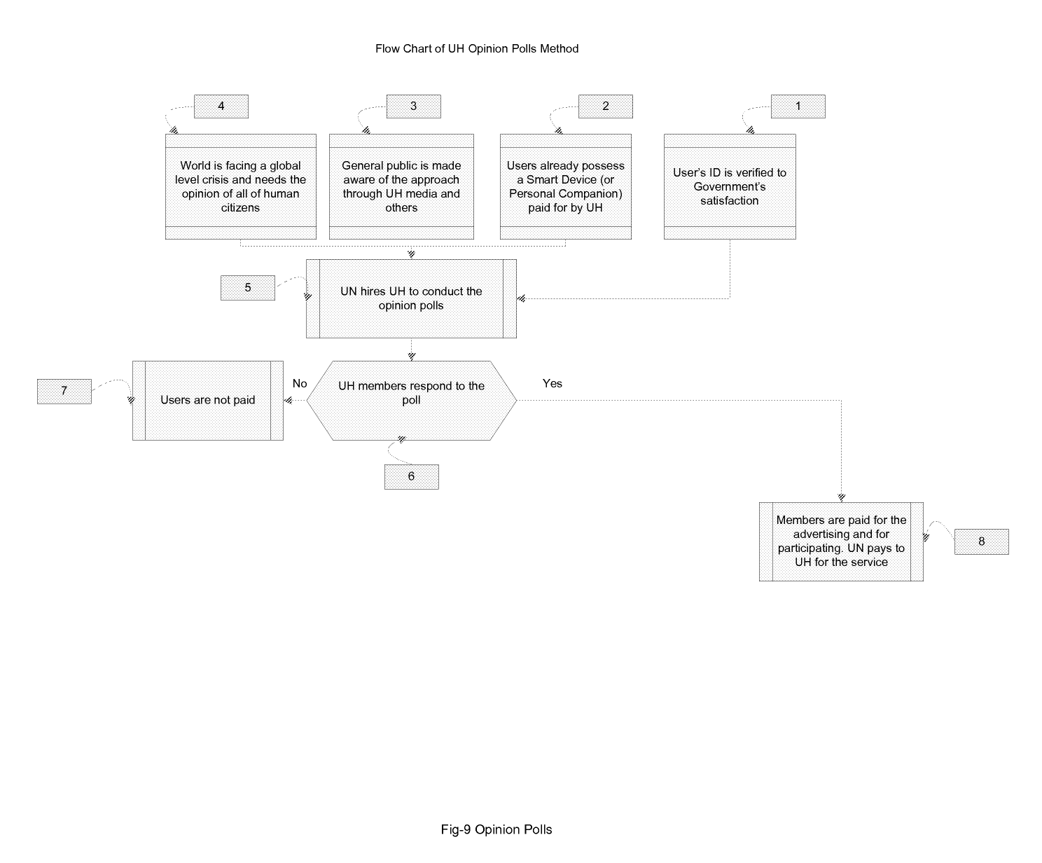

FIG. 9 Illustrates Flow Chart outlining UH Opinion Polls Method:

Steps 9.1, 9.2 and 9.3 are analogous to the correspondingly numbered steps described in reference to FIG. 6 above.

In Step 9.4, inventors see a huge utility of a free ND as envisioned in this patent application. General public can be called in to poll for matters of urgency facing all human citizens or any geography or political scenario. It can be used to get help in disasters etc.

In Step 9.5, an entity like United Nations may hire UH to conduct the opinion polls across all countries in real time.

In Step 9.6, UH members may decide to respond to the polls or not.

In Step 9.7, Users may be ignored for not opting to participate.

In Step 9.8, Members may be paid for the advertising and for participating. UN or the requesting entity may pay the UH for the service. Members may get paid for participating in the polls.

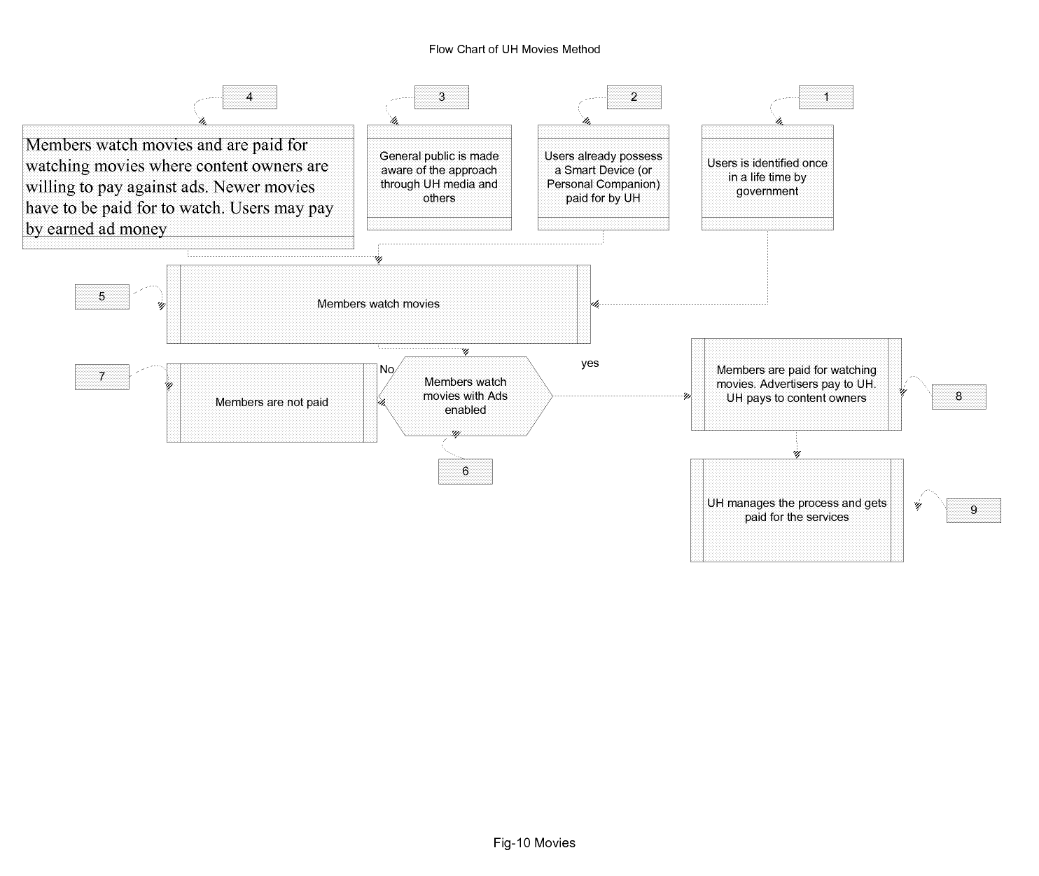

FIG. 10 Illustrates Flow Chart outlining UH Movies Method:

Steps 10.1, 10.2 and 10.3 are analogous to the correspondingly numbered steps described in reference to FIG. 6 above.

In Step 10.4 members may watch movies and may be paid (it may be a very small sum of money) for watching the movies. The content owners may, for instance, be willing to pay for the ads served during the movie's playtime. Newer movies may have to be paid for to watch. Users may pay by earned ad money. This may enable them to watch a new movie when they are in a mood for it and watch ads when they have time and inclination for watching ads. This makes them more attractive audience for advertisers and this approach to manage surveys may become a huge hit with movie lovers. The same approach may be used for other video content like political a speeches etc.

In Step 10.5 the members may watch movies without annoying interruptions from marketers.

In Step 10.6 they have the option to include ads if they want to be paid.

In Step 10.7 they are not paid if they do not want ads, they will have to pay for movies if they opted out of ads.

In Step 10.8 members are paid for watching movies as stated. Advertisers pay to UH, UH then pays to content owners.

In Step 10.9 UH manages the process and gets paid for the services of managing the web site etc.

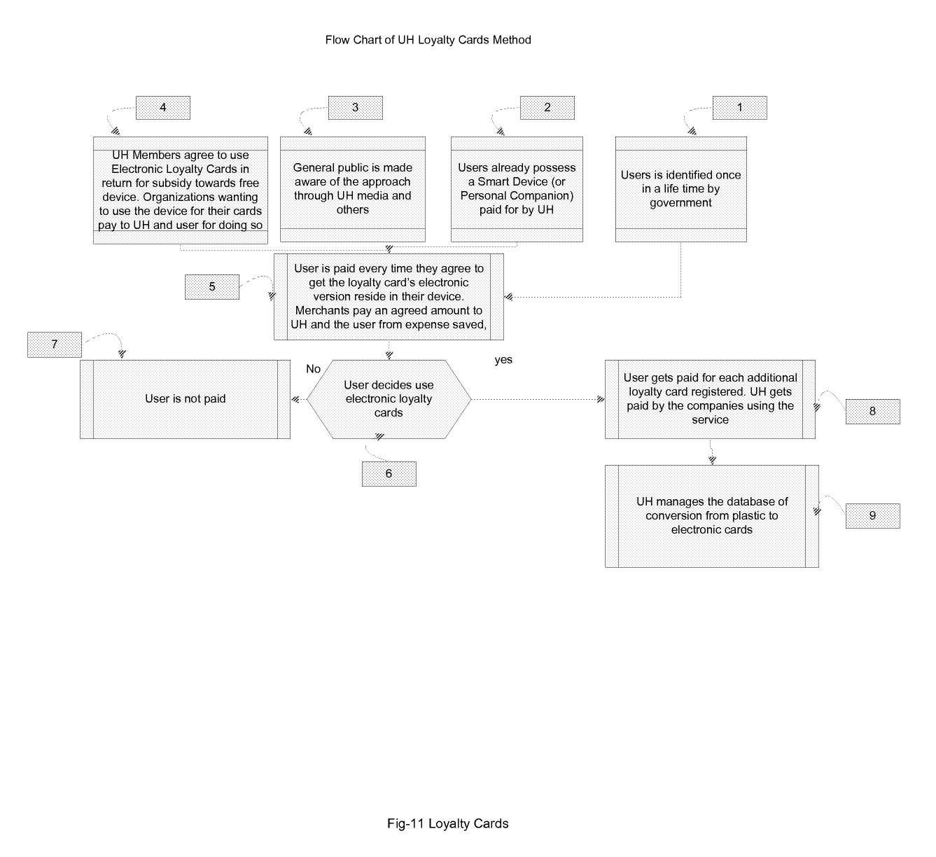

### FIG. 11 Illustrates Flow Chart Outlining Loyalty Cards Method.

Steps 11.1, 11.2 and 11.3 are analogous to the correspondingly numbered steps described in reference to FIG. 6 above.

In Step 11.4 UH, Members may agree to use Electronic Loyalty Cards in return for subsidy towards the free device that they have been provided earlier. Organizations wanting to use the device for their cards may pay (and save the cost of plastic and other overheads) an agreed amount to UH for facilitating and to the user for agreeing to do so.

In Step 11.5, a user may be paid every time they agree to get the loyalty card's electronic version reside in their device. Merchants pay an agreed amount to UH and the user from expense saved.

In Step 11.6 user may decide use electronic loyalty cards.

In Step 11.7 users may not be paid if they decline to use the feature.

In Step 11.8 user may get paid for each additional loyalty card registered. UH may get paid by the companies using the service.

In Step 11.9 UH may manage the database of conversion from plastic to electronic cards. Major stores such as, but not limited to, Shoprite or Pathmark, may use the service to save money and add ease of use to their customers. This activity may subsidize the devices provided.

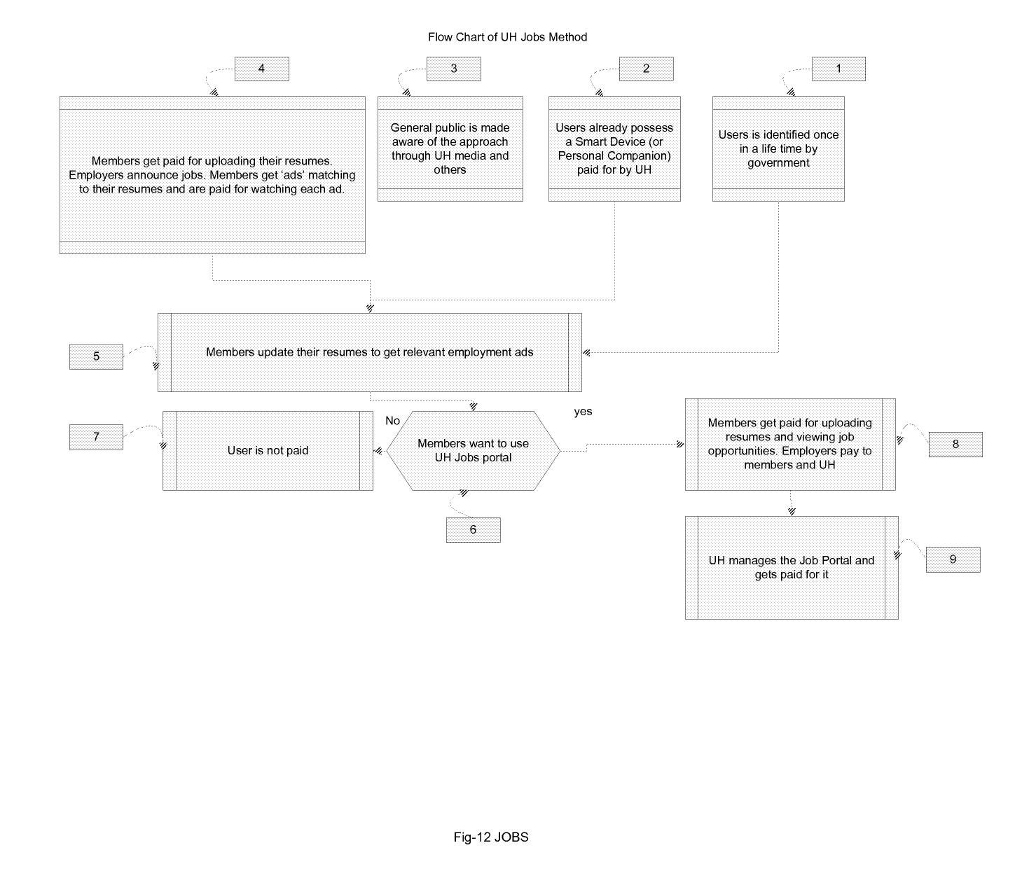

### FIG. 12 Illustrates Flow Chart of UH Job Portal Method.

Steps 12.1, 12.2 and 12.3 are analogous to the correspondingly numbered steps described in reference to FIG. 6 above.

In Step 12.4, members may get paid an agreed amount for uploading their resumes. When employers announce jobs, members may get ‘ads’ matching their resumes and may be paid for watching each of the Ads.

In Step 12.5, members may update their resumes and relevant employment ads may be filtered by the employee and employer criteria and where a match is found, the ads may be served to qualified candidates. Members may be shown an amount payable to them for clicking on employment opportunities.

In Step 12.6, members may decide not to participate.

In Step 12.7 members may not be paid for opting out of this feature, as they may be currently employed.

In Step 12.8 members may get paid for uploading resumes and viewing job opportunities. Employers may pay the members and the UH.

In Step 12.9 UH may manage the Job Portal and may get paid for it.

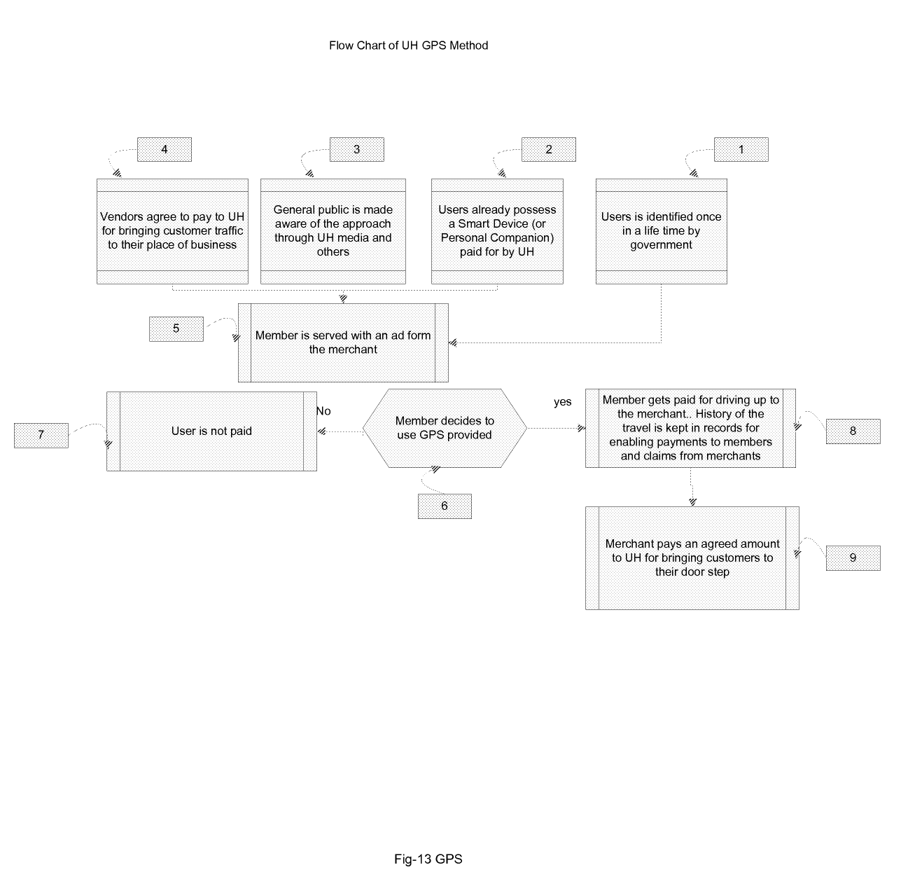

### FIG. 13 Illustrates Flow Chart of UH GPS Method.

Steps 13.1, 13.2 and 13.3 are analogous to the correspondingly numbered steps described in reference to FIG. 6 above.

In Step 13.4, vendors and businesses may agree to pay to UH for bringing customer traffic to their place of business.

In Step 13.5, members may be served with an ad form the merchant, who is interested in inviting them to their place of business. This may also happen from any other way an Ad is served to members.

In Step 13.6 member may decides if they want to use the feature or not.

In Step 13.7 members may not be paid if they opt out.

In Step 13.8 member may gets paid for driving up to the merchant. History of the travel may be kept in records for enabling payments to members and claims from merchants.

In Step 23.9 The Merchant may pay an agreed amount to UH for bringing customers to their door step.

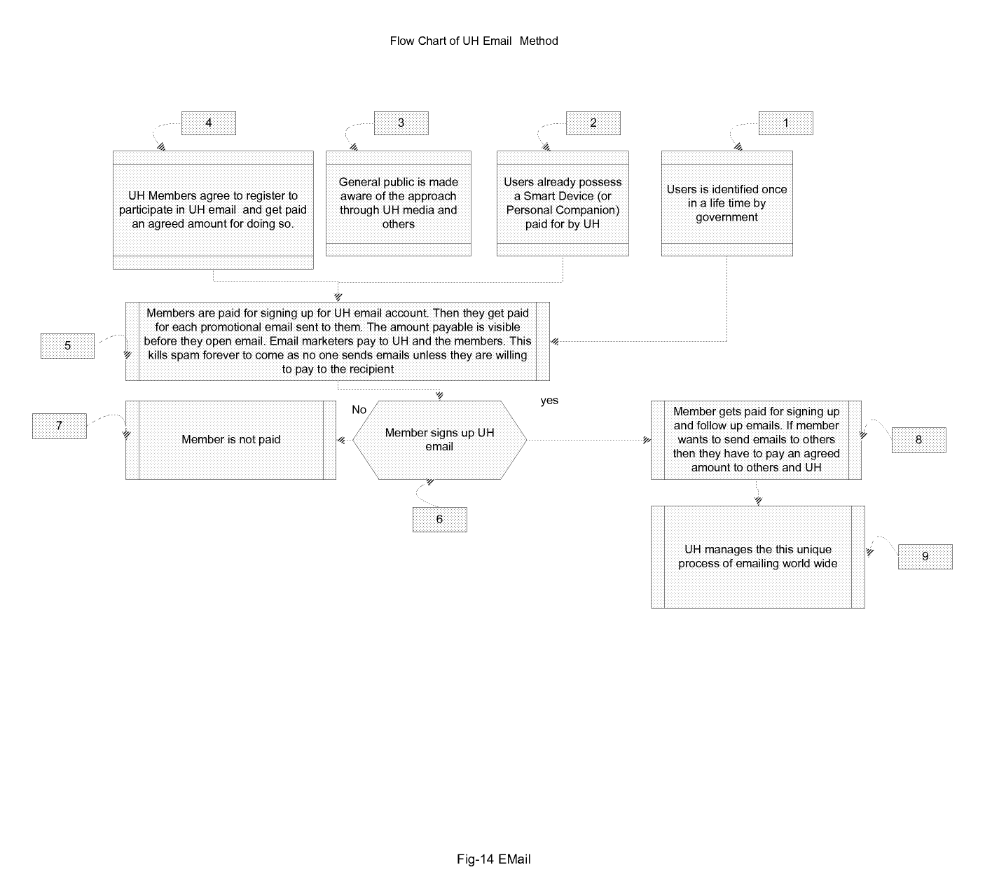

### FIG. 14 Illustrates Flow Chart of UH Email Method.

Steps 14.1, 14.2 and 14.3 are analogous to the correspondingly numbered steps described in reference to FIG. 6 above.

In Step 14.4 members may agree to register to participate in UH email and get paid an agreed amount for doing so.

In Step 14.5 Members may be paid for signing up for UH email account. Then they may get paid for each promotional email sent to them. The amount payable may be visible before they open email. Email marketers may pay the UH and the members. This may kill spam forever as no one sends emails unless they are willing to pay to the recipient.

In Step 14.6 members may decide to signup for this feature.

In Step 14.7 members may not be paid for opting out.

In Step 14.8 member gets paid for signing up and follow up emails. If a member wants to send promotional emails to others then they may have to pay an agreed amount to others and UH.

In Step 14.9 The UH may manage this unique process of emailing worldwide and may be paid for it.

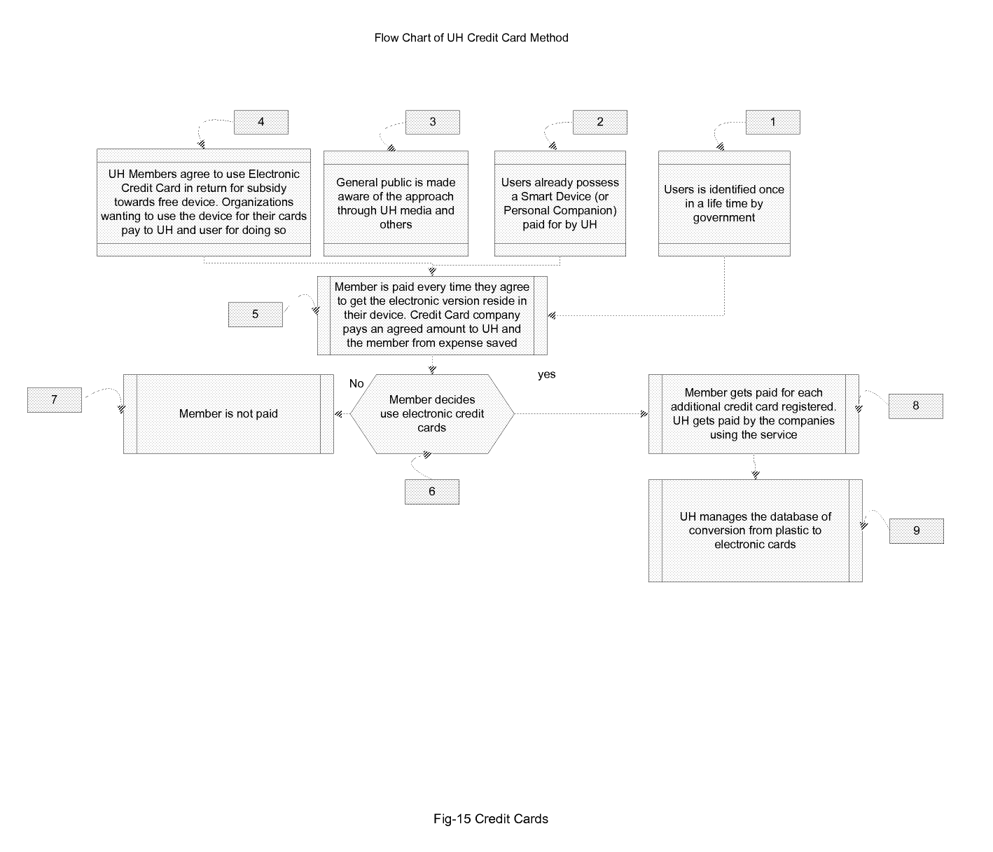

### FIG. 15 Illustrates Flow Chart of UH Credit Card Method.

Steps 15.1, 15.2 and 15.3 are analogous to the correspondingly numbered steps described in reference to FIG. 6 above.

In Step 15.4 UH members may agree to use Electronic Credit Card in return for subsidy towards free device. Organizations wanting to use the device for their cards may pay the UH and members for doing so.

In Step 15.5 member may be paid every time they agree to get the electronic version reside in their device. The Credit Card Company may pay an agreed amount to UH and the member from expense saved.

In Step 15.6 a member may decide to signup for this feature.

In Step 15.7 members may not be paid for opting out.

In Step 15.8 member may get paid for each additional credit card registered. The UH may get paid by the companies using the service.

In Step 15.9 UH may manage the database of conversion from plastic to electronic cards and may get paid in the process. The UH may decide to offer their own Credit Cards, subject to government approvals.

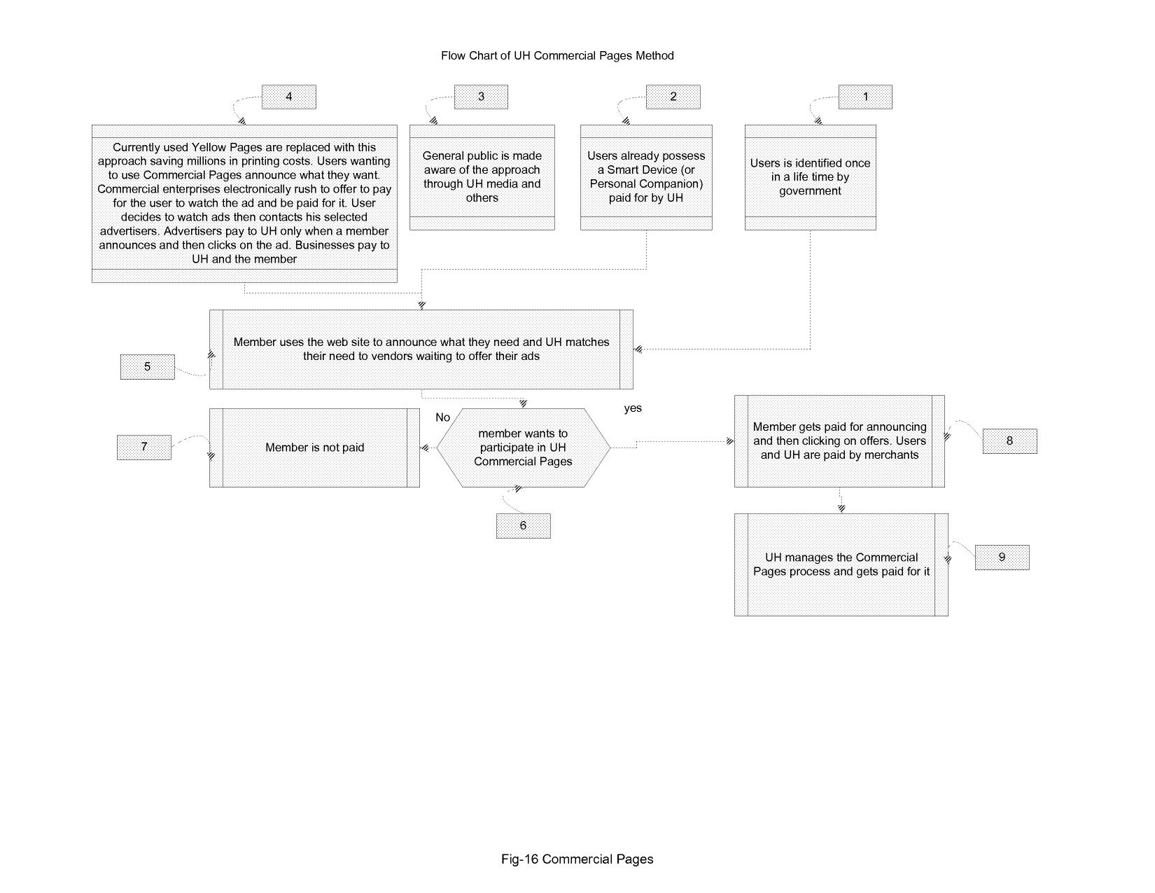

### FIG. 16 Illustrates Flow Chart of UH Email Method.

Steps 16.1, 16.2 and 16.3 are analogous to the correspondingly numbered steps described in reference to FIG. 6 above.

In Step 16.4 currently used Yellow Pages and other electronic equivalents are replaced with this approach saving millions in printing costs. Users wanting to use Commercial Pages announce what they want to buy or to check out before buying. Commercial enterprises electronically rush to offer to pay for the user to watch the ad and be paid for it. User decides to watch ads then contacts his selected advertisers. Advertisers may pay to UH only when a member announces and then clicks on the Ad. Businesses pay to UH and the member.

In Step 16.5 a member may use the web site to announce what they need and the UH may match their need to vendors waiting to offer their ads.

In Step 16.6 a member may decide to participate in UH Commercial Pages.

In Step 16.7 a member may not be paid for opting out.

In Step 16.8 member may gets paid for announcing and then clicking on offers. Users and UH may be paid by merchants.

In Step 16.9 UH may manage the Commercial Pages process and may gets paid for it.

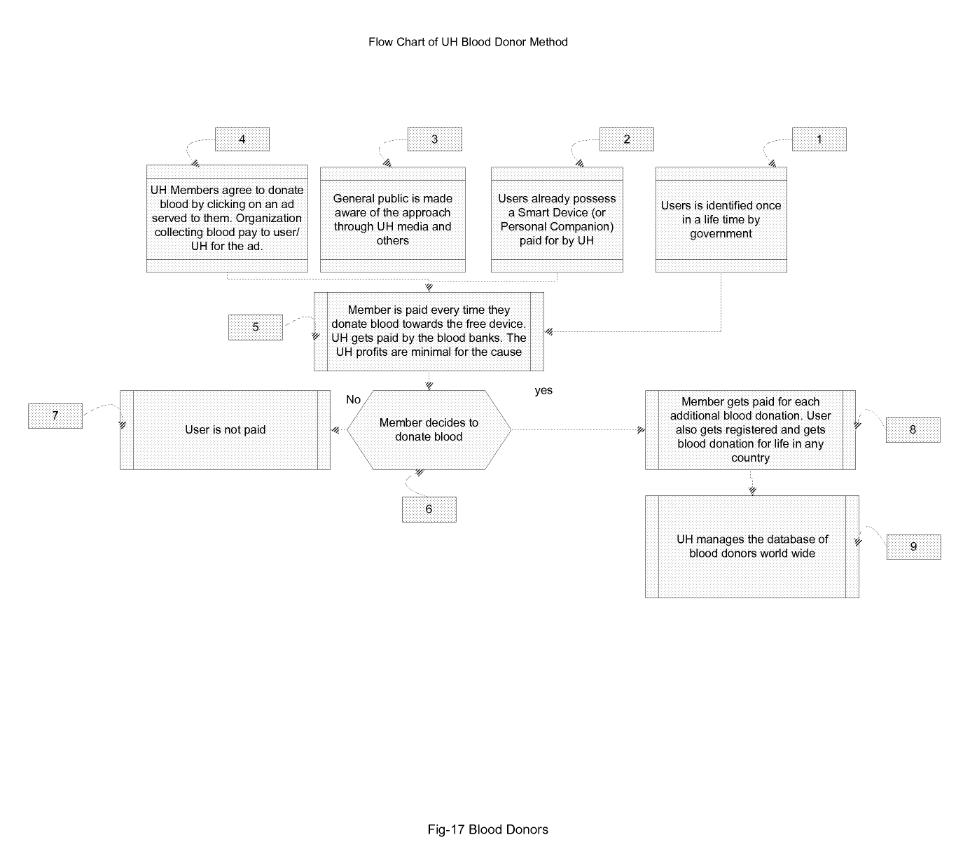

### FIG. 17 Illustrates Flow Chart of Blood Donation Method.

Steps 17.1, 17.2 and 17.3 are analogous to the correspondingly numbered steps described in reference to FIG. 6 above.

In Step 17.4 members may agree to donate blood by clicking on an ad served to them. Organization collecting blood pay to member/UH for the Ad.

In Step 17.5 member may be paid every time they donate blood towards the free device. UH gets paid by the blood banks. The UH profits are minimal for the cause.

In Step 17.6 member may decides to donate blood.

In Step 17.7 member may not be paid for opting out.

In Step 17.8 member may get paid for each additional blood donation. User also gets registered and gets blood donation for life in any country.

In Step 17.9 UH may manage the database of blood donors worldwide and every member who has donated blood once or agrees to donate blood when needed, may get blood transfusions free in any country he may be visiting.

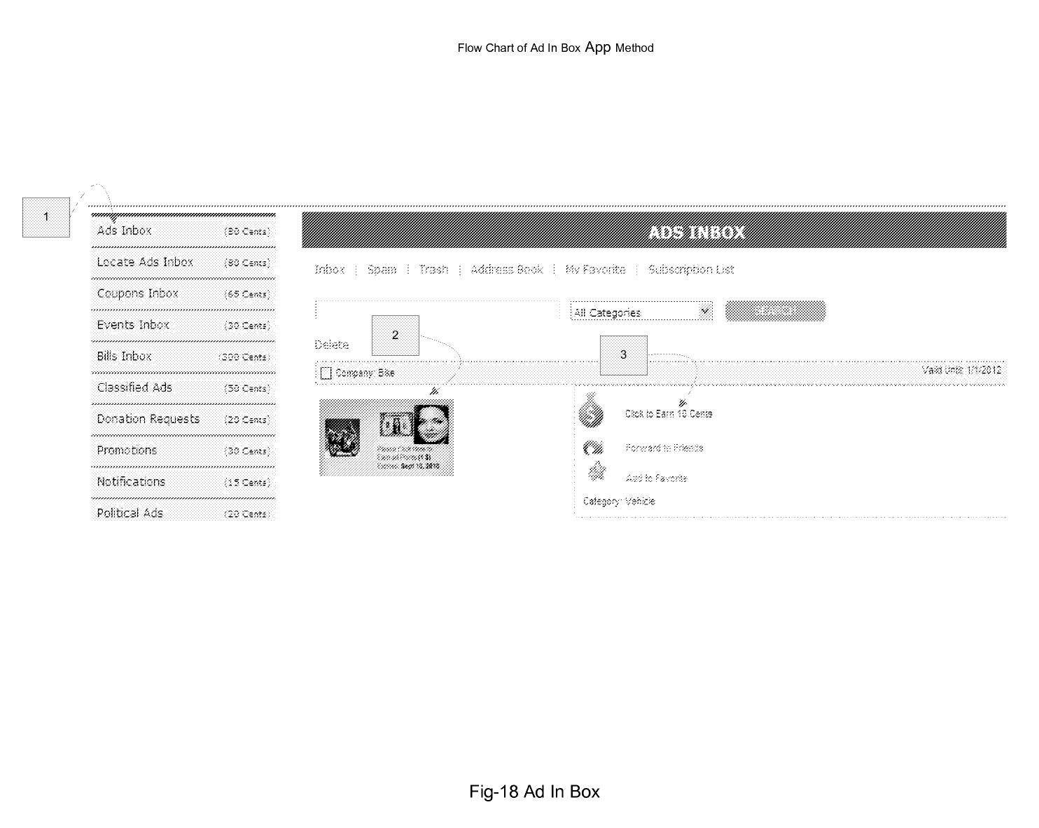

### FIG. 18 Illustrates Flow Chart of Ad In Box App Method.

Step 18.1, represents a ‘waiting area’ for the ads that may have been sent to the user while they did not want to see ads.

Step 18.2, represents a sample view of a banner advertisement that may have been sent to the user.

Step 18.3, represents a sample view of what a user may see that may entice them to click the ad.

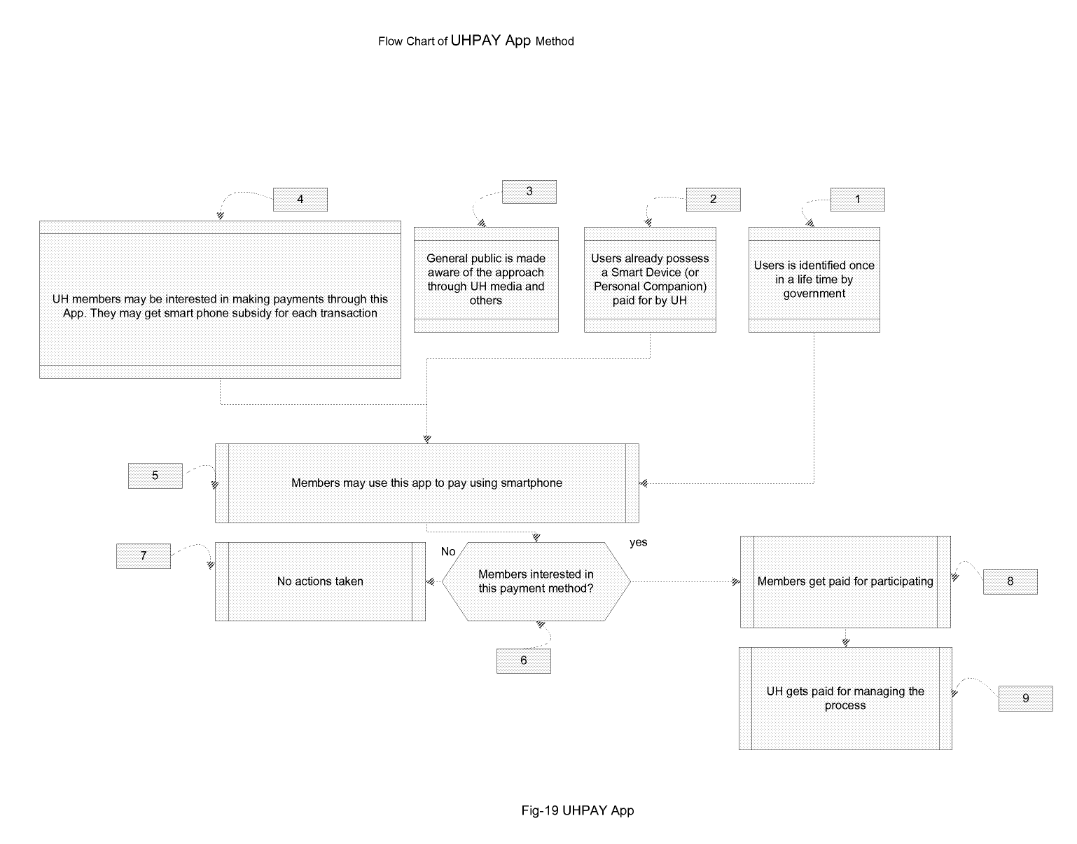

### FIG. 19 Illustrates Flow Chart of UH Pay App Method.

Steps 19.1, 19.2 and 19.3 are analogous to the correspondingly numbered steps described in reference to FIG. 6 above.

In Step 19.4 UH members may be interested in making payments through this App. They may get smart phone subsidy for each transaction.

In Step 19.5 members may use this app to pay using smartphone.

In Step 19.6 member may not be interested and may decide to opt out.

In Step 19.7 member may not be paid for opting out.

In Step 19.8 members get paid for participating.

In Step 19.9 UH may get paid for managing the process.

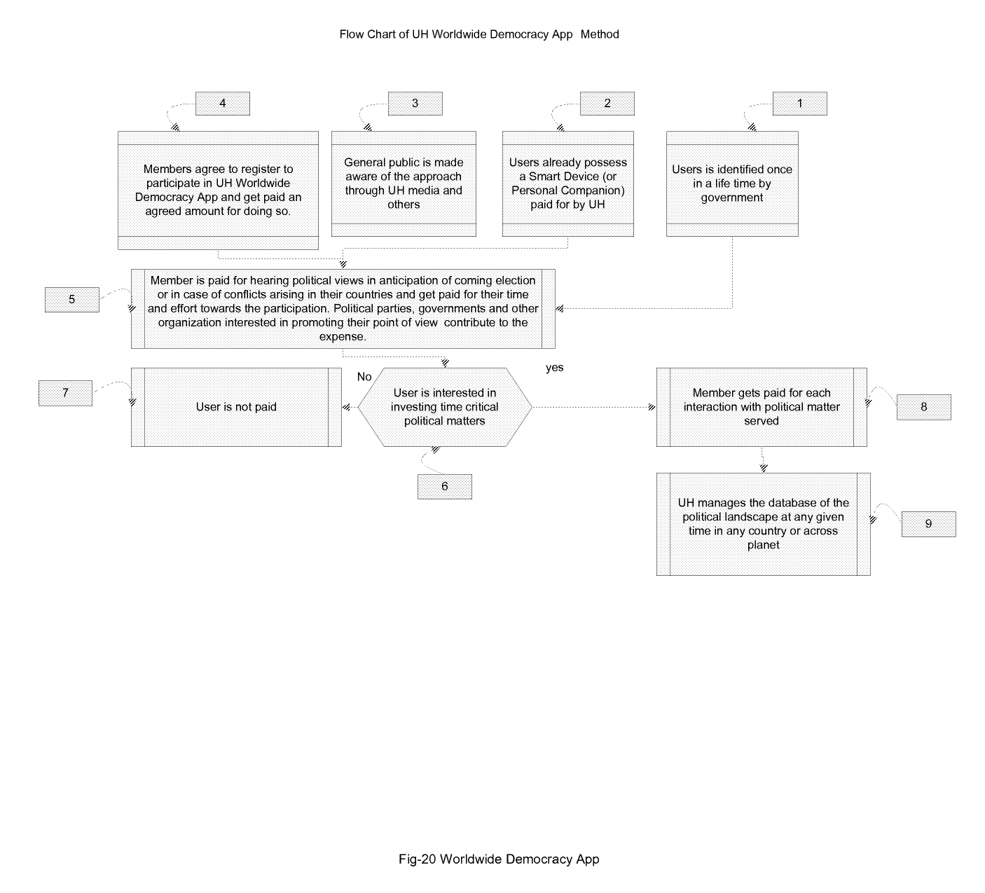

### FIG. 20 Illustrates Flow Chart of World Wide Democracy App Method.

Steps 20.1, 20.2 and 20.3 are analogous to the correspondingly numbered steps described in reference to FIG. 6 above.

In Step 20.4 members may agree to register to participate in UH Worldwide Democracy App and may get paid an agreed amount for doing so.

In Step 20.5 a member may be paid for hearing political views in anticipation of an upcoming election or of conflicts arising in their countries and may get paid for the time and effort of their participation. Political parties, governments and other organization interested in promoting their point of view may contribute to the expense.

In Step 20.6 member may decide to opt out.

In Step 20.7 member may not be paid for opting out.

In Step 20.8 member may get paid for each interaction with political material served.

In Step 20.9 UH may manage the database of the political landscape at any given time in any country or across planet and may get paid for doing so.

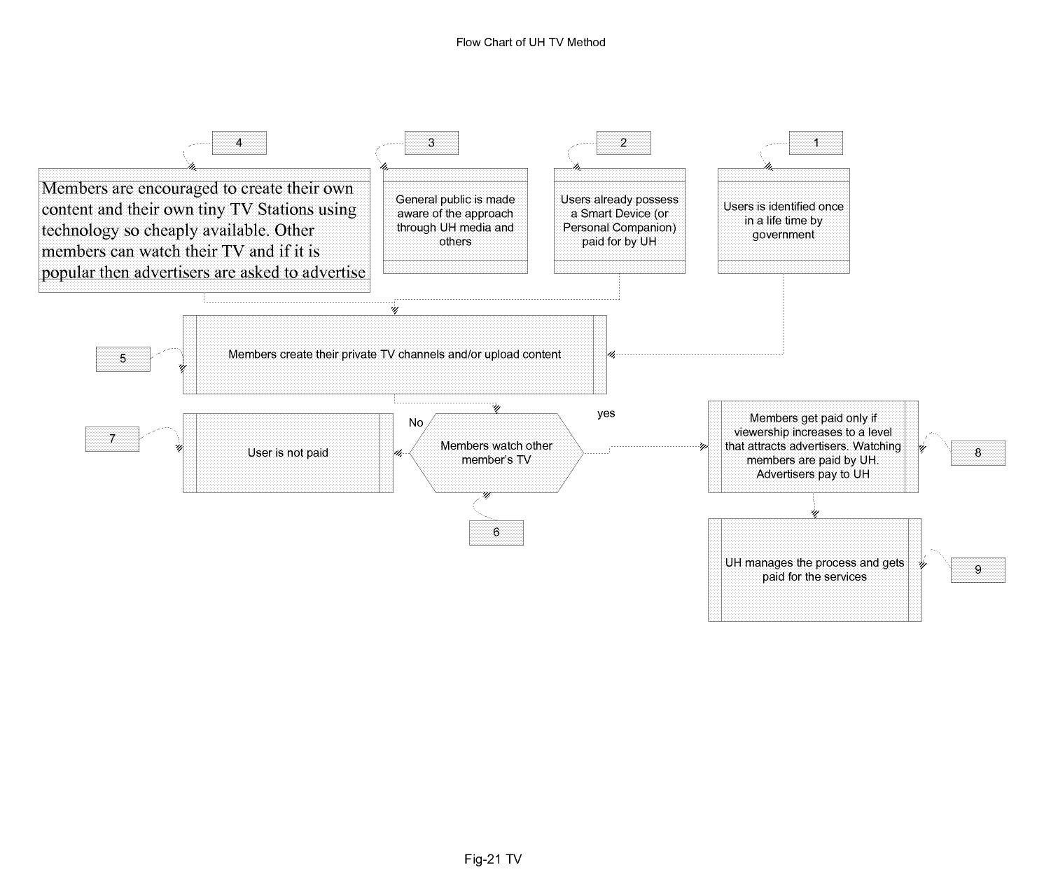

### FIG. 21 Illustrates Flow Chart of UH TV App Method.

Steps 21.1, 21.2 and 21.3 are analogous to the correspondingly numbered steps described in reference to FIG. 6 above.

In Step 21.4 members are encouraged to create their own content and their own tiny TV Stations using technology so cheaply available. Other members can watch their TV and if it is popular then advertisers are asked to advertise.

In Step 21.5 members create their private TV channels and/or upload content.

In Step 21.6 members decide to participate or not to participate.

In Step 21.7 members are not paid for opting out.

In Step 21.8 members get paid only if viewership increases to a level that attracts advertisers. Watching members are paid by UH. Advertisers pay to UH.

In Step 21.9 UH manages the process and gets paid for the services.

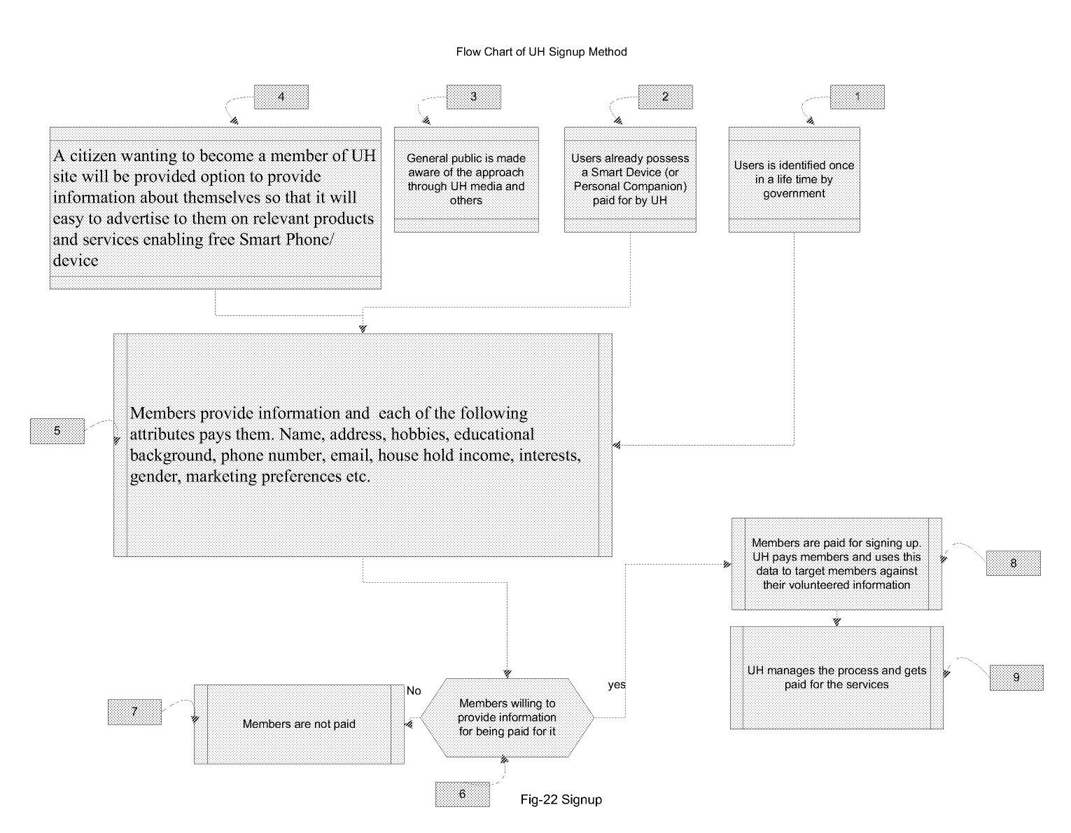

### FIG. 22 Illustrates Flow Chart of UH Signup App Method.

Steps 22.1, 22.2 and 22.3 are analogous to the correspondingly numbered steps described in reference to FIG. 6 above.

In Step 22.4 any citizen wanting to become a member of UH site may be provided option to provide information about himself or herself so that it may be easy to advertise to them on relevant products and services enabling free Smart Phone/device. Members providing more information about their buying patterns will be rewarded more in the long run also as only relevant ads will reach them.

In Step 22.5 members provide information and each of the following attributes pays them. For example name, address, hobbies, educational background, phone number, email, house hold income, interests, gender, marketing preferences etc.

In Step 22.6 members may decide to opt out.

In Step 22.7 members are not paid for opting out.

In Step 22.8 members are paid for signing up. UH pays members and uses this data to target members against their volunteered information.

In Step 22.9 UH manages the process and gets paid for the services.

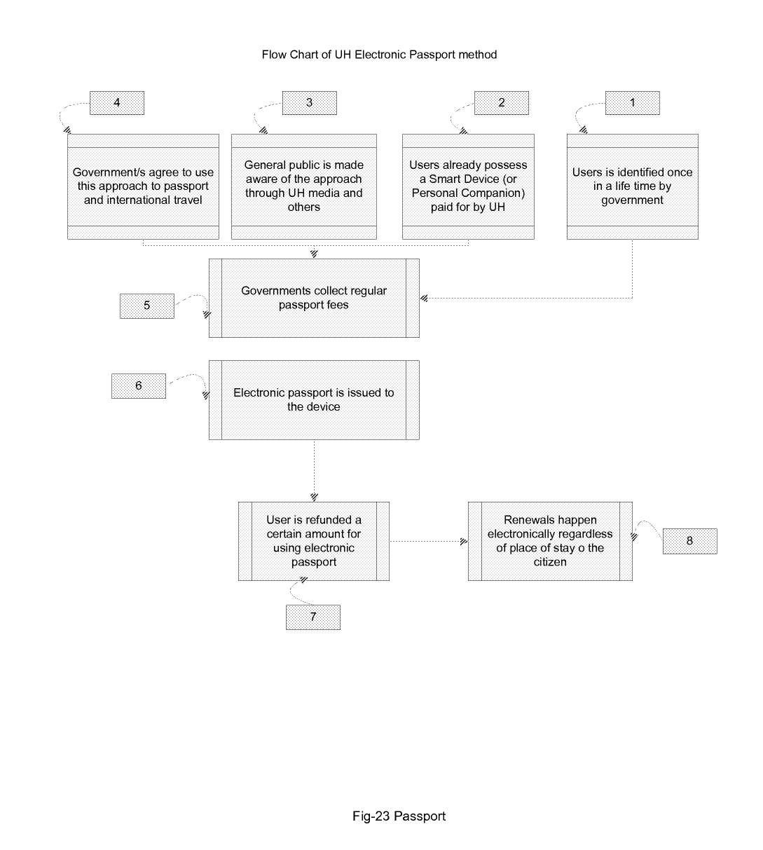

### FIG. 23 Illustrates Flow Chart of UH Electronic Passport App Method.

Steps 23.1, 23.2 and 23.3 are analogous to the correspondingly numbered steps described in reference to FIG. 6 above.

In Step 23.4 Government/s may agree to use this approach to electronic passport and international travel.

In Step 23.5 governments may collect regular passport fees.

In Step 23.6 Electronic Passport may be issued to the member and it may reside in the free device that may be provided.

In Step 23.7 member may be refunded a certain amount for using electronic passport, which is used to subsidize the free device.

In Step 23.8 renewals may happen electronically regardless of the place of stay of the citizen. Visas may now be issued electrically without the passport leaving the possession of the citizen. Governments may track movements of the person, if suspected or needed by a situation. UH may get paid fees for helping save money in physically moving passports and saving money to public.

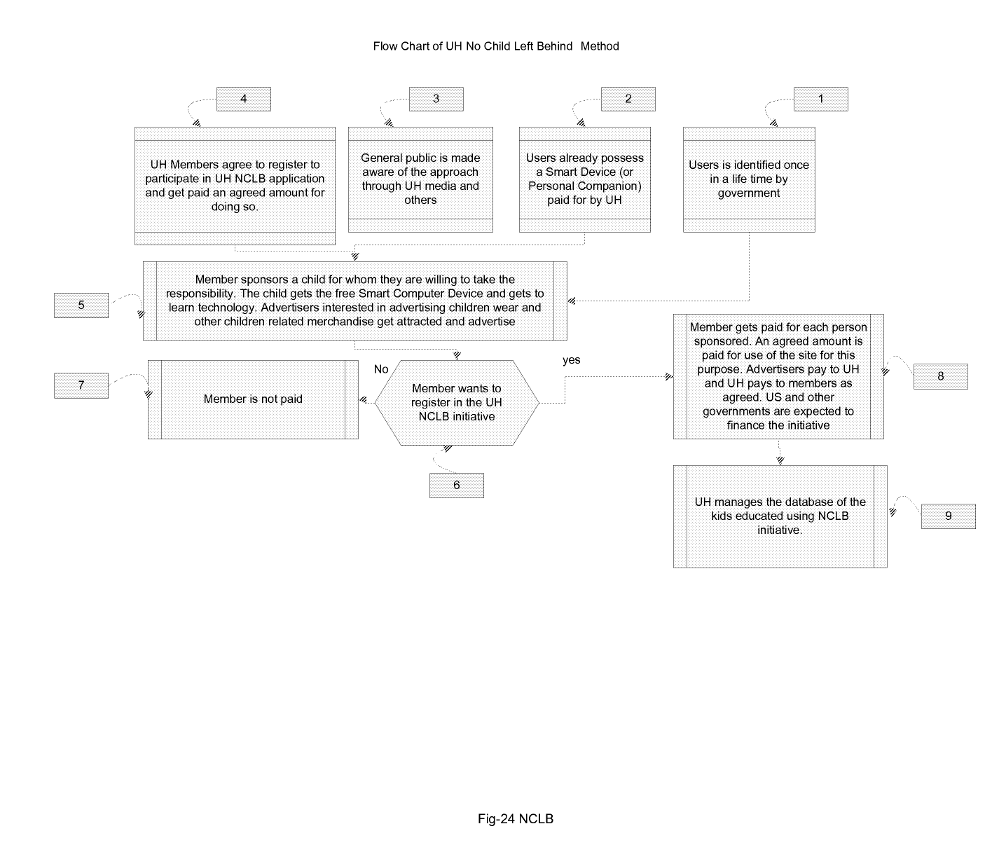

### FIG. 24 Illustrates Flow Chart of UH NCLB (No Child Left Behind) App Method.

Steps 24.1, 24.2 and 24.3 are analogous to the correspondingly numbered steps described in reference to FIG. 6 above.

In Step 24.4 members may agree to register to participate in UH NCLB application and may get paid an agreed amount for doing so.

In Step 24.5 member may sponsor a child for whom they are willing to take the responsibility. The child may get the free Smart Computer Device and may get to learn technology. Advertisers interested in advertising children wear and other children related merchandise may get attracted and may decide to advertise.

In Step 24.6 members may decide if they want to participate.

In Step 24.7 members may not be paid for opting out.

In Step 24.8 member may be paid for each person sponsored. An agreed amount may be paid for use of the site for this purpose. Advertisers may pay to UH and UH may pay to members as may be agreed with them. US and other governments may be expected to finance the initiative, which will cost much less due to ad based subsidy.

In Step 9 UH may manage the database of the children educated using NCLB initiative.

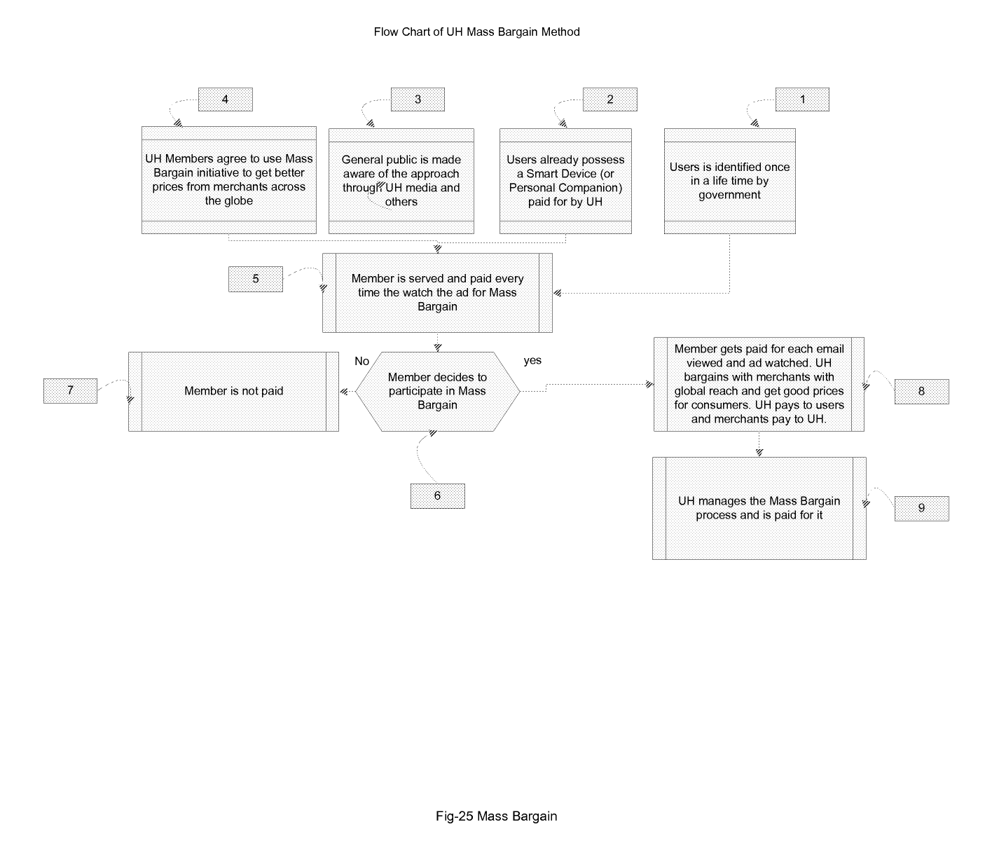

### FIG. 25 Illustrates Flow Chart of Mass Bargain App Method.

Steps 25.1, 25.2 and 25.3 are analogous to the correspondingly numbered steps described in reference to FIG. 6 above.

In Step 25.4 members may agree to use Mass Bargain initiative to get better prices from merchants across the globe.

In Step 25.5 member may be served and may be paid every time the watch the ad for Mass Bargain.

In Step 25.6 member may opt out of the feature.

In Step 25.7 member may not be paid for opting out.

In Step 25.8 member may get paid for each email viewed and ad watched. UH may bargain with merchants with global reach and may get good prices for consumers. UH may pay to users and merchants may pay to UH.

In Step 25.9 UH may manage the Mass Bargain process and may be paid for it.

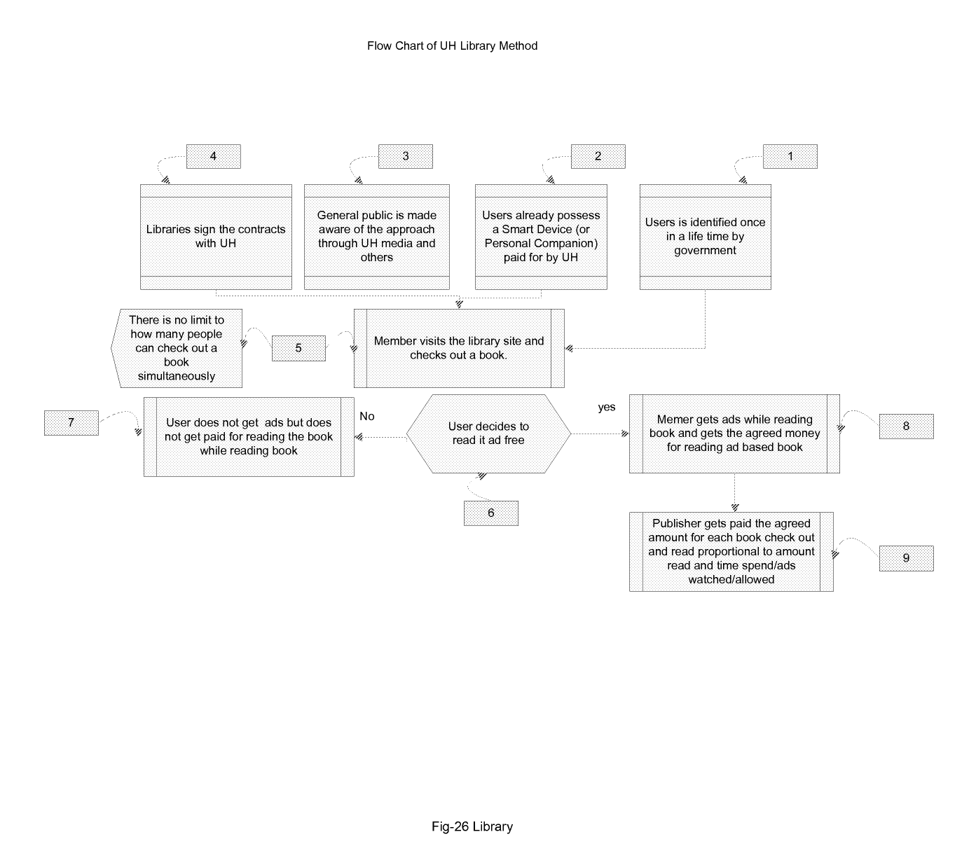

### FIG. 26 Illustrates Flow Chart of Libraries App Method.

Steps 26.1, 26.2 and 26.3 are analogous to the correspondingly numbered steps described in reference to FIG. 6 above.

In Step 26.4 libraries across the globe sign the contracts with UH.

In Step 26.5 member may visit the library site and may check out a book. There may be no limit to how many people may check out a book simultaneously.

In Step 26.6 member may decide to read the book ads free.

In Step 26.7 member may not get ads but may not get paid for the time they are reading the book In Step 26.8 member may get ads while reading book and may get the agreed money for reading ad based book.

In Step 26.9 publisher may get paid the agreed amount for each book checked out and read proportional to amount read and time spent/ads watched/allowed.

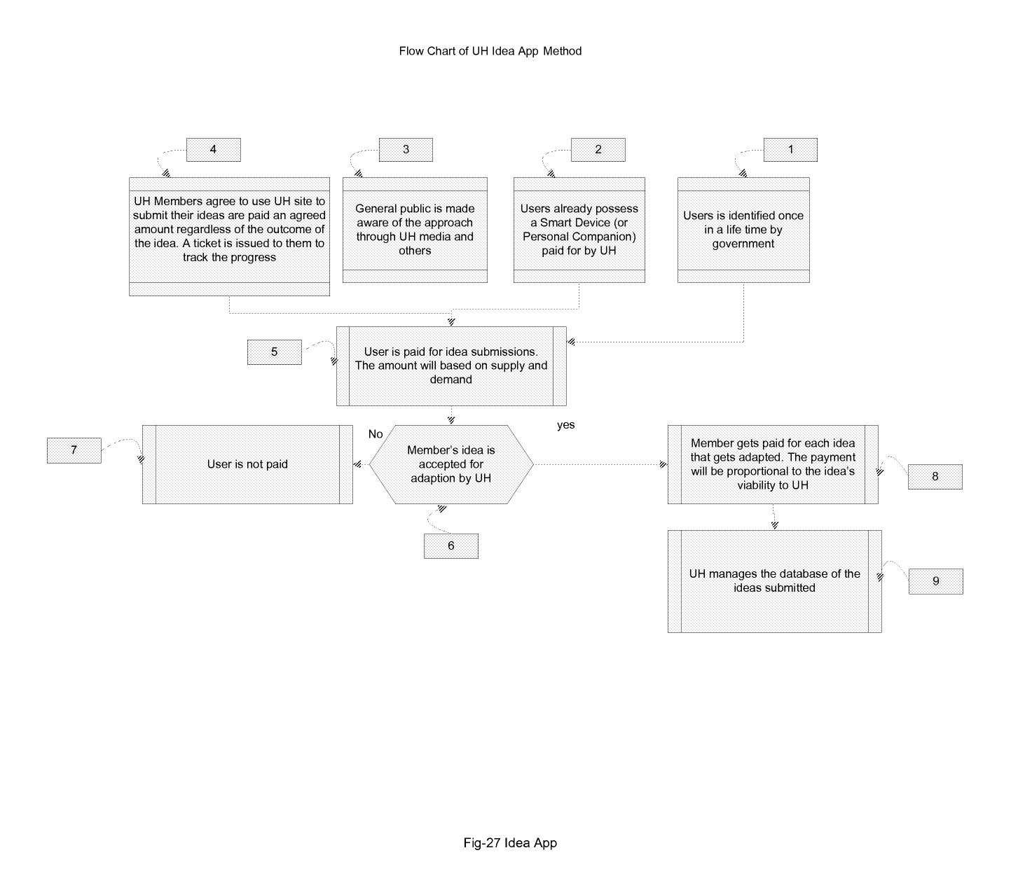

### FIG. 27 Illustrates Flow Chart of Ideas App Method.

Steps 27.1, 27.2 and 27.3 are analogous to the correspondingly numbered steps described in reference to FIG. 6 above.

In Step 27.4 members may agree to use UH site to submit their ideas and may be paid an agreed amount regardless of the outcome of the idea. A ticket may be issued to them to track the progress.

In Step 27.5 member may be paid for idea submissions. The amount may be based on supply and demand.

In Step 27.6 member's idea may be evaluated if it is to be accepted for adaption by UH or not.

In Step 27.7 member may not be paid if the idea may be rejected.

In Step 27.8 member may get paid for each idea that may get adapted. The payment may be proportional to the idea's viability to UH.

In Step 27.9 UH may manage the database of the ideas submitted and may adapt great ideas submitted from all over the world while benefiting the contributors.

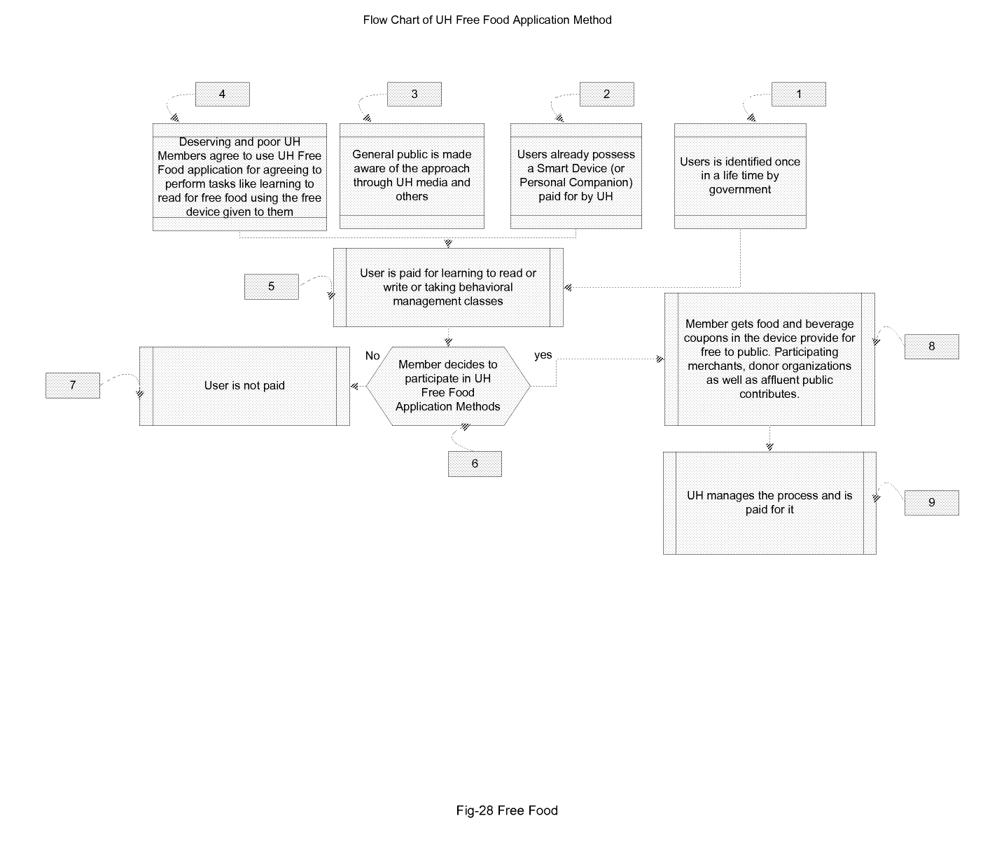

### FIG. 28 Illustrates Flow Chart of Free Food App Method.

Steps 28.1, 28.2 and 28.3 are analogous to the correspondingly numbered steps described in reference to FIG. 6 above.

In Step 28.4 deserving and poor UH members may agree to use UH Free Food application for agreeing to perform tasks like learning to read for free food and personal hygiene etc. using the free device given to them.

In Step 28.5 member may be paid (or provided food) for learning to read or write or taking behavioral management classes.

In Step 28.6 member may decide to opt out if they liked.

In Step 28.7 member may not be paid for opting out.

In Step 28.8 Member may get food and beverage coupons in the device provide for free to public. Participating merchants, donor organizations as well as affluent public may contribute.

In Step 28.8 UH may manage the process and is paid for it.

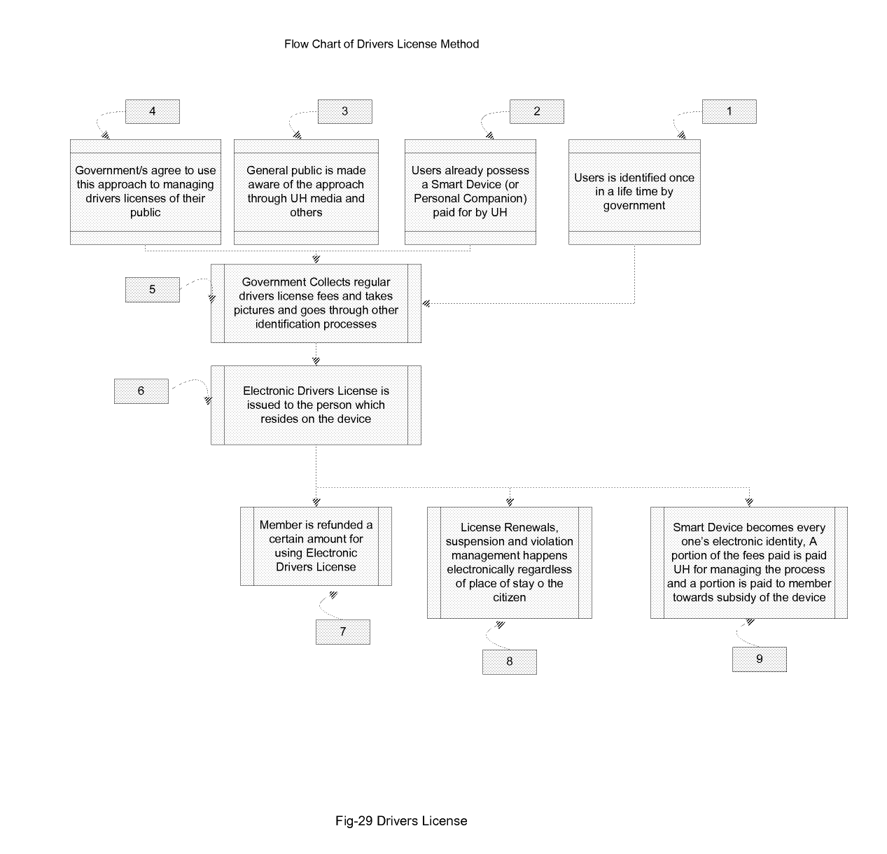

### FIG. 29 Illustrates Flow Chart of Driver's License App Method.

Steps 29.1, 29.2 and 29.3 are analogous to the correspondingly numbered steps described in reference to FIG. 6 above.

In Step 29.4 Government/s may agree to use this approach to managing driver's licenses of their public.

In Step 29.5 Government/s may collect regular driver's license fees and may take pictures and go through other identification processes.

In Step 29.6 Electronic Drivers License may be issued to the person. The license may reside on the device.

In Step 29.7 member may be refunded a certain amount for using Electronic Drivers License.

In Step 29.8 License Renewals, suspension and violation management may happen electronically regardless of place of stay o the citizen/member.

In Step 29.9 The Device may become every one's electronic identity, A portion of the fees paid is paid to UH for managing the process and a portion may be paid to member towards subsidy of the free device.

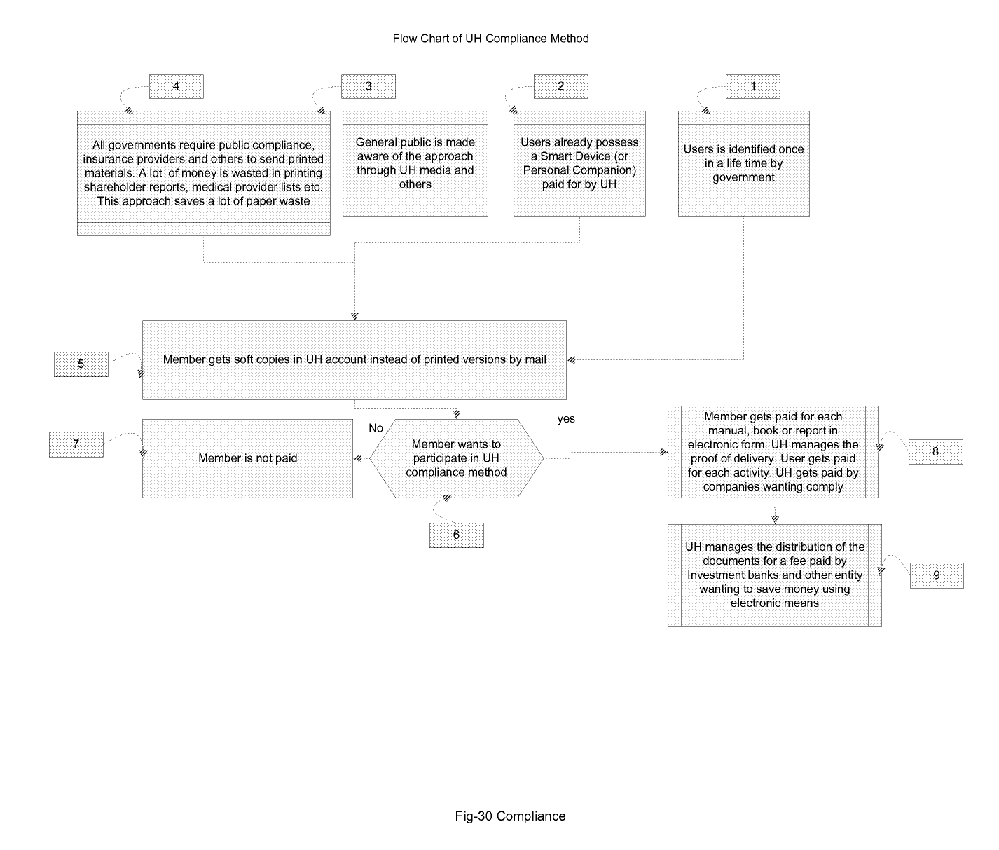

### FIG. 30 Illustrates Flow Chart of Compliance App Method.

Steps 30.1, 30.2 and 30.3 are analogous to the correspondingly numbered steps described in reference to FIG. 6 above.

In Step 30.4 governments may require public compliance by, insurance providers, Publicly Traded Companies and others to send printed materials to public. A lot of money is wasted in printing shareholder reports, medical provider lists etc. The UH approach may save a lot of paper and energy waste.

In Step 30.5 member may get soft copies in UH account instead of printed versions by mail.

In Step 30.6 member may decide to participate in UH compliance method.

In Step 30.7 member may not be paid for opting out.

In Step 30.8 member may get paid for downloading each manual, book or report in electronic form. UH may manage the proof of delivery. Member may get paid for each activity. UH may get paid by companies wanting to comply who may get real time feedback about the activity. Compliance reports may be used for submission to government agencies.

In Step 30.9 UH may manage the distribution of the documents for a fee that may be paid by Investment banks and other entity who may want to save money using electronic means. Members may get subsidy towards free device.

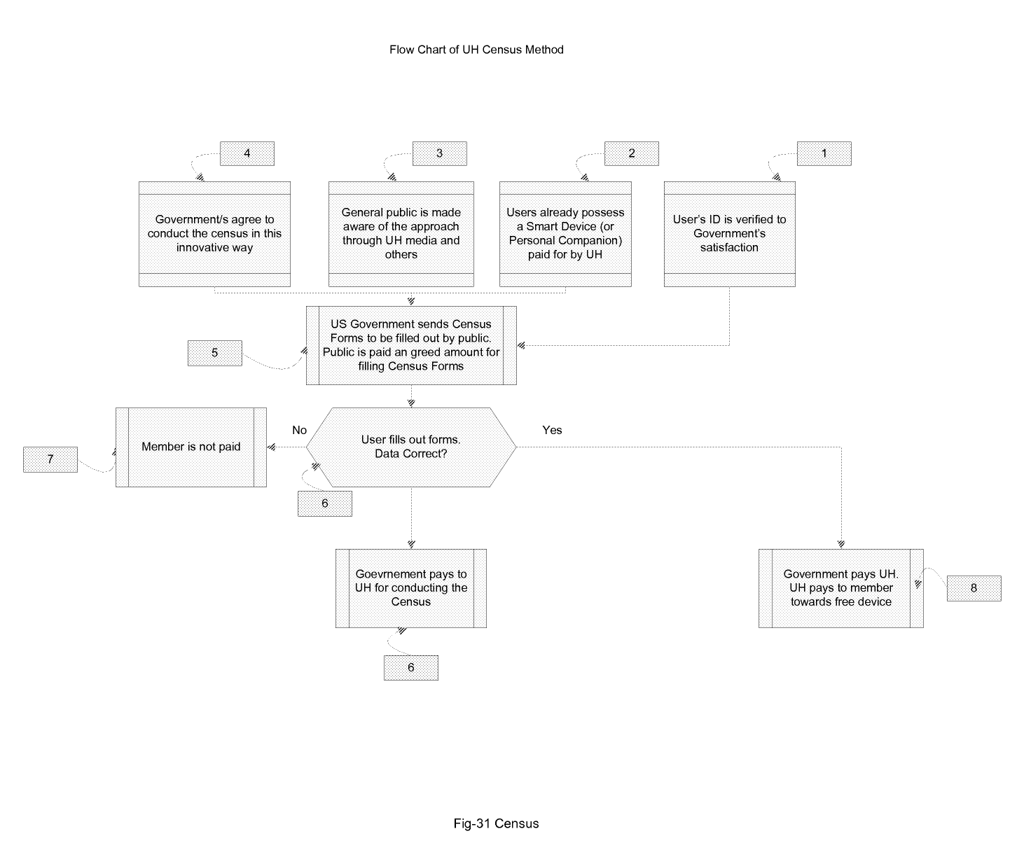

### FIG. 31 Illustrates Flow Chart of Census App Method.

Steps 31.1, 31.2 and 31.3 are analogous to the correspondingly numbered steps described in reference to FIG. 6 above.

In Step 31.4 government/s may agree to conduct the census in this innovative way.

In Step 31.5 US (or any other) government may send Census Forms to be filled out by public. Public may be paid an greed amount for filling Census Forms.

In Step 31.6 members may opt to fill out the form using the free device or Internet and ensures that data is correct.

In step 31.7 member may not be paid for opting out or filling forms incorrectly.

In Step 31.8 Government/s may pay to UH. UH may pay to member towards free device.

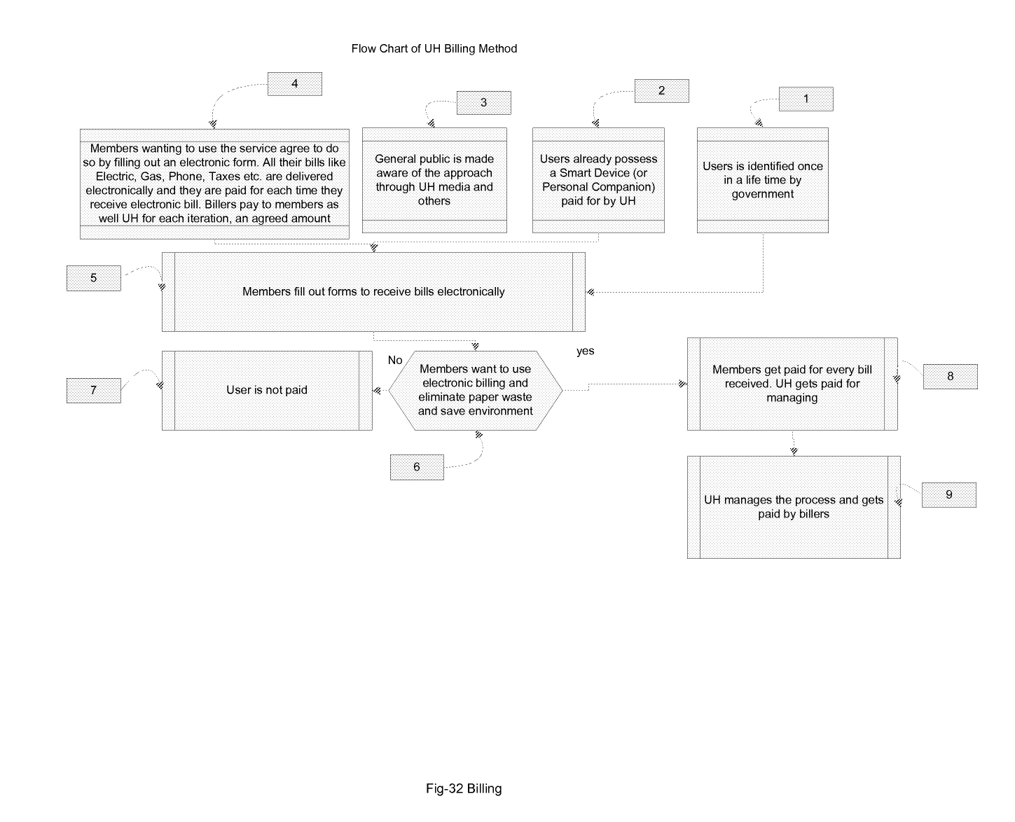

### FIG. 32 Illustrates Flow Chart of Billing App Method.

Steps 32.1, 32.2 and 32.3 are analogous to the correspondingly numbered steps described in reference to FIG. 6 above.

In Step 32.4 Members wanting to use the service agree to do so by filling out an electronic form. All their bills like Electric, Gas, Phone, Taxes etc. are delivered electronically and they are paid for each time they receive electronic bill. Billers pay to members as well UH for each iteration, an agreed amount.

In Step 32.5 members fill out forms to receive bills electronically.

In Step 32.6 Members want to use electronic billing and eliminate paper waste and save environment.

In step 32.7 user is not paid.

In Step 32.8 members get paid for every bill received. UH gets paid for managing.

In Step 32.9 UH manages the process and gets paid by billers.

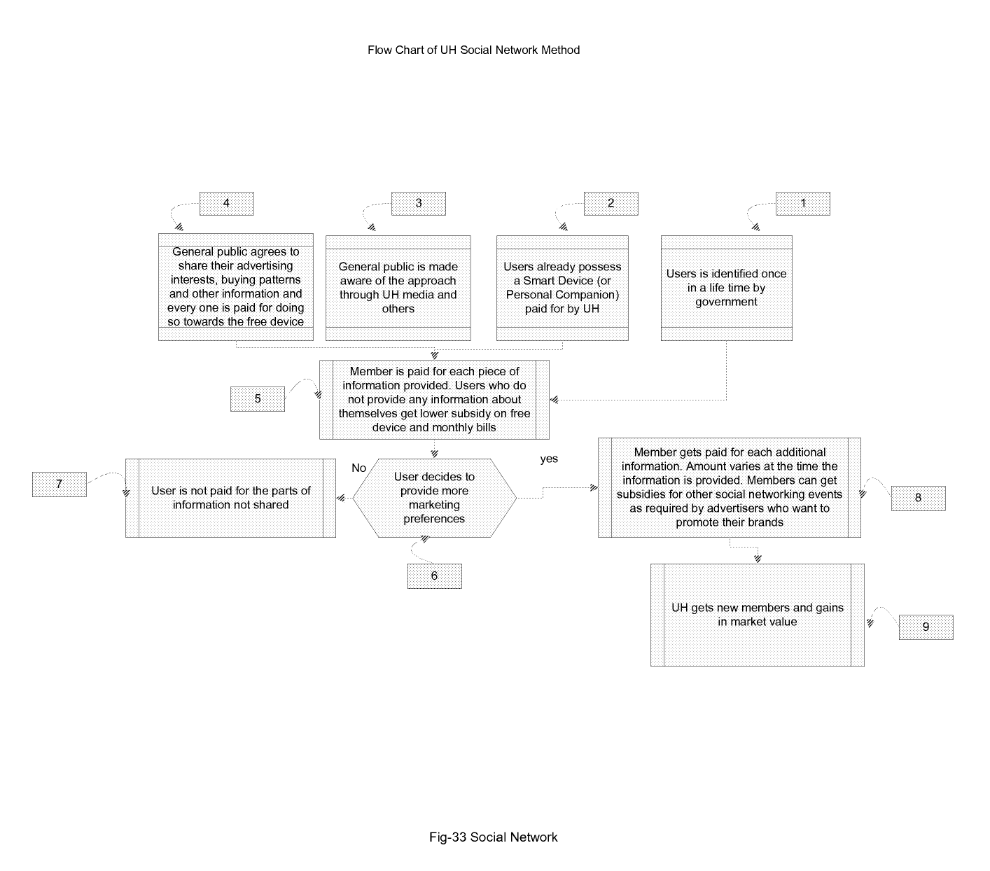

### FIG. 33 Illustrates Flow Chart of UH Social Network App Method.

Steps 33.1, 33.2 and 33.3 are analogous to the correspondingly numbered steps described in reference to FIG. 6 above.

In Step 33.4 general public may agree to share their advertising interests, buying patterns and other information and everyone may be paid for doing so towards the free device.

In Step 33.5 member may be paid for each piece of information provided at the time of signing up. Members who may not provide any information about them may get lower subsidy on free device and monthly bills.

In Step 33.6 members may have the option to provide personal information or decline it.

In Step 33.7 members who may decline to provide information may NOT be paid only for the relevant parts of information not shared.

In Step 33.8 member may get paid for additional information. Amount may vary at the time the information is provided. Members may get subsidies for other social networking events as required by advertisers who may want to promote their brands.

In Step 33.9 UH may get new members and may gain in market value of its shares for subsidizing the free device.

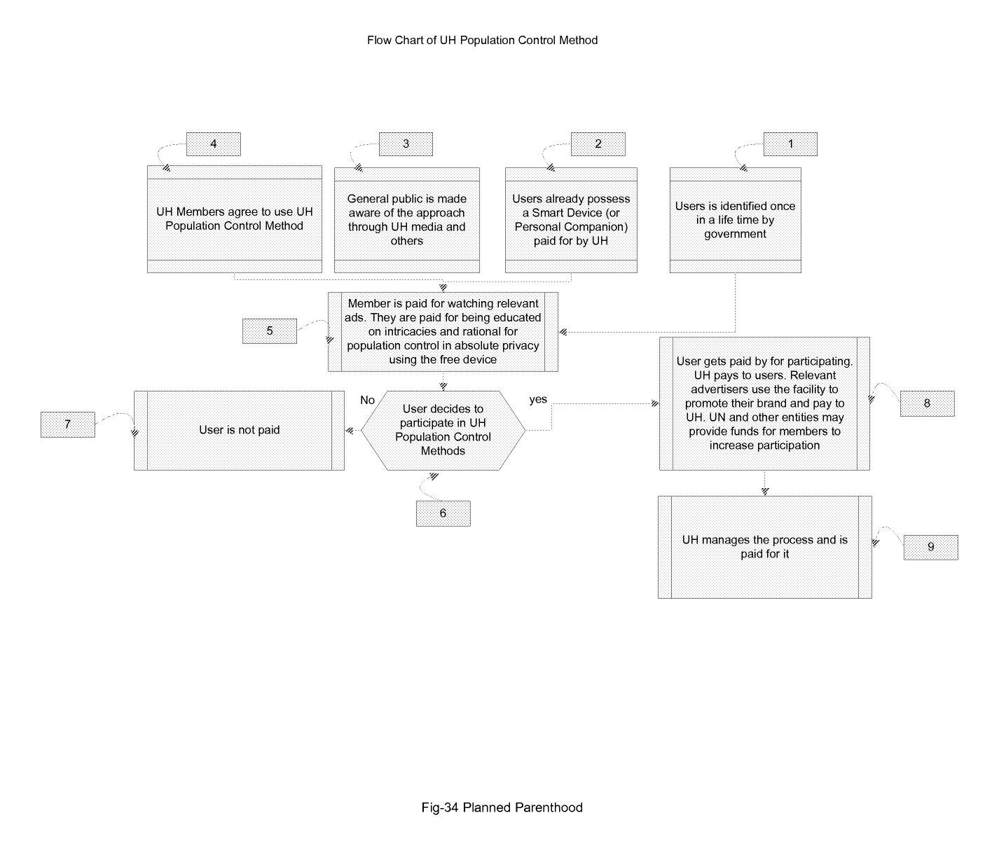

### FIG. 34 Illustrates Flow Chart of UH Planned Parenthood App Method.

Steps 34.1, 34.2 and 34.3 are analogous to the correspondingly numbered steps described in reference to FIG. 6 above.

In Step 34.4 UH members may agree to use UH Population Control Method.

In Step 34.5 member may be paid for watching relevant ads of products and services that create awareness of the subject. They may be paid for being educated on intricacies and rational for population control in absolute privacy using the free device.

In Step 34.6 members may decide to opt in or not.

In Step 34.7 members may not be paid if they opt out.

In Step 34.8 members may get paid by for participating. UH may pay to mambers. Relevant advertisers may use the facility to promote their brand and may pay to UH. UN and other entities may provide funds for members to increase participation.

In Step 34.9 UH may manage the process and may be paid for it.

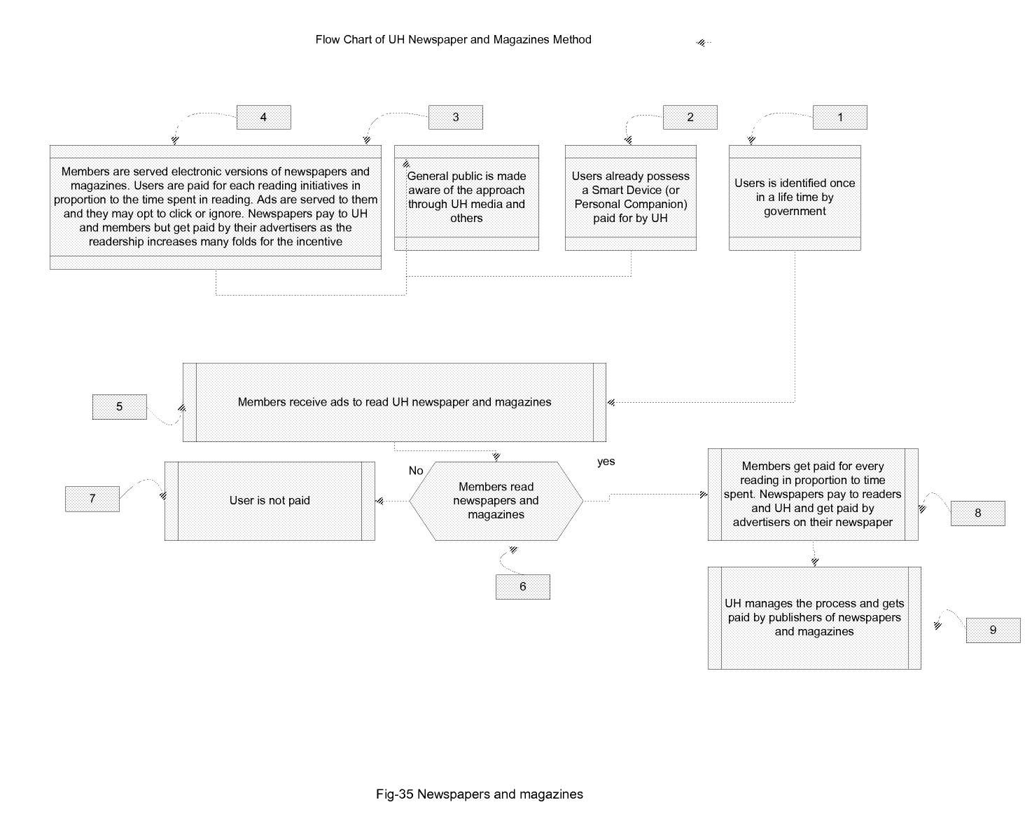

### FIG. 35 Illustrates Flow Chart of UH Newspapers and Magazines App Method.

Steps 35.1, 35.2 and 35.3 are analogous to the correspondingly numbered steps described in reference to FIG. 6 above.

In Step 35.4 members may be served electronic versions of newspapers and magazines. Members may be paid for each reading initiatives in proportion to the time spent in reading. Ads may be served to them and they may opt to click or ignore. Newspapers may pay to UH and members but may get paid by their advertisers as the readership may increase many folds for the incentive.

In Step 35.5 members may opt to read UH newspaper and magazines.

In Step 35.6 members may opt out of the feature.

In Step 35.7 members may not be paid if they have opted out.

In Step 35.8 members may get paid for every reading in proportion to time spent. Newspapers pay to readers and UH and may get paid by advertisers on their newspaper.

In Step 35.9 UH may manage the process and may get paid by publishers of newspapers and magazines.

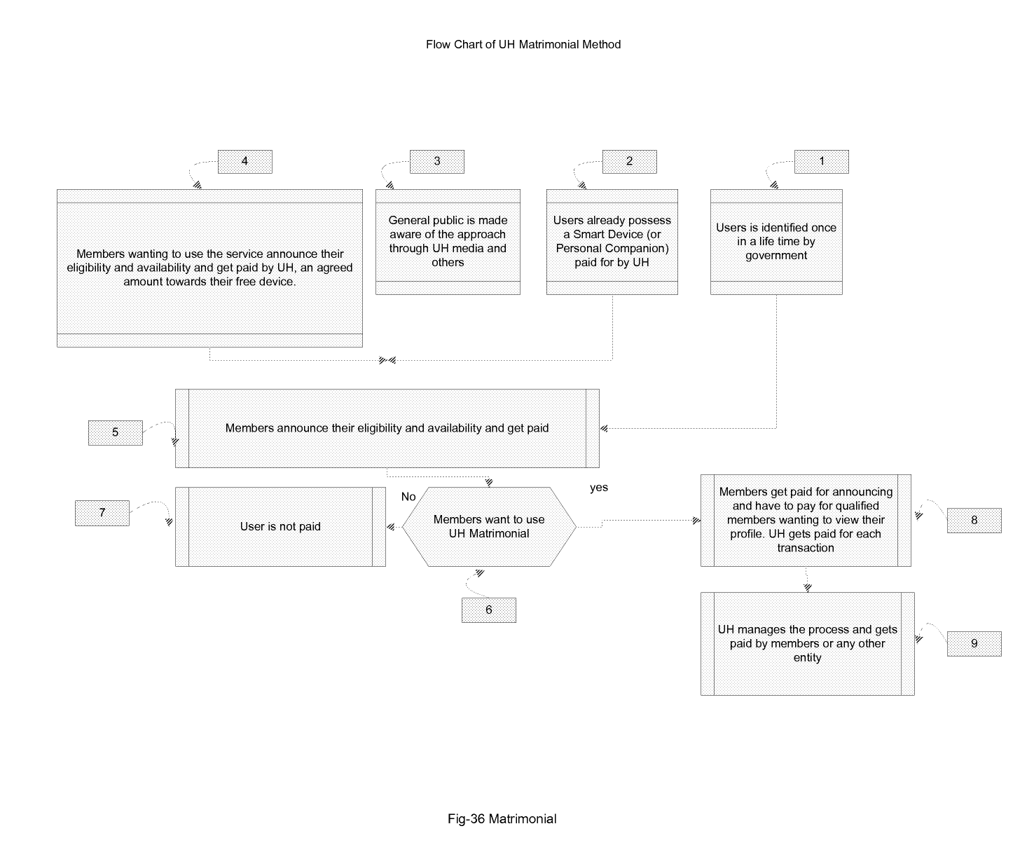

### FIG. 36 Illustrates Flow Chart of UH Matrimonial App Method.

Steps 36.1, 36.2 and 36.3 are analogous to the correspondingly numbered steps described in reference to FIG. 6 above.

In Step 36.4 Members wanting to use the service may announce their eligibility and availability and may get paid by UH, an agreed amount towards their free device.

In Step 36.5 Members may announce their eligibility and availability and get paid.

In Step 36.6 members may decide to opt out if they want.

In Step 36.7 members may not be paid if they opt out.

In Step 36.8 Members get paid for announcing and have to pay for qualified members wanting to view their profile. UH gets paid for each transaction.

In Step 36.9 UH manages the process and gets paid by members or any other entity.

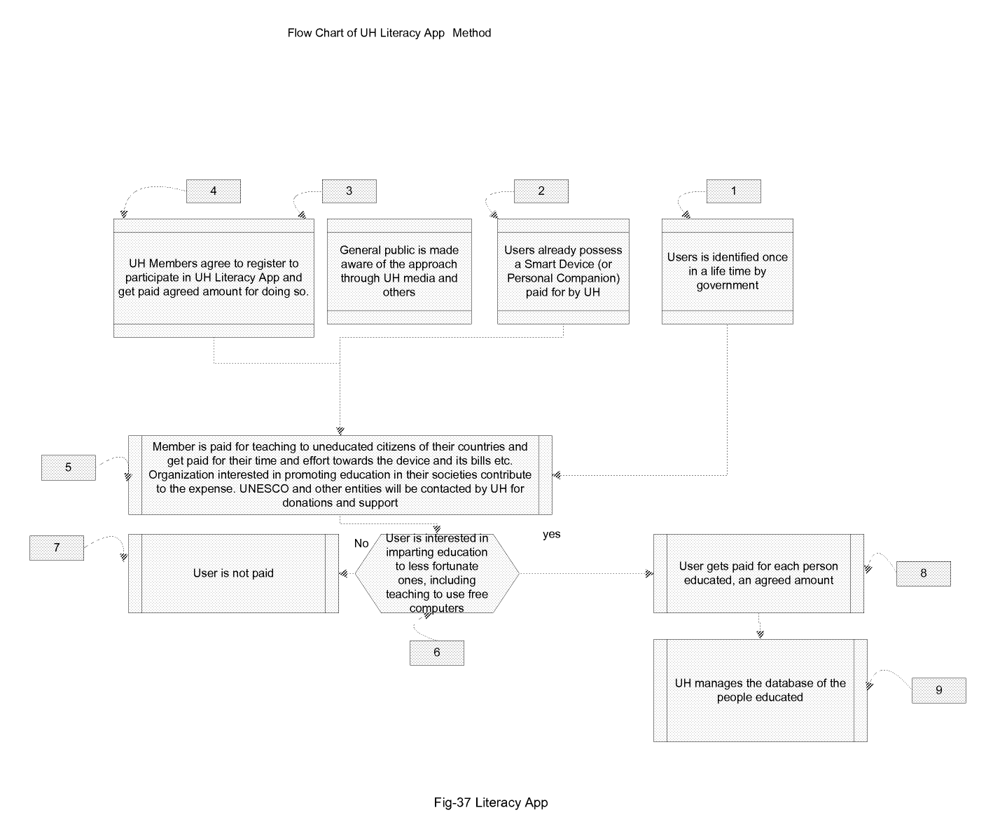

### FIG. 37 Illustrates Flow Chart of UH Literacy App Method.

Steps 37.1, 37.2 and 37.3 are analogous to the correspondingly numbered steps described in reference to FIG. 6 above.

In Step 37.4 UH members may agree to register to participate in UH Literacy App and may get paid an agreed amount for doing so.

In Step 37.5 member may be paid for teaching to uneducated citizens of their countries and may get paid for their time and effort towards the device and its bills etc. Organizations interested in promoting education in their societies contribute to the expense. UNESCO and other entities may be contacted by UH for donations and support.

In Step 37.6 members may decide if they may be interested in imparting education to less fortunate ones, including teaching to use free computers.

In Step 37.7 members may not be paid for opting out.

In Step 37.8 member may get paid an agreed amount for each person educated. This may help spread education.

In Step 37.9 UH may manage the database of the people educated.

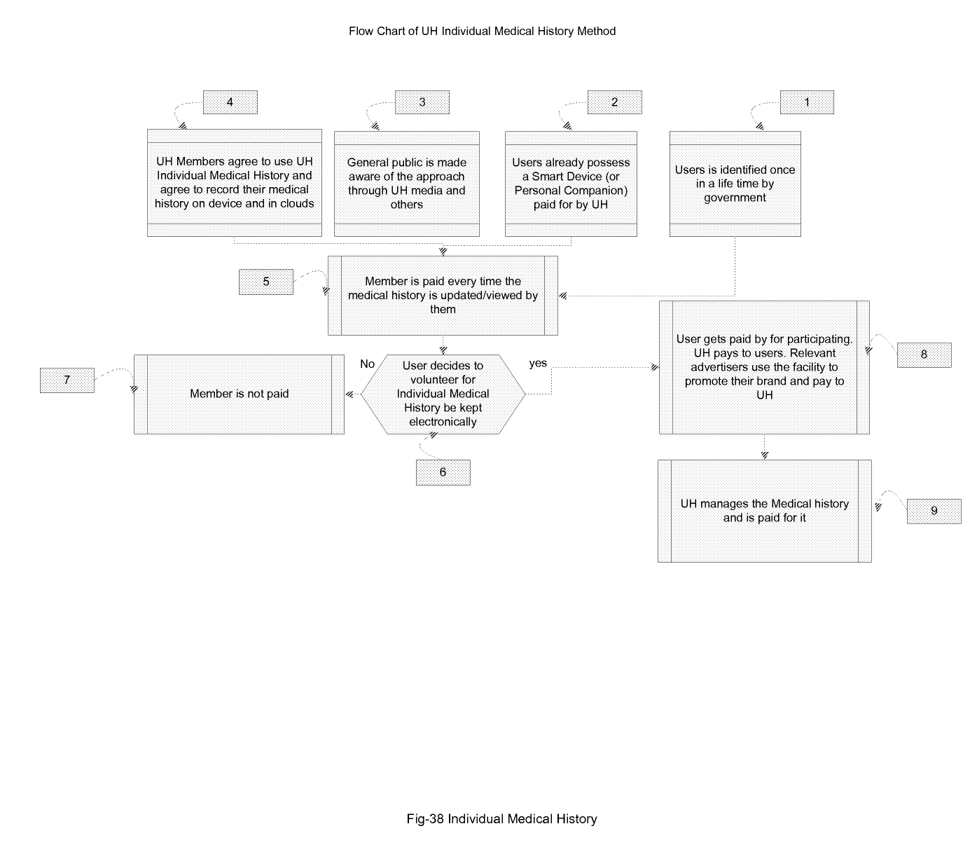

### FIG. 38 Illustrates Flow Chart of UH Medical History App Method.

Steps 38.1, 38.2 and 38.3 are analogous to the correspondingly numbered steps described in reference to FIG. 6 above.

In Step 38.4 UH members may agree to use UH Individual Medical History application and may agree to record their medical history on device and in clouds and may get paid for this activity.

In Step 38.5 member may be paid every time their medical history is updated/viewed by them.

In Step 38.6 member may decide to volunteer for Individual Medical History to be kept electronically. This may make him a potential target for advertising by medical service providers, who may not know the patient but can advertise based on his preferences and ailments. Advertisers may pay to the patient for his attention.

In Step 38.7 member may not be paid if they opt out.

In Step 38.8 member may get paid by for participating. UH may pay to users. Relevant advertisers may use the facility to promote their brand and pay to UH.

In Step 38.9 UH may manage the medical history and may be paid for it. Medical history may be used for research purposes across globe.

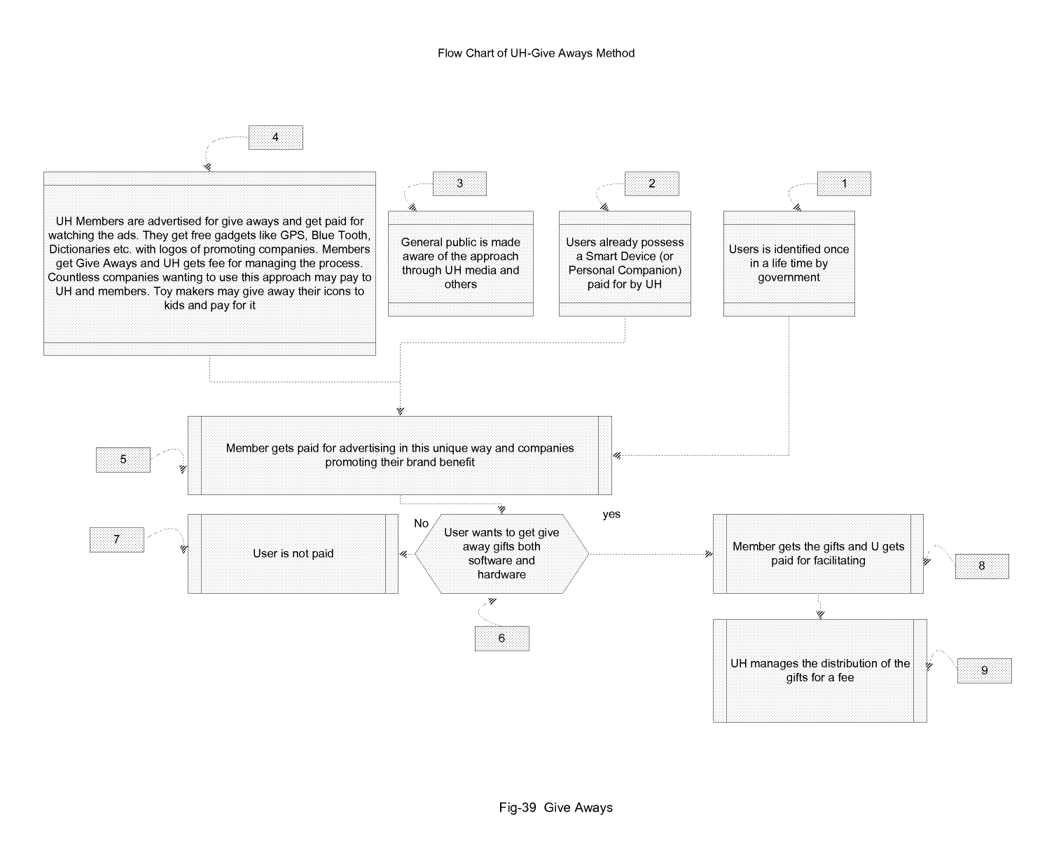

### FIG. 39 Illustrates Flow Chart of UH Give Aways App Method.

Steps 39.1, 39.2 and 39.3 are analogous to the correspondingly numbered steps described in reference to FIG. 6 above.

In Step 39.4 UH members may be advertised for give away gifts and they may get paid for watching the ads. They may get free gadgets like GPS, Blue Tooth etc. with logos of promoting companies. Members may get Give Away/s and UH may get fee for managing the process. Countless companies wanting to use this approach may pay to UH.

In Step 39.5 member may get paid for advertising in this unique way and companies promoting their brand benefit.

In Step 39.6 members may opt out.

In Step 39.7 members may not be paid for opting out.

In Step 39.8 member may get the gifts and UH gets paid for facilitating the brand. Examples may be that Coca Cola subsidizes GPS Application for the user and GPS may always display Coke's logo, reminding the member that Coke may be the donor for this great GPS application.

In Step 39.9 UH may manage the process and may get paid for it.

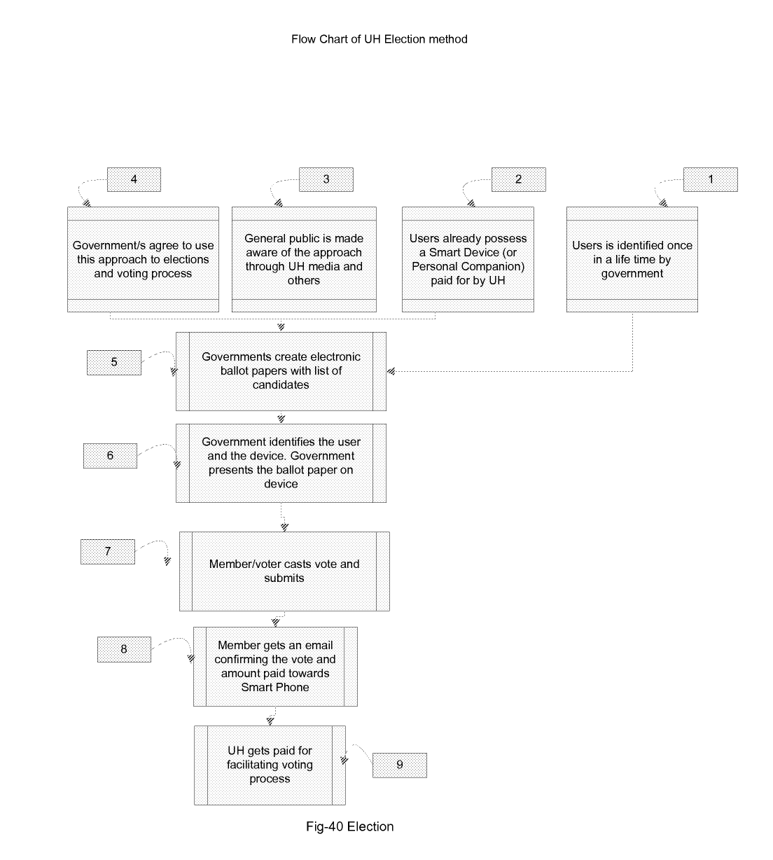

### FIG. 40 Illustrates Flow Chart of UH Elections App Method.

Steps 40.1, 40.2 and 40.3 are analogous to the correspondingly numbered steps described in reference to FIG. 6 above.

In Step 40.4 Government/s may agree to use this approach to elections and voting process.

In Step 40.5 Governments may create electronic ballot papers with list of candidates.

In Step 40.6 Government may identify the user and the device by photo, password etc. Government may present the ballot paper on device.

In Step 40.7 member/voter may casts vote and may submit the vote electronically.

In Step 40.8 member may get an email confirming that the vote might have been cast and amount may have been paid towards the device that facilitated electronic voting.

In Step 40.9 UH may get paid for facilitating voting process.

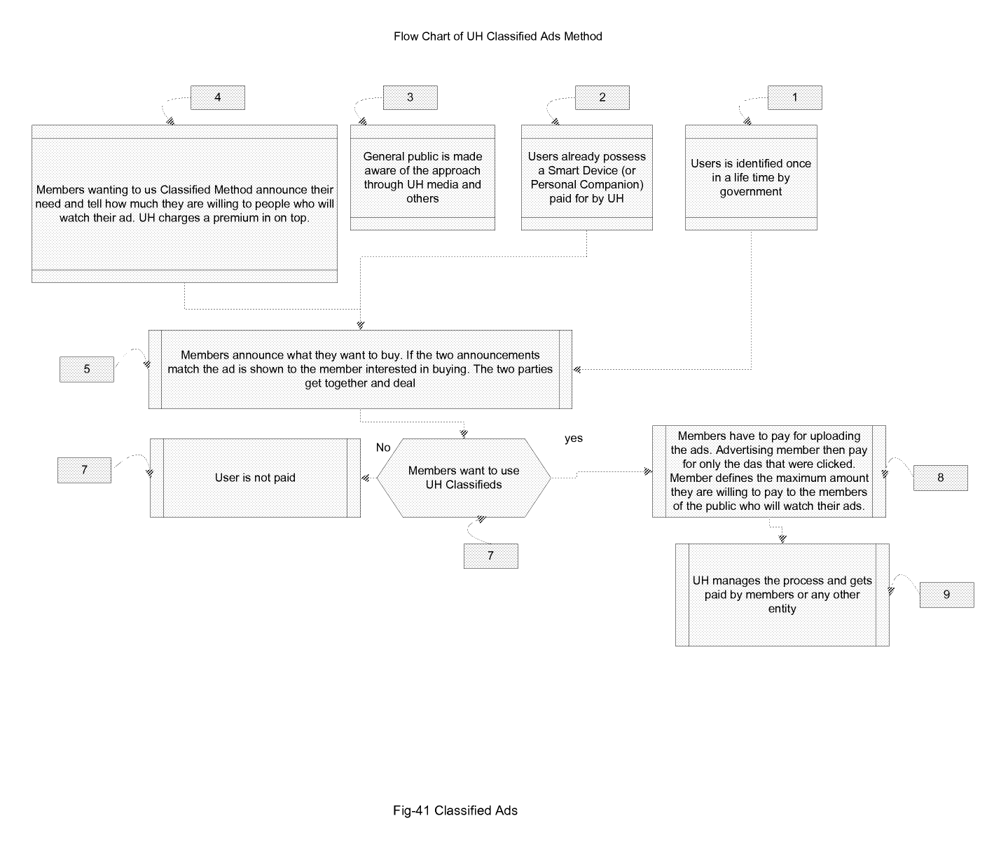

### FIG. 41 Illustrates Flow Chart of UH Classified Ads App Method.

Steps 41.1, 41.2 and 41.3 are analogous to the correspondingly numbered steps described in reference to FIG. 6 above.

In Step 41.4 members who may want to use Classified Method may announce their need and tell how much they are willing to pay people who may watch their ads. UH may charge a premium in on top.

In Step 41.5 members may announce what they want to buy. If the two announcements match the ad may be shown to the member interested in buying. The two parties may get together and deal.

In Step 41.6 members may want to opt out.

In Step 41.7 members who opt out may not be paid.

In Step 41.8 members may have to pay for uploading the ads. Advertising member may then pay for only the das that were clicked. Member may define the maximum amount they may be willing to pay to the members of the public who may watch their ads.

In Step 41.9 UH may manage the process and may get paid by members or any other entity.

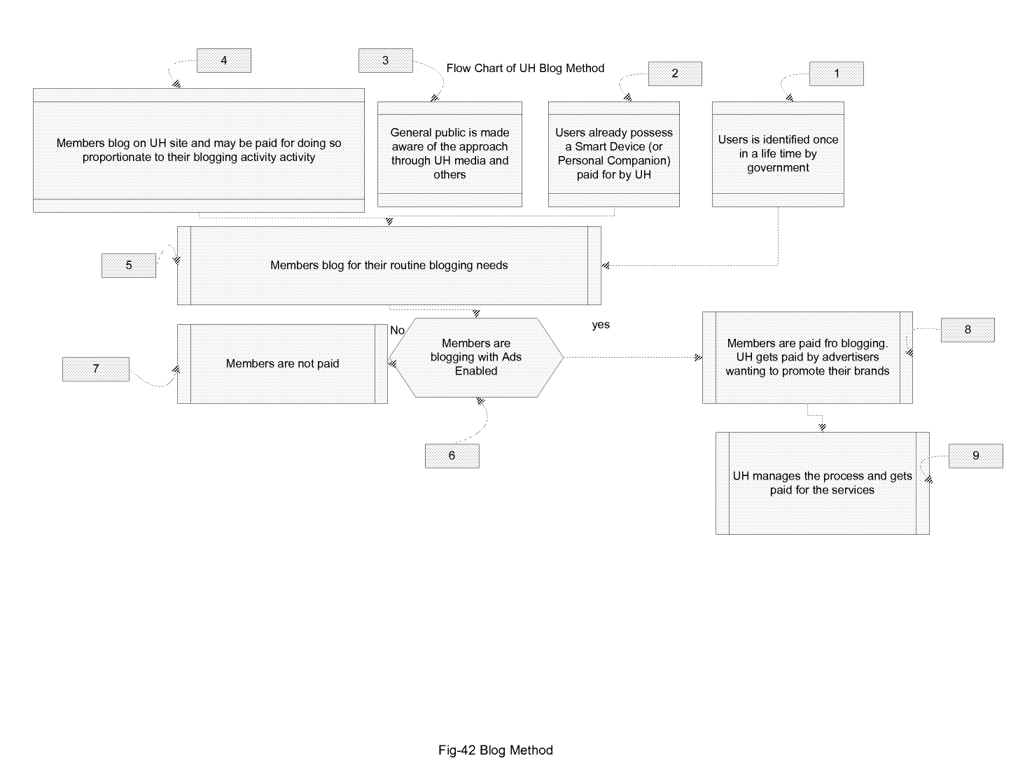

### FIG. 42 Illustrates Flow Chart of UH Blog App Method.

Steps 42.1, 42.2 and 42.3 are analogous to the correspondingly numbered steps described in reference to FIG. 6 above.

In Step 42.4 Members may agree to use this approach to Blogging.

In Step 42.5 Members may create Blogs on their favorite topics.

In Step 42.6 Members may decide to Blog with advertising enabled.

In Step 42.7 member may not be paid for opting out the mode that may enable payments.

In Step 42.8 member may be paid for blogging and UH may be paid by advertisers.

In Step 42.9 UH may get paid for facilitating the process.

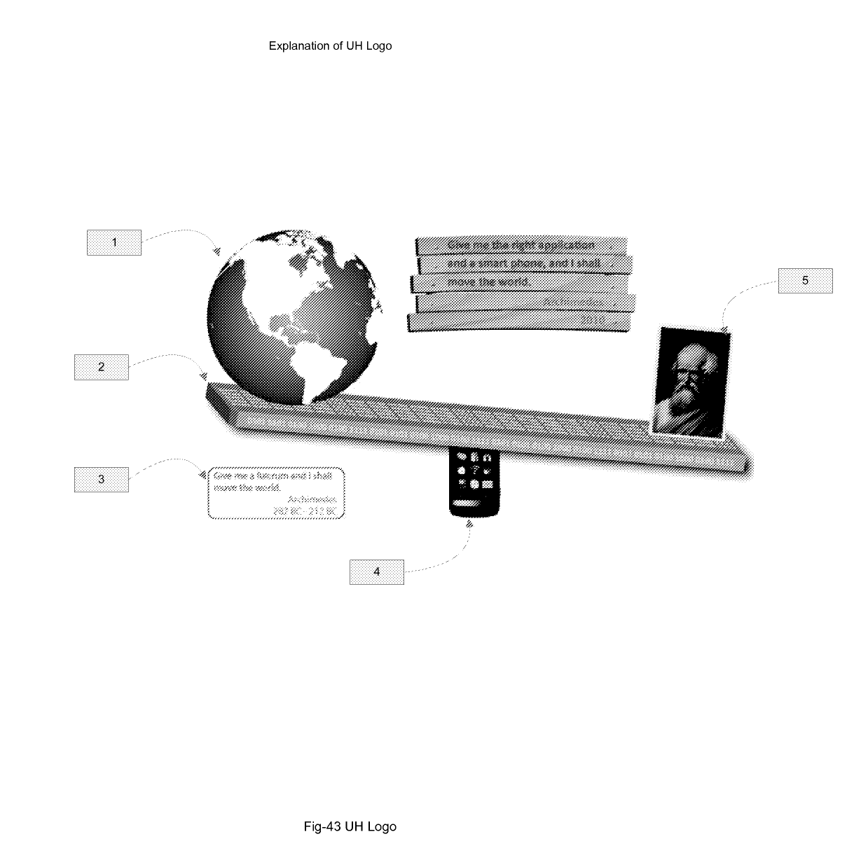

FIG. 43 is an illustration of UH Logo. The theme of the logo is that it may be possible to move the world like Archimedes stated centuries ago claiming ‘give me the fulcrum and I shall move the world’.

Inventors of the current device believe that owing to the explosive growth and penetration of Cell Phones and then Smart Phones across planet can and must be used to the advantage of humanity by making the Smart Phones free for all as these devices are smart enough to be programmed to become free or extremely cheap so that an average person in the world can afford it, thereby further dropping the price using mass purchasing advantages.

Now each step will be explained:

FIG. 43-1 The Globe or planet earth.

FIG. 43-2 Software that will run on free devices and on central servers reaching all over the world.

FIG. 43-3 Quote from Archimedes.

FIG. 43-4 Smart Phone, being used as a pivot to move the world.

FIG. 43-5 Portrait of Archimedes.

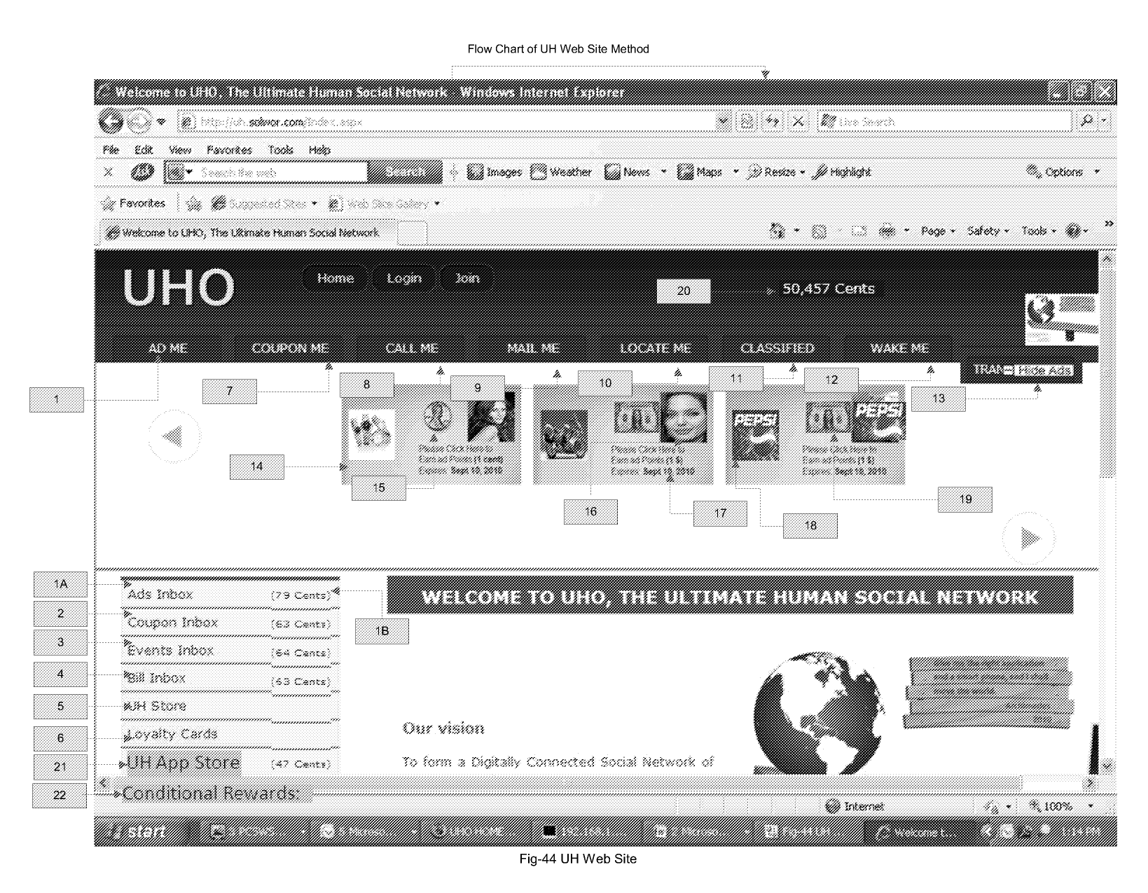

### FIG. 44 is an Illustration of UH Web Site.

The preferred embodiments of the UH Web Site will now be described with reference to the drawings. Note: There may be built-in checks and balances on each of the discussed features where members may only be paid once per ad or once in a given period of time, for clicking on ads. They may not click in quick succession to earn money that advertisers may not want to pay.

Step Fig-44.1 Illustrates Ad Me button. This button can be clicked to invite ads from merchants. Merchants will advertise based on what kind of ad is being invited. For example a member may want to be advertised ‘Bicycles’ and that makes them an attractive audience to be advertised to. The ad becomes extremely targeted as it is being served when member wants to buy what they are looking for.

Step Fig-44.1A illustrates ‘Ad Inbox’. This is like an ‘Email In-Box’ in concept. This may be a placeholder of relevant ads that may have been blocked by the user (in Fig-44 step 13, which may be discussed later) while doing some productive work and did not want ads to interrupt. Step 1B indicates the sum of money that may be waiting to be paid to the member in Ad In-Box.

Step Fig-44.2 is an illustration of ‘Coupon In-Box’. This is similar to Ad In-Box except that it may store

Discount Coupons that manufacturers and retailers may have sent to the member while they may have been busy or may have used Ad Hide Button.

Step Fig-44.3 illustrates ‘Events In-Box’. This place holds ads of events that may pay the member for viewing them.

Step Fig-44.4 illustrates Bills In-Box. This may be a placeholder for bills that may have been sent by billers of Electricity, Gas, Income Tax and others. The user may click, learn about the bill, may pay it and may save the money otherwise may have spent/wasted in paper billing

Step Fig-44.5 illustrates UH Store. This may be the place where members may come and shop for any merchandise that UH may offer.

Step Fig-44.6 illustrates the clickable link to Loyalty Cards Application as explained earlier in this document.

Step Fig-44.7 illustrates the clickable link to Coupon Me Application. Members may invite coupons for their favorite products or needed items. They get to explain the product or service that they need and coupons are served to them in real time based on their interest. They may be paid for downloading coupons to their devices.

Step Fig-44.8 illustrates the clickable link to Call Me Application. It may be very annoying when telemarketers may call in the middle of meetings etc. to sell their services or merchandise. This feature may enable members to let them be called by advertisers based on their ‘announcement’. For example if someone may be interested in refinancing their home then they may type ‘refinance’ and UH site may ask for their permission and the current number that they want called on. Telemarketers may immediately rush to offer money to be noticed. Member may click on offered ads and may select the best. It may be an extremely cost effective way as telemarketers may only be calling those who have shown interest relevant services.

Step Fig-44.9 illustrates the clickable link to Mail Me. This is also another feature where member can request material to be sent to them based on their interest. For example Mail Me feature can be used to get printed copies of Parts Catalogs etc. if needed.

Step Fig-44.10 illustrates the clickable link to Locate Me. Members may use this powerful feature when they may ‘want’ to be located by advertisers. For example a family wanting to find a restaurant in the area they may be visiting may use this feature. Based on their current location, advertisers may rush to offer their services and pay the member for viewing their offer. Member may click on multiple ads before deciding to dine at a given place.

Step Fig-44.11 illustrates the clickable link to Classified Ads. A member who may want to buy, say, a car may click on this link and may be given opportunity to enter details of their needs. Other members or advertisers may offer their ads with the money payable for clicking their ads. Member may click on selected few ads and may buy based on their free choice. Advertisers may pay fraction of the cost that may be incurred in advertising on other media as only interested parties may interact with each other.

Step Fig-44.12 illustrates the clickable link to Wake Me App. This may be the only alarm clock in the world that may wake up members and may pay them every time they wake up. Members may wake up at the time they set to the sound an advertisement. Advertisers mat be very interested in waking people up to their message at a reasonable cost to them. Members may be interested in using this as they may never have seen an alarm clock that may pay them every morning.

Step Fig-44.13 illustrates the clickable link to Hide Ads. This button may enable members to work on the site and all the visible ads disappear but may start going to relevant ads In-boxes. The ads are served based on member's buying, clicking and ‘ad inviting’ patterns and interests that they may have shown at the time of signing up.

Step Fig-44.14 illustrates what is also a clickable link to the site/page of the advertiser. If member may be interested to watch the ad then they may click on one of the ad banners shown and that may take to the site/page of the advertiser who may have just paid them for clicking a known amount.

Ad Banner may also have following attributes:
It may be any shape, color or size.
It may be static or moving.
It may change its attributes while waiting to be clicked on (in Ad In-box etc.).
It may kill itself if not viewed or otherwise felt that conditions are not conducive for it to exist.
It may multiply if needed. It may move between ad boxes or it may be forwarded.
It may be recalled. It may be tagged for later viewing etc. It may be commented on and returned by user. It may be ‘Forced’ to be viewed or member may have to pay if not viewed in a given date range.

Step Fig-44.15 illustrates that the member can see how much money the advertiser may be willing to pay them for clicking on the ad and interacting with it. In this case member may be paid 10 Cents in their account. The amount may vary based on the member's history of buying behavior based on UH assessment and advertiser's budget.

Step Fig-44.16 illustrates the picture of the person who may have sent the ad, provided it was a forwarded ad.

Step Fig-44.17 illustrates the expiring date of the ad. The ads may disappear after they are no longer valid or they may change the offer in real time, making it possible for advertisers to change the messages even after the ads have left the servers.

Step Fig-44.18 illustrates the clickable link to the advertiser who may be paying for watching or clicking on the ad.

Step Fig-44.19 illustrates the clickable link to a bigger amount that some advertisers may want to pay based on next activity performed. For example a bank may offer 10 Cents to watch their ad but $150 for opening an account with them through UH web site.

Step Fig-44.20 illustrates the clickable link to the amount that a member may have earned by clicking and interacting with ads. If a member wants an explanation of their earnings then they may click here for details.

Step Fig-44.21 illustrates the clickable link to the UH App Store.

Step Fig-44.22 illustrates the clickable link to the Conditional Rewards.

In this App the member may get an offer to watch an ad (say for example 5 Cents but promises to refund (say) $5 on real purchase). The member may click, and may get 5 Cents and then $5 becomes accrued with a recorded commitment from the seller that the member may get $5 towards the device provided the deal happened in the allotted time. The offer, if not clicked on, may disappear from the device.

Another example may be of the perishable food items that have known expiry date. The merchant has to return to the manufacturer if the item/s are not sold by the expiry date. Both merchants and manufacturers may face penalties if items are sold after expiry date. In this application businesses with the knowledge of such items (like Ice Cream, Milk, Yogurt, Bread etc.) may use UH Conditional Rewards App and may have the option of rushing to buy the product and be rewarded towards the free device and its gadgets etc. All merchandise is sold on time and huge waste of food is avoided.

Members may like this highly rewarding feature and merchants can use this feature to attract buyers in slow times. UH gets rewarded in the process. Members may get subsidy to the free device.

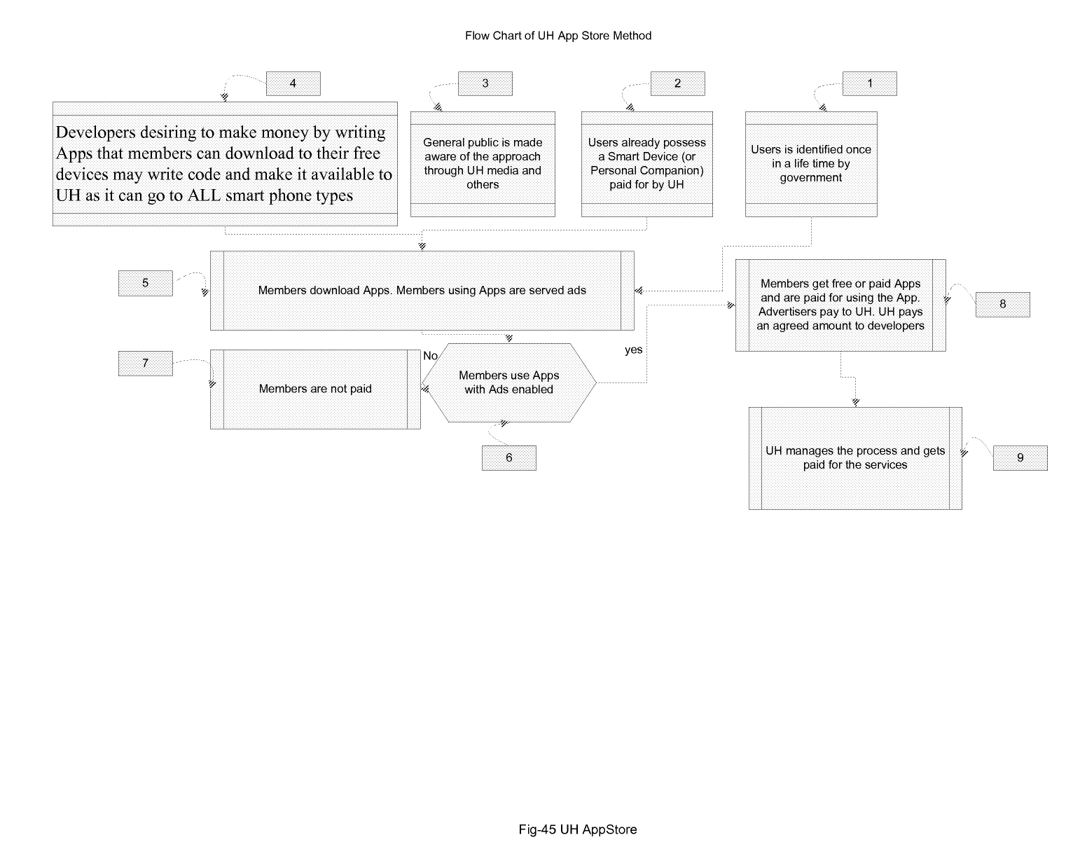

### FIG. 45 Illustrates Flow Chart of UH App Store Method.

Steps 45.1, 45.2 and 45.3 are analogous to the correspondingly numbered steps described in reference to FIG. 6 above.

In Step 45.4 developers who may want to use UH APP Method may announce their App availability and may tell how much they are willing to pay people who want their App loaded. The amount may be small but will still be an innovative approach to build clients who use these Apps.

In Step 45.5 members may opt to take a look at the offered Apps for being rewarded. They may download Apps to their devices and may get paid. Members then start using the Apps of their liking

In Step 45.6 members may want to opt out.

In Step 45.7 members who opt out may not be paid.

In Step 45.8 members get free or paid Apps and are paid for using the App. Advertisers may pay to UH based on agreed click through rates. UH may pay an agreed amount to developers.

In Step 45.9 UH may manage the process and may get paid by members or any other entity.

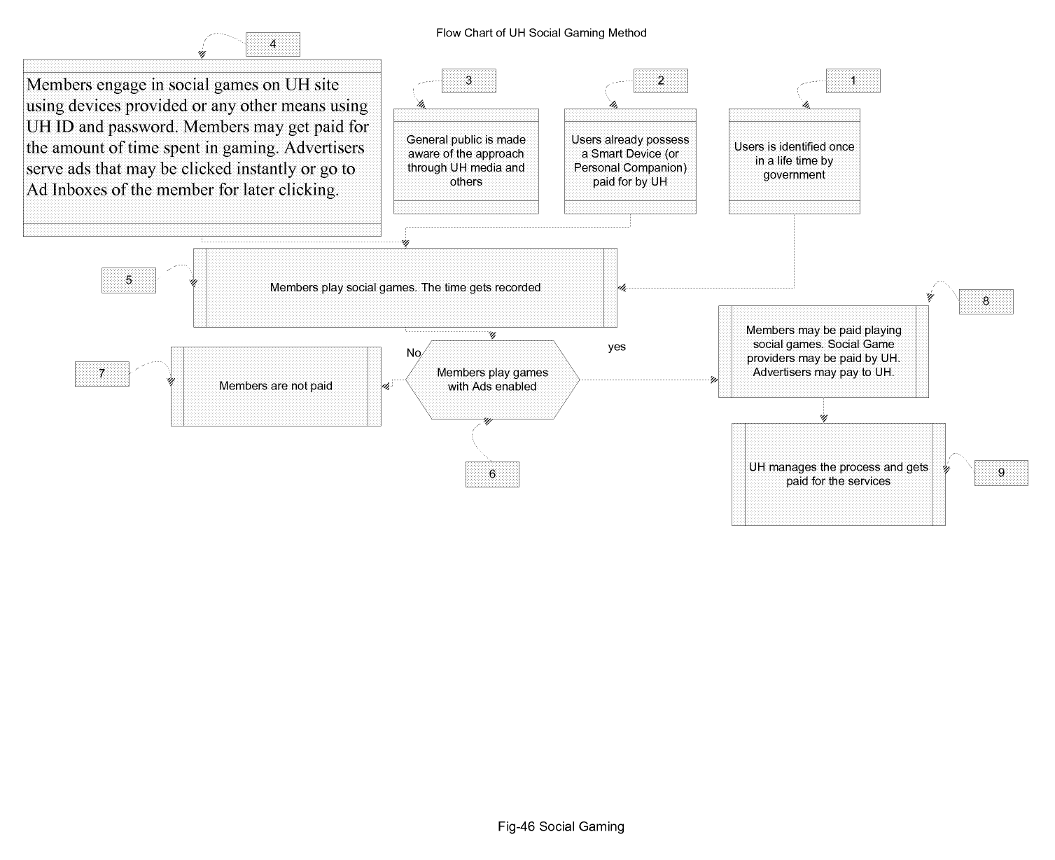

### FIG. 46 Illustrates Flow Chart of UH Parcel Service Method.

Steps 46.1, 46.2 and 46.3 are analogous to the correspondingly numbered steps described in reference to FIG. 6 above.

In Step 46.4 members may agree to accept the approach to delivery of groceries etc. at their preferred place.

In Step 46.5 UH may create a portal that may keep track of buying habits and may suggest the replenishments of groceries and other items.

In Step 46.6 members may order on line and may get an ETA. UH may contract the delivery to USPS.

In Step 46.6A Local groceries may save good money as there is no need to store items and cost associated with storing them may be saved and it may be possible to deliver free even small items.

In Step 46.7 USPS or any other entity may deliver economically as they go door to door.

In Step 46.7A USPS may be hired to deliver the groceries. It may create the jobs that their employees may be losing due to technology adoption.

In Step 46.8 member may get agreed discounts. Member may pay agreed delivery charges and may still save. Members may also get agreed subsidy towards the free device.

In Step 46.8A members may create a huge value by agreeing to shop online and getting groceries delivered. Members may save huge in time it takes to travel. Gas prices may compel people to save by delivery using this method.

In Step 46.9 UH may manage the process and may get paid for the services.

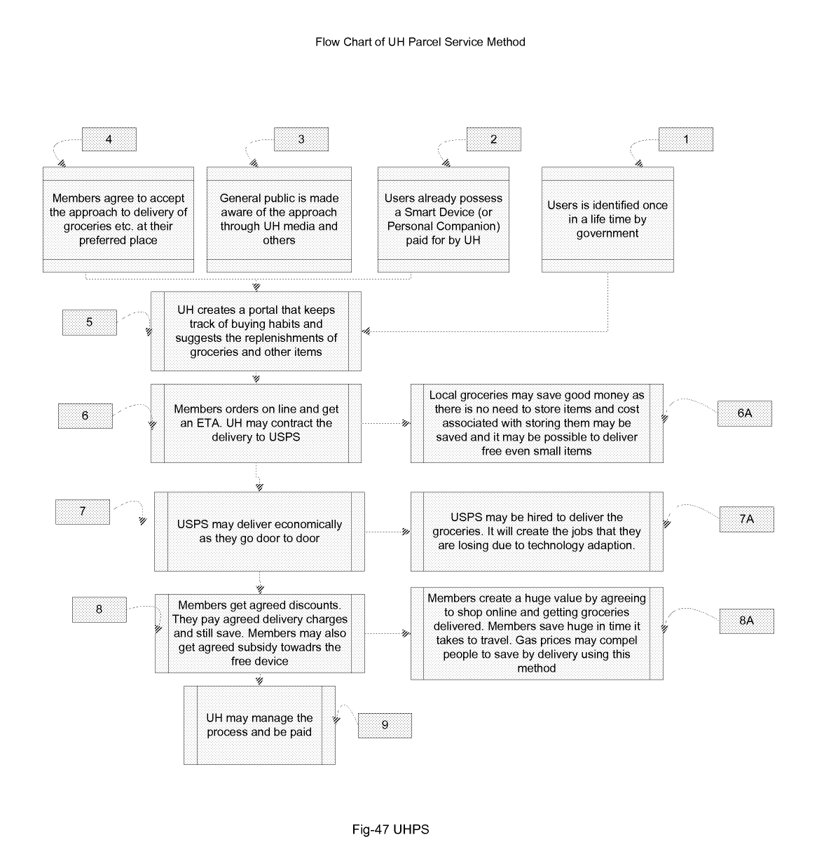

### FIG. 47 Illustrates Flow Chart of UH App Store Method.

Steps 47.1, 47.2 and 47.3 are analogous to the correspondingly numbered steps described in reference to FIG. 6 above.

In Step 47.4 developers who may want to use UH APP Method may announce their App availability and may tell how much they are willing to pay people who want their App loaded. The amount may be small but will still be an innovative approach to build clients who use these Apps.

In Step 47.5 members may opt to take a look at the offered Apps for being rewarded. They may download Apps to their devices and may get paid. Members then start using the Apps of their liking

In Step 47.6 members may want to opt out.

In Step 47.7 members who opt out may not be paid.

In Step 47.8 members get free or paid Apps and are paid for using the App. Advertisers may pay to UH based on agreed click through rates. UH may pay an agreed amount to developers.

In Step 47.9 UH may manage the process and may get paid by members or any other entity.

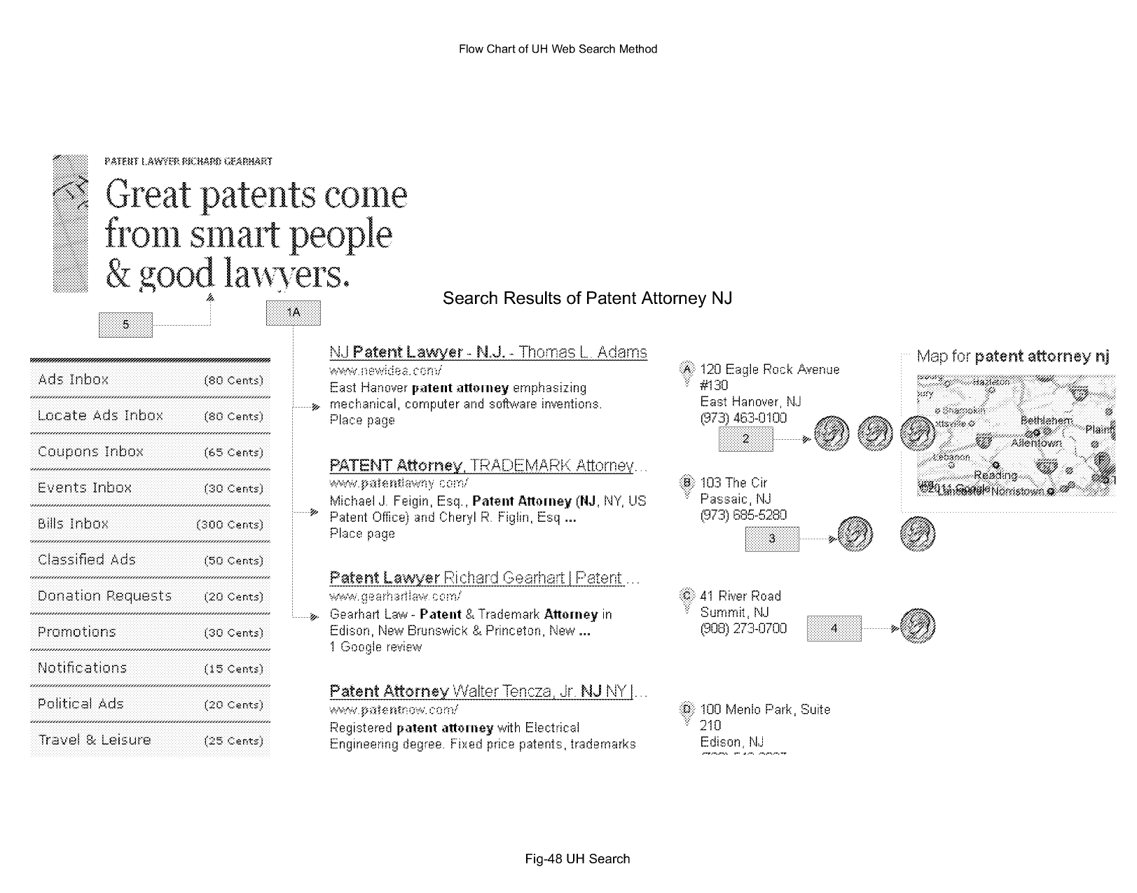

### FIG. 48 Illustrates Flow Chart of UH Search Method.

In Step 48.1 (not illustrated) member may want to search for a Patent Attorney in New Jersey who may give him the best advice on patent related laws. Member may type the search phrase ‘Patent Attorney NJ’ and UH site may present him a list of patent attorneys in New Jersey.

In Step 48.1A, the member may be presented with a list of attorneys located in New Jersey duly sorted by the amount that they are willing to pay to the member. In the illustrated example four attorneys may be willing to pay to the member for viewing their profile with intent of luring the member to click and then possibly read their information and then contact and give them business.

In Step 48.2, the attorney/firm may be willing to pay 30 Cents to attract the attention of the member.

In Step 48.3, the attorney/firm may be willing to pay 20 Cents to attract the attention of the member.

In Step 48.4 the attorney/firm may be willing to pay 10 Cents to attract the attention of the member.

In Step 48.5 the member may decide to click on the 10 Cent offer and may be taken to the web site of the attorney/firm. Patent Attorney's firm may then pay an agreed amount to UH for bringing the qualified client to their firm's web site.

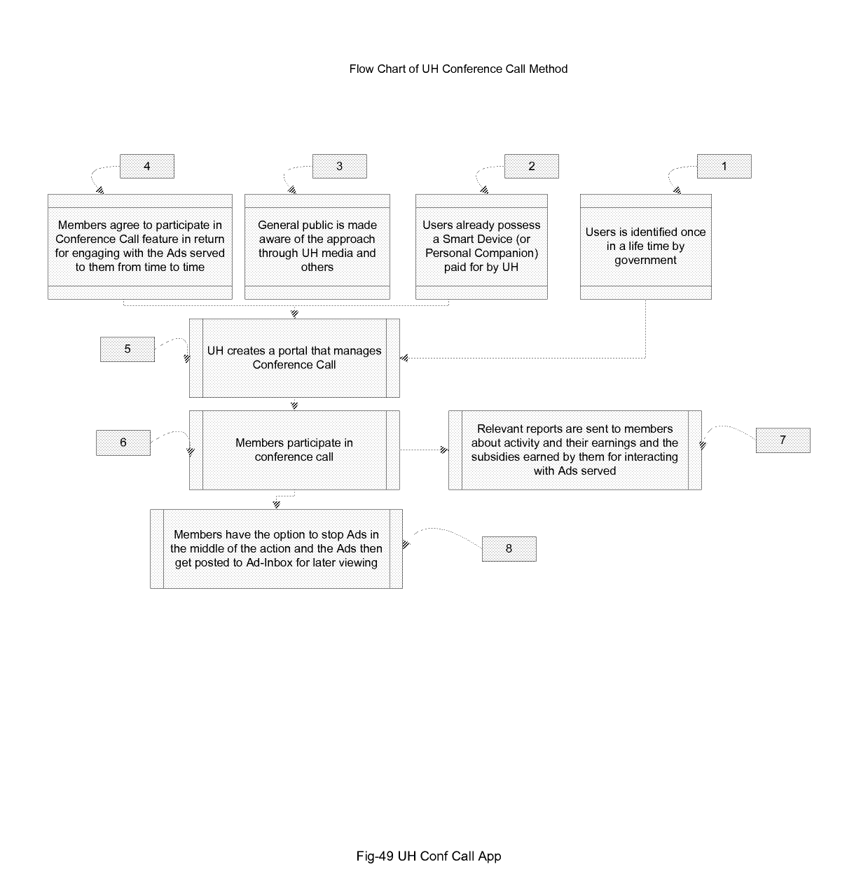

### FIG. 49 Illustrates Flow Chart of UH Conference Call Method.

Steps 49.1, 49.2 and 49.3 are analogous to the correspondingly numbered steps described in reference to FIG. 6 above.

In Step 49.4 members may agree to participate in the Conference Call feature in return for—having Ads served to them from time to time, and may also have an option to stop reviewing the ads at any time or with in predefined periods of time.

In Step 49.5 UH may create a portal that manages Conference Calls for members.

In Step 49.6 members may participate in conference calls.

In Step 49.7 relevant reports may be sent to members about their activity and their earnings and the subsidies earned by them for interacting with the Ads served.

In Step 49.8 members may have the option to stop Ads in the middle of the conference call and the Ads then get posted to Ad-Inbox for later viewing, though the compensation for later viewed ads may differ from those viewed during the conference call.

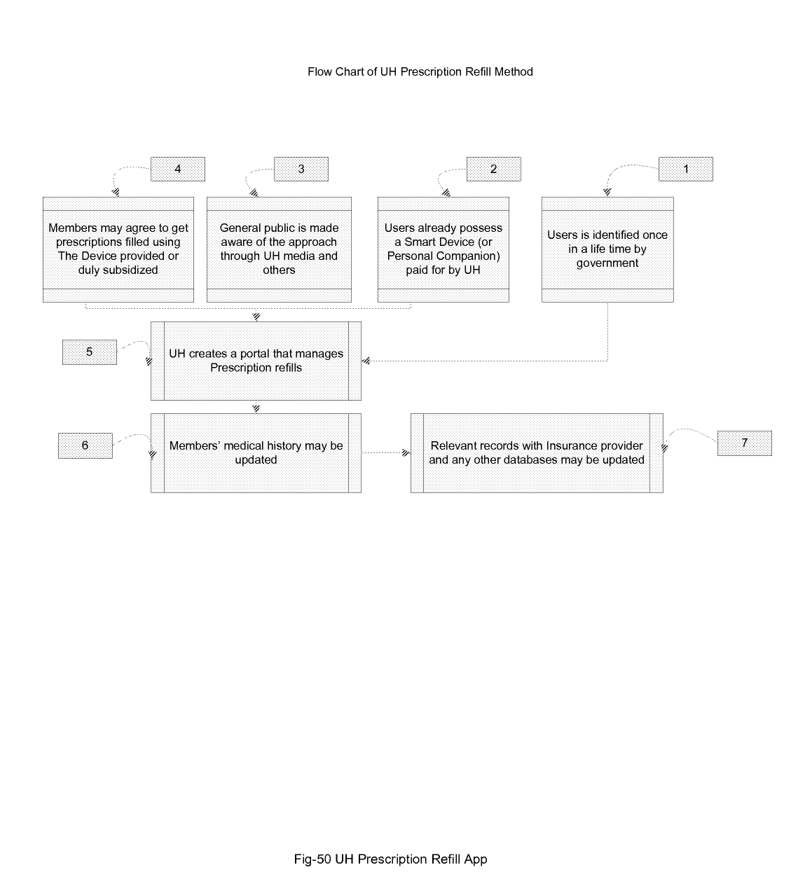

### FIG. 50 Illustrates Flow Chart of UH Prescription Refill Method.

Steps 50.1, 50.2 and 50.3 are analogous to the correspondingly numbered steps described in reference to FIG. 6 above.

In Step 50.4 members may agree to get prescriptions filled using The Device provided to them for free, or a subsidized rate, by the UH or a similar or affiliated agency.

In Step 50.5UH may create a portal that may manage Prescription refills.

In Step 50.6 members' medical histories may be updated.

In Step 50.7 the relevant records of authorized third parties, such as, but not limited to, the member's Insurance provider, the member's physician or a hospital treating the member, or some combination thereof, may be updated.

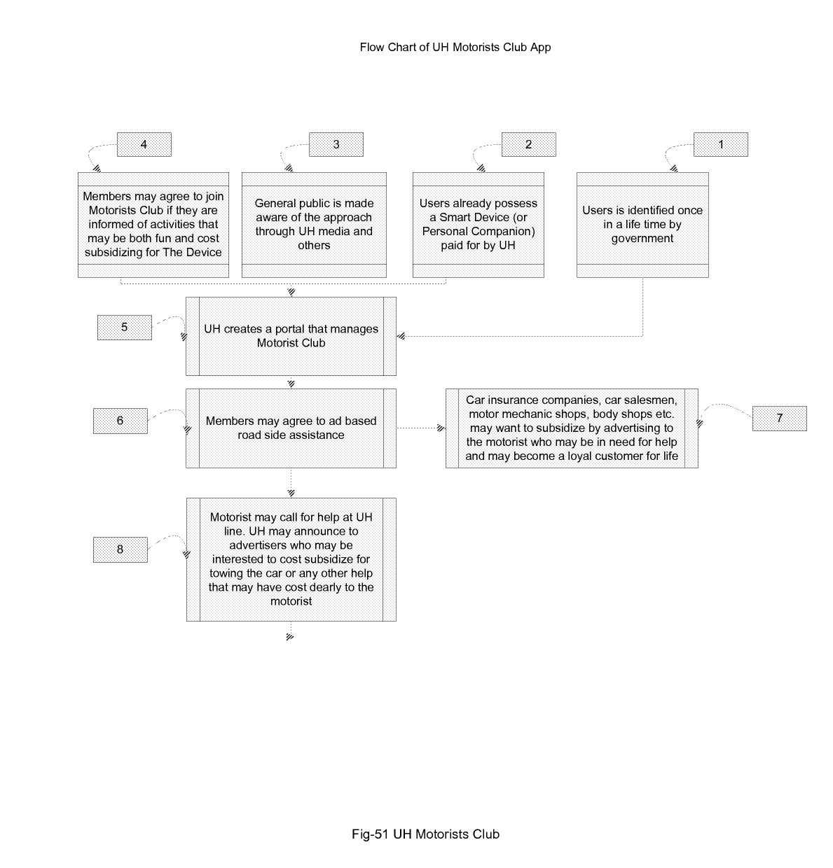

### FIG. 51 Illustrates Flow Chart of UH Motorists Club App Method.

Steps 51.1, 51.2 and 51.3 are analogous to the correspondingly numbered steps described in reference to FIG. 6 above.

In Step 51.4 members may agree to join UH Motorists Club if they are informed of activities that may be both fun and cost subsidizing for The Device.

In Step 51.5UH may create a portal that manages Motorist Club.

In Step 51.6 members may agree to ad based road side assistance.

In Step 51.7 car insurance companies, car salesmen, motor mechanic shops, body shops etc. may want to subsidize by advertising to the motorist who may be in need for help.

In Step 51.8 motorist may call for help at UH line or text for help. UH may announce to advertisers who may be interested to cost subsidize for towing the car or any other help that may cost dearly to the motorist. Advertisers may find this an opportunity to create lifelong loyalty by helping the needy motorist.

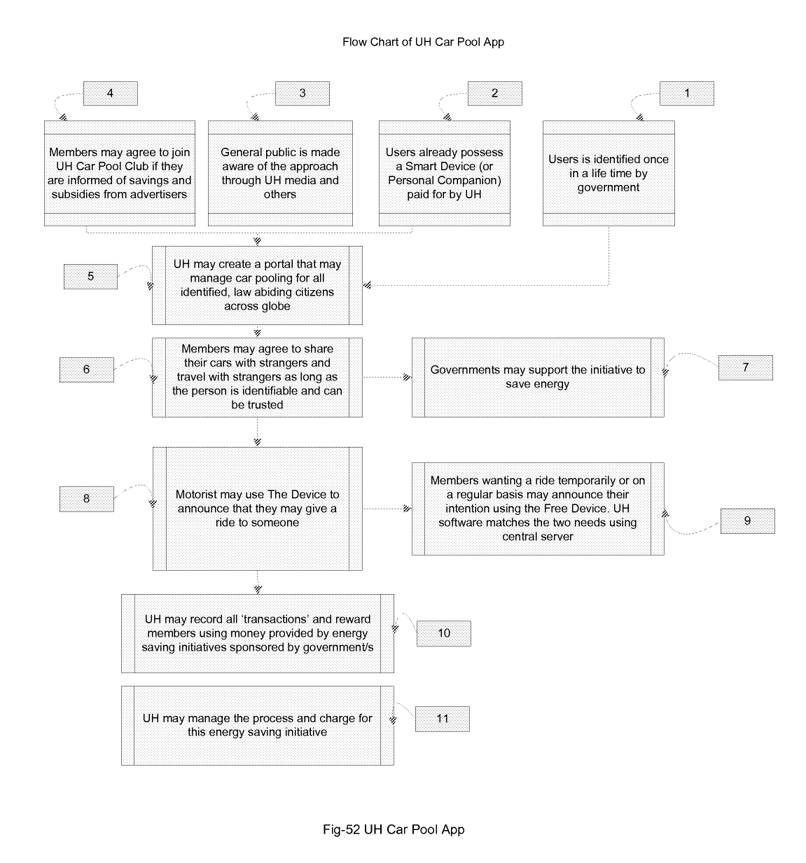

### FIG. 52 Illustrates Flow Chart of UH Car Pool App Method.

Steps 52.1, 52.2 and 52.3 are analogous to the correspondingly numbered steps described in reference to FIG. 6 above.

In Step 52.4 members may agree to join UH Car Pool Club if they are informed of savings and subsidies from advertisers.

In Step 52.5 UH may create a portal that may manage car pooling for all identified, law abiding citizens across globe.

In Step 52.6 members may agree to share their cars with strangers and travel with strangers as long as the person is identifiable and can be trusted.

In Step 52.7 governments may support the initiative to save energy.

In Step 52.8 motorist may use The Device to announce that they may give a ride to some.

In Step 52.9 members wanting a ride temporarily or on a regular basis may announce their intention using the Free Device. UH software matches the two needs using central server.

In Step 52.10 UH may record all ‘transactions’ and reward members using money provided by energy saving initiatives sponsored by government/s.

In Step 52.11 UH may manage the process and charge for this energy saving initiative.

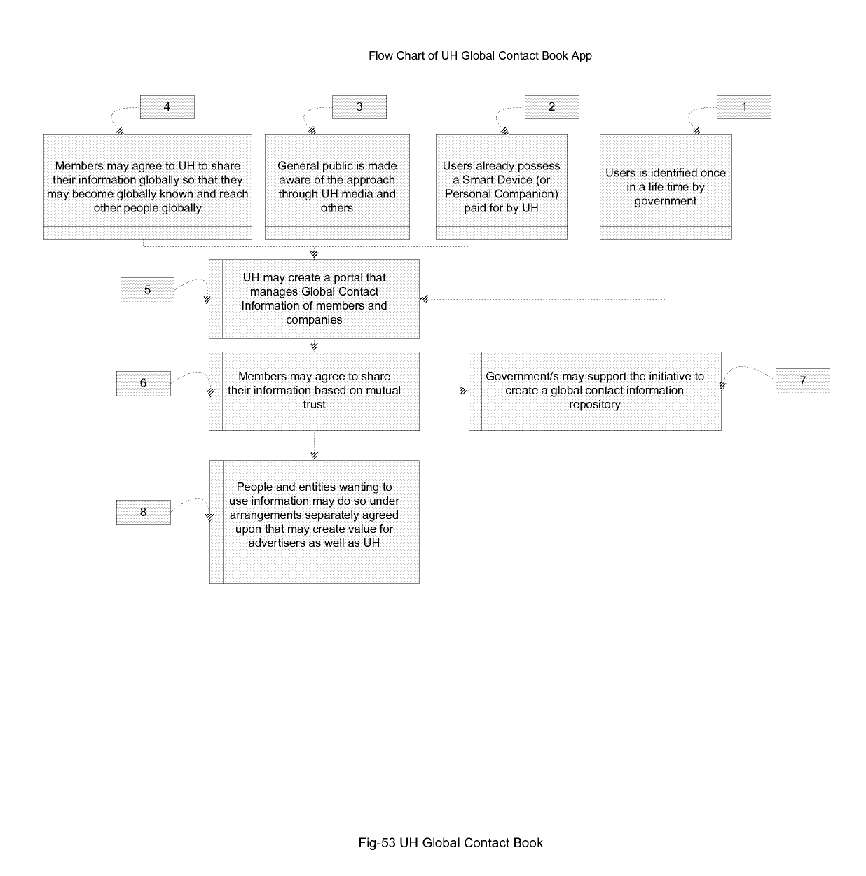

### FIG. 53 Illustrates Flow Chart of UH Global Contact Book App Method.

Steps 53.1, 53.2 and 53.3 are analogous to the correspondingly numbered steps described in reference to FIG. 6 above.

In Step 53.4 members may agree to UH to share their information globally so that they may become globally known and reach other people globally.

In Step 53.5 UH may create a portal that manages Global Contact Information of members and companies.

In Step 53.6 members may agree to share their information based on mutual trust.

In Step 53.7 government/s may support the initiative to create a global contact information repository.

In Step 53.8 people and entities wanting to use information may do so under arrangements separately agreed upon that may create value for advertisers as well as UH.

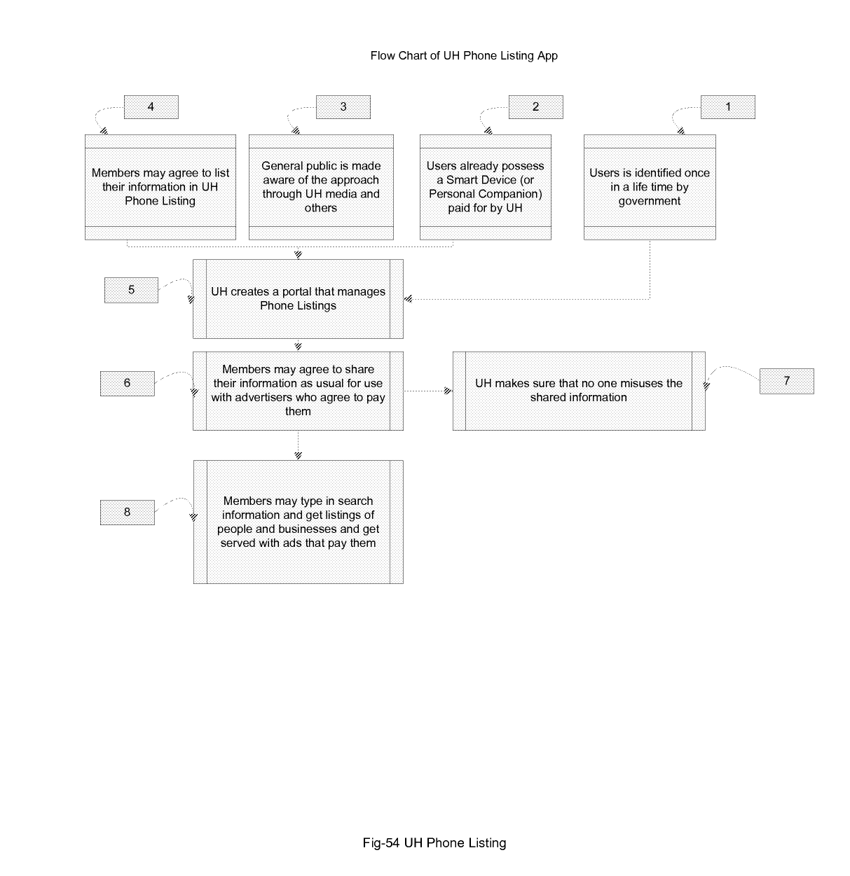

### FIG. 54 Illustrates Flow Chart of UH Phone Listing App Method.

Steps 54.1, 54.2 and 54.3 are analogous to the correspondingly numbered steps described in reference to FIG. 6 above.

In Step 54.4 members may agree to list their information in UH Phone Listing.

In Step 54.5 UH creates a portal that manages Phone Listings.

In Step 54.6 members may agree to share their information as usual for use with advertisers who agree to pay them.

In Step 54.7 UH makes sure that no one misuses the shared information.

In Step 54.8 members may type in search information and get listings of people and businesses and get served with ads that pay them.

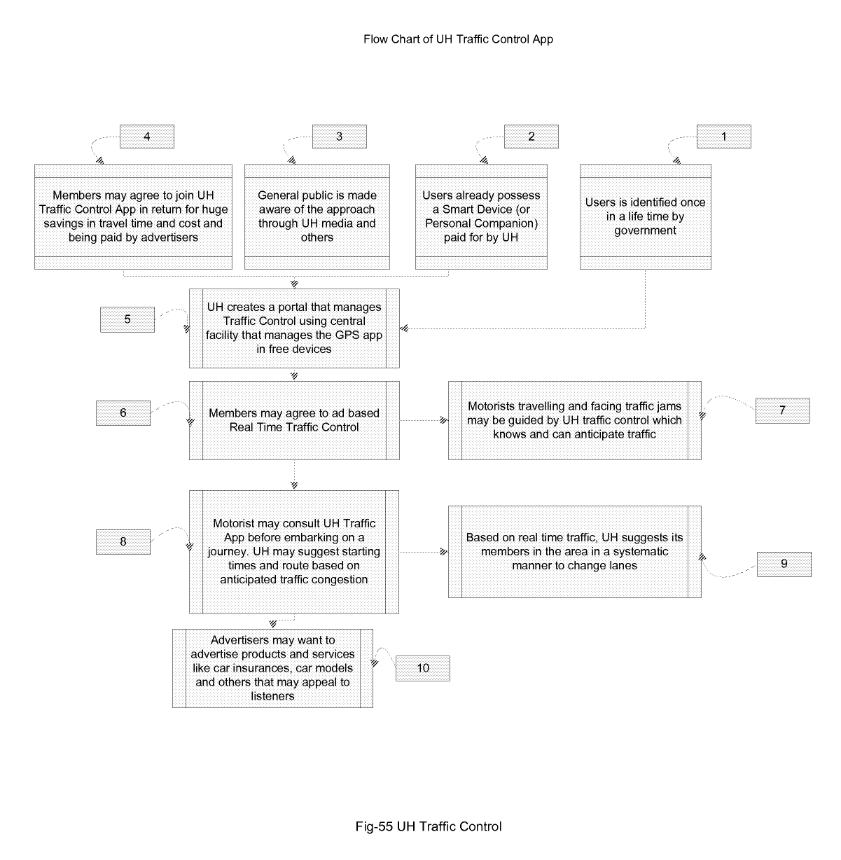

### FIG. 55 Illustrates Flow Chart of UH Traffic Control App Method.

Steps 55.1, 55.2 and 55.3 are analogous to the correspondingly numbered steps described in reference to FIG. 6 above.

In Step 55.4 members may agree to join UH Traffic Control App in return for huge savings in travel time and cost and being paid by advertisers.

In Step 55.5 UH may create a portal that manages Traffic Control using central facility that manages the GPS app in free devices.

In Step 55.6 members may agree to ad based Real Time Traffic Control.

In Step 55.7 motorists travelling and facing traffic jams may be guided by UH traffic control which knows and can anticipate traffic.

In Step 55.8 motorist may consult UH Traffic App before embarking on a journey. UH may suggest starting times and route based on anticipated traffic congestion.

In Step 55.9 based on real time traffic, UH suggests its members in the area in a systematic manner to change lanes.

In Step 55.10 advertisers may want to advertise products and services like car insurances, car models and others that may appeal to listeners.

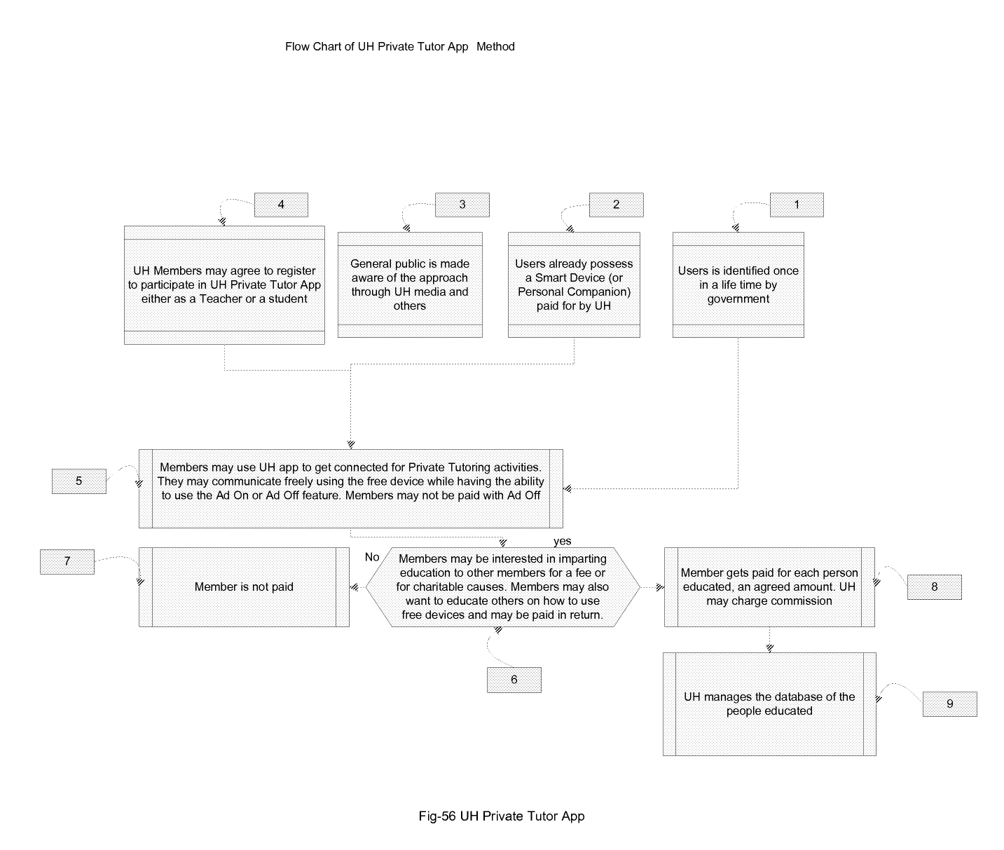

### FIG. 56 Illustrates Flow Chart of UH Private Tutor App Method.

Steps 56.1, 56.2 and 56.3 are analogous to the correspondingly numbered steps described in reference to FIG. 6 above.

In Step 56.4 members may agree to register to participate in UH Private Tutor App either as a Teacher or a student.

In Step 56.5 members may use UH app to get connected for Private Tutoring activities. They may communicate freely using the free device while having the ability to use the Ad On or Ad Off feature. Members may not be paid with Ad Off but ads may go to Ad In-boxes.

In Step 56.6 members may be interested in imparting education to other members for a fee or for charitable causes. Members may also want to educate others on use of free devices and may be paid in return.

In Step 56.7 members who are not interested may not be paid for this App.

In Step 56.8 member gets paid for each person educated, an agreed amount. UH may charge commission.

In Step 56.9 UH may manage the database of the people educated.

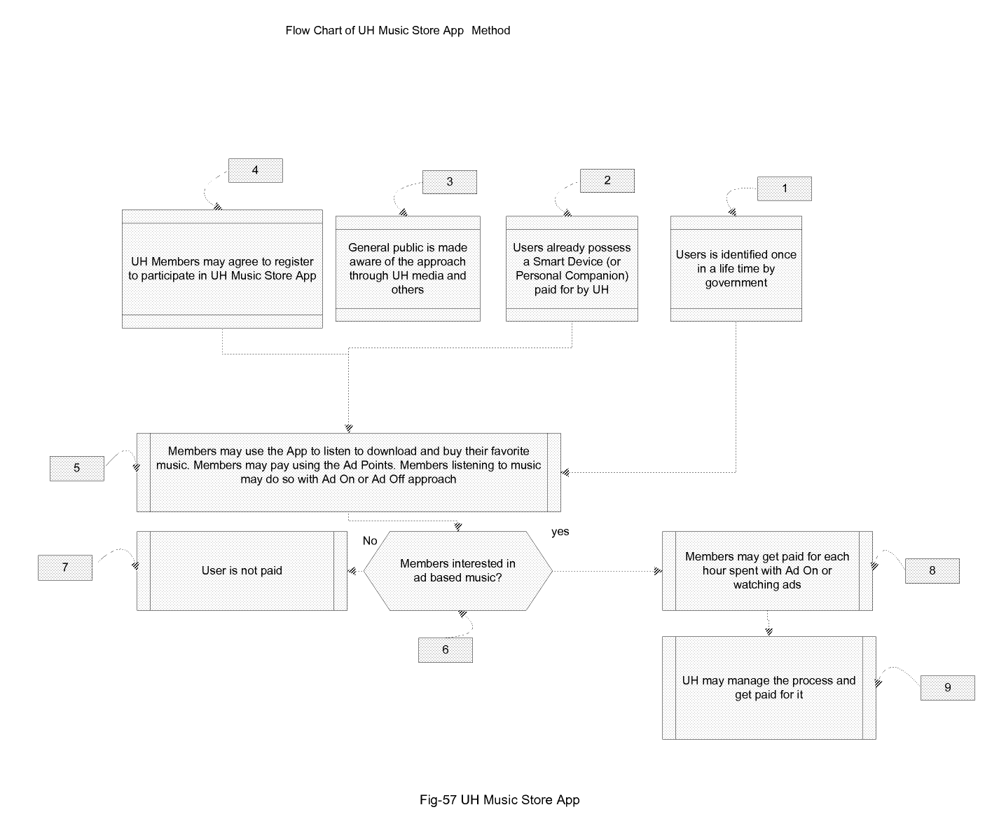

### FIG. 57 Illustrates Flow Chart of UH Music Store Method.

Steps 57.1, 57.2 and 57.3 are analogous to the correspondingly numbered steps described in reference to FIG. 6 above.

In Step 57.4 members may agree to register to participate in UH Music Store App.

In Step 57.5 members may use the App to listen, to download and buy their favorite music. Members may pay using the Ad Points. Members listening to music may do so with Ad On or Ad Off approach.

In Step 57.6 members may decide if they are interested in ad based music.

In Step 57.7 members who are not interested may not be paid for this App.

In Step 57.8 members may get paid for each hour spent with Ad On or watching ads.

In Step 57.9 UH may manage the process and get paid for it.

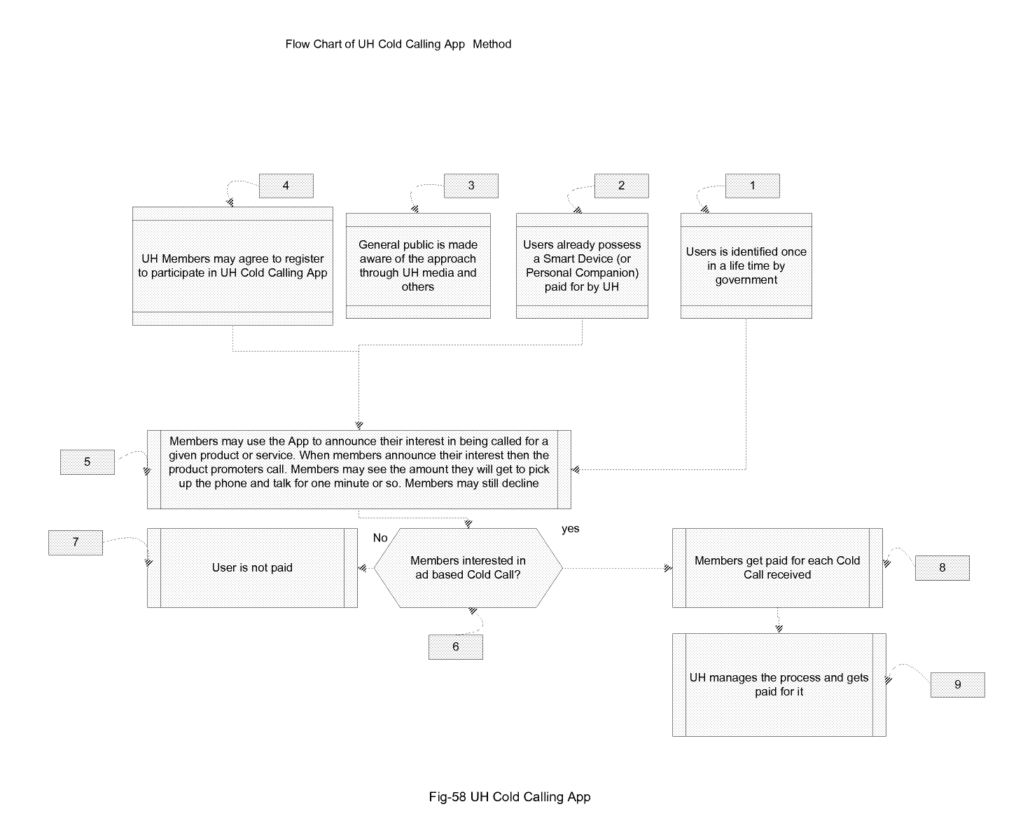

### FIG. 58 Illustrates Flow Chart of UH Cold Calling Method.

Steps 58.1, 58.2 and 58.3 are analogous to the correspondingly numbered steps described in reference to FIG. 6 above.

In Step 58.4 members may agree to register to participate in UH Cold Calling App.

In Step 58.5 members may use the App to announce their interest in being called for a given product or service. When members announce their interest then the product promoters call. Members may see the amount they will get to pick up the phone and talk for one minute or so. Members may still decline if caller is not trustworthy.

In Step 58.6 members may decide if they are interested in ad based cold calls.

In Step 58.7 members who are not interested may not be paid for this App.

In Step 58.8 members may get paid for each Cold Call received.

In Step 58.9 UH may manage the process and get paid for it.

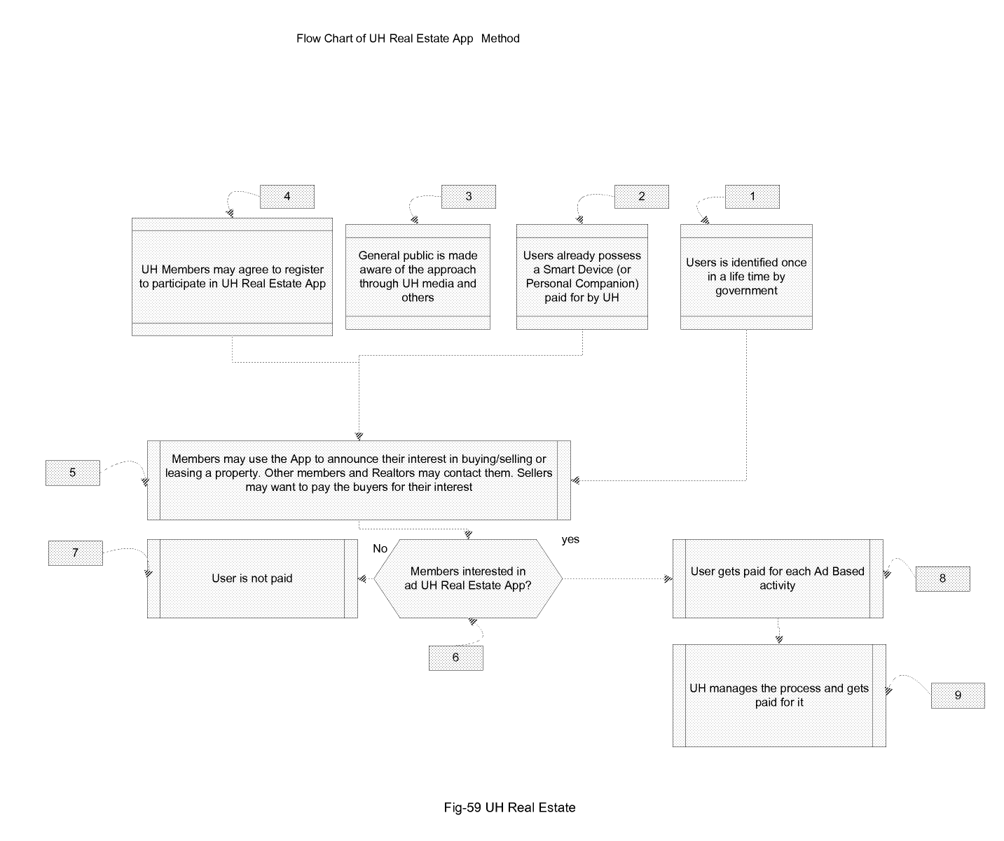

### FIG. 59 Illustrates Flow Chart of UH Real Estate Method.

Steps 59.1, 59.2 and 59.3 are analogous to the correspondingly numbered steps described in reference to FIG. 6 above.

In Step 59.4 members may agree to register to participate in UH Real Estate App.

In Step 59.5 members may use the App to announce their interest in buying/selling or leasing a property. Other members and Realtors may contact them. Sellers may want to pay the buyers for their interest.

In Step 59.6 members may decide if they are interested in ad based Real Estate App.

In Step 59.7 members who are not interested may not be paid for this App.

In Step 59.8 User gets paid for each Ad Based activity.

In Step 59.9 UH may manage the process and get paid for it.

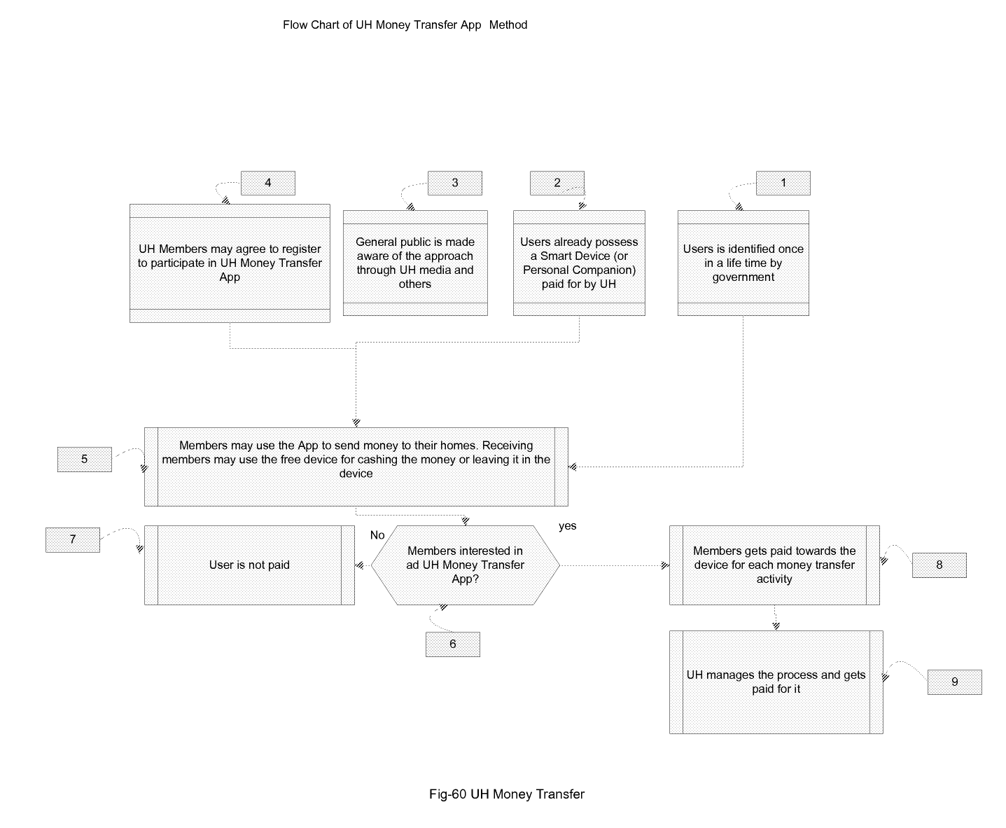

### FIG. 60 Illustrates Flow Chart of UH Money Transfer Method.

Steps 60.1, 60.2 and 60.3 are analogous to the correspondingly numbered steps described in reference to FIG. 6 above.

In Step 60.4 members may agree to register to participate in UH Money Transfer App.

In Step 60.5 members may use the App to send money to their homes/families. Receiving members may use the free device for cashing the money or leaving it in the device/UH account.

In Step 60.6 members may decide if they are interested in ad based Money Transfer App.

In Step 60.7 members who are not interested may not be paid for this App.

In Step 60.8 members gets paid towards the device for each money transfer activity.

In Step 60.9 UH may manage the process and get paid for it.

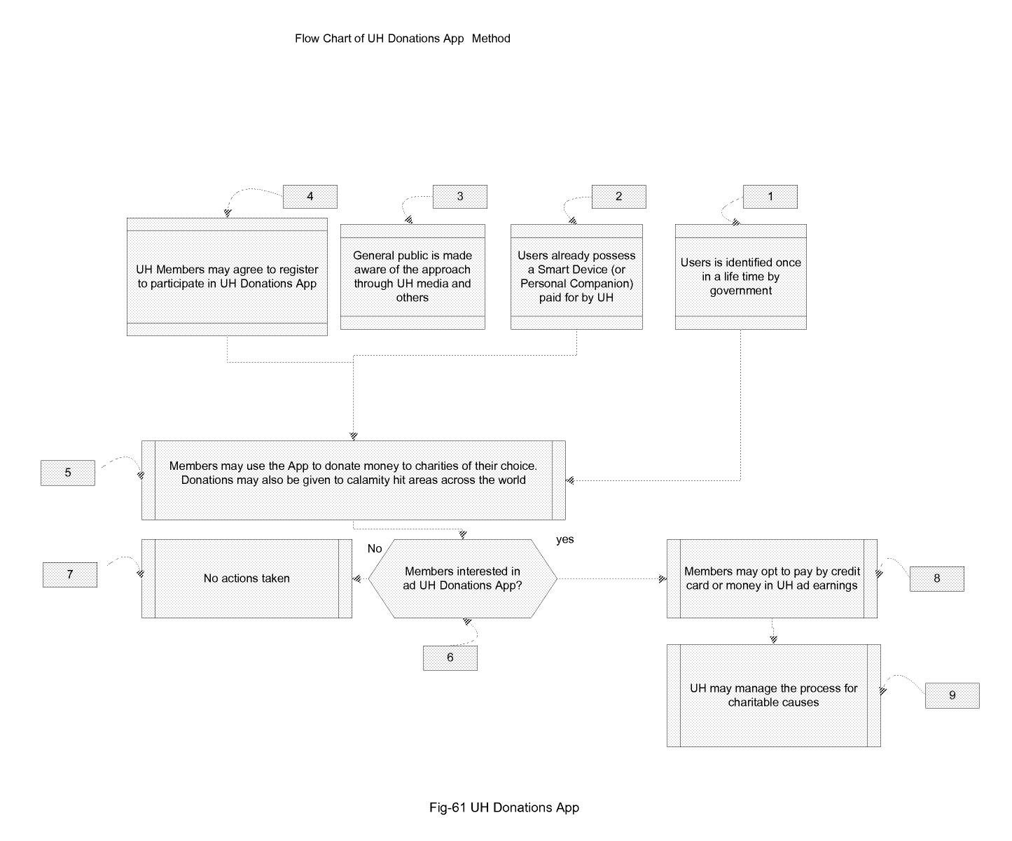

### FIG. 61 Illustrates Flow Chart of UH Donations Method.

Steps 61.1, 61.2 and 61.3 are analogous to the correspondingly numbered steps described in reference to FIG. 6 above.

In Step 61.4 members may agree to register to participate in UH Donations App.

In Step 61.5 members may use the App to donate money to charities of their choice. Donations may also be given to calamity hit areas across the world.

In Step 61.6 members interested in ad UH Donations App?

In Step 61.7 members who are not interested may not be paid for this App.

In Step 61.8 members may opt to pay by credit card or money in UH ad earnings.

In Step 61.9 UH may manage the process for charitable causes.

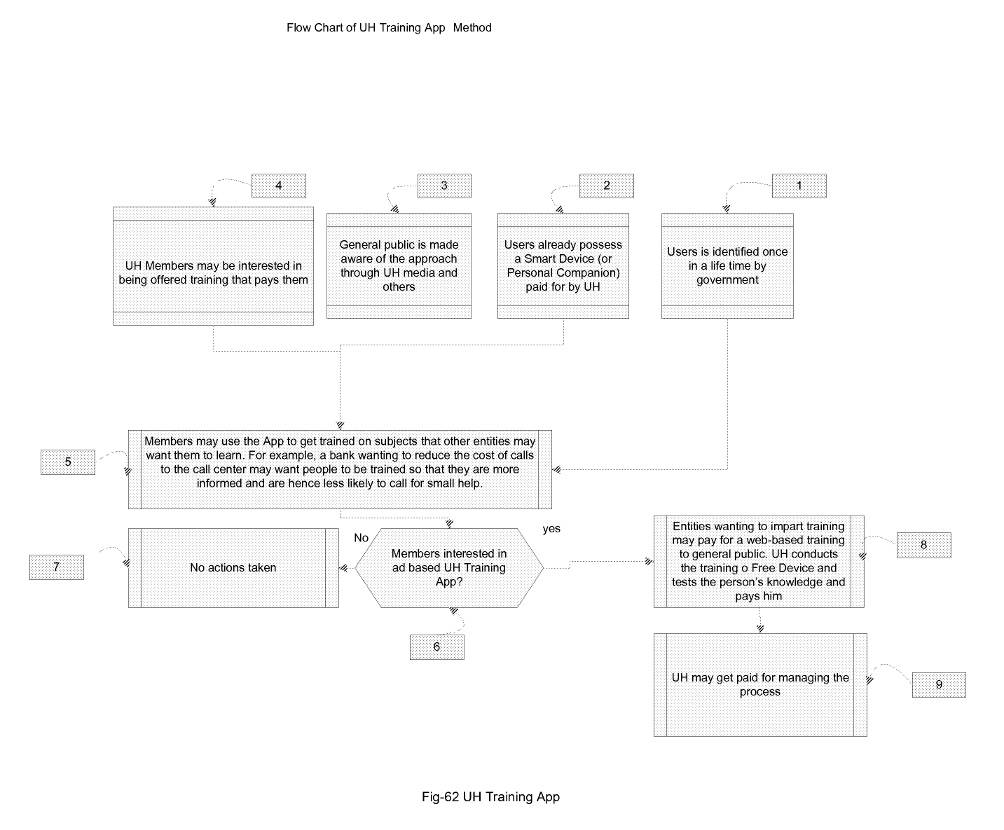

### FIG. 62 Illustrates Flow Chart of UH Training Method.

Steps 62.1, 62.2 and 62.3 are analogous to the correspondingly numbered steps described in reference to FIG. 6 above.

In Step 62.4 UH members may be interested in being offered training that pays them.

In Step 62.5 members may use the App to get trained on subjects that other entities may want them to learn. For example, a bank wanting to reduce the cost of calls to the call center may want people to be trained so that they are more informed and are hence less likely to call for small help or a cell phone manufacturer may want to train people in use of their machines and may want to pay them.

In Step 62.6 members may decide if they are interested in ad based UH Training App.

In Step 62.7 members who are not interested may not be paid for this App.

In Step 62.8 entities wanting to impart training may pay for a web-based training to general public. UH may conduct the training on Free Device and may also test the person's knowledge and pays him.

In Step 62.9 UH may get paid for managing the process.

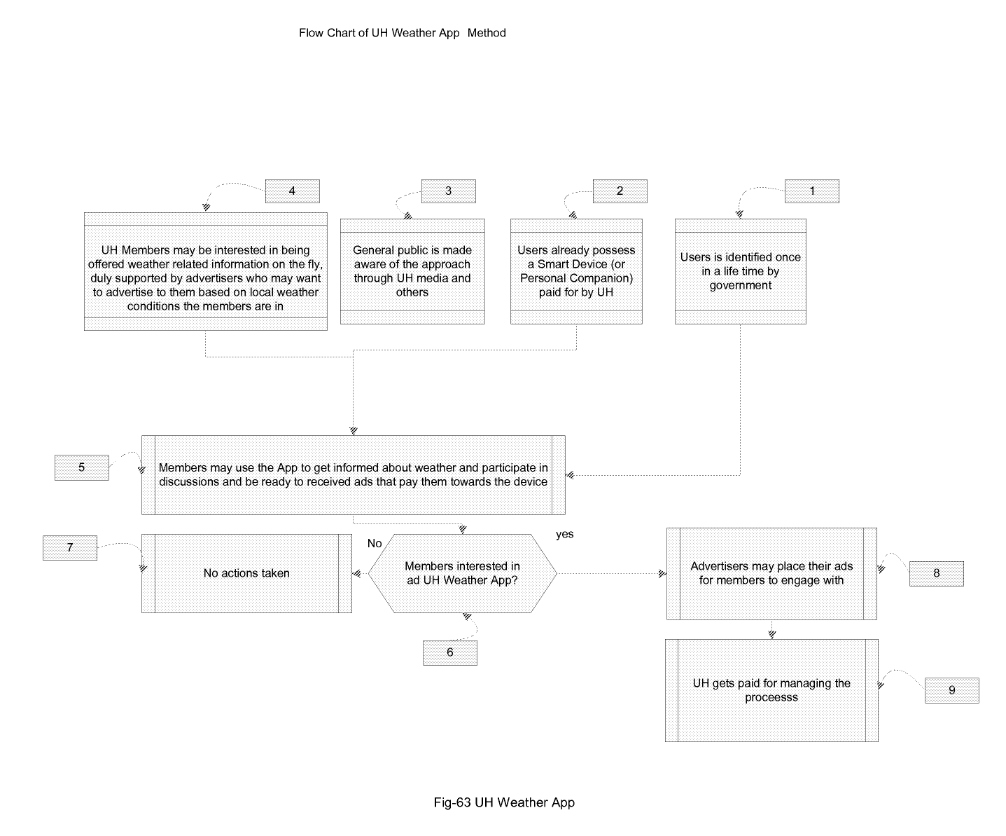

### FIG. 63 Illustrates Flow Chart of UH Weather App Method.

Steps 63.1, 63.2 and 63.3 are analogous to the correspondingly numbered steps described in reference to FIG. 6 above.

In Step 63.4 UH members may be interested in being offered weather related information on the fly, duly supported by advertisers who may want to advertise to them based on local weather conditions the members are in.

In Step 63.5 members may use the App to get informed about weather and participate in discussions and be ready to received ads that pay them towards the device.

In Step 63.6 members may decide if they are interested in ad based UH Weather App.

In Step 63.7 members who are not interested may not be paid for this App.

In Step 63.8 advertisers may place their ads for members to engage with.

In Step 63.9 UH may get paid for managing the process.

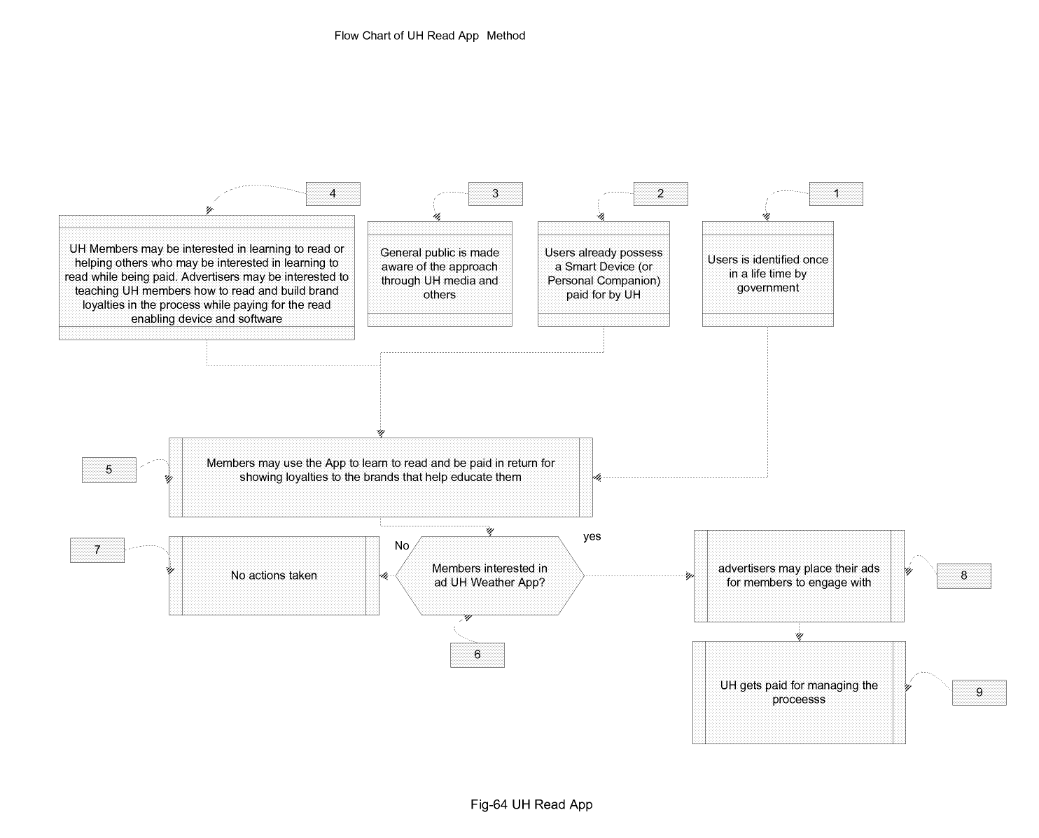

### FIG. 64 Illustrates Flow Chart of UH Read App Method.

Steps 64.1, 64.2 and 64.3 are analogous to the correspondingly numbered steps described in reference to FIG. 6 above.

In Step 64.4 members may be interested in learning to read or helping others who may be interested in learning to read while being paid. Advertisers may be interested to teaching UH members how to read and build brand loyalties in the process while paying for the read enabling device and software.

In Step 64.5 members may use the App to learn to read and be paid in return for showing loyalties to the brands that help educate them.

In Step 64.6 members may decide if they are interested in ad based UH Read App.

In Step 64.7 members who are not interested may not be paid for this App.

In Step 64.8 advertisers may place their ads for members to engage with.

In Step 64.9 UH may get paid for managing the process.

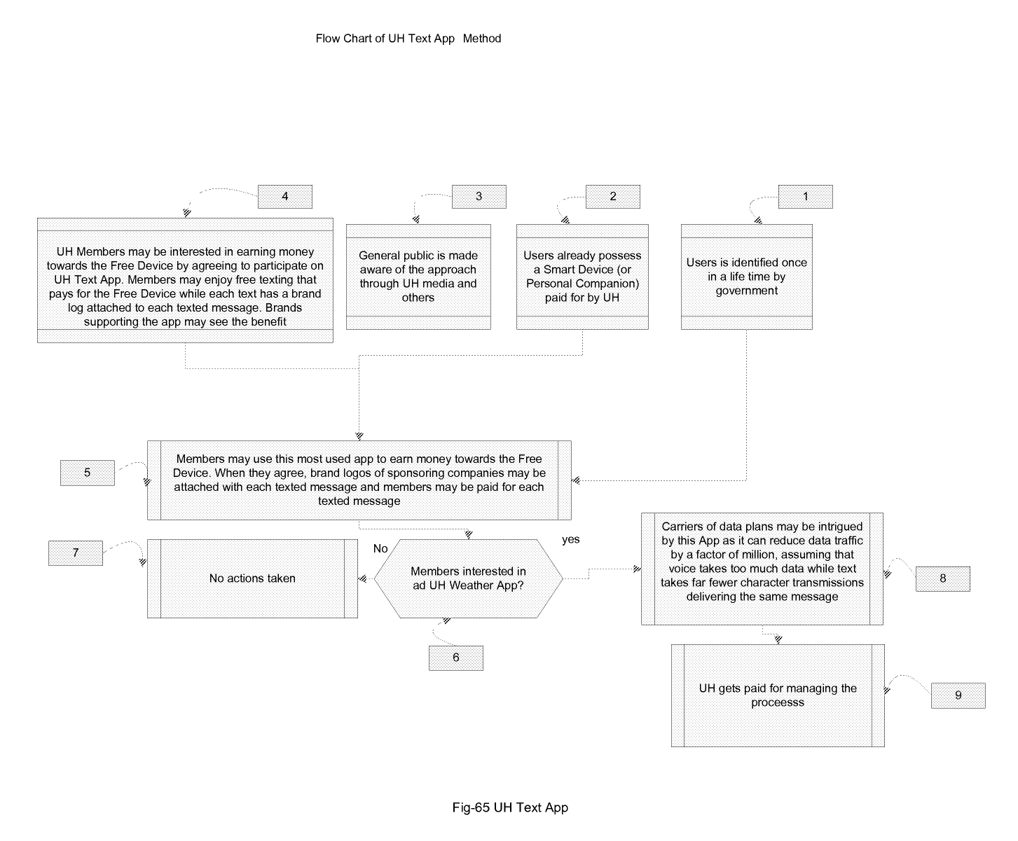

### FIG. 65 Illustrates Flow Chart of UH Text App Method.

Steps 65.1, 65.2 and 65.3 are analogous to the correspondingly numbered steps described in reference to FIG. 6 above.

In Step 65.4 members may be interested in earning money towards the Free Device by agreeing to participate on UH Text App. Members may enjoy free texting that pays for the Free Device while each text has a brand logo attached to each texted message. Brands supporting the app may see the benefit.

In Step 65.5 members may use this most used app to earn money towards the Free Device. When they agree, brand logos of sponsoring companies may be attached with each texted message and members may be paid for each texted message.

In Step 65.6 members may decide if they are interested in ad based UH Text App.

In Step 65.7 members who are not interested may not be paid for this App.

In Step 65.8 Carriers of data plans may be intrigued by this App as it can reduce data traffic by a factor of million, assuming that voice takes too much data while text takes far fewer character transmissions delivering the same message.

In Step 65.9 UH may get paid for managing the process.

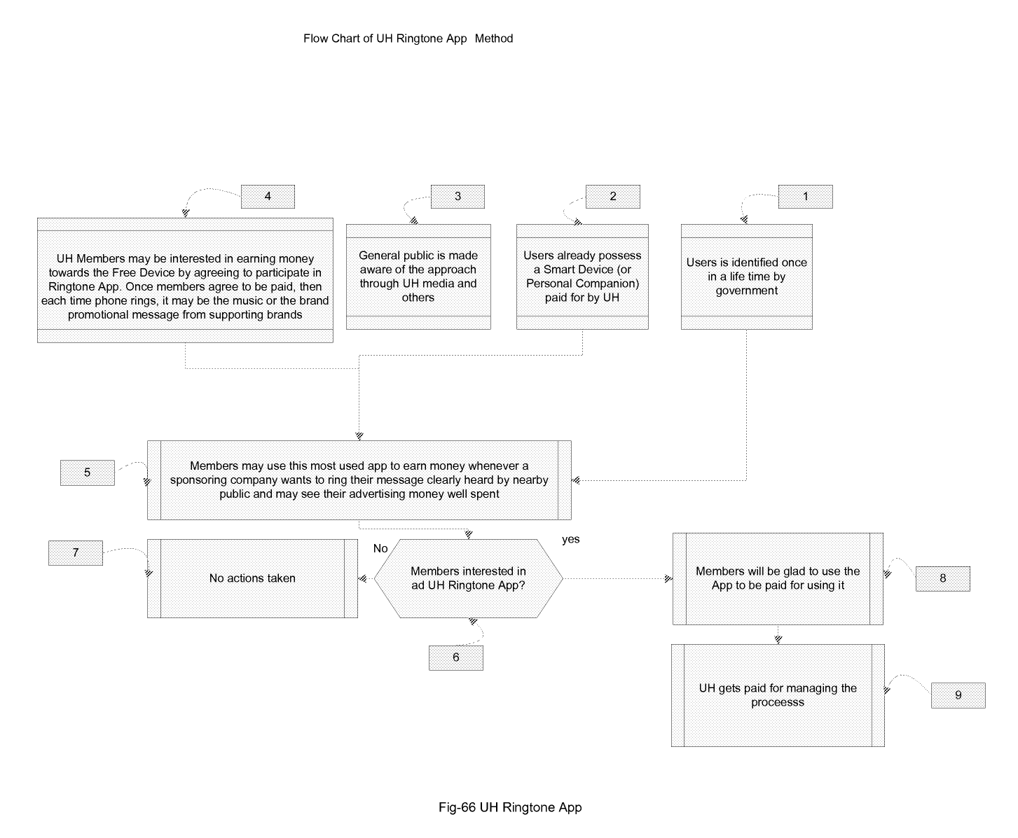

### FIG. 66 Illustrates Flow Chart of UH Ringtone App Method.

Steps 66.1, 66.2 and 66.3 are analogous to the correspondingly numbered steps described in reference to FIG. 6 above.

In Step 66.4 members may be interested in earning money towards the Free Device by agreeing to participate in Ringtone App. Once members agree to be paid, then each time phone rings, it may be the music or the brand promotional message from supporting brands.

In Step 66.5 members may use this most used app to earn money whenever a sponsoring company wants to ring their message clearly heard by nearby public and may see their advertising money well spent.

In Step 66.6 members may decide if they are interested in ad based UH Ringtone App.

In Step 66.7 members who are not interested may not be paid for this App.

In Step 66.8 members will be glad to use the App to be paid for using it.

In Step 66.9 UH may get paid for managing the process.

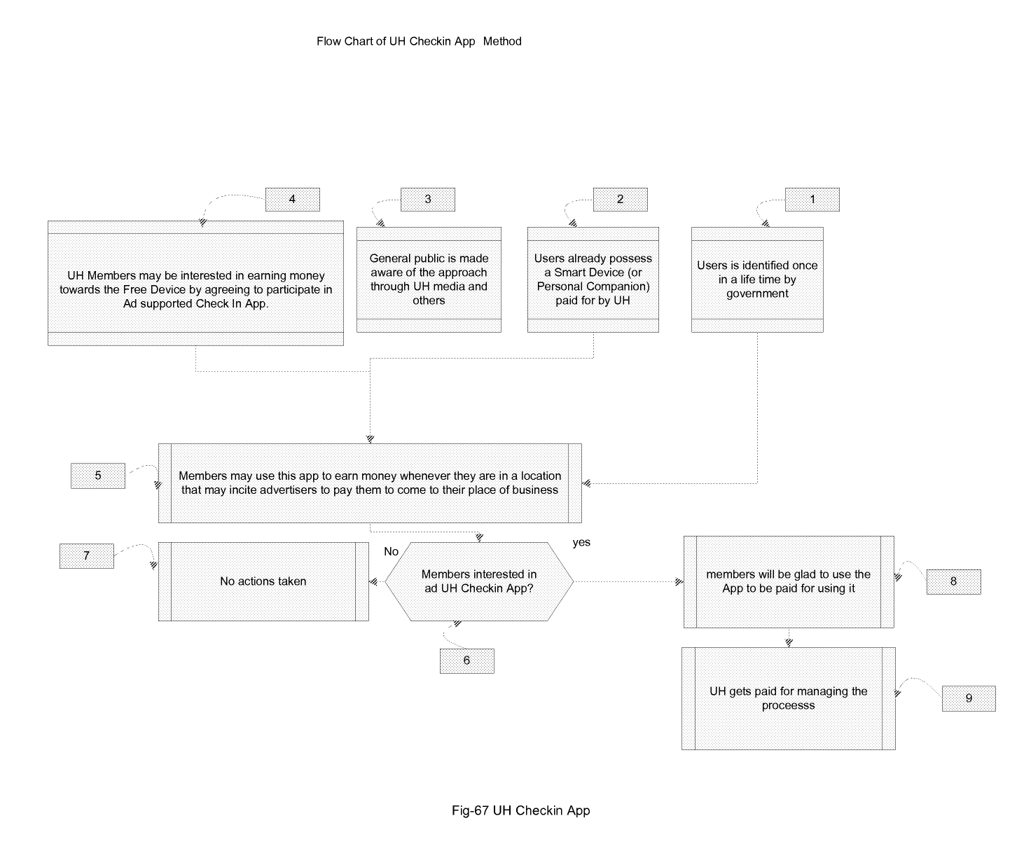

### FIG. 67 Illustrates Flow Chart of UH Checkin App Method.

Steps 67.1, 67.2 and 67.3 are analogous to the correspondingly numbered steps described in reference to FIG. 6 above.

In Step 67.4 members may be interested in earning money towards the Free Device by agreeing to participate in Ad supported Check In App.

In Step 67.5 members may use this app to earn money whenever they are in a location that may incite advertisers to pay them to come to their place of business.

In Step 67.6 members may decide if they are interested in ad based UH Checkin App.

In Step 67.7 members who are not interested may not be paid for this App.

In Step 67.8 members will be glad to use the App to be paid for using it.

In Step 67.9 UH may get paid for managing the process.

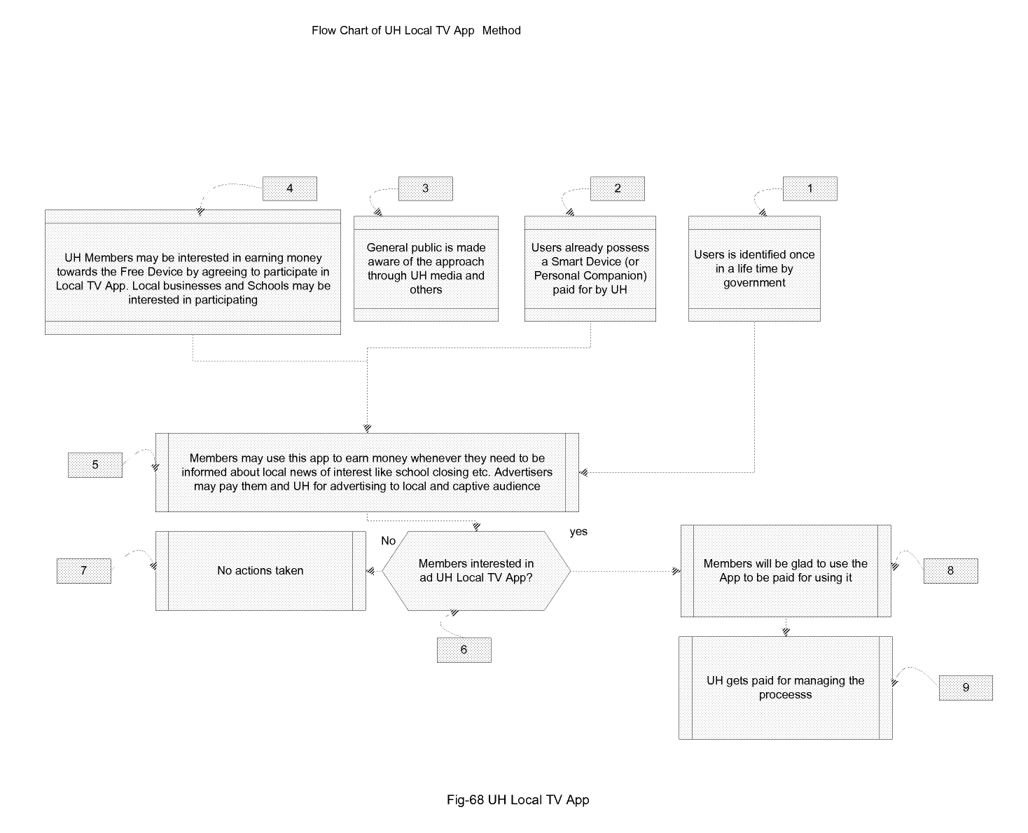

### FIG. 68 Illustrates Flow Chart of UH Local TV App Method.

Steps 68.1, 68.2 and 68.3 are analogous to the correspondingly numbered steps described in reference to FIG. 6 above.

In Step 68.4 members may be interested in earning money towards the Free Device by agreeing to participate in Local TV App. Local businesses and Schools may be interested in participating.

In Step 68.5 members may use this app to earn money whenever they need to be informed about local news of interest like school closing etc. Advertisers may pay them and UH for advertising to local and captive audience.

In Step 68.6 members may decide if they are interested in ad based UH Checkin App.

In Step 68.7 members who are not interested may not be paid for this App.

In Step 68.8 members will be glad to use the App to be paid for using it.

In Step 68.9 UH may get paid for managing the process.

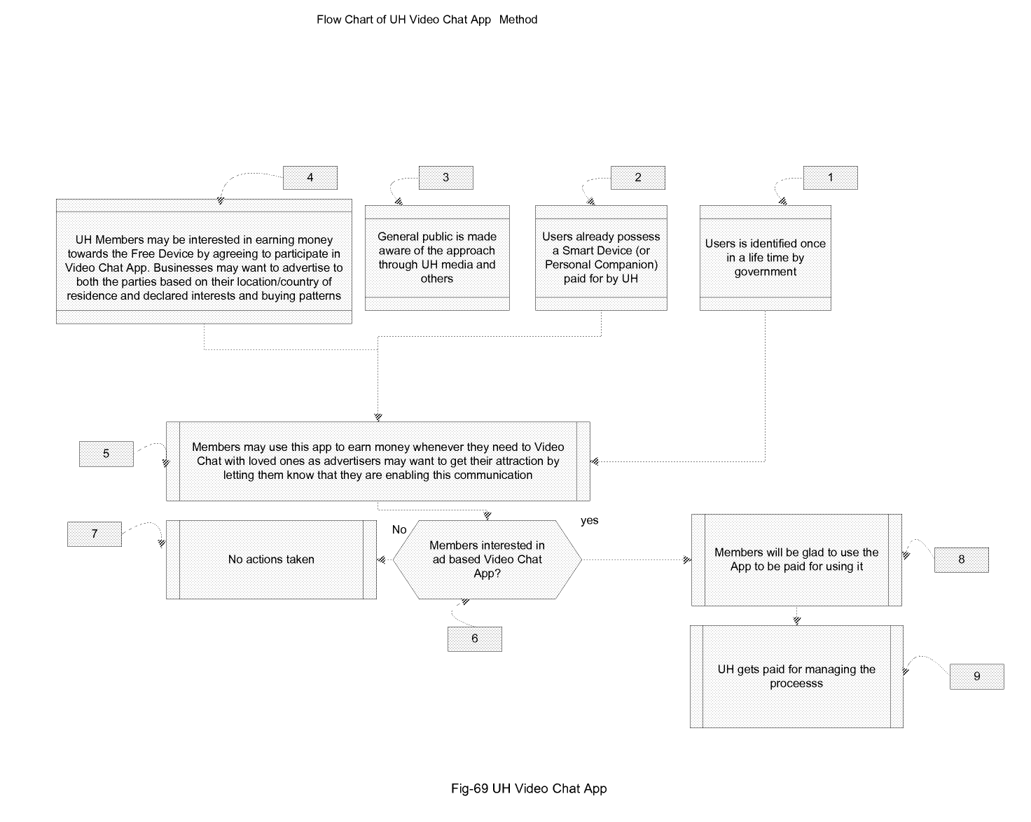

### FIG. 69 Illustrates Flow Chart of UH Video Chat App Method.

Steps 69.1, 69.2 and 69.3 are analogous to the correspondingly numbered steps described in reference to FIG. 6 above.

In Step 69.4 members may be interested in earning money towards the Free Device by agreeing to participate in Video Chat App. Businesses may want to advertise to both the parties based on their location/country of residence and declared interests and buying patterns.

In Step 69.5 Members may use this app to earn money whenever they need to Video Chat with loved ones as advertisers may want to get their attraction by letting them know that they are enabling this communication.

In Step 69.6 members may decide if they are interested in ad based Video Chat App.

In Step 69.7 members who are not interested may not be paid for this App.

In Step 69.8 members will be glad to use the App to be paid for using it.

In Step 69.9 UH may get paid for managing the process.

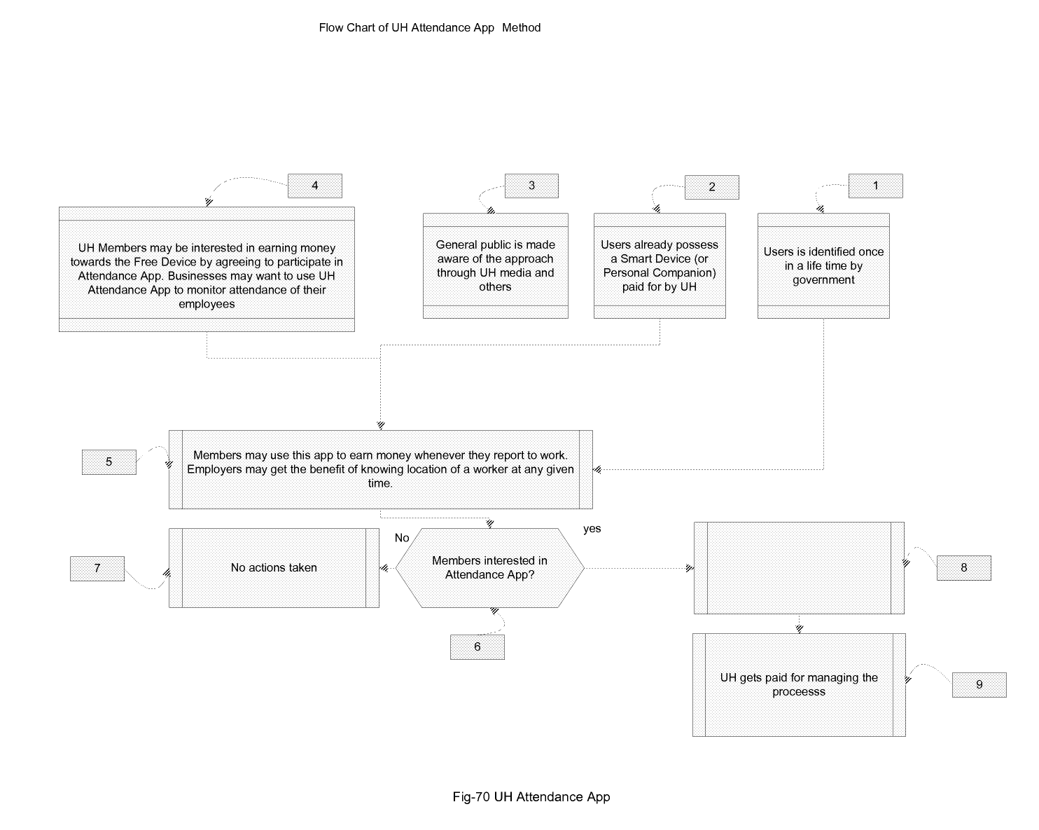

### FIG. 70 Illustrates Flow Chart of UH Attendance App Method.

Steps 70.1, 70.2 and 70.3 are analogous to the correspondingly numbered steps described in reference to FIG. 6 above.

In Step 70.4 members may be interested in earning money towards the Free Device by agreeing to participate in Attendance App. Businesses may want to use UH Attendance App to monitor attendance of their employees.

In Step 70.5 members may use this app to earn money whenever they report to work. Employers may get the benefit of knowing location of a worker at any given time.

In Step 70.6 members may decide if they are interested in Attendance App.

In Step 70.7 members who are not interested may not be paid for this App.

In Step 70.8 members will be glad to use the App to be paid for using it.

In Step 70.9 UH may get paid for managing the process.

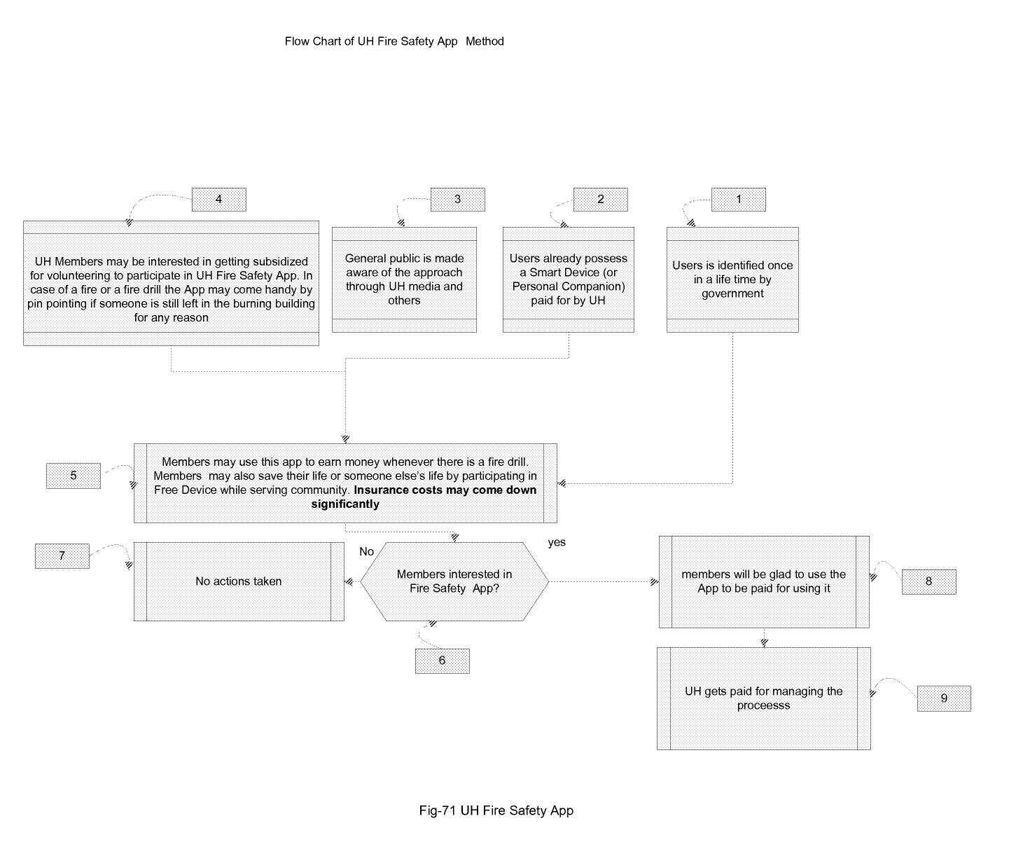

### FIG. 71 Illustrates Flow Chart of UH Fire Safety App Method.

Steps 71.1, 71.2 and 71.3 are analogous to the correspondingly numbered steps described in reference to FIG. 6 above.

In Step 71.4 members may be interested in getting subsidized for volunteering to participate in UH Fire Safety App. In case of a fire or a fire drill the App may come handy by pin pointing if someone is still left in the burning building for any reason.

In Step 71.5 Members may use this app to earn money whenever there is a fire drill. Members may also save their life or someone else's life by participating in Free Device while serving community. Insurance costs may come down significantly.

In Step 71.6 members may decide if they are interested in this App.

In Step 71.7 members who are not interested may not be paid for this App.

In Step 71.8 members will be glad to use the App to be paid for using it.

In Step 71.9 UH may get paid for managing the process.

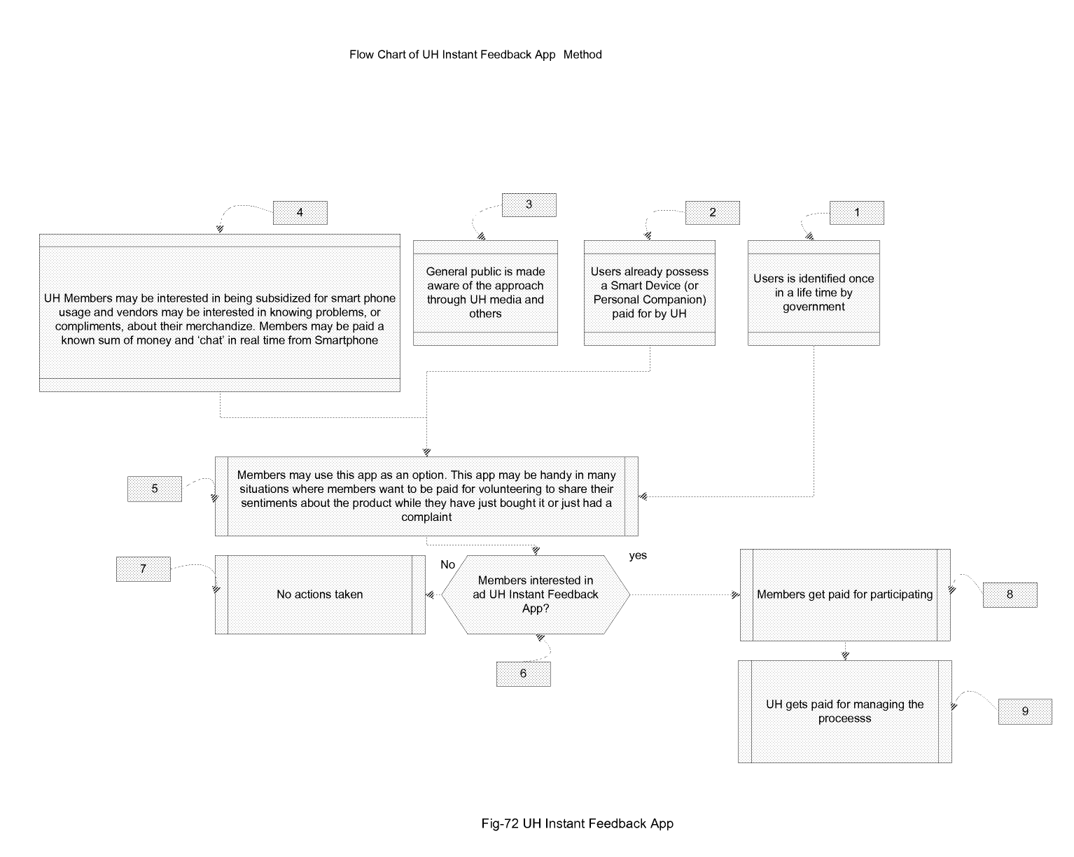

### FIG. 72 Illustrates Flow Chart of UH Instant Feedback App Method.

Steps 72.1, 72.2 and 72.3 are analogous to the correspondingly numbered steps described in reference to FIG. 6 above.

In Step 72.4 members may be interested in being subsidized for smart phone usage and vendors may be interested in knowing problems, or compliments, about their merchandize. Members may be paid a known sum of money and ‘chat’ in real time from Smartphone.

In Step 72.5 members may use this App as an option. This app may be handy in many situations where members want to be paid for volunteering to share their sentiments about the product while they have just bought it or just had a complaint.

In Step 72.6 members may decide if they are interested in this App.

In Step 72.7 members who are not interested may not be paid for this App.

In Step 72.8 members will be glad to use the App to be paid for using it.

In Step 72.9 UH may get paid for managing the process.

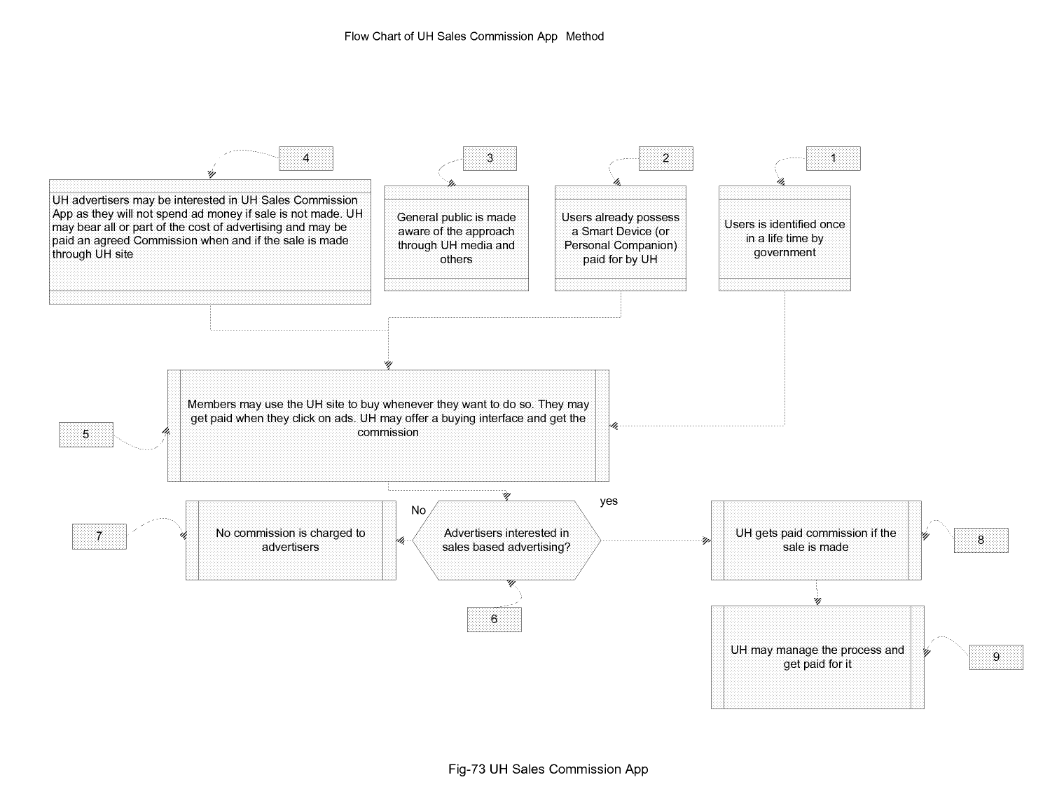

### FIG. 73 Illustrates Flow Chart of UH Sales Commission App Method.

Steps 73.1, 73.2 and 73.3 are analogous to the correspondingly numbered steps described in reference to FIG. 6 above.

In Step 73.4 UH advertisers may be interested in UH Sales Commission App as they will not spend ad money if sale is not made. UH may bear all or part of the cost of advertising and may be paid an agreed Commission when and if the sale is made through UH site.

In Step 73.5 members may use the UH site to buy whenever they want to do so. They may get paid when they click on ads. UH may offer a buying interface and get the commission.

In Step 73.6 advertisers may decide if they are interested in sales based advertising.

In Step 73.7 no commission is charged to advertisers.

In Step 73.8 UH gets paid commission if the sale is made.

In Step 73.9 UH may manage the process and get paid for it.

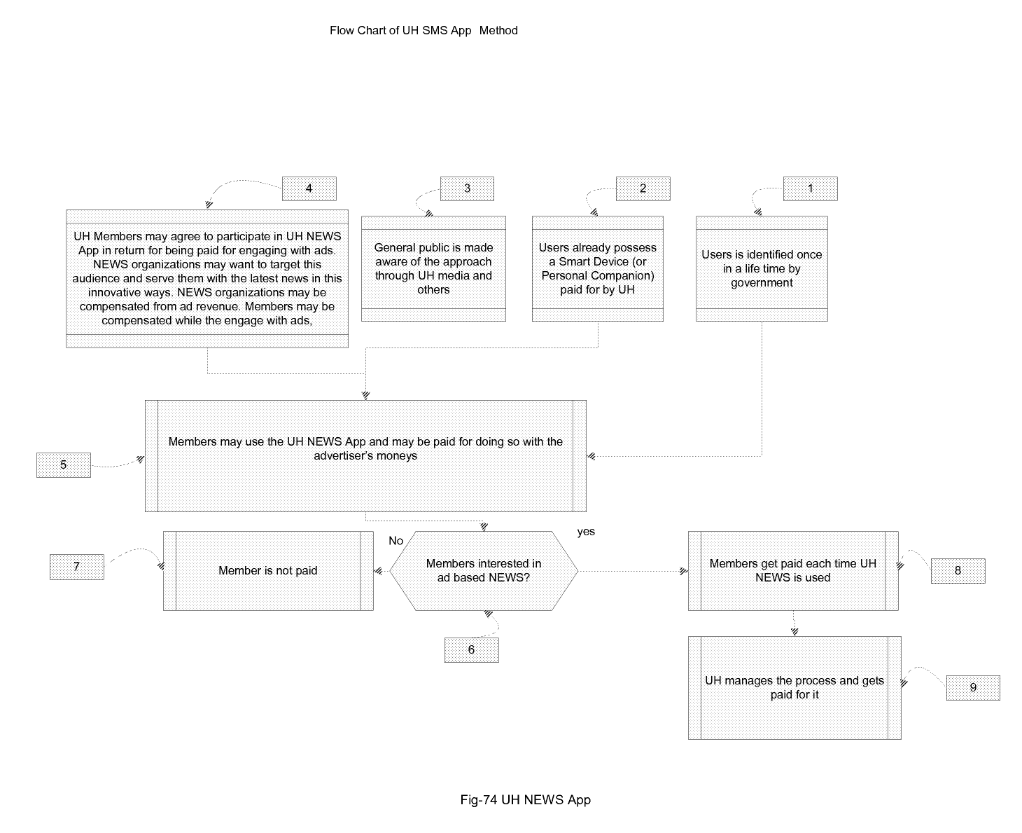

### FIG. 74 Illustrates Flow Chart of UH NEWS App Method.

Steps 74.1, 74.2 and 74.3 are analogous to the correspondingly numbered steps described in reference to FIG. 6 above.

In Step 74.4 UH members may agree to participate in UH NEWS App in return for being paid for engaging with ads. NEWS organizations may want to target this audience and serve them with the latest news in this innovative ways. NEWS organizations may be compensated from ad revenue. Members may be compensated while the engage with ads.

In Step 74.5 Members may use the UH NEWS App and may be paid for doing so with the advertiser's moneys.

In Step 74.6 advertisers may decide if they are interested in sales based advertising.

In Step 74.7 no commission is charged to advertisers.

In Step 74.8 UH gets paid commission if the sale is made.

In Step 74.9 UH may manage the process and get paid for it.

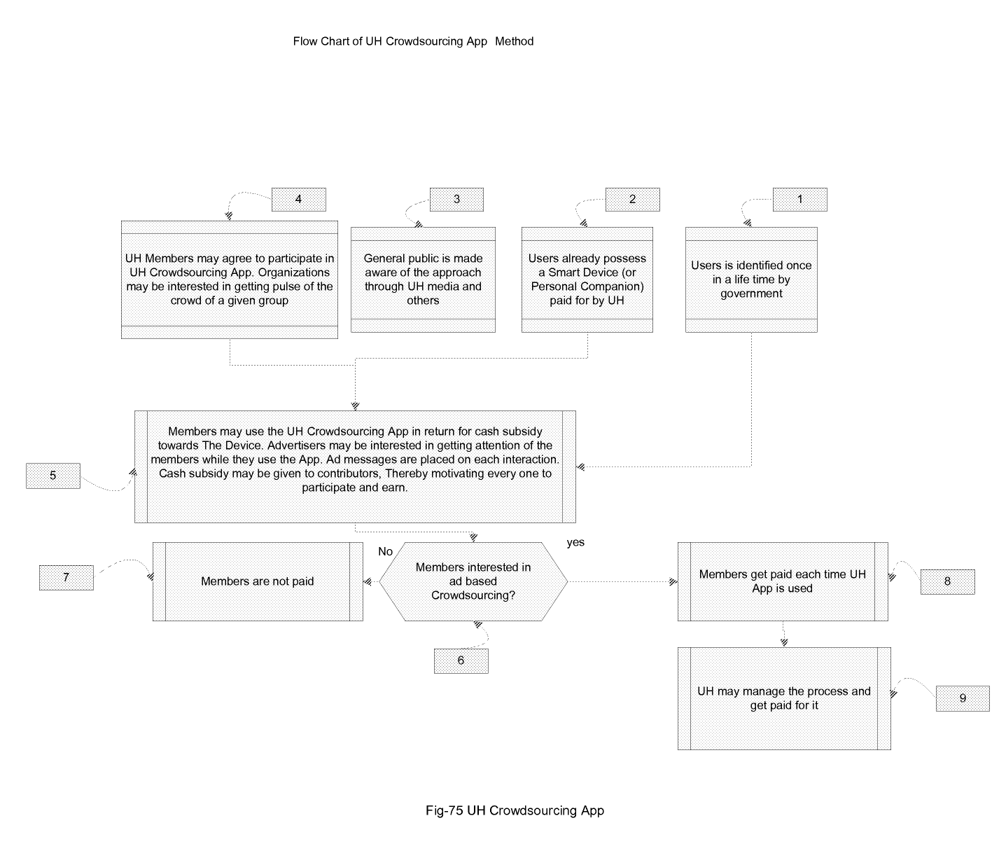

### FIG. 75 Illustrates Flow Chart of UH Crowdsourcing App Method.

Steps 75.1, 75.2 and 75.3 are analogous to the correspondingly numbered steps described in reference to FIG. 6 above.

In Step 75.4 members may agree to participate in UH Crowdsourcing App. Organizations may be interested in getting pulse and opinion of the crowd of a given group.

In Step 75.5 members may use the UH Crowdsourcing App in return for cash subsidy towards The Device. Advertisers may be interested in getting attention of the members while they use the App. Ad messages are placed on each interaction. Cash subsidy may be given to contributors, Thereby motivating everyone to participate and earn.

In Step 75.6 members may decide if they are interested in ad based Crowdsourcing.

In Step 75.7 members are not paid.

In Step 75.8 members get paid each time UH App is used.

In Step 75.9 UH may manage the process and get paid for it.

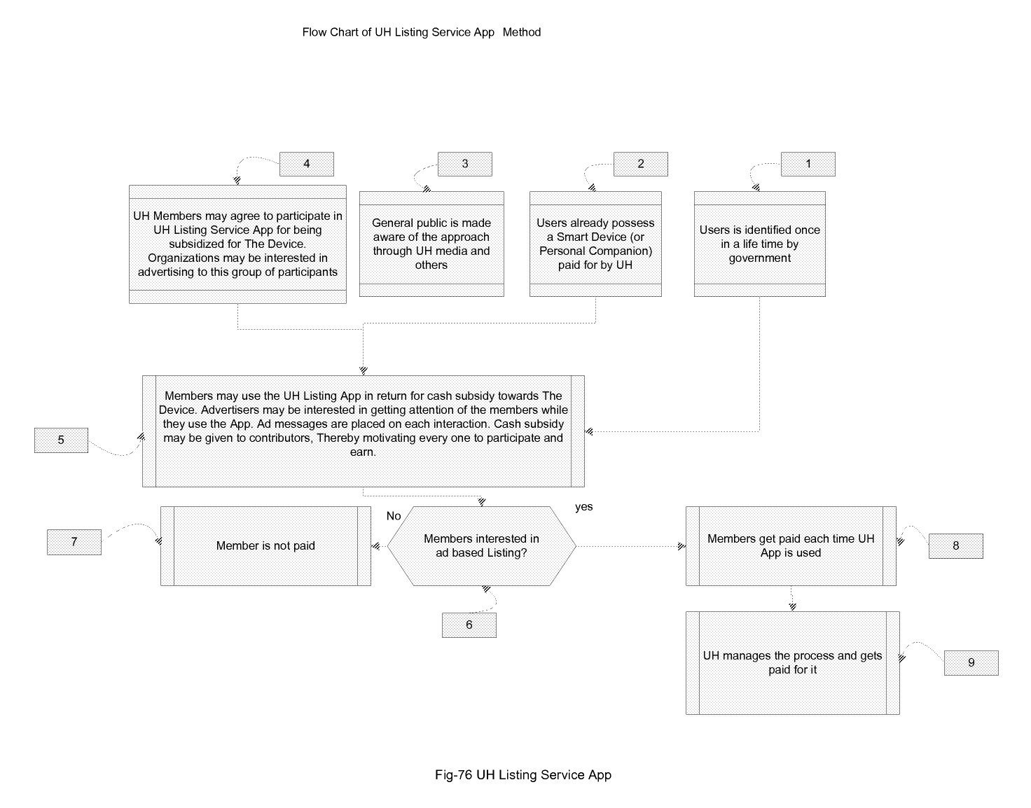

### FIG. 76 Illustrates Flow Chart of UH Listing Service App Method.

Steps 76.1, 76.2 and 76.3 are analogous to the correspondingly numbered steps described in reference to FIG. 6 above.

In Step 76.4 members may agree to participate in UH Listing Service App for being subsidized for The Device. Organizations may be interested in advertising to this group of participants.

In Step 76.5 members may use the UH Listing App in return for cash subsidy towards The Device. Advertisers may be interested in getting attention of the members while they use the App. Ad messages are placed on each interaction. Cash subsidy may be given to contributors, Thereby motivating everyone to participate and earn.

In Step 76.6 members may decide if they are interested in ad based Listing.

In Step 76.7 members are not paid.

In Step 76.8 members get paid each time UH App is used.

In Step 76.9 UH may manage the process and get paid for it.

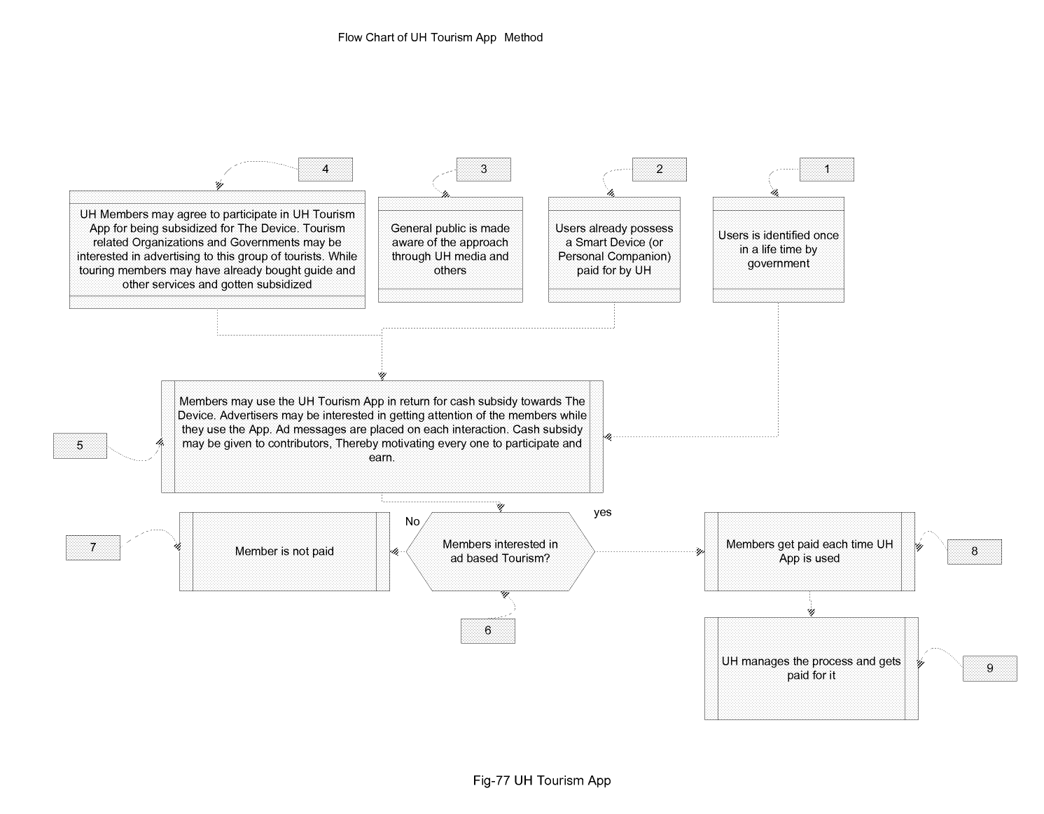

### FIG. 77 Illustrates Flow Chart of UH Tourism App Method.

Steps 77.1, 77.2 and 77.3 are analogous to the correspondingly numbered steps described in reference to FIG. 6 above.

In Step 77.4 members may agree to participate in UH Tourism App for being subsidized for The Device. Tourism related Organizations and Governments may be interested in advertising to this group of tourists. While touring members may have already bought guide and other services and gotten subsidized.

In Step 77.5 members may use the UH Tourism App in return for cash subsidy towards The Device. Advertisers may be interested in getting attention of the members while they use the App. Ad messages are placed on each interaction. Cash subsidy may be given to contributors, Thereby motivating everyone to participate and earn.

In Step 77.6 members may decide if they are interested in ad based tourism.

In Step 77.7 members are not paid if they opt out.

In Step 77.8 members get paid each time UH App is used.

In Step 77.9 UH may manage the process and get paid for it.

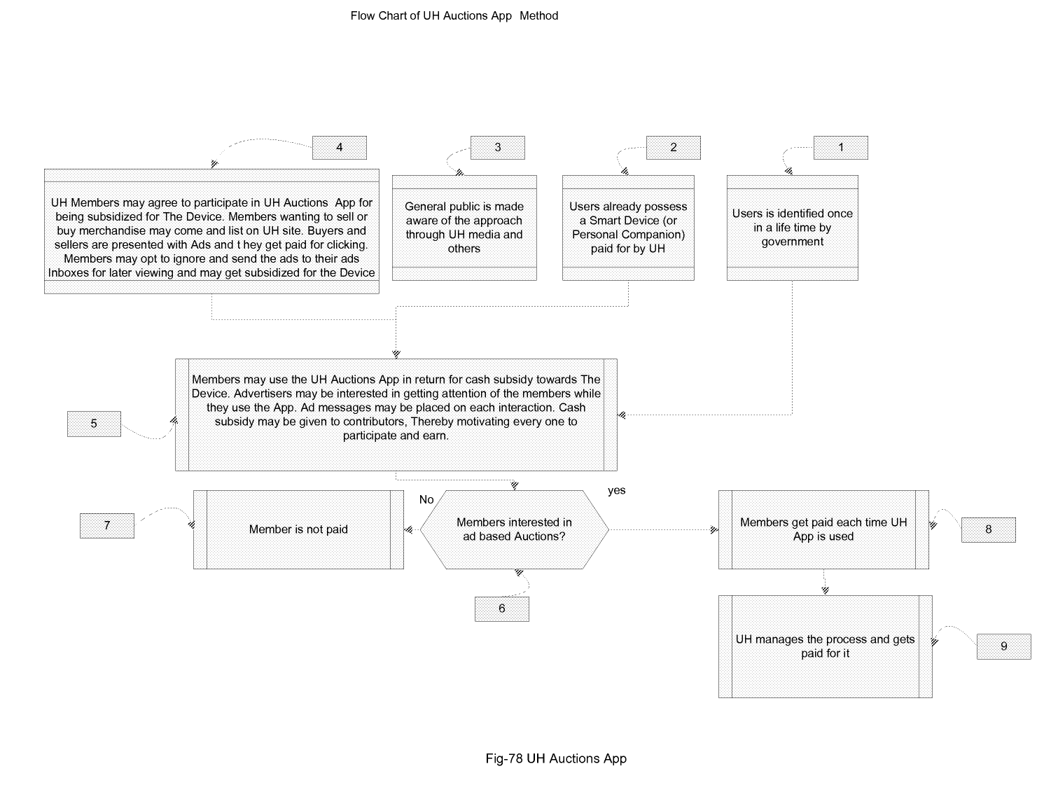

### FIG. 78 Illustrates Flow Chart of UH Auctions App Method.

Steps 78.1, 78.2 and 78.3 are analogous to the correspondingly numbered steps described in reference to FIG. 6 above.

In Step 78.4 members may agree to participate in UH Auctions App for being subsidized for The Device. Members wanting to sell or buy merchandise may come and list on UH site. Buyers and sellers are presented with Ads and they get paid for clicking. Members may opt to ignore and send the ads to their ads Inboxes for later viewing and may get subsidized for the Device.

In Step 78.5 members may use the UH Auctions App in return for cash subsidy towards The Device. Advertisers may be interested in getting attention of the members while they use the App. Ad messages may be placed on each interaction. Cash subsidy may be given to contributors, Thereby motivating everyone to participate and earn.

In Step 78.6 members may decide if they are interested in ad based auctions.

In Step 78.7 members are not paid if they opt out.

In Step 78.8 members get paid each time UH App is used.

In Step 78.9 UH may manage the process and get paid for it.

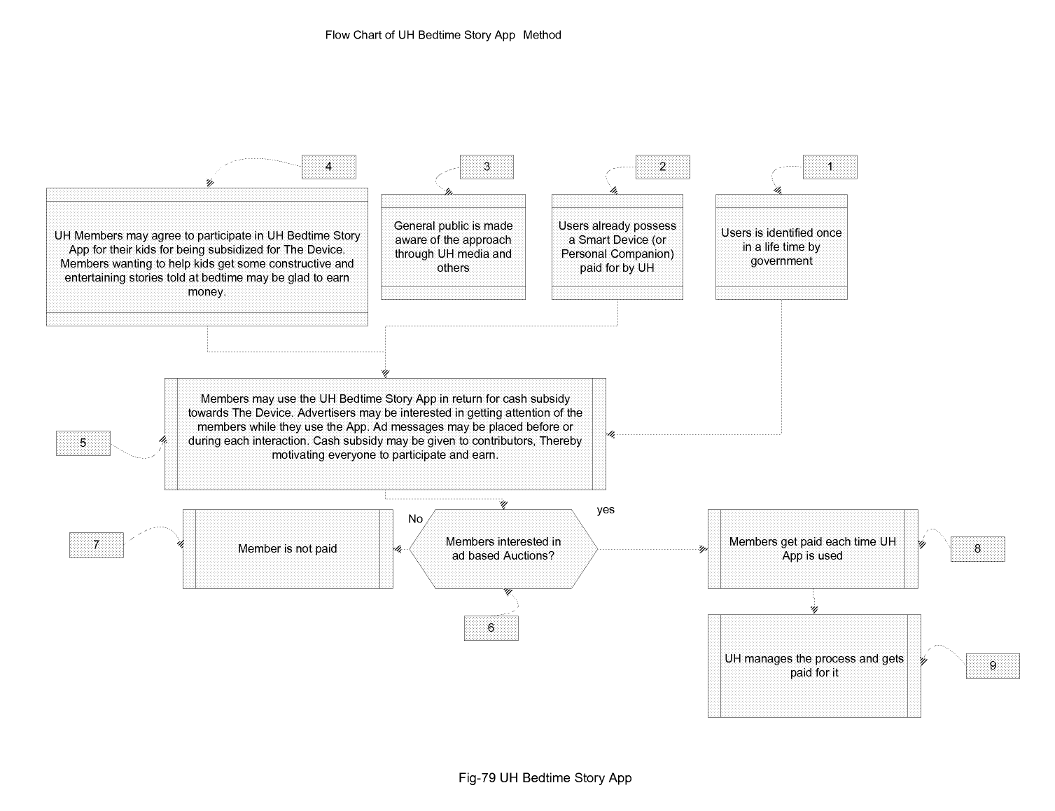

### FIG. 79 Illustrates Flow Chart of UH Bedtime Story App Method.

Steps 79.1, 79.2 and 79.3 are analogous to the correspondingly numbered steps described in reference to FIG. 6 above.

In Step 79.4 members may agree to participate in UH Bedtime Story App for their kids for being subsidized for The Device. Members wanting to help kids get some constructive and entertaining stories told at bedtime may be glad to earn money.

In Step 79.5 members may use the UH Bedtime Story App in return for cash subsidy towards The Device. Advertisers may be interested in getting attention of the members while they use the App. Ad messages may be placed before or during each interaction. Cash subsidy may be given to contributors, Thereby motivating everyone to participate and earn.

In Step 79.6 members may decide if they are interested in ad based Bedtime Story App.

In Step 79.7 members are not paid if they opt out.

In Step 79.8 members get paid each time UH App is used.

In Step 79.9 UH may manage the process and get paid for it.

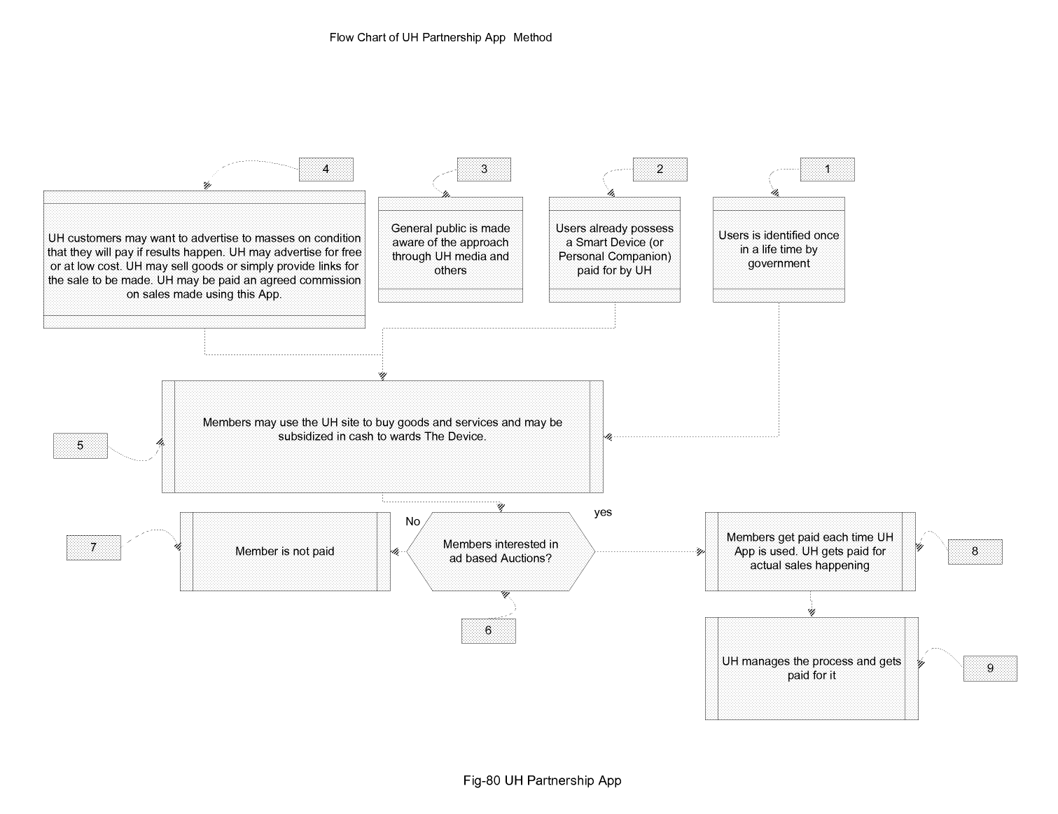

### FIG. 80 Illustrates Flow Chart of UH Partnership App Method.

Steps 80.1, 80.2 and 80.3 are analogous to the correspondingly numbered steps described in reference to FIG. 6 above.

In Step 80.4 UH customers may want to advertise to masses on condition that they will pay if results happen. UH may advertise for free or at low cost. UH may sell goods or simply provide links for the sale to be made. UH may be paid an agreed commission on sales made using this App.

In Step 80.5 members may use the UH site to buy goods and services and may be subsidized in cash towards The Device.

In Step 80.6 members may decide if they are interested in this App.

In Step 80.7 members are not paid if they opt out.

In Step 80.8 members get paid each time UH App is used.

In Step 80.9 UH may manage the process and get paid for it.

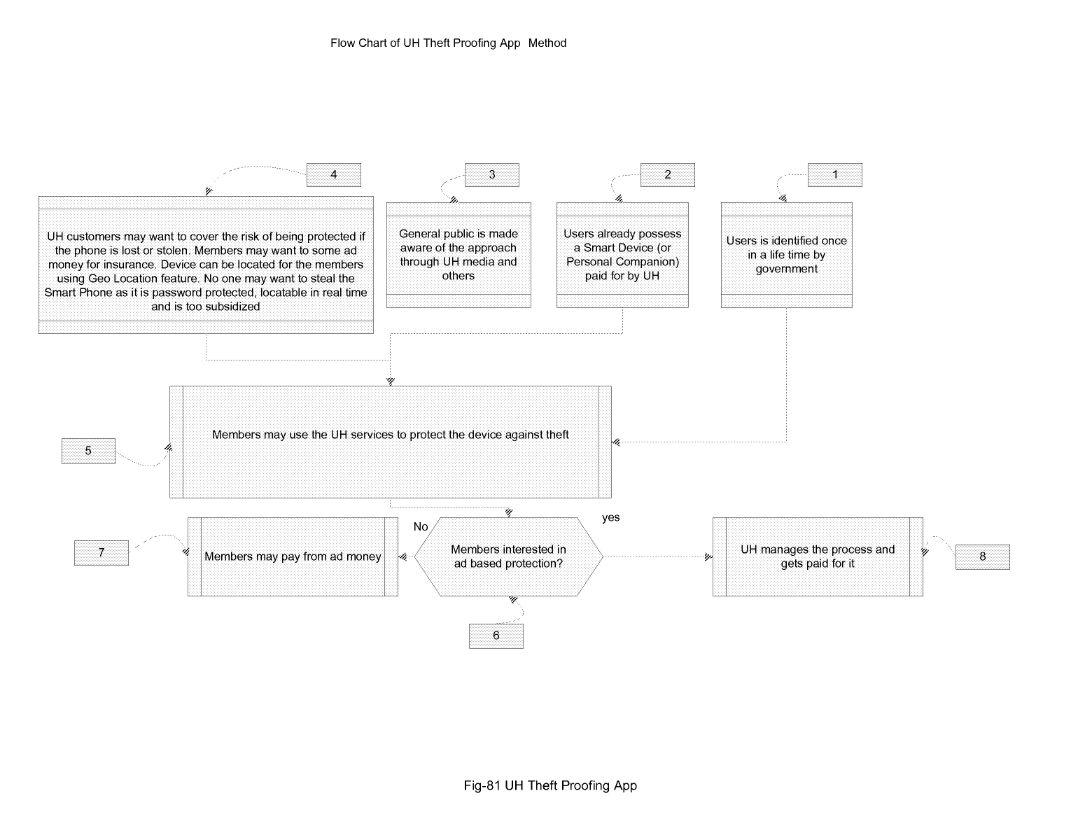

### FIG. 81 Illustrates Flow Chart of UH Theft Proofing App Method.

Steps 81.1, 81.2 and 81.3 are analogous to the correspondingly numbered steps described in reference to FIG. 6 above.

In Step 81.4 customers may want to cover the risk of being protected if the phone is lost or stolen. Members may want to some ad money for insurance. Device can be located for the members using Geo Location feature. No one may want to steal the Smart Phone as it is password protected, locatable in real time and is too subsidized.

In Step 81.5 Members may use the UH services to protect the device against theft.

In Step 81.6 members may decide if they are interested in this App.

In Step 81.7 members are not paid if they opt out.

In Step 81.8 UH manages the process and gets paid for it.

### FIG. 82 Illustrates Flow Chart of UH Photo Share App Method.

Steps 82.1, 82.2 and 82.3 are analogous to the correspondingly numbered steps described in reference to FIG. 6 above.

In Step 82.4 members may be interested in earning money by sharing their photos with family and friends, thereby attracting attention of advertisers. Advertisers may be interested in advertising to the viewers of the photos and paying them for their attention span.

In Step 82.5 members may use this app and share photos. Friends viewing their photos may be served ads and members may get paid.

In Step 82.6 members may decide if they are interested in ad based Photo Share.

In Step 82.7 members are not paid if they opt out.

In Step 82.8 members get paid each time UH App is used.

In Step 82.9 UH may manage the process and get paid for it.

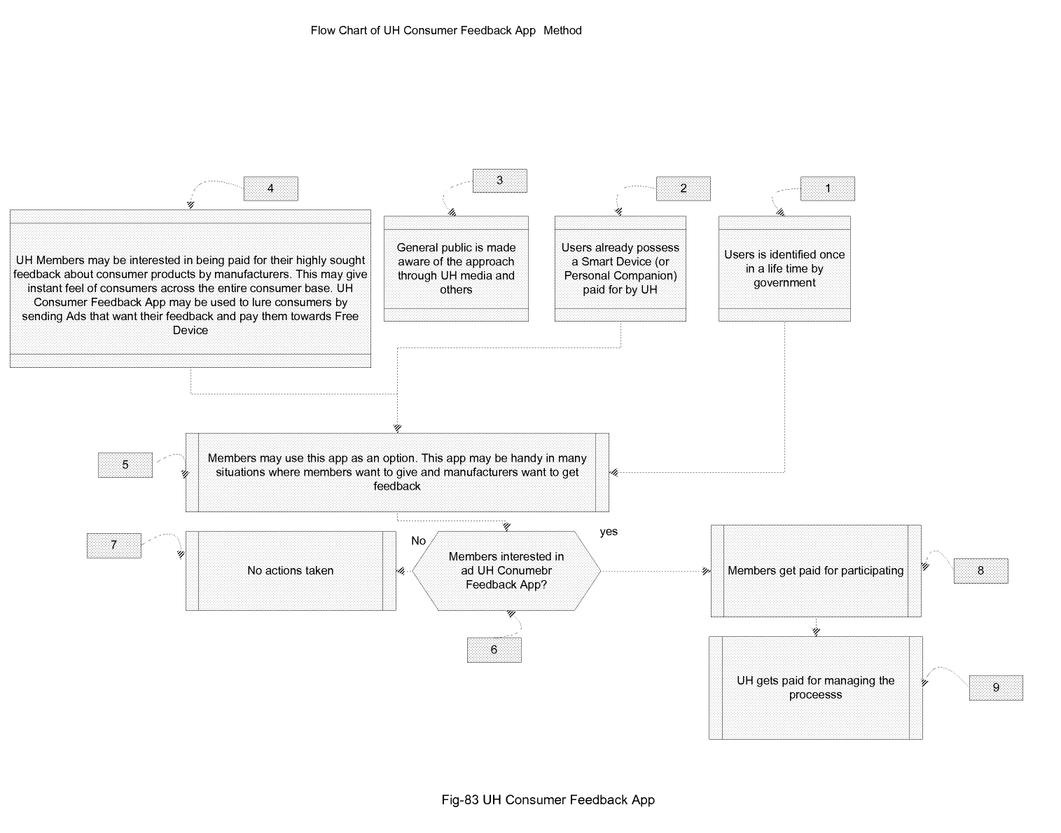

### FIG. 83 Illustrates Flow Chart of UH Consumer Feedback App Method.

Steps 83.1, 83.2 and 83.3 are analogous to the correspondingly numbered steps described in reference to FIG. 6 above.

In Step 83.4 members may be interested in being paid for their highly sought feedback about consumer products by manufacturers. This may give instant feel of consumers across the entire consumer base. UH Consumer Feedback App may be used to lure consumers by sending Ads that want their feedback and pay them towards Free Device.

In Step 83.5 members may use this app as an option. This app may be handy in many situations where members want to give and manufacturers want to get feedback.

In Step 83.6 members may decide if they are interested in ad based feedback App.

In Step 83.7 members are not paid if they opt out.

In Step 83.8 members get paid each time UH App is used.

In Step 83.9 UH may manage the process and get paid for it.

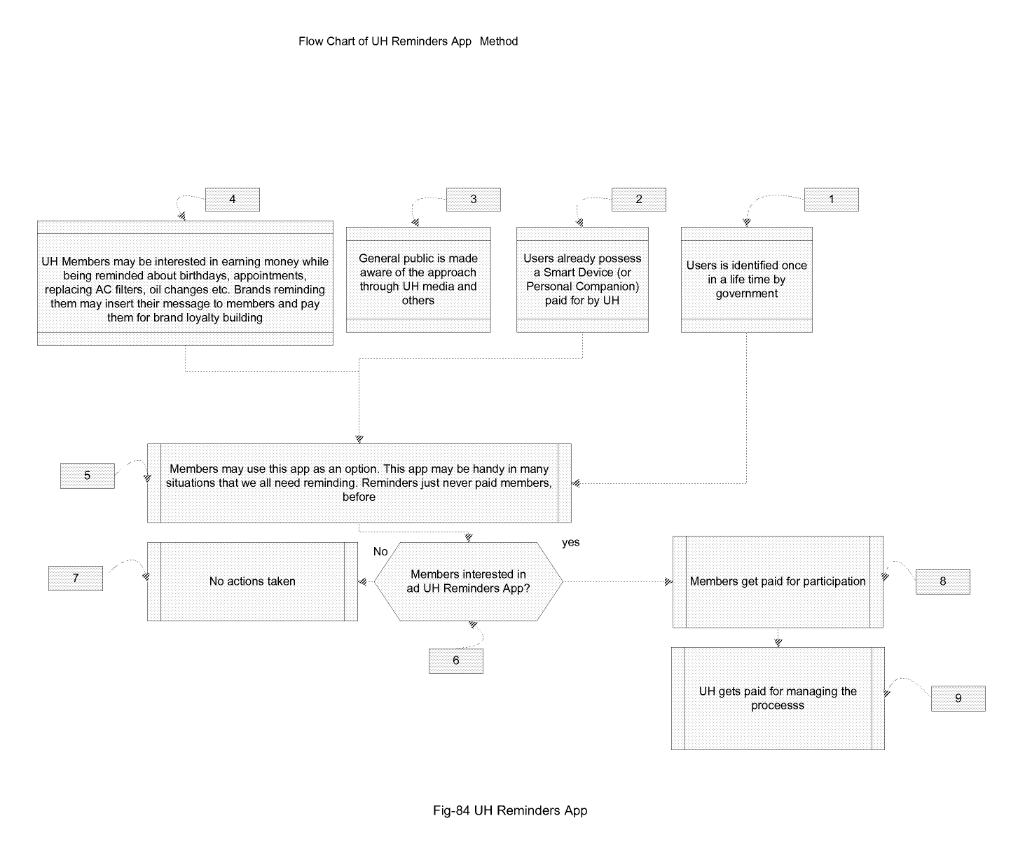

### FIG. 84 Illustrates Flow Chart of UH Reminders App Method.

Steps 84.1, 84.2 and 84.3 are analogous to the correspondingly numbered steps described in reference to FIG. 6 above.

In Step 84.4 members may be interested in earning money while being reminded about birthdays, appointments, replacing AC filters, oil changes etc. Brands reminding them may insert their message to members and pay them for brand loyalty building.

In Step 84.5 members may use this app as an option. This app may be handy in many situations that we all need reminding. Reminders just never paid members, before.

In Step 84.6 members may decide if they are interested in ad based reminders App.

In Step 84.7 members are not paid if they opt out.

In Step 84.8 members get paid each time UH App is used.

In Step 84.9 UH may manage the process and get paid for it.

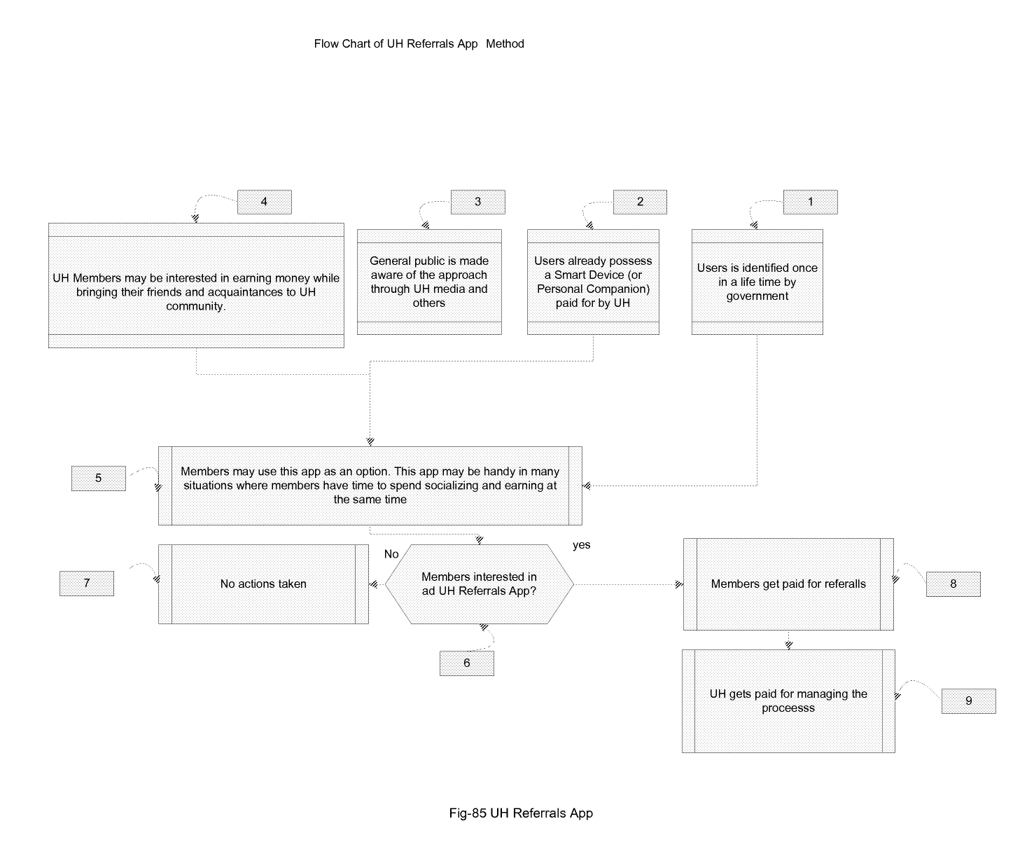

### FIG. 85 Illustrates Flow Chart of UH Referrals App Method.

Steps 85.1, 85.2 and 85.3 are analogous to the correspondingly numbered steps described in reference to FIG. 6 above.

In Step 85.4 members may be interested in earning money while bringing their friends and acquaintances to UH community.

In Step 85.5 members may use this app as an option. This app may be handy in many situations where members have time to spend socializing and earning at the same time.

In Step 85.6 members may decide if they are interested in referrals App.

In Step 85.7 members are not paid if they opt out.

In Step 85.8 members get paid each time UH App is used.

In Step 85.9 UH may manage the process and get paid.

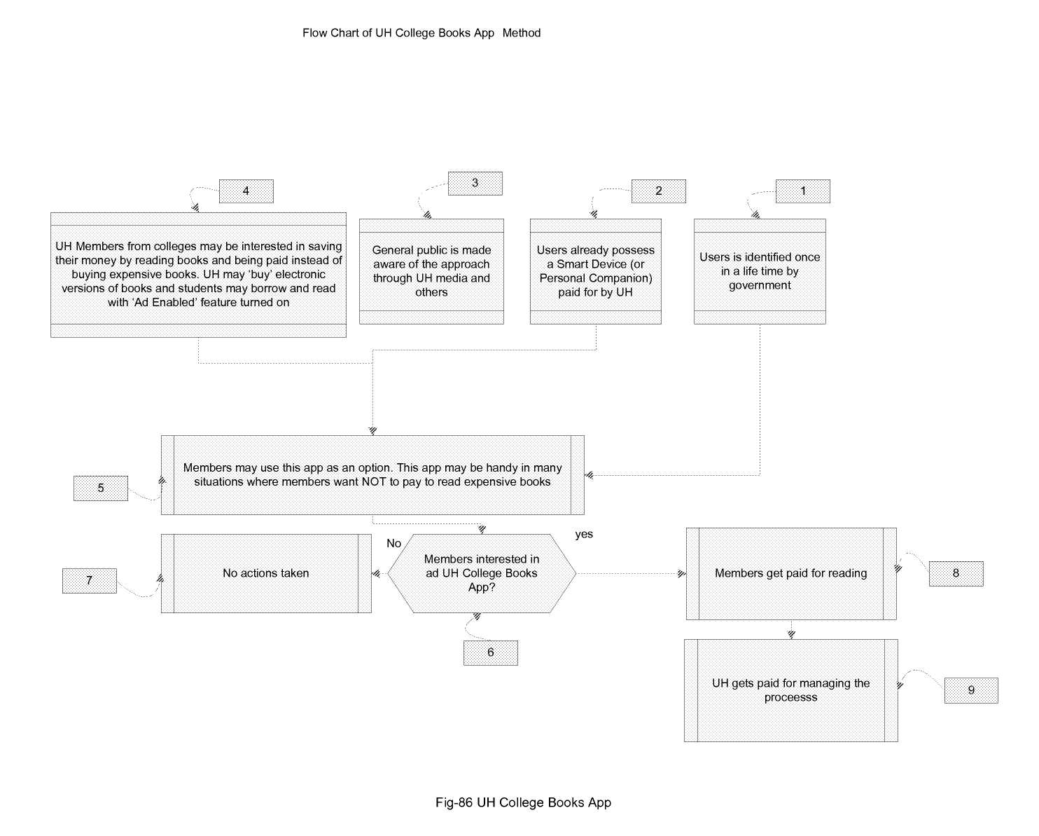

### FIG. 86 Illustrates Flow Chart of UH College Books App Method.

Steps 86.1, 86.2 and 86.3 are analogous to the correspondingly numbered steps described in reference to FIG. 6 above.

In Step 86.4 members from colleges may be interested in saving their money by reading books and being paid instead of buying expensive books. UH may ‘buy’ electronic versions of books and students may borrow and read with ‘Ad Enabled’ feature turned on.

In Step 86.5 members may use this app as an option. This app may be handy in many situations where members want NOT to pay to read expensive books.

In Step 86.6 members may decide if they are interested in this App.

In Step 86.7 members are not paid if they opt out.

In Step 86.8 members get paid each time UH App is used.

In Step 86.9 UH may manage the process and get paid.

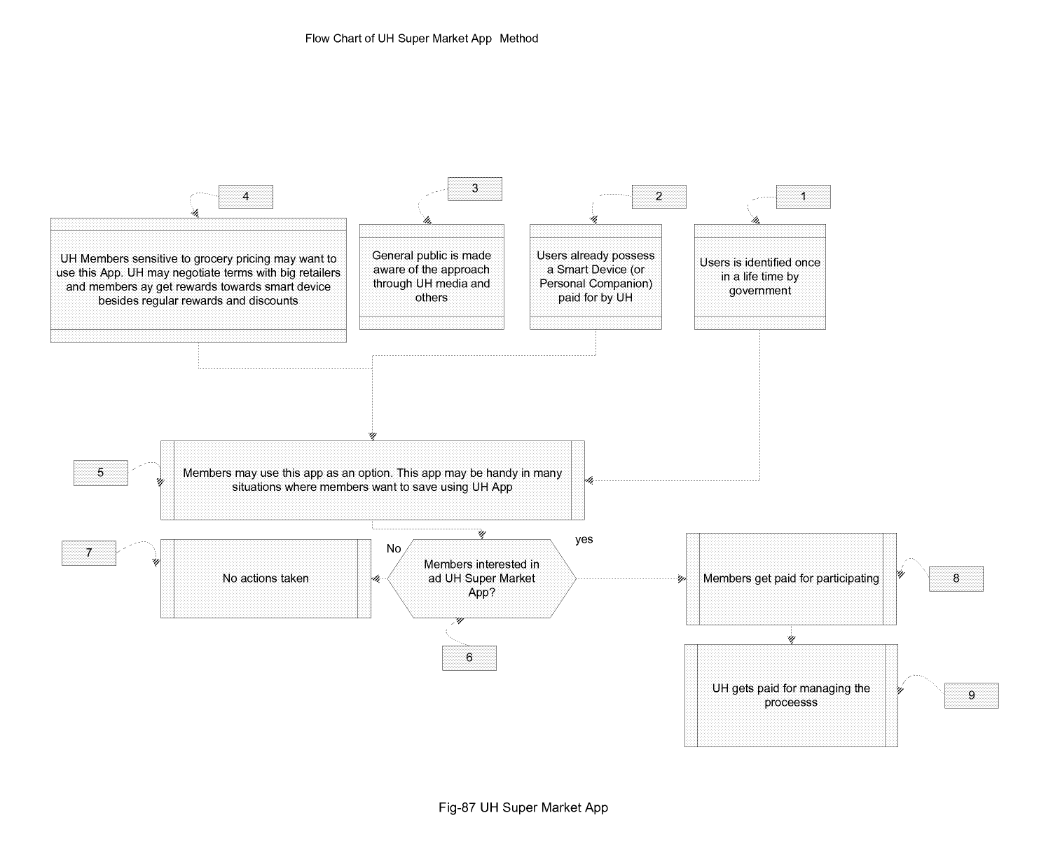

### FIG. 87 Illustrates Flow Chart of UH Super Market App Method.

Steps 87.1, 87.2 and 87.3 are analogous to the correspondingly numbered steps described in reference to FIG. 6 above.

In Step 87.4 members sensitive to grocery pricing may want to use this App. UH may negotiate terms with big retailers and members may get rewards towards smart device besides regular rewards and discounts.

In Step 87.5 members may use this app as an option. This app may be handy in many situations where members want to save using UH App.

In Step 87.6 members may decide if they are interested in this App.

In Step 87.7 members are not paid if they opt out.

In Step 87.8 members get paid each time UH App is used.

In Step 87.9 UH may manage the process and get paid.

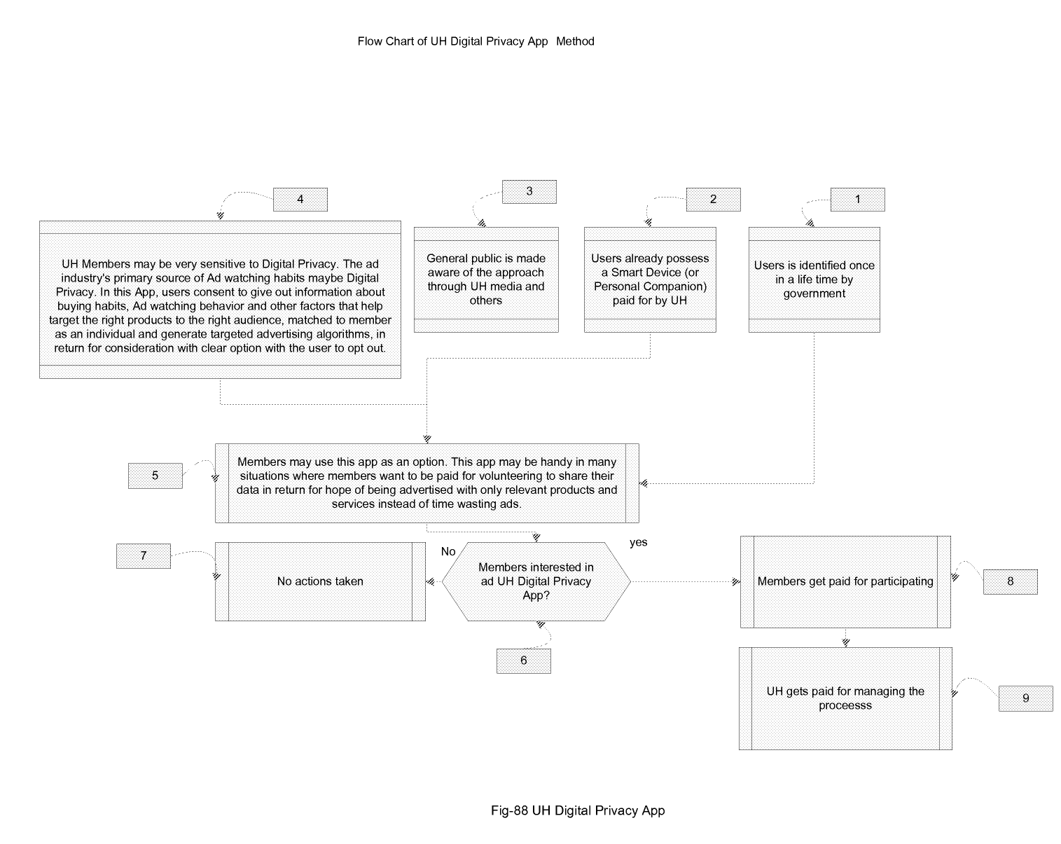

### FIG. 88 Illustrates Flow Chart of UH Digital Privacy App Method.

Steps 88.1, 88.2 and 88.3 are analogous to the correspondingly numbered steps described in reference to FIG. 6 above.

In Step 88.4 members may be very sensitive to Digital Privacy. The ad industry's primary source of Ad watching habits maybe Digital Privacy. In this App, users consent to give out information about buying habits, Ad watching behavior and other factors that help target the right products to the right audience, matched to member as an individual and generate targeted advertising algorithms, in return for consideration with clear option with the user to opt out.

In Step 88.5 Members may use this app as an option. This app may be handy in many situations where members want to be paid for volunteering to share their data in return for hope of being advertised with only relevant products and services instead of time wasting ads.

In Step 88.6 members may decide if they are interested in this App.

In Step 88.7 members are not paid if they opt out.

In Step 88.8 members get paid each time UH App is used.

In Step 88.9 UH may manage the process and get paid.

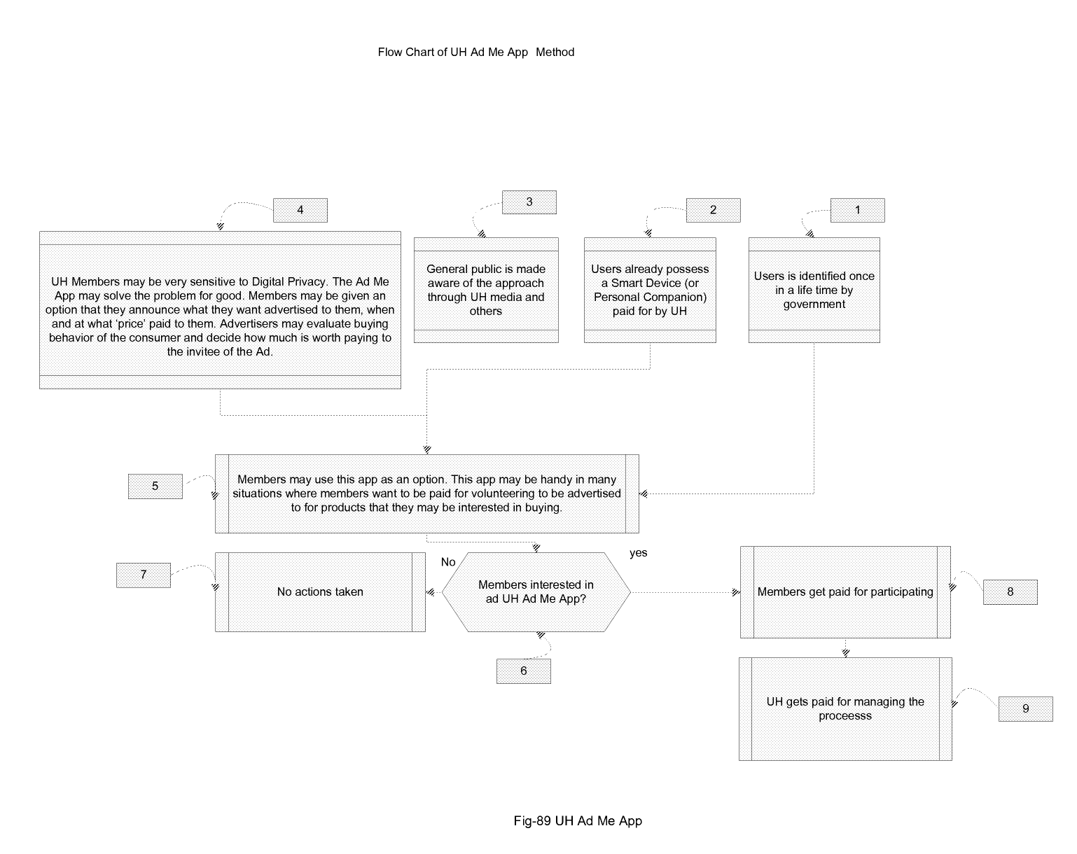

### FIG. 89 Illustrates Flow Chart of UH AD Me App Method.

Steps 89.1, 89.2 and 89.3 are analogous to the correspondingly numbered steps described in reference to FIG. 6 above.

In Step 89.4 members may be very sensitive to Digital Privacy. The Ad Me App may solve the problem for good. Members may be given an option that they announce what they want advertised to them, when and at what ‘price’ paid to them. Advertisers may evaluate buying behavior of the consumer and decide how much is worth paying to the invitee of the Ad.

In Step 89.5 members may use this app as an option. This app may be handy in many situations where members want to be paid for volunteering to be advertised to for products that they may be interested in buying.

In Step 89.6 members may decide if they are interested in this App.

In Step 89.7 members are not paid if they opt out.

In Step 89.8 members get paid each time UH App is used.

In Step 89.9 UH may manage the process and get paid.

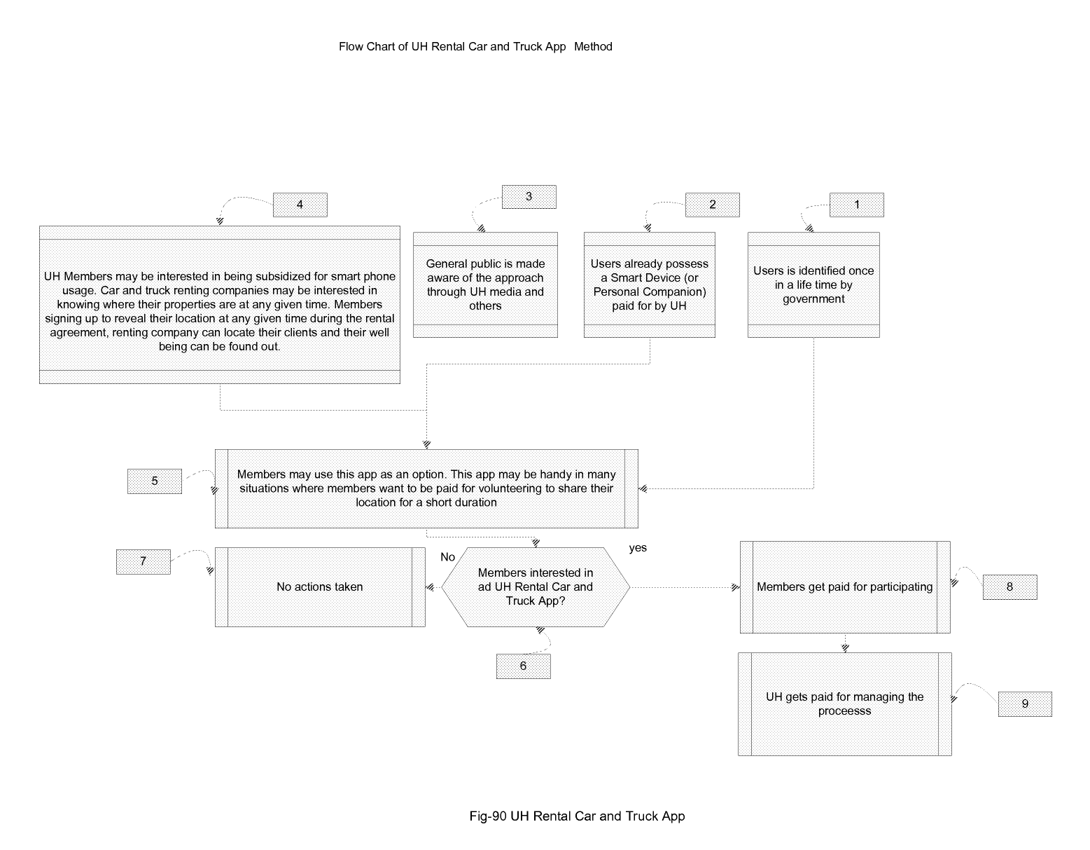

### FIG. 90 Illustrates Flow Chart of Rental Car and Truck App Method.

Steps 90.1, 90.2 and 90.3 are analogous to the correspondingly numbered steps described in reference to FIG. 6 above.

In Step 90.4 members may be interested in being subsidized for smart phone usage. Car and truck renting companies may be interested in knowing where their properties are at any given time. Members signing up to reveal their location at any given time during the rental agreement, renting company can locate their clients and their well being can be found out.

In Step 90.5 members may use this app as an option. This app may be handy in many situations where members want to be paid for volunteering to share their location for a short duration.

In Step 90.6 members may decide if they are interested in this App.

In Step 90.7 members are not paid if they opt out.

In Step 90.8 members get paid each time UH App is used.

In Step 90.9 UH may manage the process and get paid.

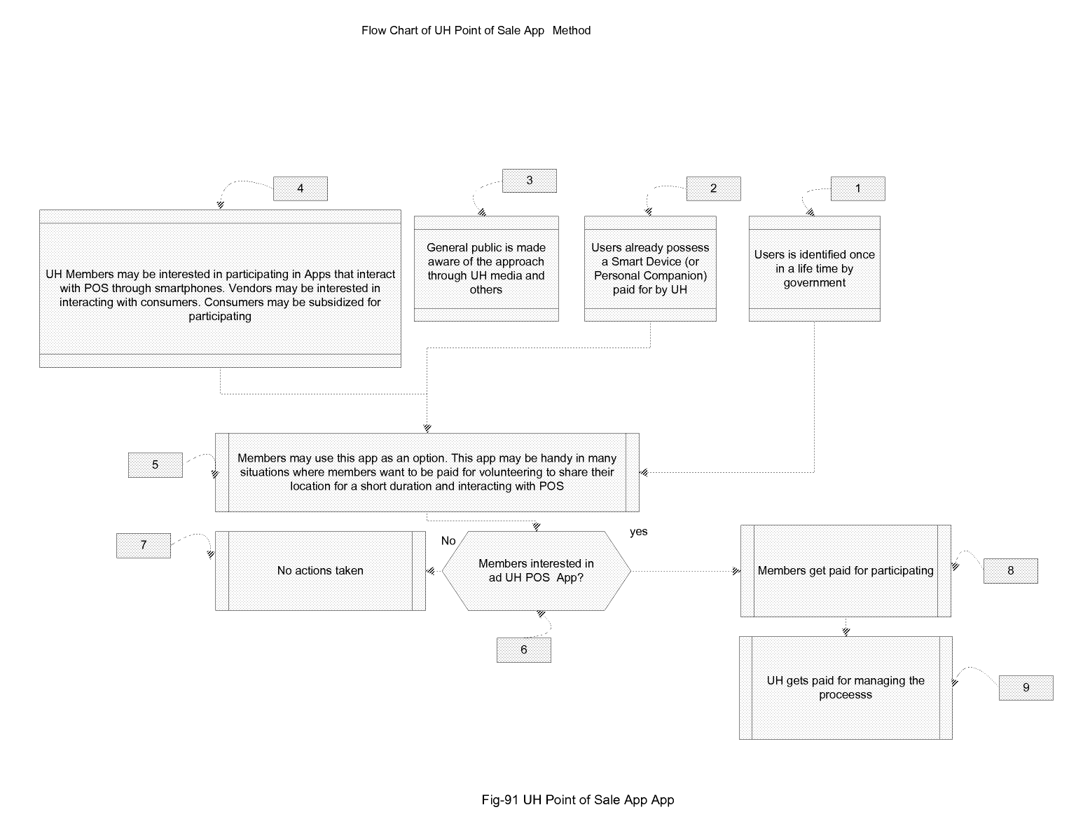

### FIG. 91 Illustrates Flow Chart of Point of Sale App Method.

Steps 91.1, 91.2 and 91.3 are analogous to the correspondingly numbered steps described in reference to FIG. 6 above.

In Step 91.4 embers may be interested in participating in Apps that interact with POS through smart phones. Vendors may be interested in interacting with consumers. Consumers may be subsidized for participating.

In Step 91.5 members may use this app as an option. This app may be handy in many situations where members want to be paid for volunteering to share their location for a short duration and interacting with POS.

In Step 91.6 members may decide if they are interested in this App.

In Step 91.7 members are not paid if they opt out.

In Step 91.8 members get paid each time UH App is used.

In Step 91.9 UH may manage the process and get paid.

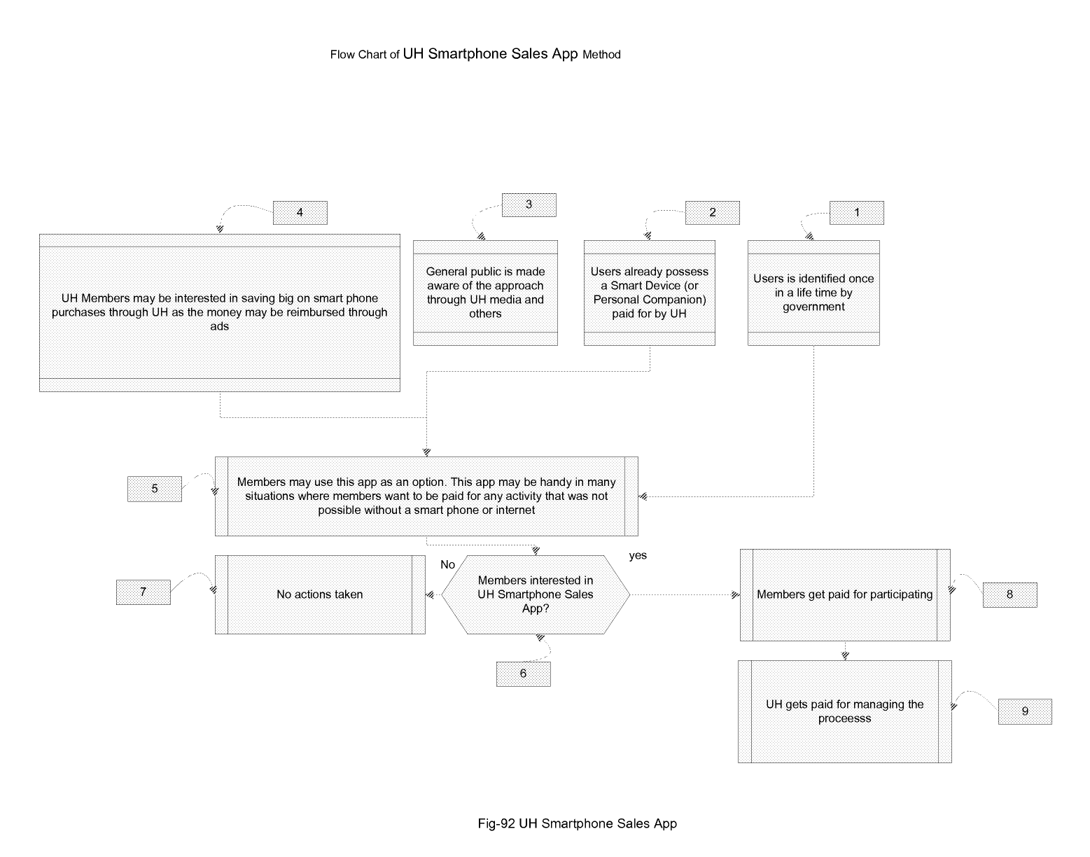

### FIG. 92 Illustrates Flow Chart of Smartphone Sales App Method.

Steps 92.1, 92.2 and 92.3 are analogous to the correspondingly numbered steps described in reference to FIG. 6 above.

In Step 92.4 members may be interested in saving big on smart phone purchases through UH as the money may be reimbursed through ads.

In Step 92.5 members may use this app as an option. This app may be handy in many situations where members want to be paid for any activity that was not possible without a smart phone or internet.

In Step 92.6 members may decide if they are interested in this App.

In Step 92.7 members are not paid if they opt out.

In Step 92.8 members get paid each time UH App is used.

In Step 92.9 UH may manage the process and get paid.

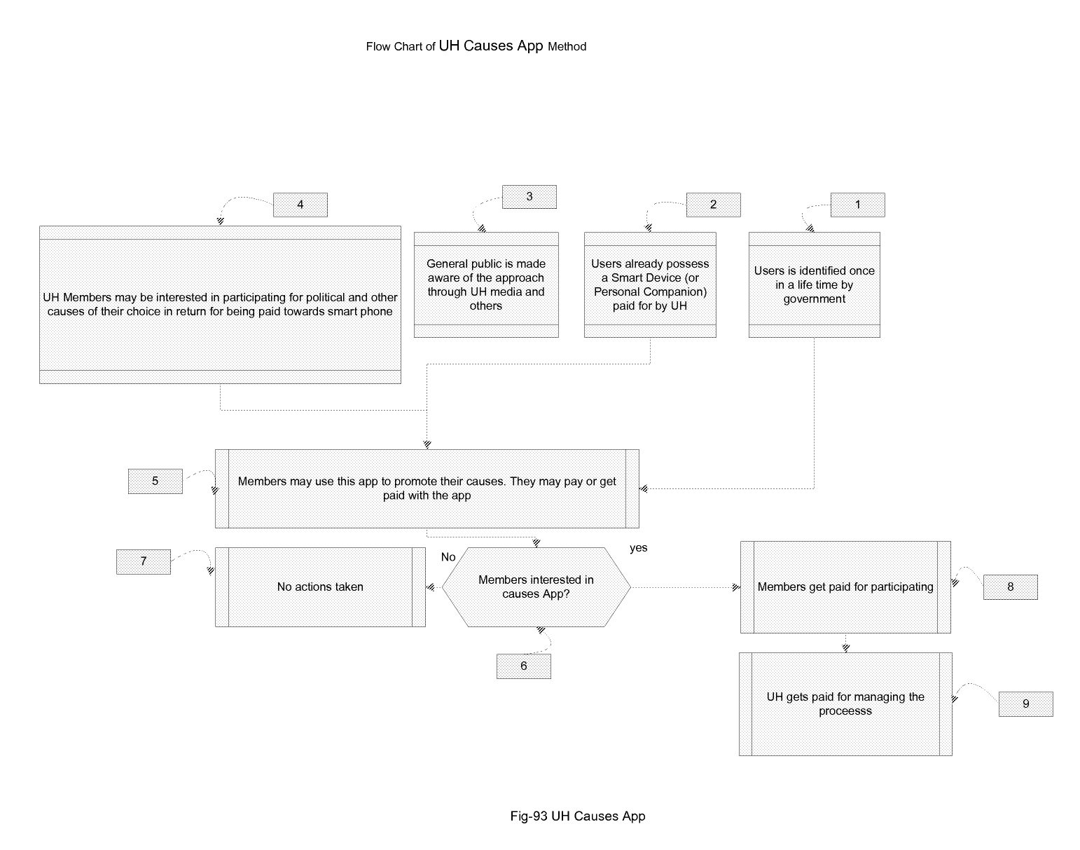

### FIG. 93 Illustrates Flow Chart of Causes App Method.

Steps 93.1, 93.2 and 93.3 are analogous to the correspondingly numbered steps described in reference to FIG. 6 above.

In Step 93.4 members may be interested in participating for political and other causes of their choice in return for being paid towards smart phone.

In Step 93.5 members may use this app to promote their causes. They may pay or get paid with the app.

In Step 93.6 members may decide if they are interested in this App.

In Step 93.7 members are not paid if they opt out.

In Step 93.8 members get paid each time UH App is used.

In Step 93.9 UH may manage the process and get paid.

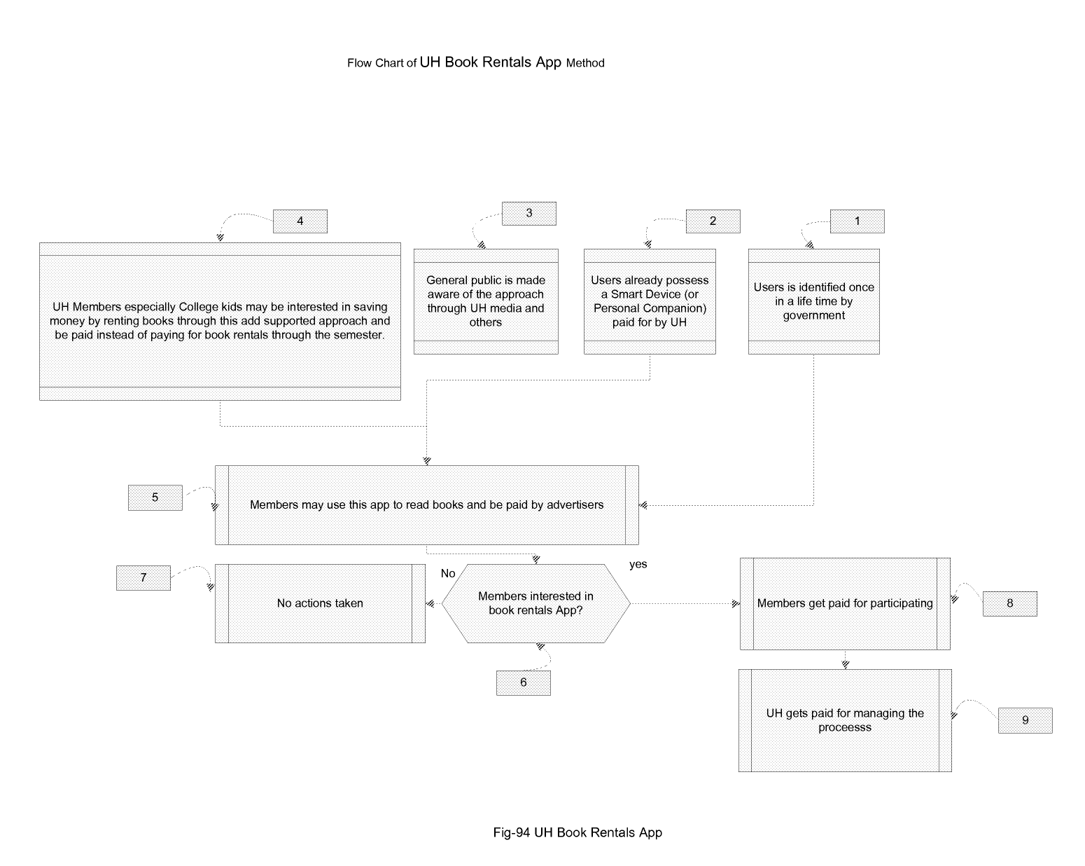

### FIG. 94 Illustrates Flow Chart of Book Rentals App Method.

Steps 94.1, 94.2 and 94.3 are analogous to the correspondingly numbered steps described in reference to FIG. 6 above.

In Step 94.4 members especially College kids may be interested in saving money by renting books through this add supported approach and be paid instead of paying for book rentals through the semester.

In Step 94.5 members may use this app to read books and be paid by advertisers.

In Step 94.6 members may decide if they are interested in this App.

In Step 94.7 members are not paid if they opt out.

In Step 94.8 members get paid each time UH App is used.

In Step 94.9 UH may manage the process and get paid.

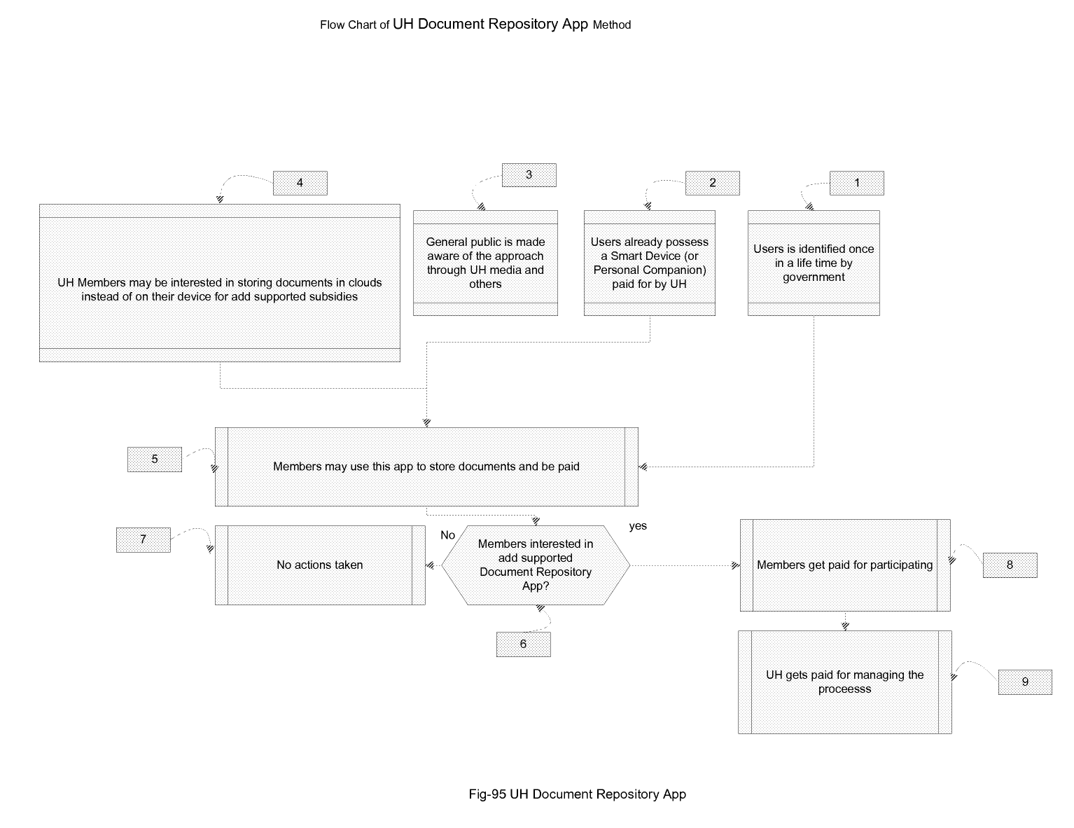

### FIG. 95 Illustrates Flow Chart of Document Repository App Method.

Steps 95.1, 95.2 and 95.3 are analogous to the correspondingly numbered steps described in reference to FIG. 6 above.

In Step 95.4 members may be interested in storing documents in clouds instead of on their device for add supported subsidies.

In Step 95.5 members may use this app to store documents and be paid.

In Step 95.6 members may decide if they are interested in this App.

In Step 95.7 members are not paid if they opt out.

In Step 95.8 members get paid each time UH App is used.

In Step 95.9 UH may manage the process and get paid.

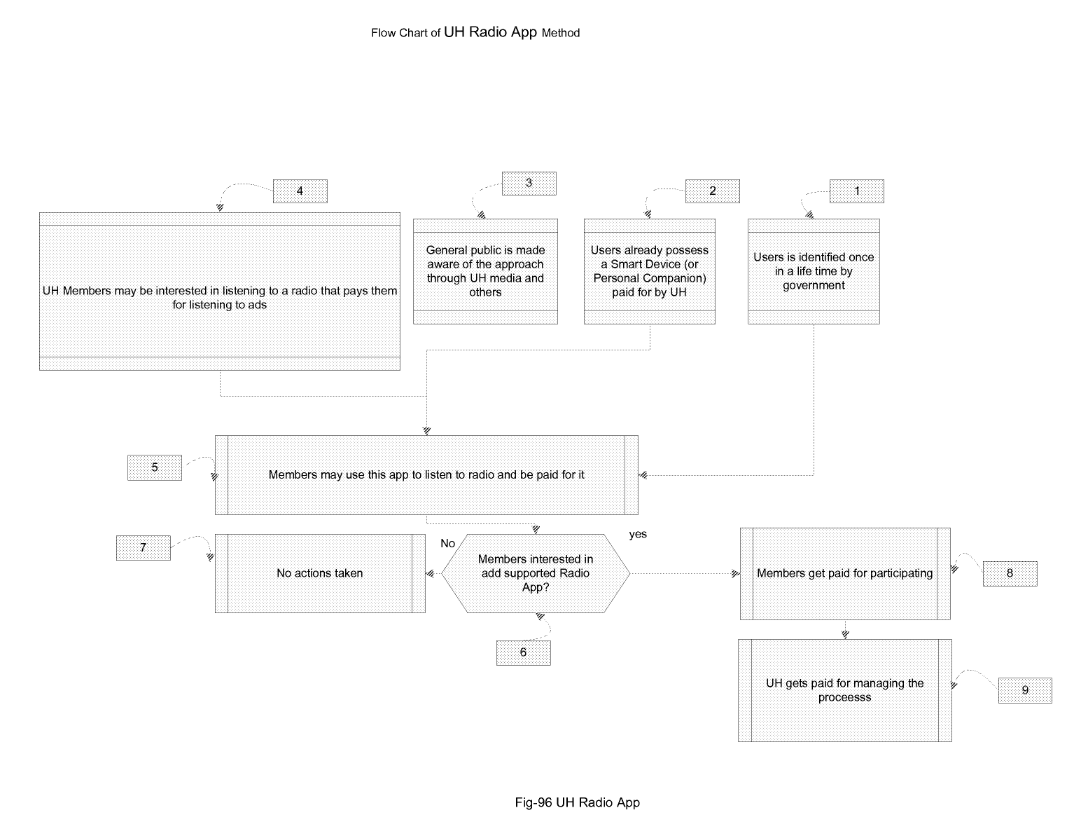

### FIG. 96 Illustrates Flow Chart of Radio App Method.

Steps 96.1, 96.2 and 96.3 are analogous to the correspondingly numbered steps described in reference to FIG. 6 above.

In Step 96.4 members may be interested in listening to a radio that pays them for listening to ads.

In Step 96.5 members may use this app to listen to radio and be paid for it.

In Step 96.6 members may decide if they are interested in this App.

In Step 96.7 members are not paid if they opt out.

In Step 96.8 members get paid each time UH App is used.

In Step 96.9 UH may manage the process and get paid.

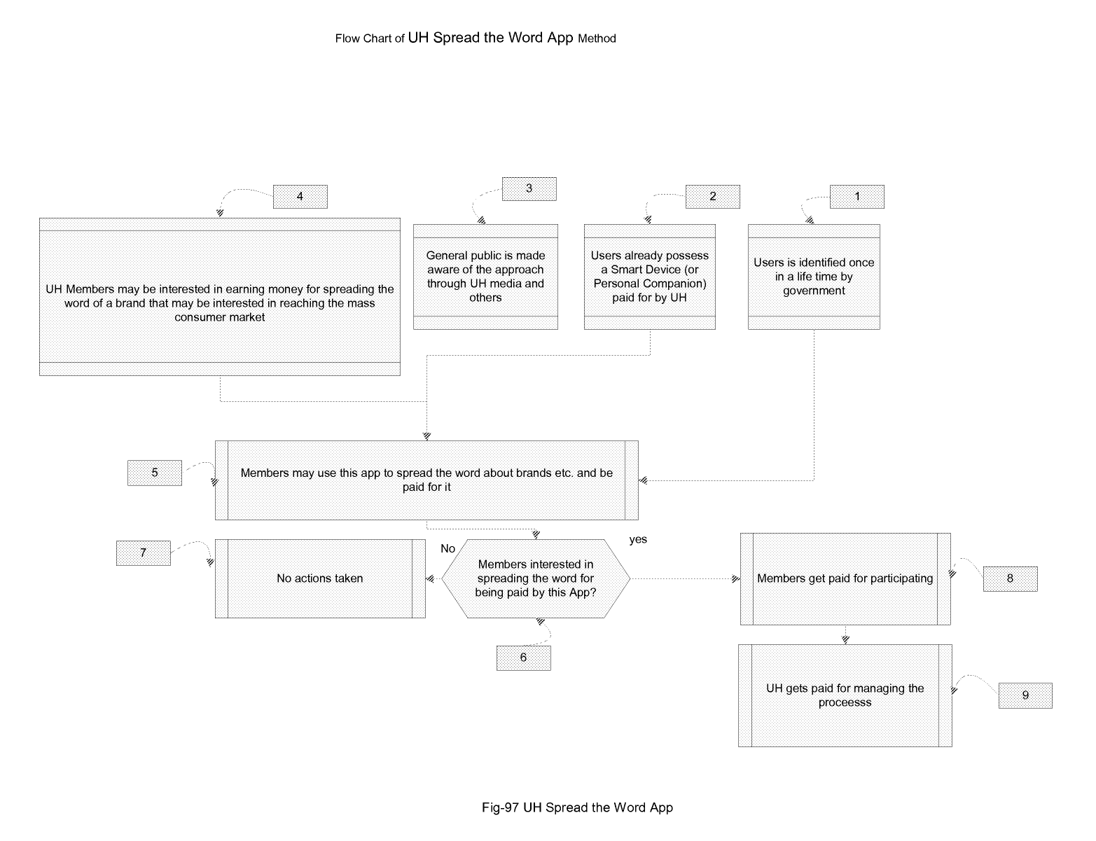

### FIG. 97 Illustrates Flow Chart of Spread The Word App Method.

Steps 97.1, 97.2 and 97.3 are analogous to the correspondingly numbered steps described in reference to FIG. 6 above.

In Step 97.4 members may be interested in earning money for spreading the word of a brand that may be interested in reaching the mass consumer market.

In Step 97.5 members may use this app to spread the word about brands etc. and be paid for it.

In Step 97.6 members may decide if they are interested in this App.

In Step 97.7 members are not paid if they opt out.

In Step 97.8 members get paid each time UH App is used.

In Step 97.9 UH may manage the process and get paid.

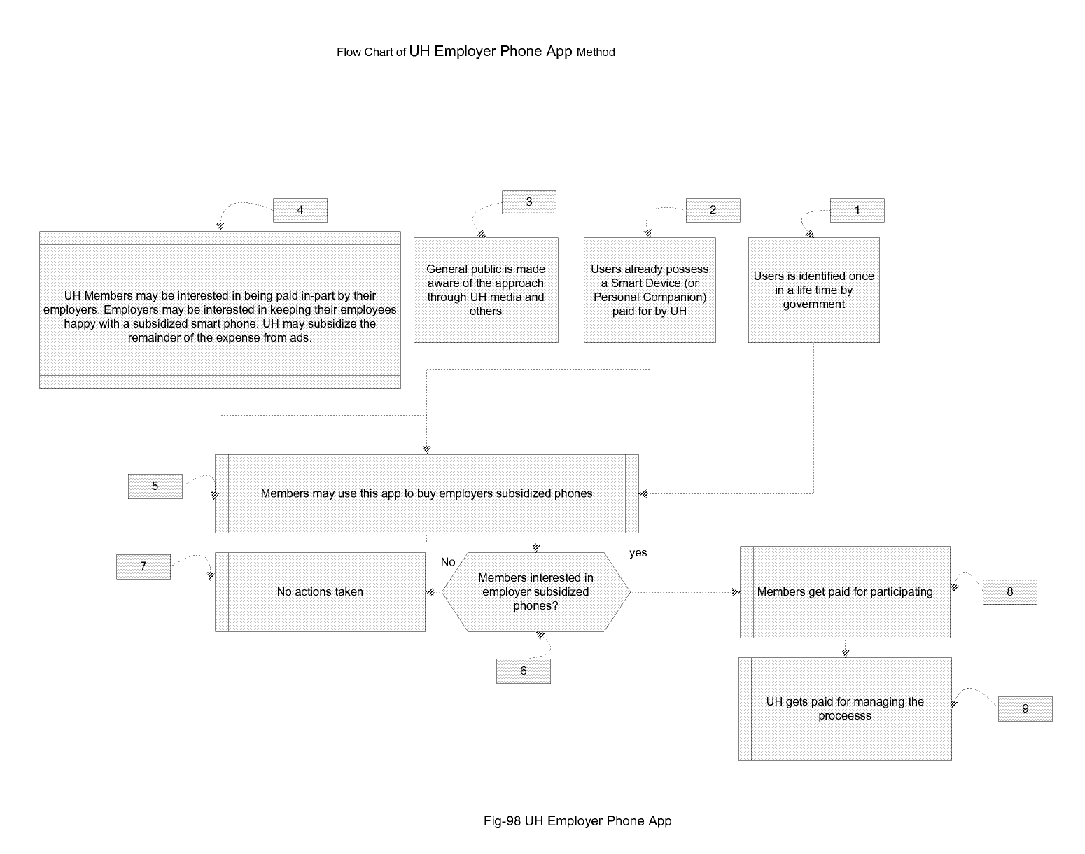

### FIG. 98 Illustrates Flow Chart of Employer Phone App Method.

Steps 98.1, 98.2 and 98.3 are analogous to the correspondingly numbered steps described in reference to FIG. 6 above.

In Step 98.4 members may be interested in being paid in-part by their employers. Employers may be interested in keeping their employees happy with a subsidized smart phone. UH may subsidize the remainder of the expense from ads.

In Step 98.5 members may use this app to buy employers subsidized phones.

In Step 98.6 members may decide if they are interested in this App.

In Step 98.7 members are not paid if they opt out.

In Step 98.8 members get paid each time UH App is used.

In Step 98.9 UH may manage the process and get paid.

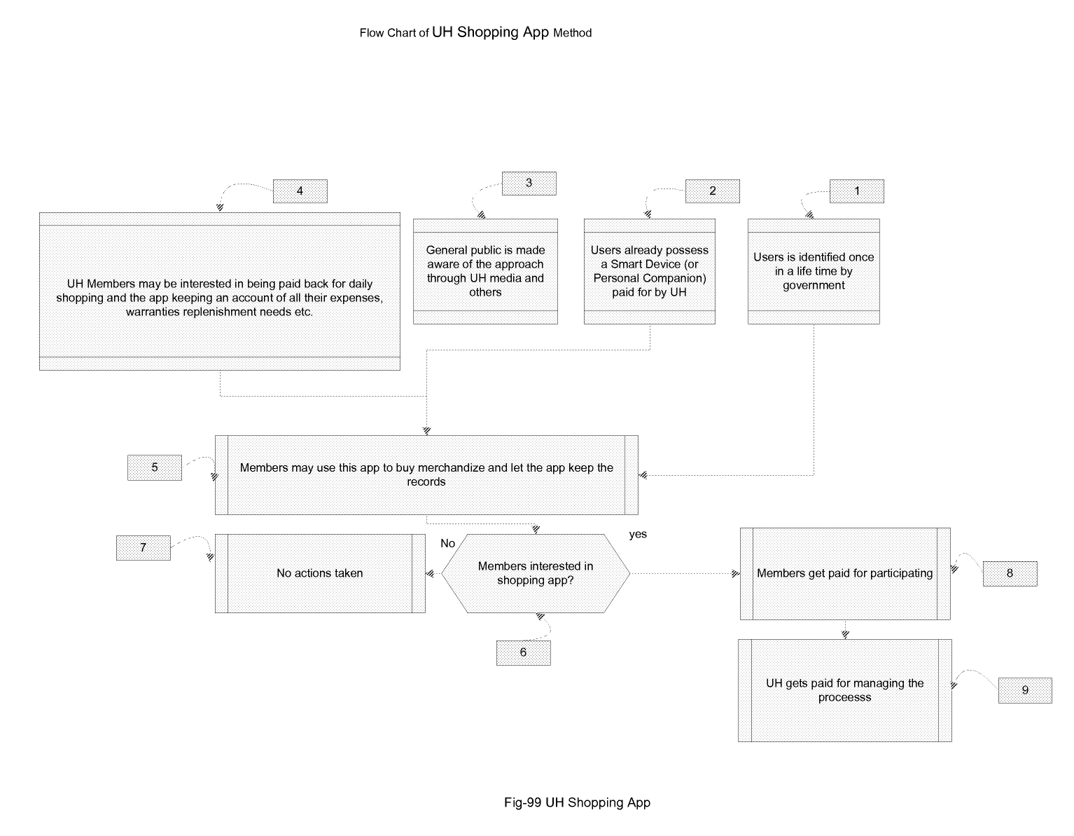

### FIG. 99 Illustrates Flow Chart of Shopping App Method.

Steps 99.1, 99.2 and 99.3 are analogous to the correspondingly numbered steps described in reference to FIG. 6 above.

In Step 99.4 members may be interested in being paid back for daily shopping and the app keeping an account of all their expenses, warranties replenishment needs etc.

In Step 99.5 members may use this app to buy merchandize and let the app keep the records.

In Step 99.6 members may decide if they are interested in this App.

In Step 99.7 members are not paid if they opt out.

In Step 99.8 members get paid each time UH App is used.

In Step 99.9 UH may manage the process and get paid.

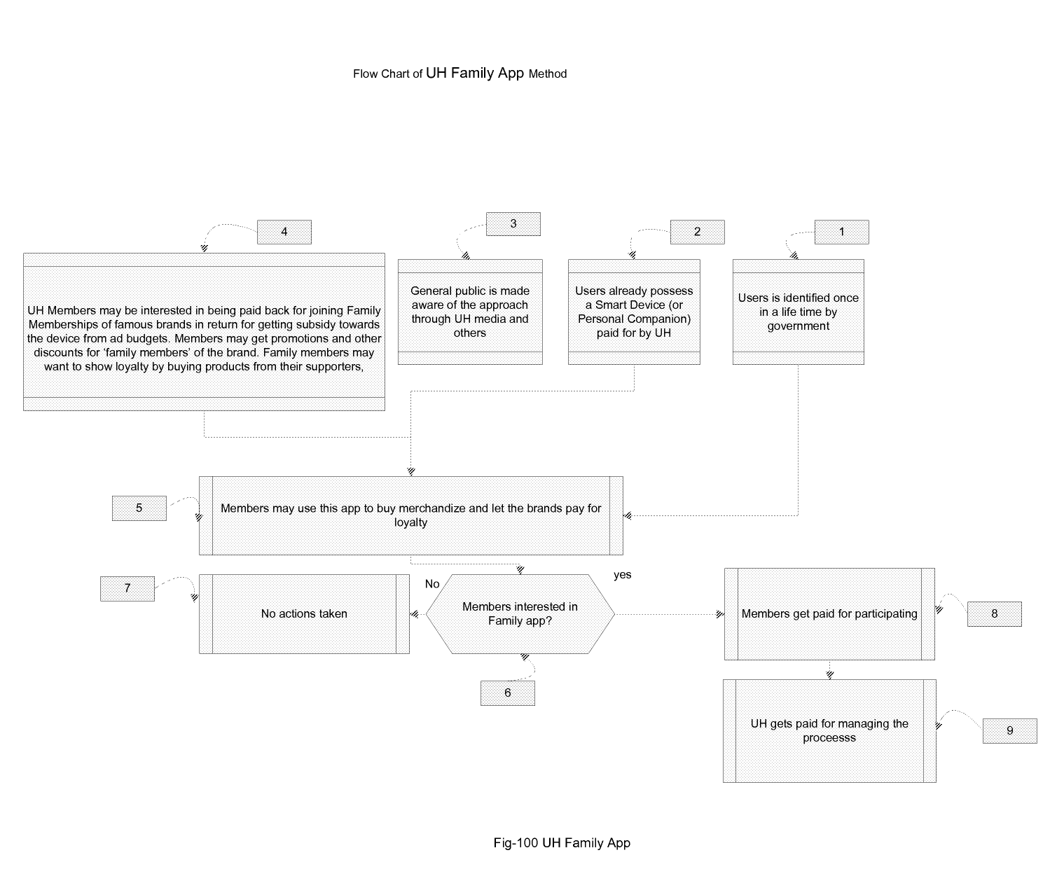

### FIG. 100 Illustrates Flow Chart of Family App Method.

Steps 100.1, 100.2 and 100.3 are analogous to the correspondingly numbered steps described in reference to FIG. 6 above.

In Step 100.4 members may be interested in being paid back for joining Family Memberships of famous brands in return for getting subsidy towards the device from ad budgets. Members may get promotions and other discounts for ‘family members’ of the brand. Family members may want to show loyalty by buying products from their supporters.

In Step 100.5 members may use this app to buy merchandize and let the brands pay for loyalty.

In Step 100.6 members may decide if they are interested in this App.

In Step 100.7 members are not paid if they opt out.

In Step 100.8 members get paid each time UH App is used.

In Step 100.9 UH may manage the process and get paid.

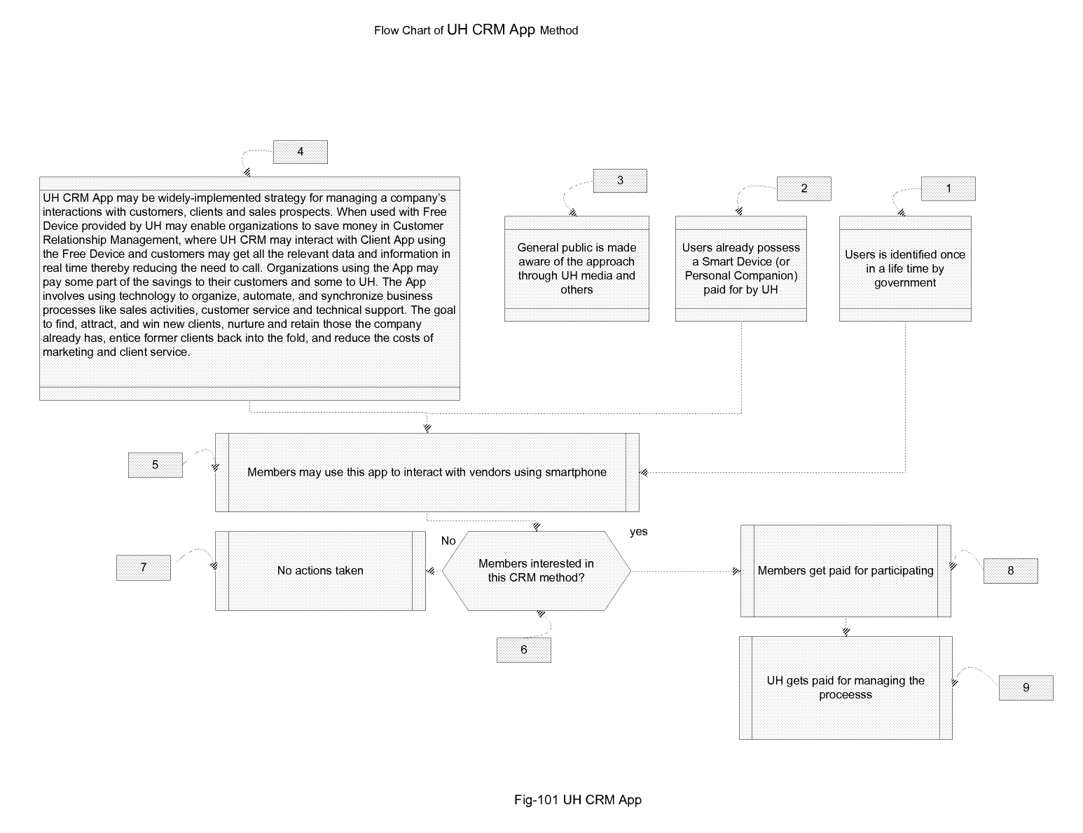

### FIG. 101 Illustrates Flow Chart of CRM App Method.

Steps 101.1, 101.2 and 101.3 are analogous to the correspondingly numbered steps described in reference to FIG. 6 above.

In Step 101.4 UH CRM App may be widely-implemented strategy for managing a company's interactions with customers, clients and sales prospects. When used with Free Device provided by UH may enable organizations to save money in Customer Relationship Management, where UH CRM may interact with Client App using the Free Device and customers may get all the relevant data and information in real time thereby reducing the need to call. Organizations using the App may pay some part of the savings to their customers and some to UH. The App involves using technology to organize, automate, and synchronize business processes like sales activities, customer service and technical support. The goal to find, attract, and win new clients, nurture and retain those the company already has, entice former clients back into the fold, and reduce the costs of marketing and client service.

In Step 101.5 members may use this app to interact with vendors using smartphone.

In Step 101.6 members may decide if they are interested in this App.

In Step 101.7 members are not paid if they opt out.

In Step 101.8 members get paid each time UH App is used.

In Step 101.9 UH may manage the process and get paid.

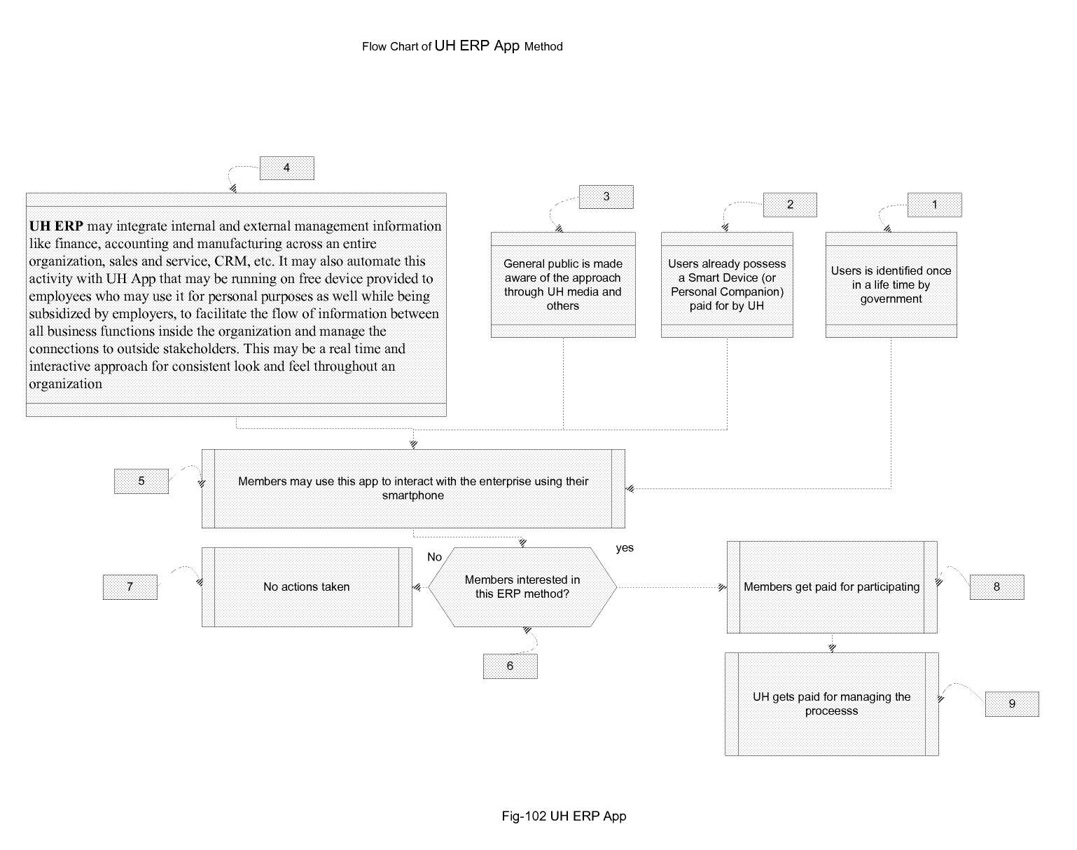

### FIG. 102 Illustrates Flow Chart of ERP App Method.

Steps 102.1, 102.2 and 102.3 are analogous to the correspondingly numbered steps described in reference to FIG. 6 above.

In Step 102.4 UH ERP may integrate internal and external management information like finance, accounting and manufacturing across an entire organization, sales and service, CRM, etc. It may also automate this activity with UH App that may be running on free device provided to employees who may use it for personal purposes as well while being subsidized by employers, to facilitate the flow of information between all business functions inside the organization and manage the connections to outside stakeholders. This may be a real time and interactive approach for consistent look and feel throughout an organization.

In Step 102.5 members may use this app to interact with the enterprises, using their smartphone.

In Step 102.6 members may decide if they are interested in this App.

In Step 102.7 members are not paid if they opt out.

In Step 102.8 members get paid each time UH App is used.

In Step 102.9 UH may manage the process and get paid.

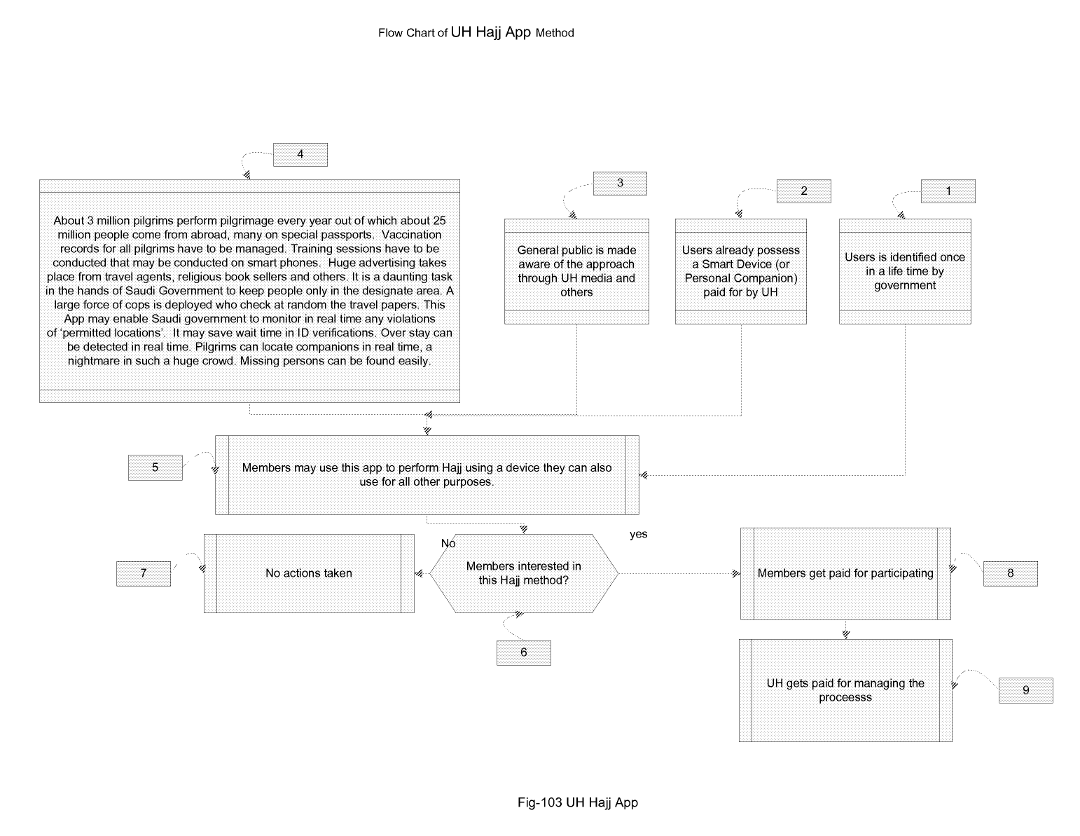

### FIG. 103 Illustrates Flow Chart of Hajj App Method.

Steps 103.1, 103.2 and 103.3 are analogous to the correspondingly numbered steps described in reference to FIG. 6 above.

In Step 103.4. About 3 million pilgrims perform pilgrimage every year out of which about 25 million people come from abroad, many on special passports. Vaccination records for all pilgrims have to be managed. Training sessions have to be conducted that may be conducted on smart phones. Huge advertising takes place from travel agents, religious book sellers and others. It is a daunting task in the hands of Saudi Government to keep people only in the designate area. A large force of cops is deployed who check at random the travel papers. This App may enable Saudi government to monitor in real time any violations of ‘permitted locations’. It may save wait time in ID verifications. Over stay can be detected in real time. Pilgrims can locate companions in real time, a nightmare in such a huge crowd. Missing persons can be found easily.

In Step 103.5 members may use this app to perform Hajj using a device they can also use for all other purposes.

In Step 103.6 members may decide if they are interested in this App.

In Step 103.7 members are not paid if they opt out.

In Step 103.8 members get paid each time UH App is used.

In Step 103.9 UH may manage the process and get paid.

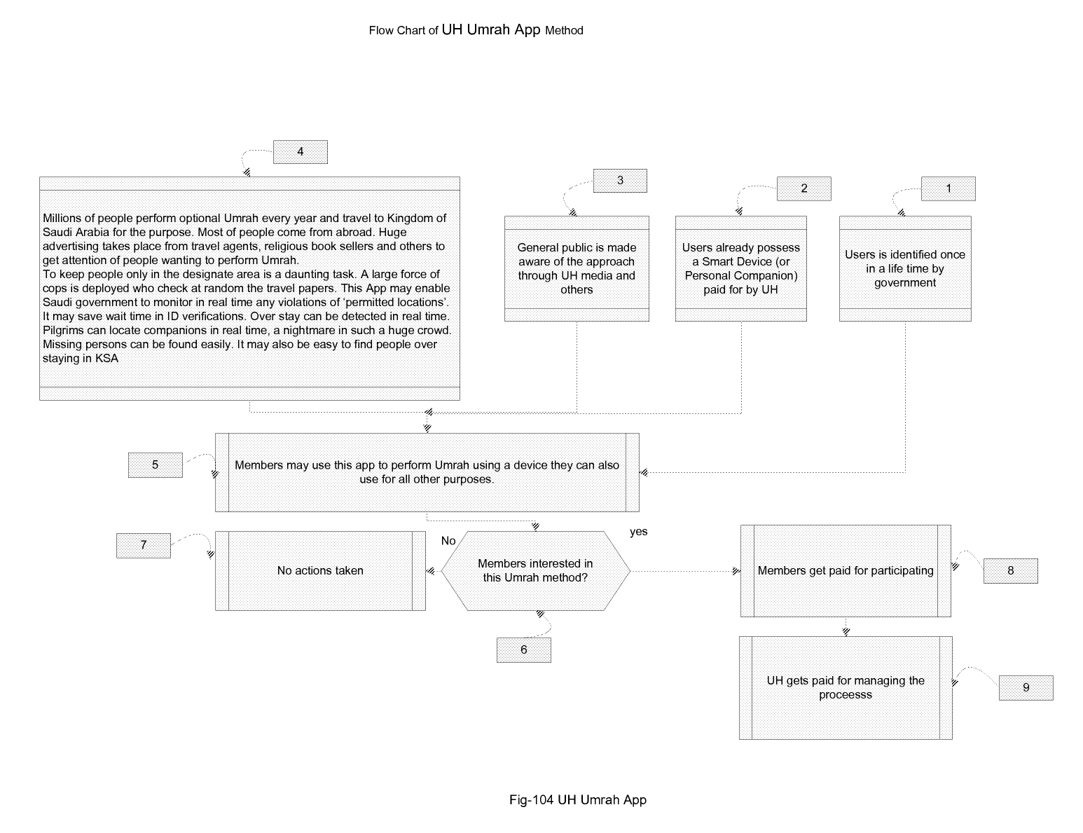

### FIG. 104 Illustrates Flow Chart of Umrah App Method.

Steps 104.1, 104.2 and 104.3 are analogous to the correspondingly numbered steps described in reference to FIG. 6 above.

In Step 104 4 Millions of people perform optional Umrah every year and travel to Kingdom of Saudi Arabia for this purpose. Most of people come from abroad. Huge advertising takes place from travel agents, religious book sellers and others to get attention of people wanting to perform Umrah.

To keep people only in the designate area is a daunting task. A large force of cops is deployed who check at random the travel papers. This App may enable Saudi government to monitor in real time any violations of ‘permitted locations’. It may save wait time in ID verifications. Over stay can be detected in real time. Pilgrims can locate companions in real time, a nightmare in such a huge crowd. Missing persons can be found easily. It may also be easy to find people over staying in KSA.

In Step 104.5 members may use this app to perform Umrah using a device they can also use for all other purposes.

In Step 104.6 members may decide if they are interested in this App.

In Step 104.7 members are not paid if they opt out.

In Step 104.8 members get paid each time UH App is used.

In Step 104.9 UH may manage the process and get paid.

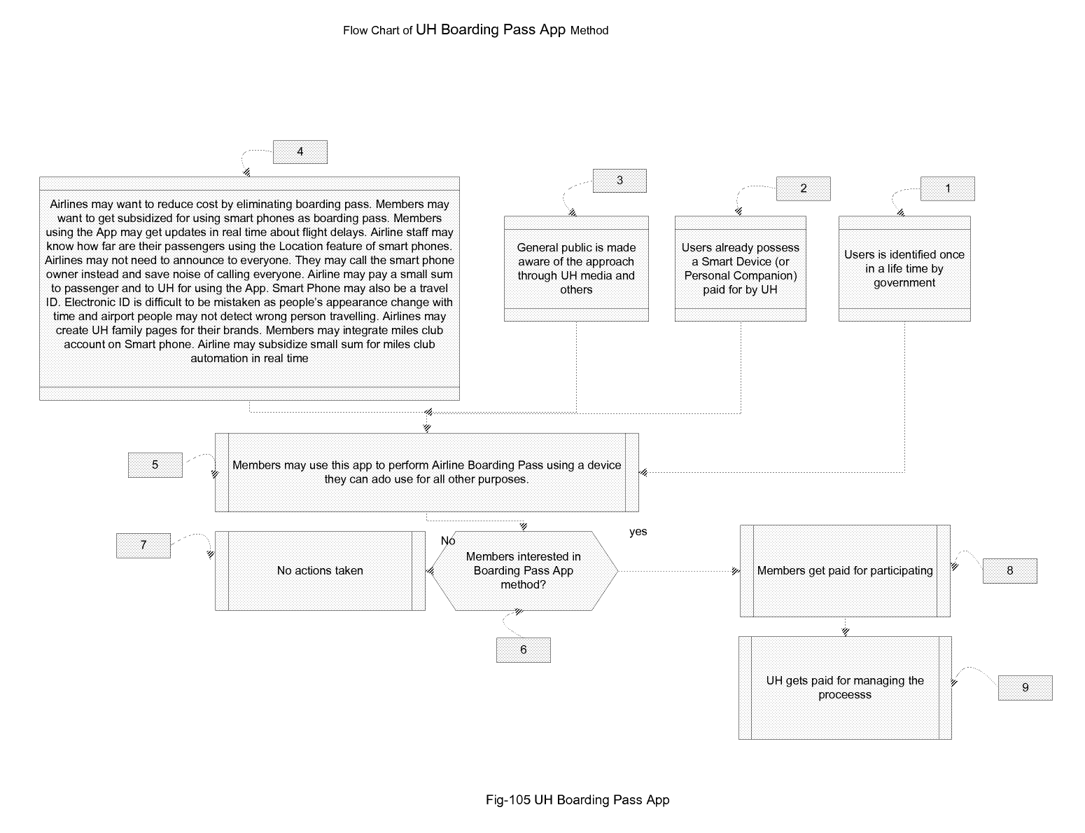

### FIG. 105 Illustrates Flow Chart of Boarding Pass App Method.

Steps 105.1, 105.2 and 105.3 are analogous to the correspondingly numbered steps described in reference to FIG. 6 above.

In Step 105.4. Airlines may want to reduce cost by eliminating boarding pass. Members may want to get subsidized for using smart phones as boarding pass. Members using the App may get updates in real time about flight delays. Airline staff may know how far are their passengers using the Location feature of smart phones. Airlines may not need to announce to everyone. They may call the smart phone owner instead and save noise of calling everyone. Airline may pay a small sum to passenger and to UH for using the App. Smart Phone may also be a travel ID. Electronic ID is difficult to be mistaken as people's appearance change with time and airport people may not detect wrong person travelling. Airlines may create UH family pages for their brands. Members may integrate miles club account on Smart phone. Airline may subsidize small sum for miles club automation in real time.

In Step 105.5 members may use this app to perform Airline Boarding Pass using a device they can also use for all other purposes.

In Step 105.6 members may decide if they are interested in this App.

In Step 105.7 members are not paid if they opt out.

In Step 105.8 members get paid each time UH App is used.

In Step 105.9 UH may manage the process and get paid.

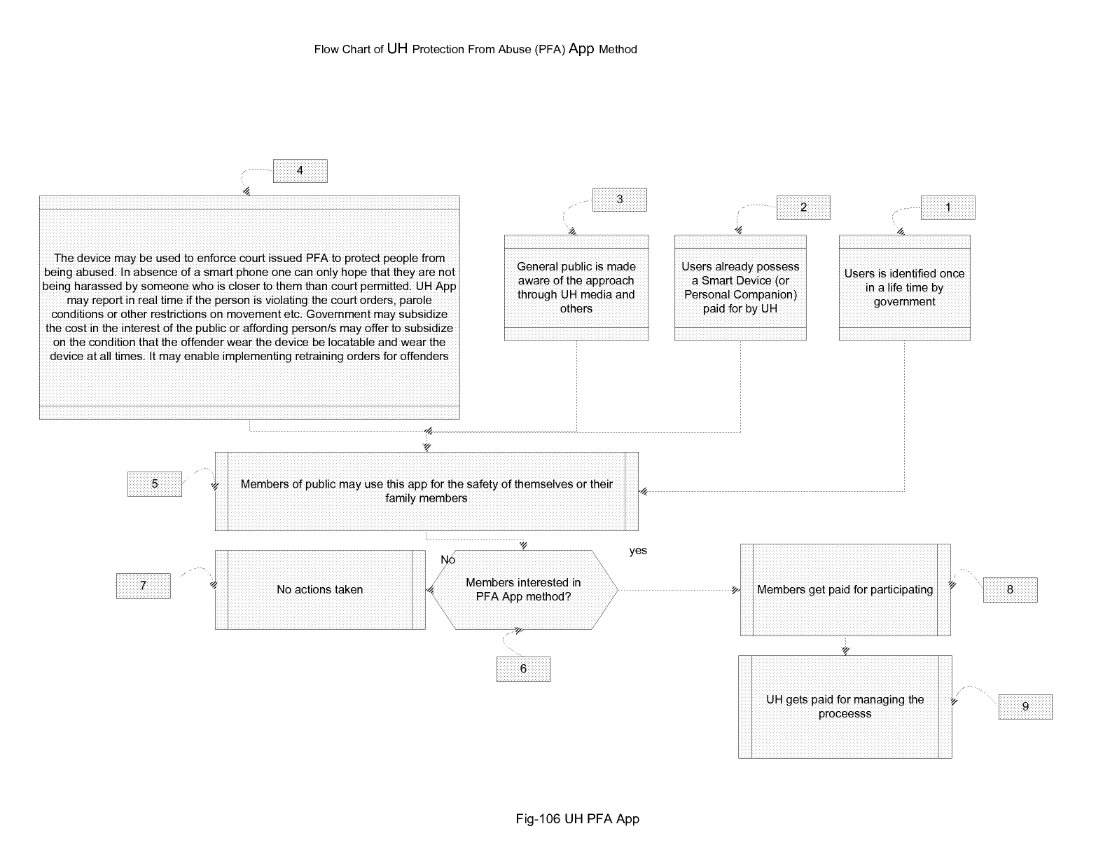

### FIG. 106 Illustrates Flow Chart of Protection From Abuse (PFA) App Method.

Steps 106.1, 106.2 and 106.3 are analogous to the correspondingly numbered steps described in reference to FIG. 6 above.

In Step 106.4. the device may be used to enforce court issued PFA to protect people from being abused. In absence of a smart phone one can only hope that they are not being harassed by someone who is closer to them than court permitted. UH App may report in real time if the person is violating the court orders, parole conditions or other restrictions on movement etc. Government may subsidize the cost in the interest of the public or affording person/s may offer to subsidize on the condition that the offender wear the device be locatable and wear the device at all times. It may enable implementing retraining orders for offenders.

In Step 106.5 members of public may use this app for the safety of themselves or their family members.

In Step 106.6 members may decide if they are interested in this App.

In Step 106.7 members are not paid if they opt out.

In Step 106.8 members get paid each time UH App is used.

In Step 106.9 UH may manage the process and get paid.

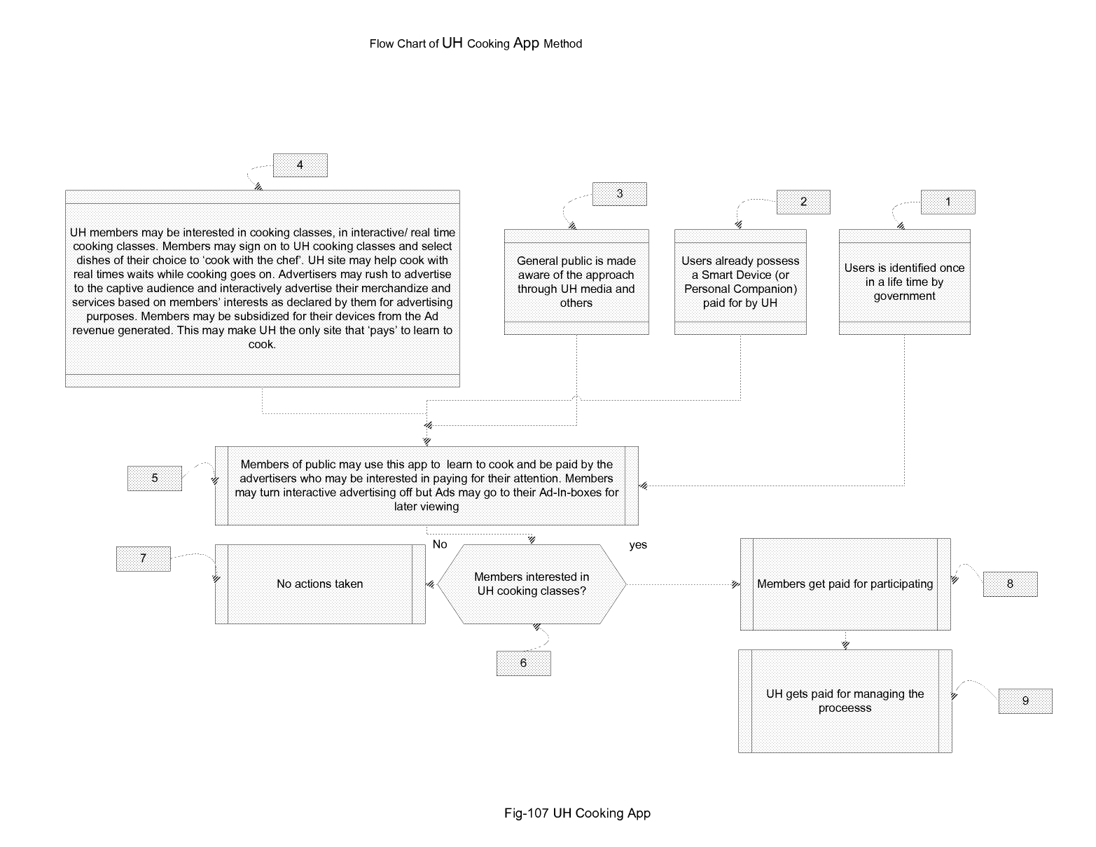

### FIG. 107 Illustrates Flow Chart of Cooking App Method.

Steps 107.1, 107.2 and 107.3 are analogous to the correspondingly numbered steps described in reference to FIG. 6 above.

In Step 107.4. UH members may be interested in cooking classes, in interactive/real time cooking classes. Members may sign on to UH cooking classes and select dishes of their choice to ‘cook with the chef’. UH site may help cook with real times waits while cooking goes on. Advertisers may rush to advertise to the captive audience and interactively advertise their merchandize and services based on members' interests as declared by them for advertising purposes. Members may be subsidized for their devices from the Ad revenue generated. This may make UH the only site that ‘pays’ to learn to cook.

In Step 107.5 members of public may use this app to learn to cook and be paid by the advertisers who may be interested in paying for their attention. Members may turn interactive advertising off but Ads may go to their Ad-In-boxes for later viewing.

In Step 107.6 members may decide if they are interested in this App.

In Step 107.7 members are not paid if they opt out.

In Step 107.8 members get paid each time UH App is used.

In Step 107.9 UH may manage the process and get paid.

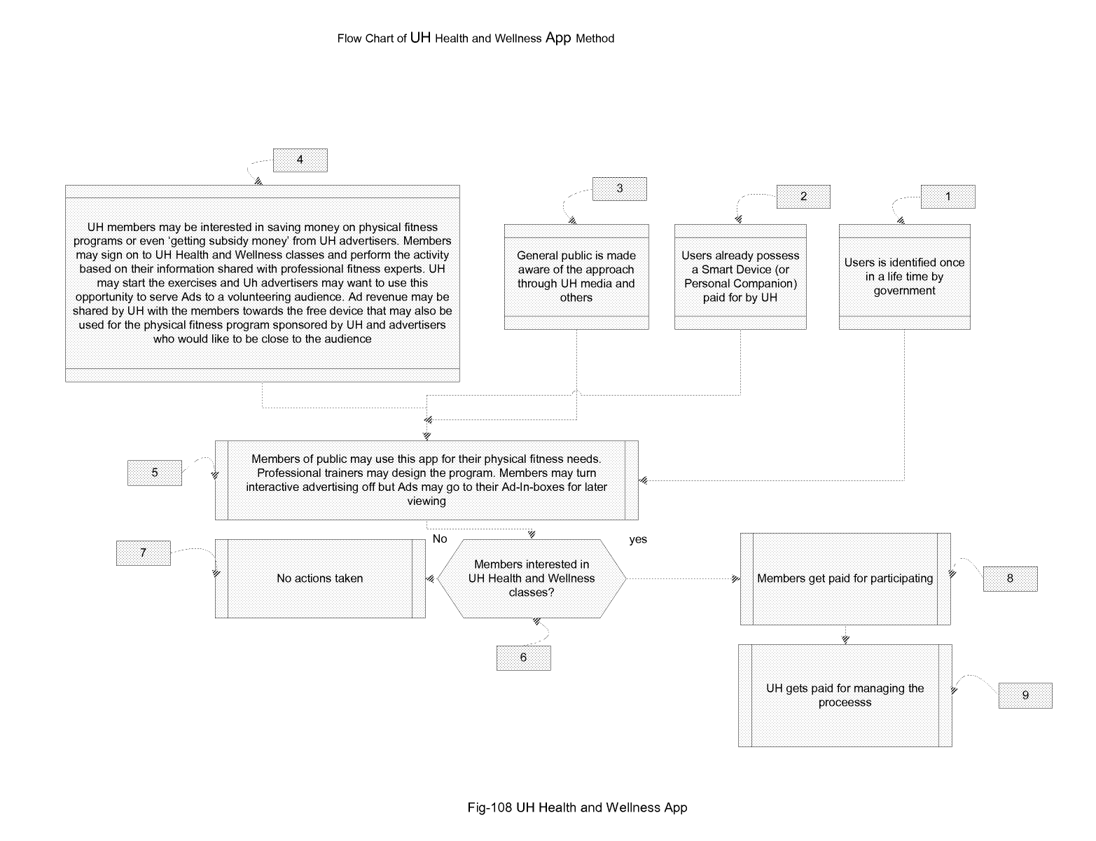

### FIG. 108 Illustrates Flow Chart of Health and Wellness App Method.

Steps 108.1, 108.2 and 108.3 are analogous to the correspondingly numbered steps described in reference to FIG. 6 above.

In Step 108.4. members may be interested in saving money on physical fitness programs or even ‘getting subsidy money’ from UH advertisers. Members may sign on to UH Health and Wellness classes and perform the activity based on their information shared with professional fitness experts. UH may start the exercises and Uh advertisers may want to use this opportunity to serve Ads to a volunteering audience. Ad revenue may be shared by UH with the members towards the free device that may also be used for the physical fitness program sponsored by UH and advertisers who would like to be close to the audience.

In Step 108.5 members of public may use this app for their physical fitness needs. Professional trainers may design the program. Members may turn interactive advertising off but Ads may go to their Ad-In-boxes for later viewing.

In Step 108.6 members may decide if they are interested in this App.

In Step 108.7 members are not paid if they opt out.

In Step 108.8 members get paid each time UH App is used.

In Step 108.9 UH may manage the process and get paid.

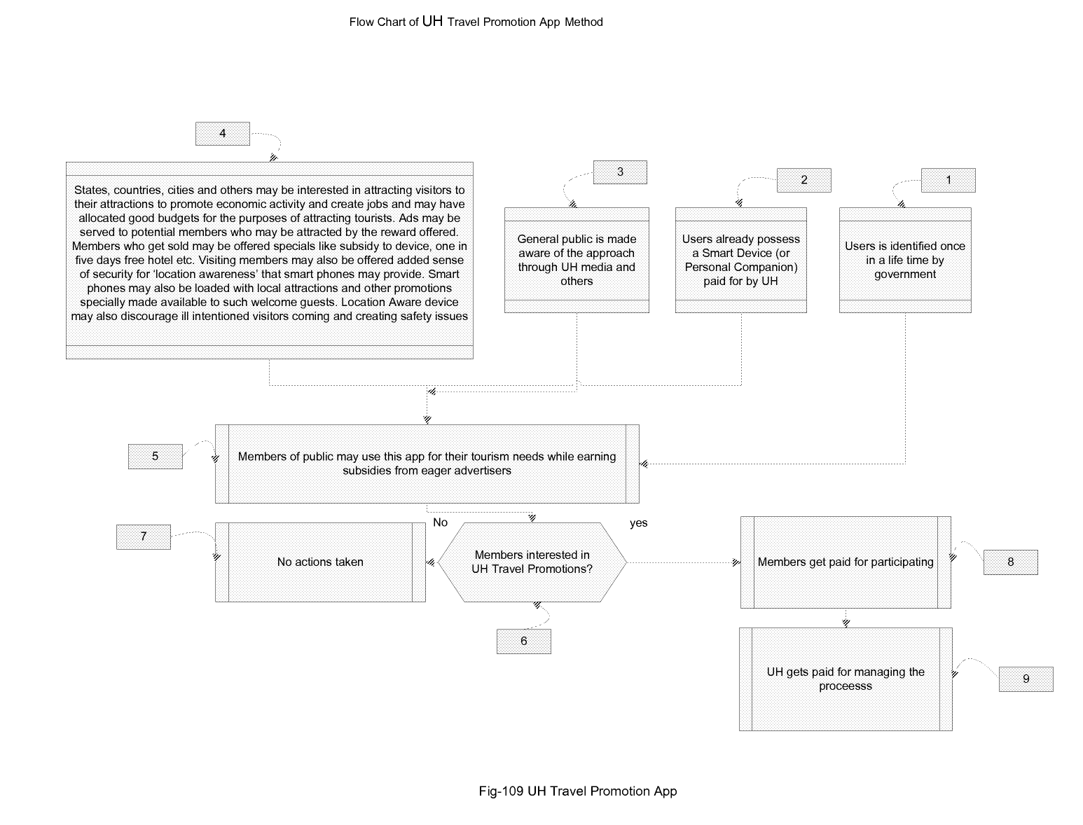

### FIG. 109 Illustrates Flow Chart of Travel Promotion App Method.

Steps 109.1, 109.2 and 109.3 are analogous to the correspondingly numbered steps described in reference to FIG. 6 above.

In Step 109.4. states, countries, cities and others may be interested in attracting visitors to their attractions to promote economic activity and create jobs and may have allocated good budgets for the purposes of attracting tourists. Ads may be served to potential members who may be attracted by the reward offered. Members who get sold may be offered specials like subsidy to device, one in five days free hotel etc. Visiting members may also be offered added sense of security for ‘location awareness’ that smart phones may provide. Smart phones may also be loaded with local attractions and other promotions specially made available to such welcome guests. Location Aware device may also discourage ill intentioned visitors coming and creating safety issues.

In Step 109.5 members of public may use this app for their tourism needs while earning subsidies from eager advertisers.

In Step 109.6 members may decide if they are interested in this App.

In Step 109.7 members are not paid if they opt out.

In Step 109.8 members get paid each time UH App is used.

In Step 109.9 UH may manage the process and get paid.

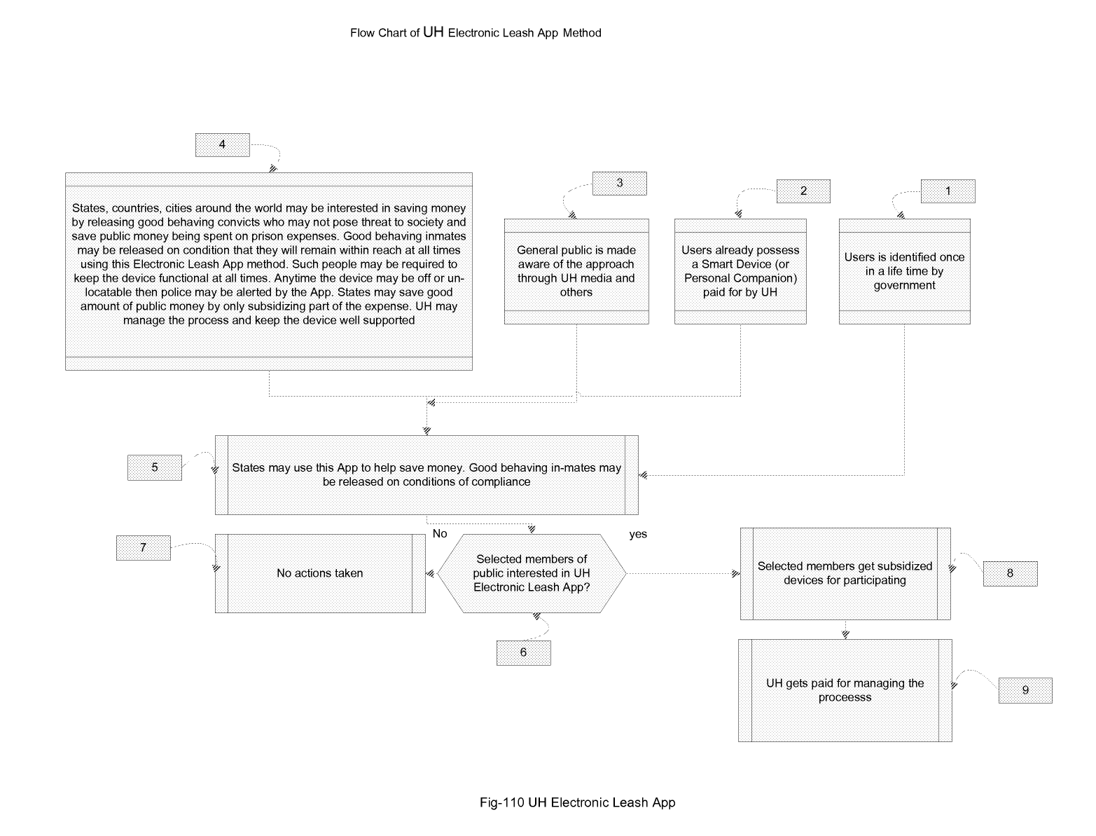

### FIG. 110 Illustrates Flow Chart of Electronic Leash App Method.

Steps 110.1, 110.2 and 110.3 are analogous to the correspondingly numbered steps described in reference to FIG. 6 above.

In Step 110.4, states, countries, cities around the world may be interested in saving money by releasing good behaving convicts who may not pose threat to society and save public money being spent on prison expenses. Good behaving inmates may be released on condition that they will remain within reach at all times using this Electronic Leash App method. Such people may be required to keep the device functional at all times. Anytime the device may be off or un-locatable then police may be alerted by the App. States may save good amount of public money by only subsidizing part of the expense. UH may manage the process and keep the device well supported.

In Step 110.5 States may use this App to help save money. Good behaving in-mates may be released on conditions of compliance.

In Step 110.6 members may decide if they are interested in this App.

In Step 110.7 members are not paid if they opt out.

In Step 110.8 members get paid each time UH App is used.

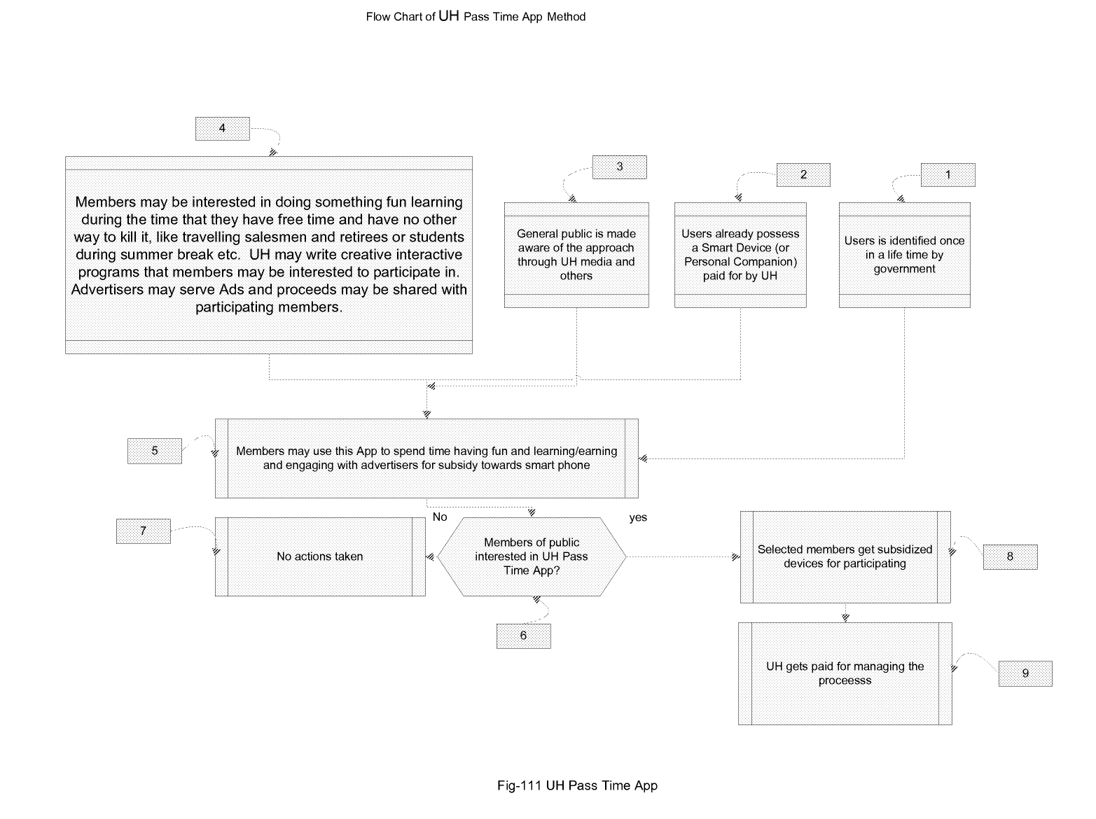

FIG. 111 Illustrates Flow Chart of Pass Time App Method.

Steps 111.1, 111.2 and 111.3 are analogous to the correspondingly numbered steps described in reference to FIG. 6 above.

In Step 111.4, Members may be interested in doing something fun learning during the time that they have free time and have no other way to kill it, like travelling salesmen and retirees or students during summer break etc. UH may write creative interactive programs that members may be interested to participate in. Advertisers may serve Ads and proceeds may be shared with participating members.

In Step 111.5 members may use this App to spend time having fun and learning/earning and engaging with advertisers for subsidy towards smart phone.

In Step 111.6 members may decide if they are interested in this App.

In Step 111.7 members are not paid if they opt out.

In Step 111.8 members get paid each time UH App is used.

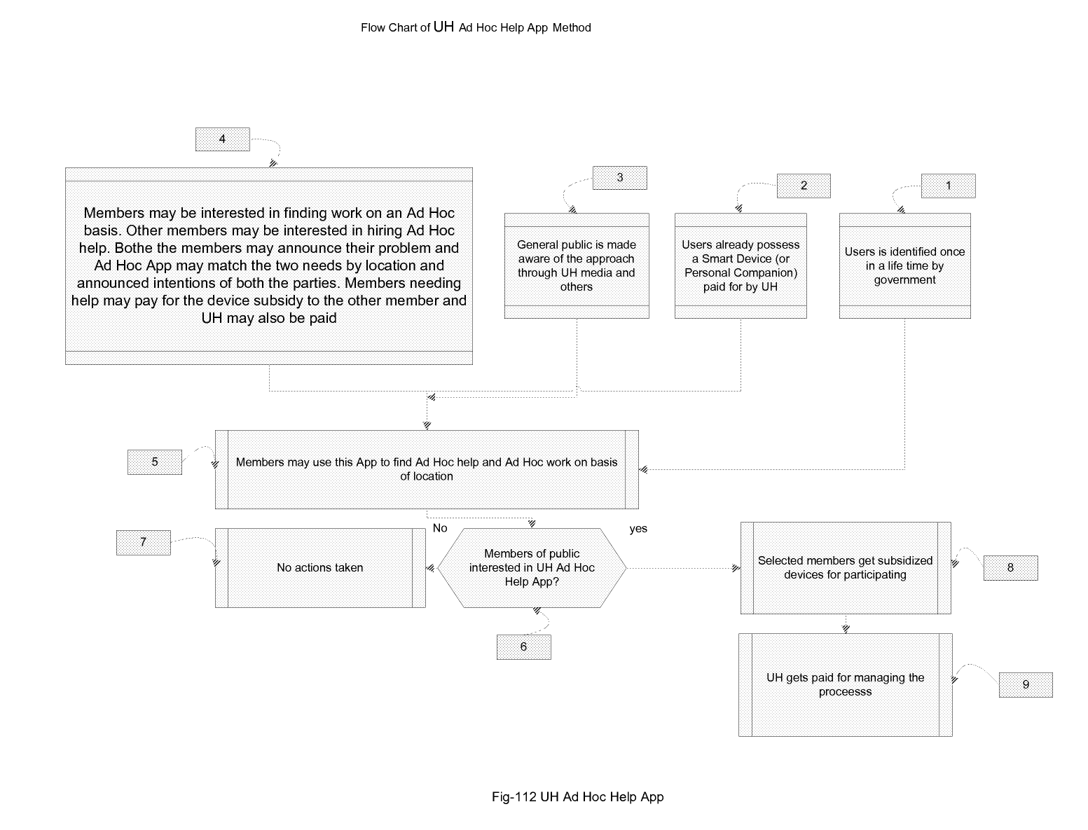

### FIG. 112 Illustrates Flow Chart of Ad Hoc Help App Method.

Steps 112.1, 112.2 and 112.3 are analogous to the correspondingly numbered steps described in reference to FIG. 6 above.

In Step 112.4, members may be interested in finding work on an Ad Hoc basis. Other members may be interested in hiring Ad Hoc help. Bothe the members may announce their problem and Ad Hoc App may match the two needs by location and announced intentions of both the parties. Members needing help may pay for the device subsidy to the other member and UH may also be paid.

In Step 112.5 members may use this App to find Ad Hoc help and Ad Hoc work on basis of location.

In Step 112.6 members may decide if they are interested in this App.

In Step 112.7 members are not paid if they opt out.

In Step 112.8 members get paid each time UH App is used.

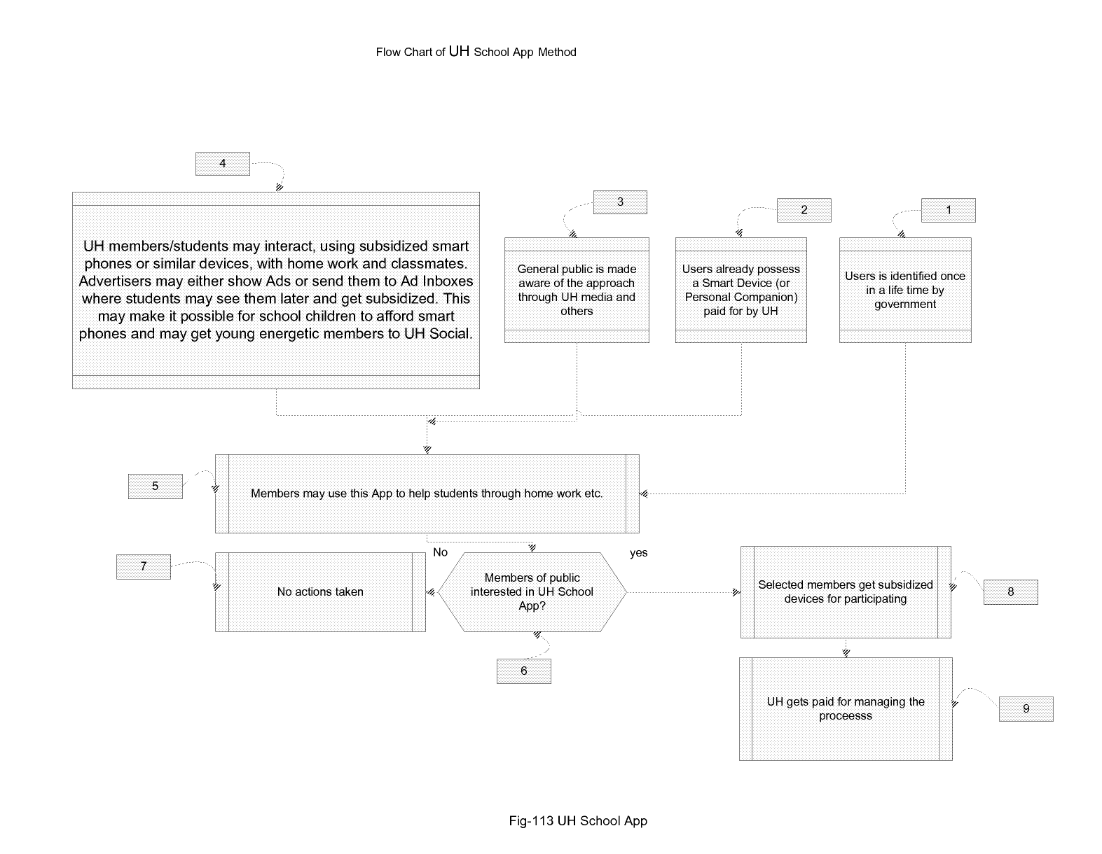

### FIG. 113 Illustrates Flow Chart of School App Method.

Steps 113.1, 113.2 and 113.3 are analogous to the correspondingly numbered steps described in reference to FIG. 6 above.

In Step 113.4, UH members/students may interact, using subsidized smart phones or similar devices, with home work and classmates. Advertisers may either show Ads or send them to Ad Inboxes where students may see them later and get subsidized. This may make it possible for school children to afford smart phones and may get young energetic members to UH Social.

In Step 113.5 members may use this App to help students through home work etc.

In Step 113.6 members may decide if they are interested in this App.

In Step 113.7 members are not paid if they opt out.

In Step 113.8 members get paid each time UH App is used.

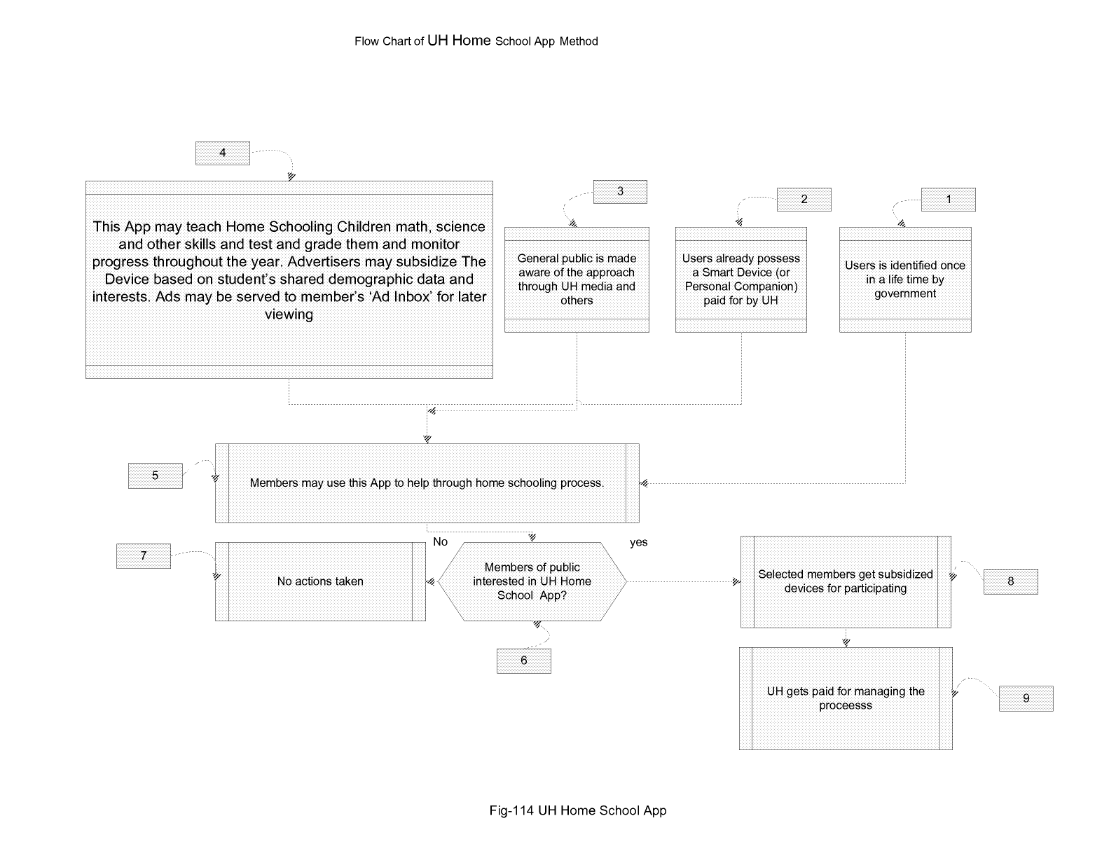

### FIG. 114 Illustrates Flow Chart of Home School App Method.

Steps 114.1, 114.2 and 114.3 are analogous to the correspondingly numbered steps described in reference to FIG. 6 above.

In Step 114.4, this App may teach Home Schooling Children math, science and other skills and test and grade them and monitor progress throughout the year. Advertisers may subsidize The Device based on student's shared demographic data and interests. Ads may be served to member's ‘Ad Inbox’ for later viewing.

In Step 114.5 members may use this App to help through home schooling process.

In Step 114.6 members may decide if they are interested in this App.

In Step 115.7 members are not paid if they opt out.

In Step 115.8 members get paid each time UH App is used.

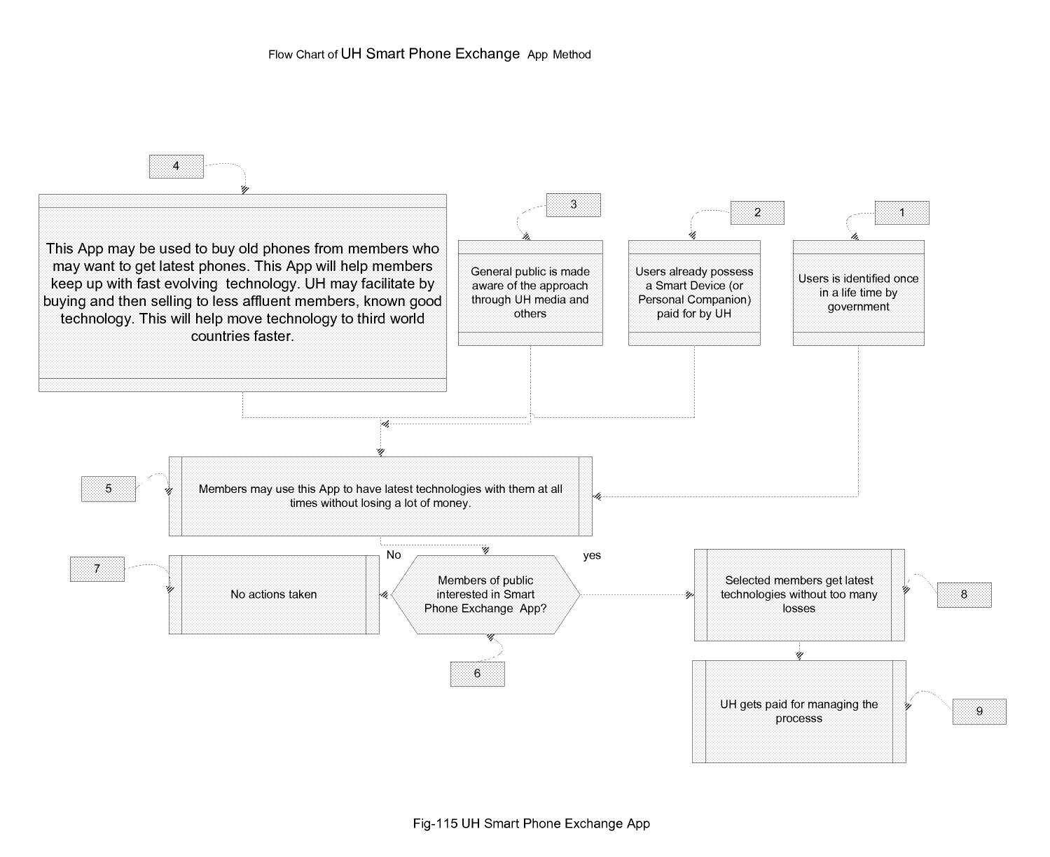

### FIG. 115 Illustrates Flow Chart of Smart Phone Exchange App Method.

Steps 115.1, 115.2 and 115.3 are analogous to the correspondingly numbered steps described in reference to FIG. 6 above.

In Step 115.4, this App may be used to buy old phones from members who may want to get latest phones. This App will help members keep up with fast evolving technology. UH may facilitate by buying and then selling to less affluent members, known good technology. This will help move technology to third world countries faster.

In Step 115.5 members may use this App to have latest technologies with them at all times without losing a lot of money.

In Step 115.6 members may decide if they are interested in this App.

In Step 115.7 members are not paid if they opt out.

In Step 115.8 members get paid each time UH App is used.

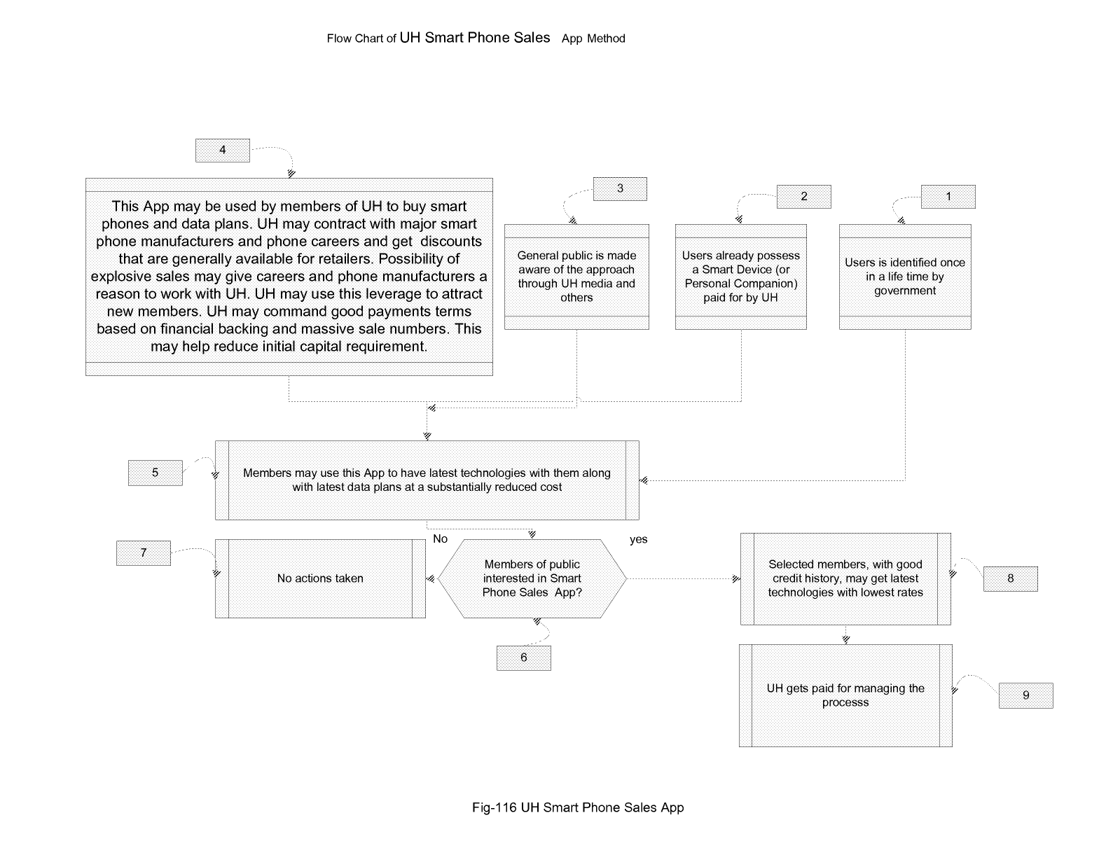

### FIG. 116 Illustrates Flow Chart of Smart Phone Sales App Method.

Steps 116.1, 116.2 and 116.3 are analogous to the correspondingly numbered steps described in reference to FIG. 6 above.

In Step 116.4, this App may be used by members of UH to buy smart phones and data plans. UH may contract with major smart phone manufacturers and phone careers and get discounts that are generally available for retailers. Possibility of explosive sales may give careers and phone manufacturers a reason to work with UH. UH may use this leverage to attract new members. UH may command good payments terms based on financial backing and massive sale numbers. This may help reduce initial capital requirement.

In Step 116.5 members may use this App to have latest technologies with them along with latest data plans at a substantially reduced cost.

In Step 116.6 members may decide if they are interested in this App.

In Step 116.7 members are not paid if they opt out.

In Step 116.8 members get paid each time UH App is used.

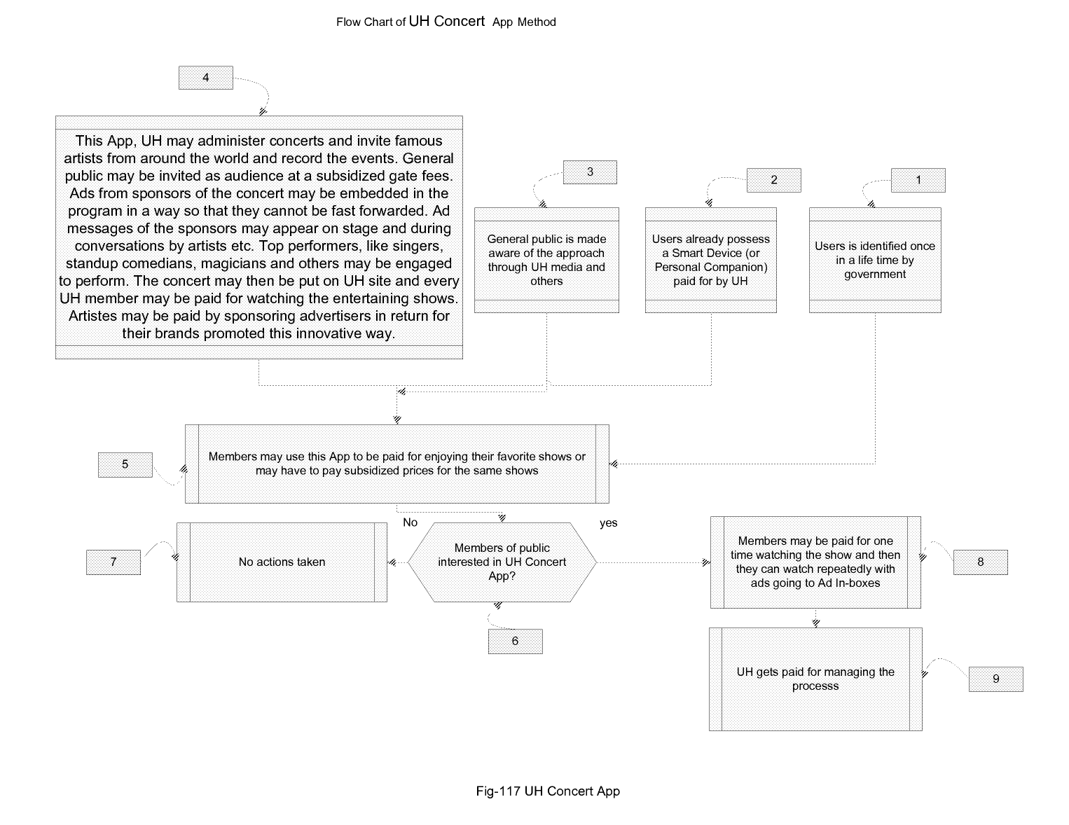

### FIG. 117 Illustrates Flow Chart of Concert App Method.

Steps 117.1, 117.2 and 117.3 are analogous to the correspondingly numbered steps described in reference to FIG. 6 above.

In Step 117.4, this App, UH may administer concerts and invite famous artists from around the world and record the events. General public may be invited as audience at a subsidized gate fees. Ads from sponsors of the concert may be embedded in the program in a way so that they cannot be fast forwarded. Ad messages of the sponsors may appear on stage and during conversations by artists etc. Top performers, like singers, standup comedians, magicians and others may be engaged to perform. The concert may then be put on UH site and every UH member may be paid for watching the entertaining shows. Artistes may be paid by sponsoring advertisers in return for their brands promoted this innovative way.

In Step 117.5 members may use this App to be paid for enjoying their favorite shows or may have to pay subsidized prices for the same shows.

In Step 117.6 members may decide if they are interested in this App.

In Step 117.7 members are not paid if they opt out.

In Step 117.8 members get paid each time UH App is used.

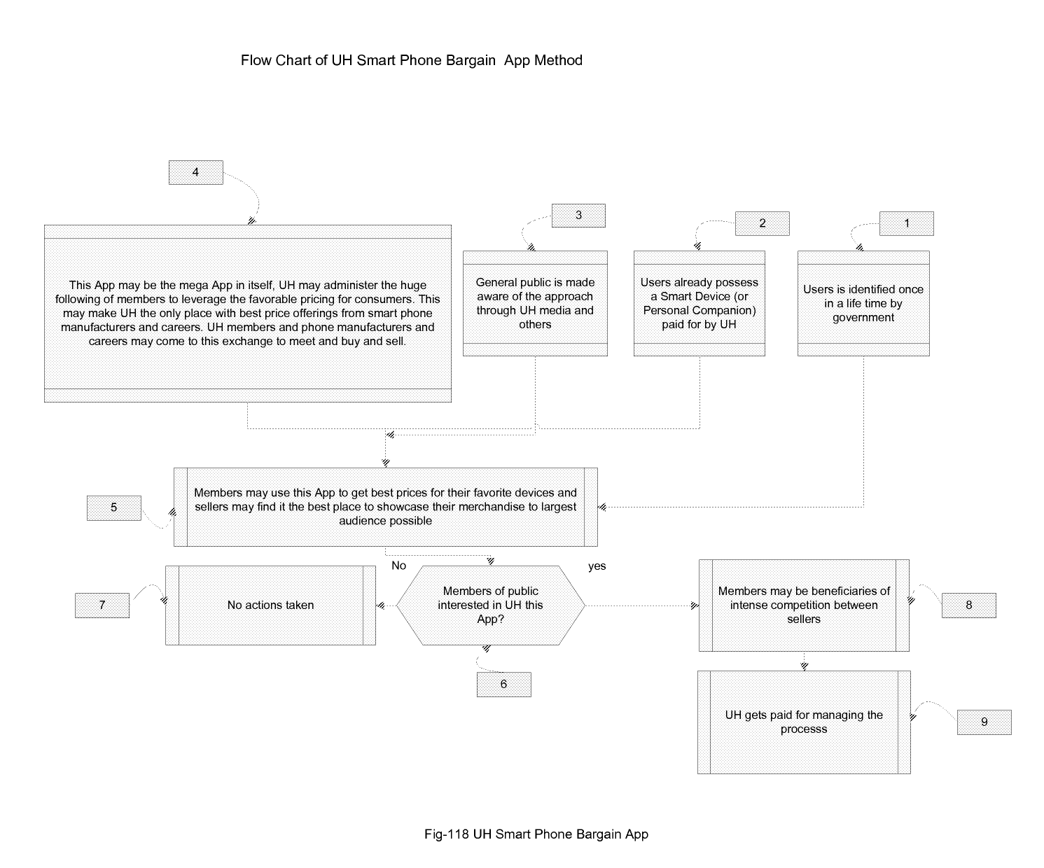

### FIG. 118 Illustrates Flow Chart of Smart Phone Exchange App Method.

Steps 118.1, 118.2 and 118.3 are analogous to the correspondingly numbered steps described in reference to FIG. 6 above.

In Step 118.4, this App may be the mega App in itself, UH may administer the huge following of members to leverage the favorable pricing for consumers. This may make UH the only place with best price offerings from smart phone manufacturers and careers. UH members and phone manufacturers and careers may come to this exchange to meet and buy and sell.

In Step 118.5 members may use this App to get best prices for their favorite devices and sellers may find it the best place to showcase their Smart phones merchandise to largest audience possible.

In Step 118.6 members may decide if they are interested in this App.

In Step 118.7 members are not paid if they opt out.

In Step 118.8 members get paid each time UH App is used.

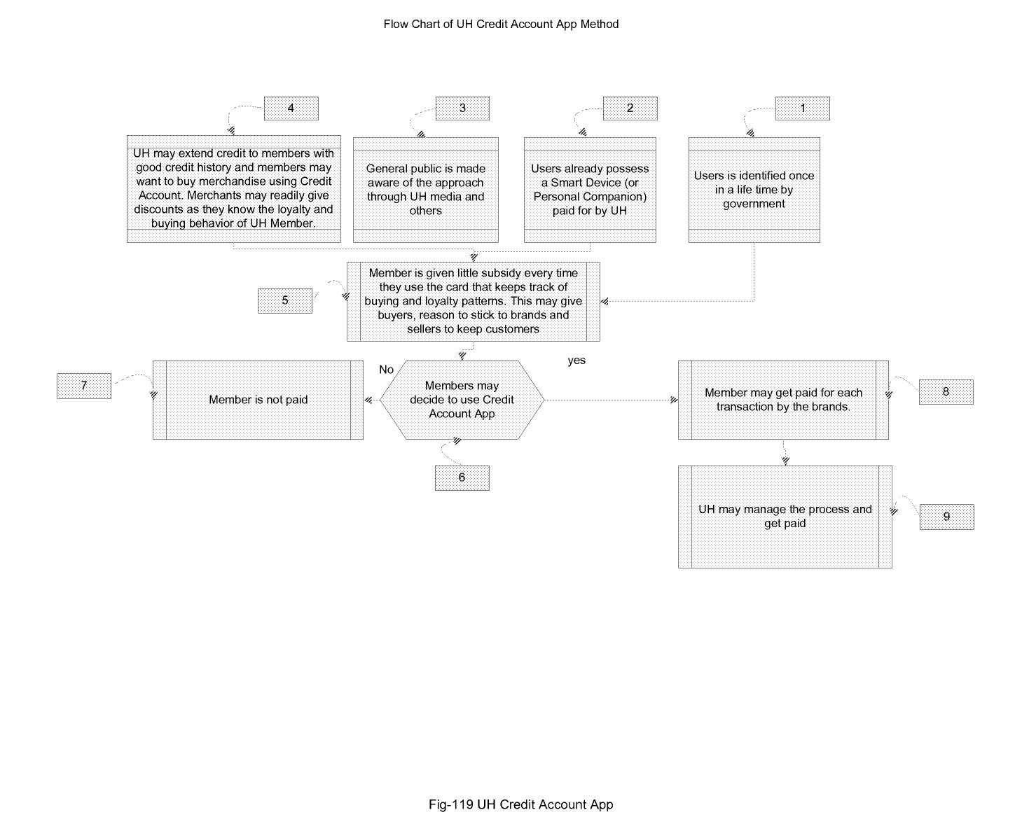

### FIG. 119 Illustrates Flow Chart of Credit Account App Method.

Steps 119.1, 119.2 and 119.3 are analogous to the correspondingly numbered steps described in reference to FIG. 6 above.

In Step 119.4, UH may extend credit to members with good credit history and members may want to buy merchandise using Credit Account. Merchants may readily give discounts as they know the loyalty and buying behavior of UH Member.

In Step 119.5 member is given little subsidy every time they use the card that keeps track of buying and loyalty patterns. This may give buyers, reason to stick to brands and sellers to keep customers.

In Step 119.6 members may decide if they are interested in this App.

In Step 119.7 members are not paid if they opt out.

In Step 119.8 members get paid each time UH App is used.

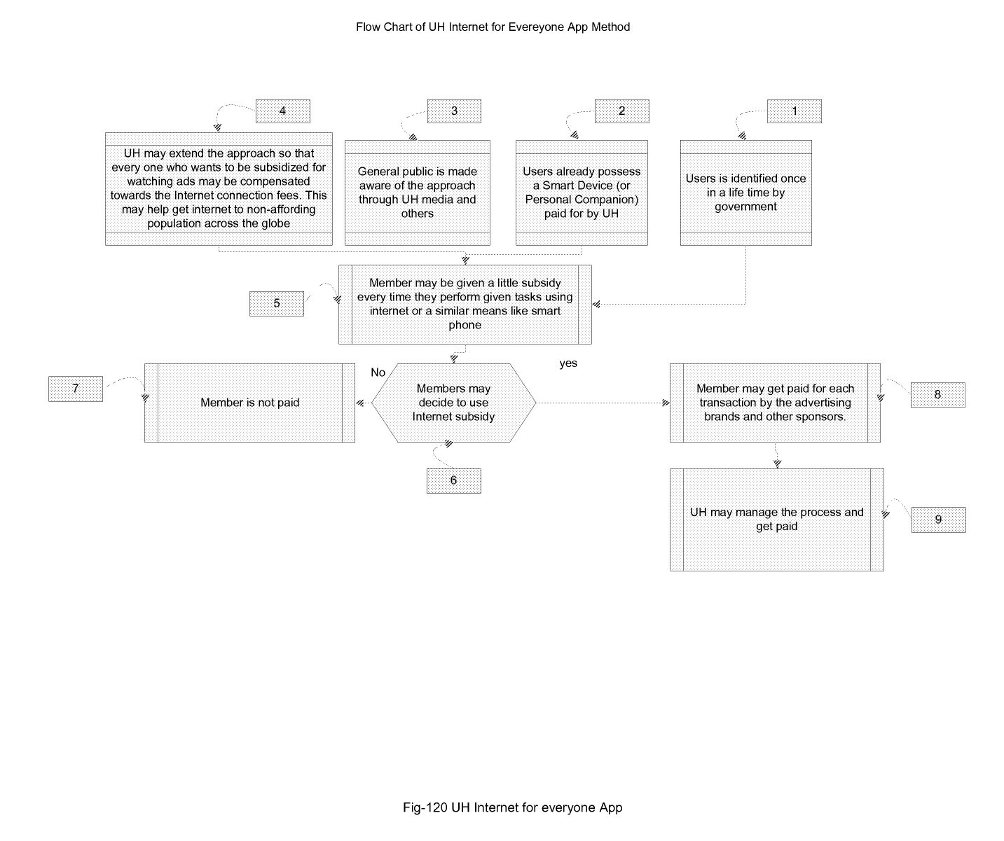

### FIG. 120 Illustrates Flow Chart of Internet for Everyone App Method.

Steps 120.1, 120.2 and 120.3 are analogous to the correspondingly numbered steps described in reference to FIG. 6 above.

In Step 120.4, UH may extend the approach so that everyone who wants to be subsidized for watching ads may be compensated towards the Internet connection fees. This may help get internet to non-affording population across the globe.

In Step 120.5 member may be given a little subsidy every time they perform given tasks using internet or a similar means like smart phone.

In Step 120.6 members may decide if they are interested in this App.

In Step 120.7 members are not paid if they opt out.

In Step 120.8 members get paid each time UH App is used.

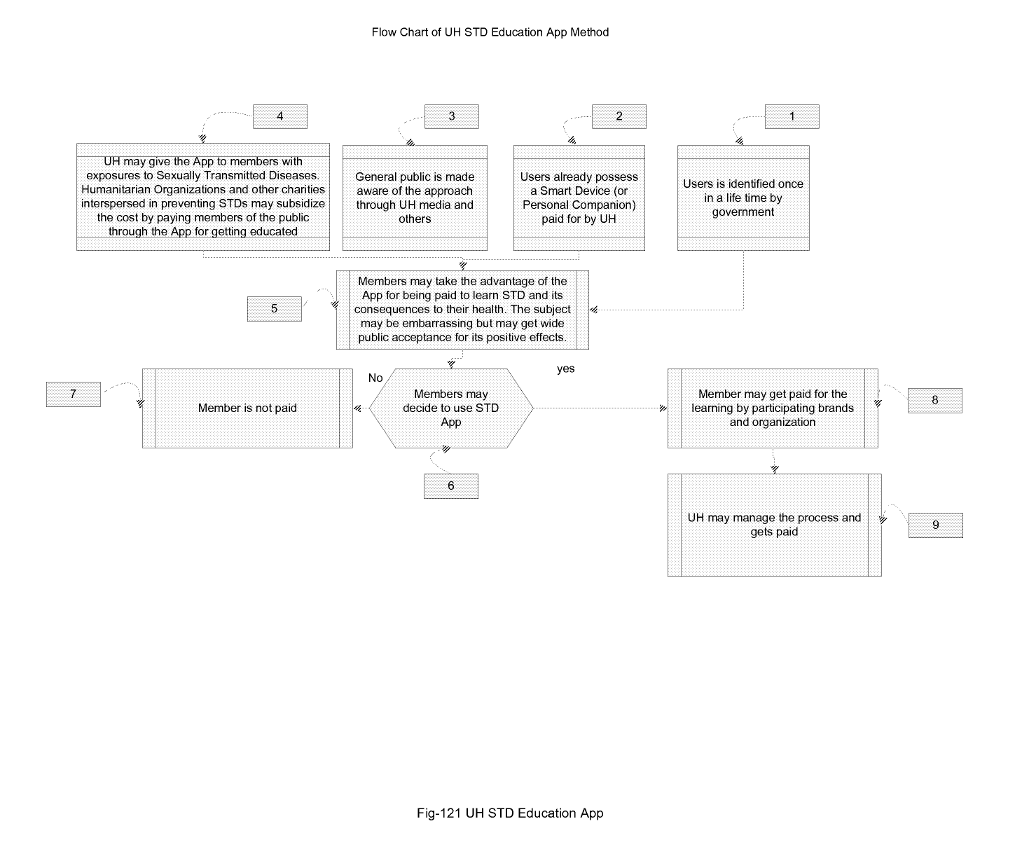

### FIG. 121 Illustrates Flow Chart of STD Education App Method.

Steps 121.1, 121.2 and 121.3 are analogous to the correspondingly numbered steps described in reference to FIG. 6 above.

In Step 121.4, UH may give the App to members with exposures to Sexually Transmitted Diseases. Humanitarian Organizations and other charities interspersed in preventing STDs may subsidize the cost by paying members of the public through the App for getting educated.

In Step 121.5 members may take the advantage of the App for being paid to learn STD and its consequences to their health. The subject may be embarrassing but may get wide public acceptance for its positive effects.

In Step 121.6 members may decide if they are interested in this App.

In Step 121.7 members are not paid if they opt out.

In Step 121.8 members get paid each time UH App is used.

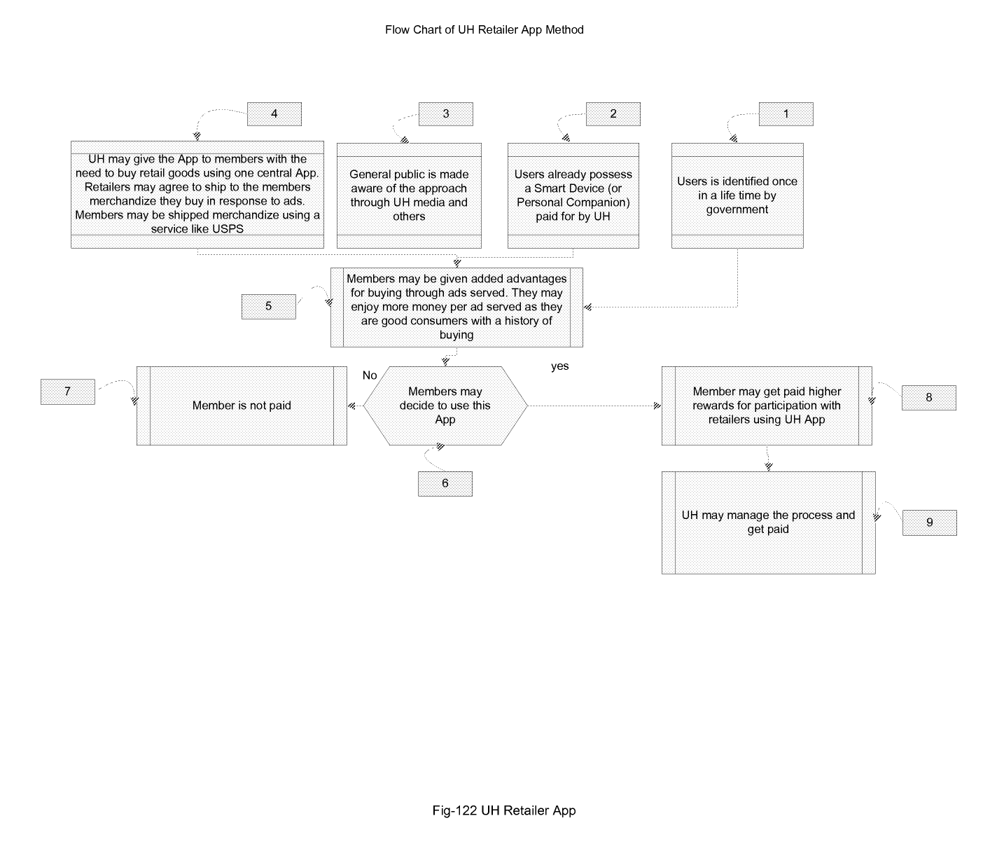

### FIG. 122 Illustrates Flow Chart of Retailer App Method.

Steps 122.1, 122.2 and 122.3 are analogous to the correspondingly numbered steps described in reference to FIG. 6 above.

In Step 122.4, UH may give the App to members with the need to buy retail goods using one central App. Retailers may agree to ship to the members merchandize they buy in response to ads. Members may be shipped merchandize using a service like USPS.

In Step 122.5 members may be given added advantages for buying through ads served. They may enjoy more money per ad served as they are good consumers with a history of buying.

In Step 122.6 members may decide if they are interested in this App.

In Step 122.7 members are not paid if they opt out.

In Step 122.8 members get paid each time UH App is used.

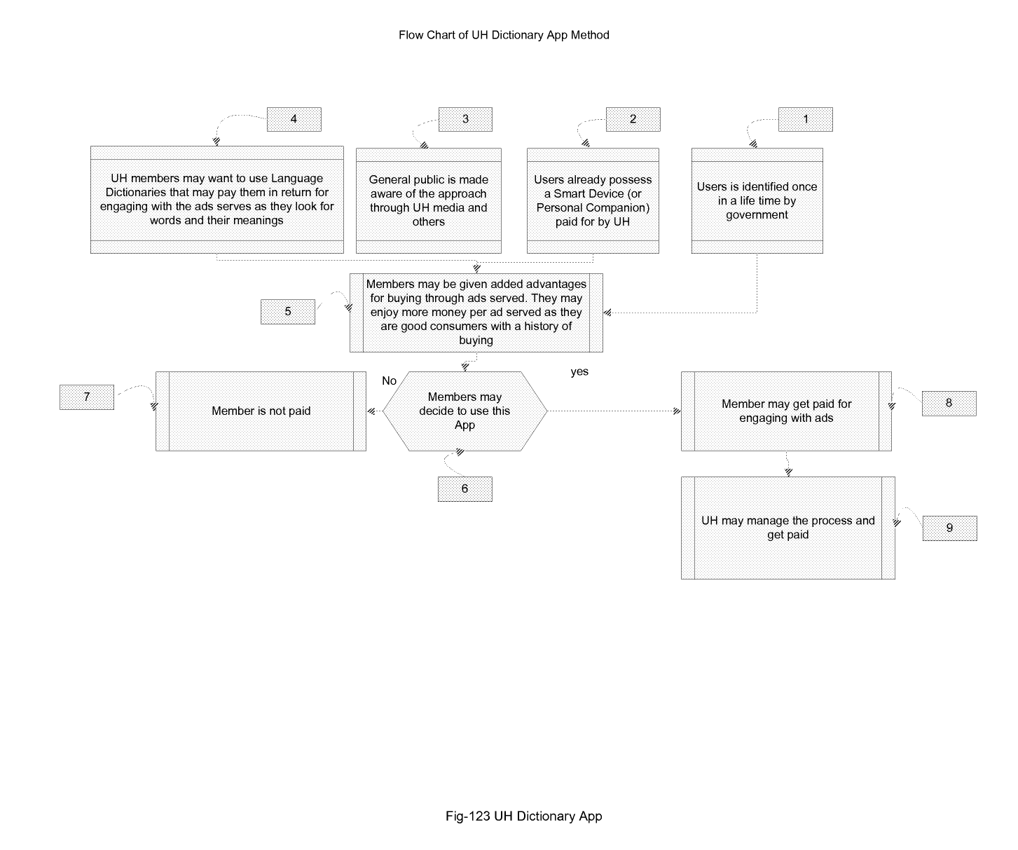

### FIG. 123 Illustrates Flow Chart of Dictionary App Method.

Steps 123.1, 123.2 and 123.3 are analogous to the correspondingly numbered steps described in reference to FIG. 6 above.

In Step 123.4, UH members may want to use Language Dictionaries that may pay them in return for engaging with the ads serves as they look for words and their meanings.

In Step 123.5 members may be given added advantages for buying through ads served. They may enjoy more money per ad served as they are good consumers with a history of buying.

In Step 123.6 members may decide if they are interested in this App.

In Step 123.7 members are not paid if they opt out.

In Step 123.8 members get paid each time UH App is used.

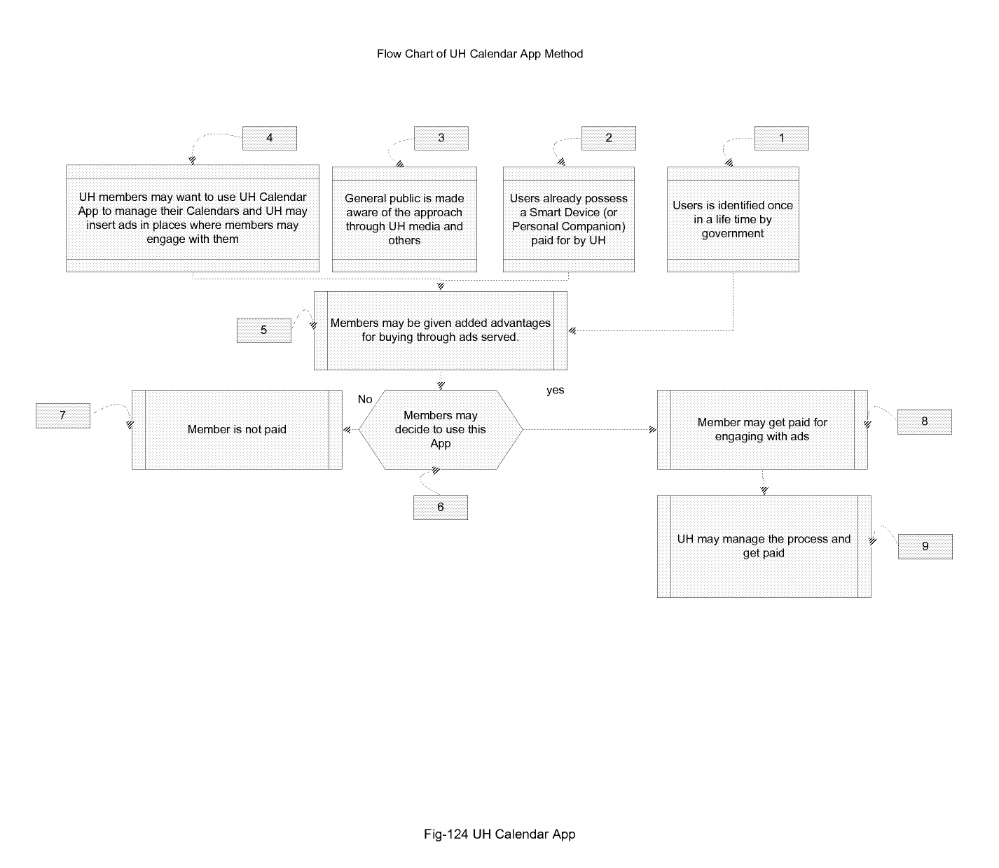

### FIG. 124 Illustrates Flow Chart of Calendar App Method.

Steps 124.1, 124.2 and 124.3 are analogous to the correspondingly numbered steps described in reference to FIG. 6 above.

In Step 124.4, UH members may want to use UH Calendar App to manage their Calendars and UH may insert ads in places where members may engage with them.

In Step 124.5 members may be given added advantages for buying through ads served.

In Step 124.6 members may decide if they are interested in this App.

In Step 124.7 members are not paid if they opt out.

In Step 124.8 members get paid each time UH App is used.

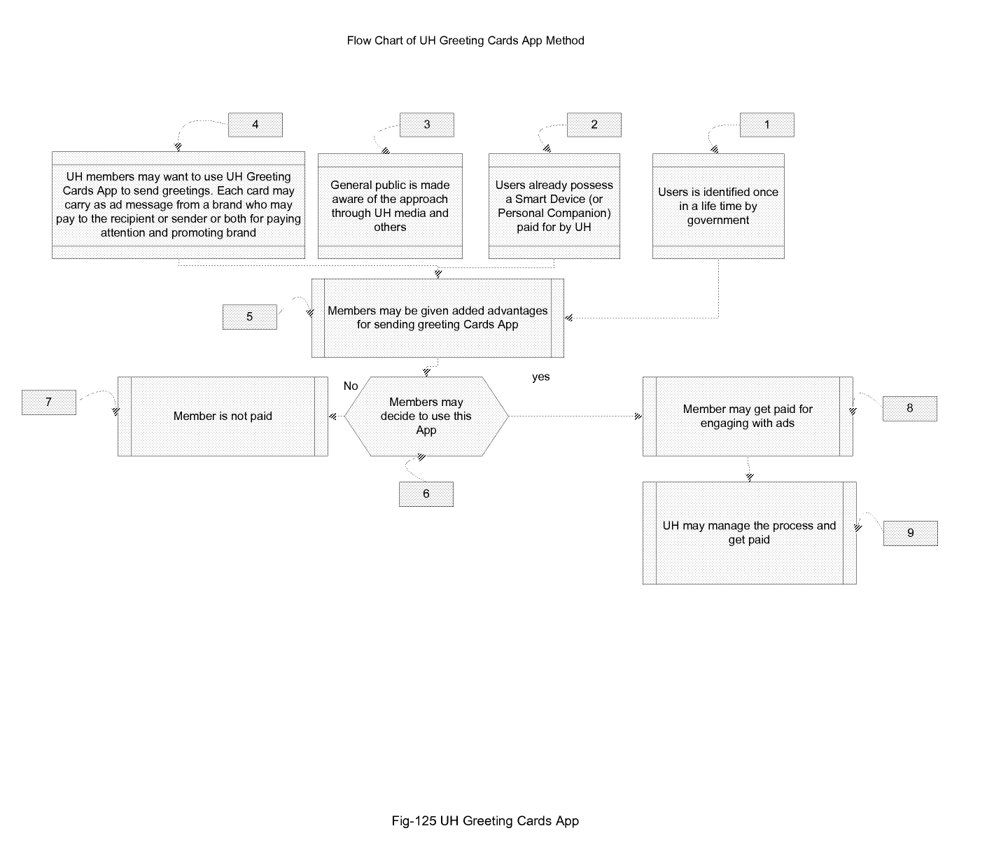

### FIG. 125 Illustrates Flow Chart of Calendar App Method.

Steps 125.1, 125.2 and 125.3 are analogous to the correspondingly numbered steps described in reference to FIG. 6 above.

In Step 125.4, UH members may want to use UH Greeting Cards App to send greetings. Each card may carry as ad message from a brand who may pay to the recipient or sender or both for paying attention and promoting brand.

In Step 125.5 members may be given added advantages for sending greeting Cards App.

In Step 125.6 members may decide if they are interested in this App.

In Step 125.7 members are not paid if they opt out.

In Step 125.8 members get paid each time UH App is used.

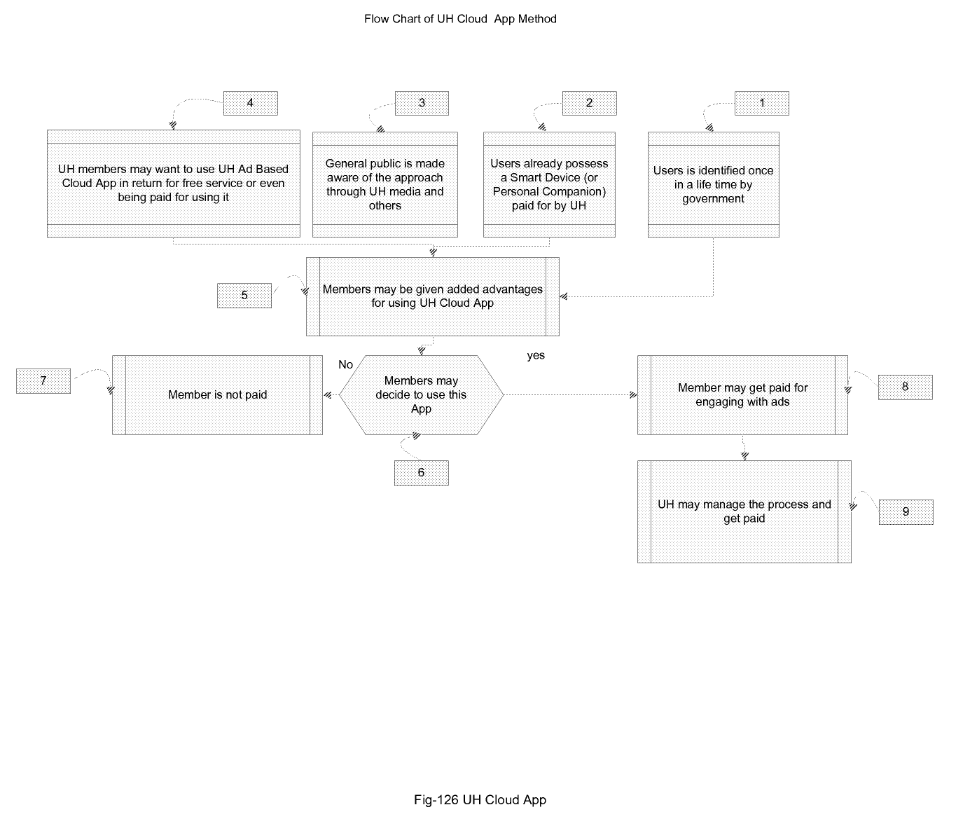

### FIG. 126 Illustrates Flow Chart of Cloud App Method.

Steps 126.1, 126.2 and 126.3 are analogous to the correspondingly numbered steps described in reference to FIG. 6 above.

In Step 126.4, UH members may want to use UH Ad Based Cloud App in return for free service or even being paid for using it.

In Step 126.5 members may be given added advantages for using UH Cloud App.

In Step 126.6 members may decide if they are interested in this App.

In Step 126.7 members are not paid if they opt out.

In Step 126.8 members get paid each time UH App is used.

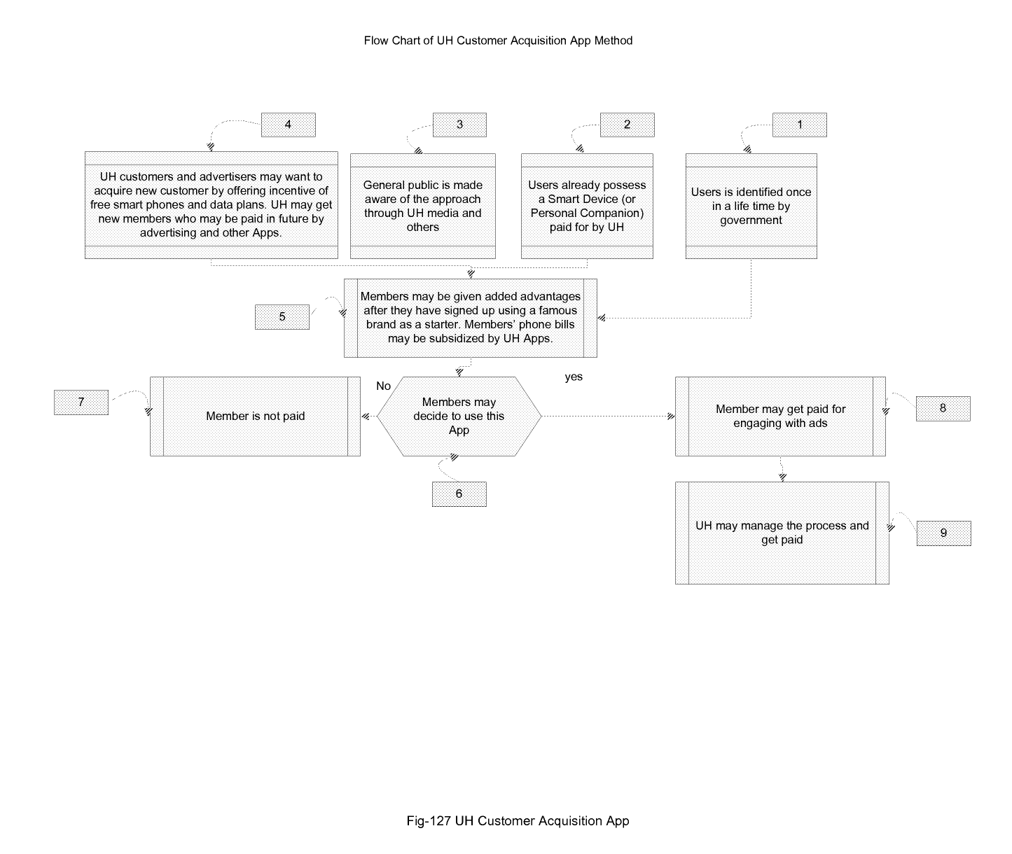

### FIG. 127 Illustrates Flow Chart of Customer Acquisition App Method.

Steps 127.1, 127.2 and 127.3 are analogous to the correspondingly numbered steps described in reference to FIG. 6 above.

In Step 127.4, UH customers and advertisers may want to acquire new customer by offering incentive of free smart phones and data plans. UH may get new members who may be paid in future by advertising and other Apps.

In Step 127.5 members may be given added advantages after they have signed up using a famous brand as a starter. Members' phone bills may be subsidized by UH Apps.

In Step 127.6 members may decide if they are interested in this App.

In Step 127.7 members are not paid if they opt out.

In Step 127.8 members get paid each time UH App is used.

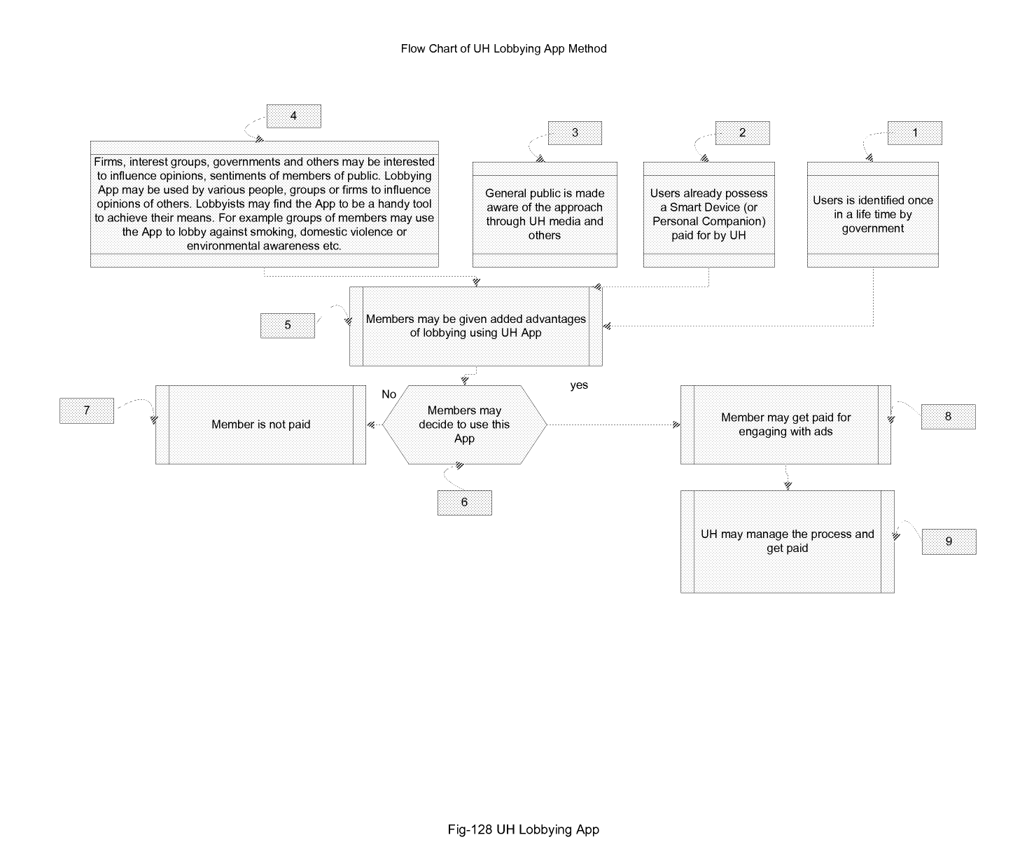

### FIG. 128 Illustrates Flow Chart of Lobbying App Method.

Steps 128.1, 128.2 and 128.3 are analogous to the correspondingly numbered steps described in reference to FIG. 6 above.

In Step 128.4, firms, interest groups, governments and others may be interested to influence opinions, sentiments of members of public. Lobbying App may be used by various people, groups or firms to influence opinions of others. Lobbyists may find the App to be a handy tool to achieve their means. For example groups of members may use the App to lobby against smoking, domestic violence or environmental awareness etc.

In Step 128.5 members may be given added advantages of lobbying using UH App.

In Step 128.6 members may decide if they are interested in this App.

In Step 128.7 members are not paid if they opt out.

In Step 128.8 members get paid each time UH.

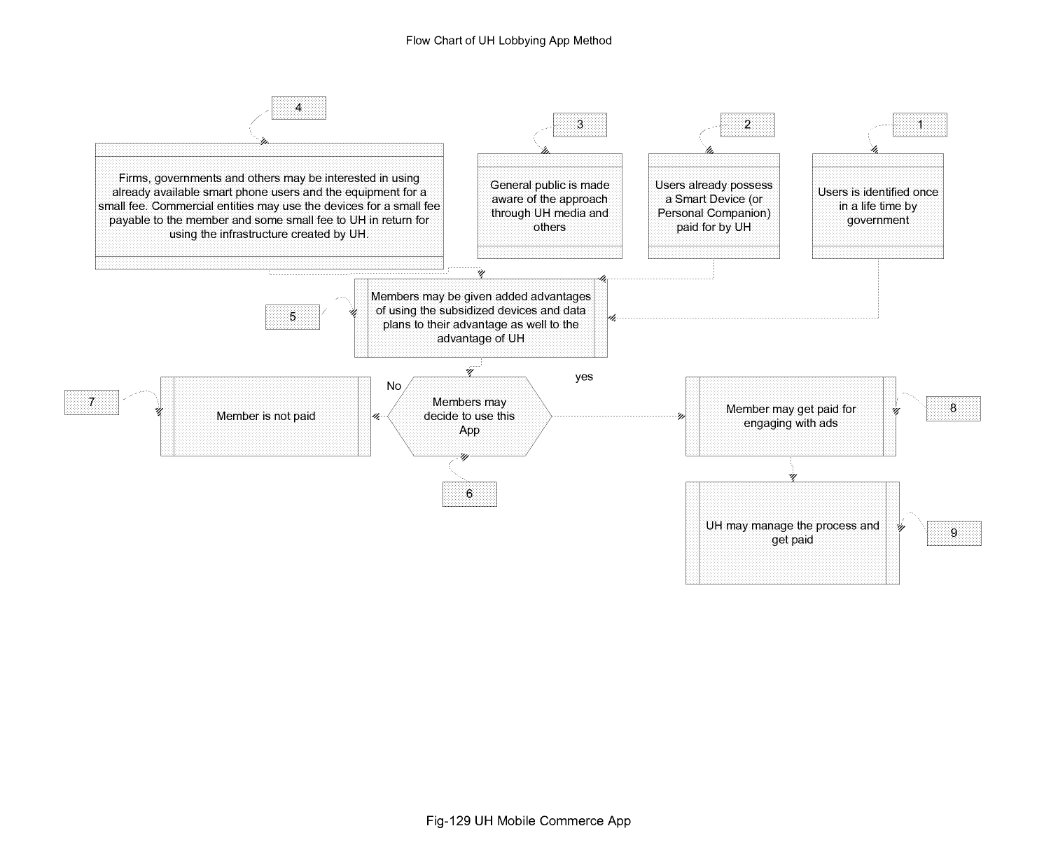

### FIG. 129 Illustrates Flow Chart of Mobile Commerce App Method.

Steps 129.1, 129.2 and 129.3 are analogous to the correspondingly numbered steps described in reference to FIG. 6 above.

In Step 129.4, firms, governments and others may be interested in using already available smart phone users and the equipment for a small fee. Commercial entities may use the devices for a small fee payable to the member and some small fee to UH in return for using the infrastructure created by UH.

In Step 129.5 members may be given added advantages of using the subsidized devices and data plans to their advantage as well to the advantage of UH.

In Step 129.6 members may decide if they are interested in this App.

In Step 129.7 members are not paid if they opt out.

In Step 129.8 members may get paid for engaging with ads.

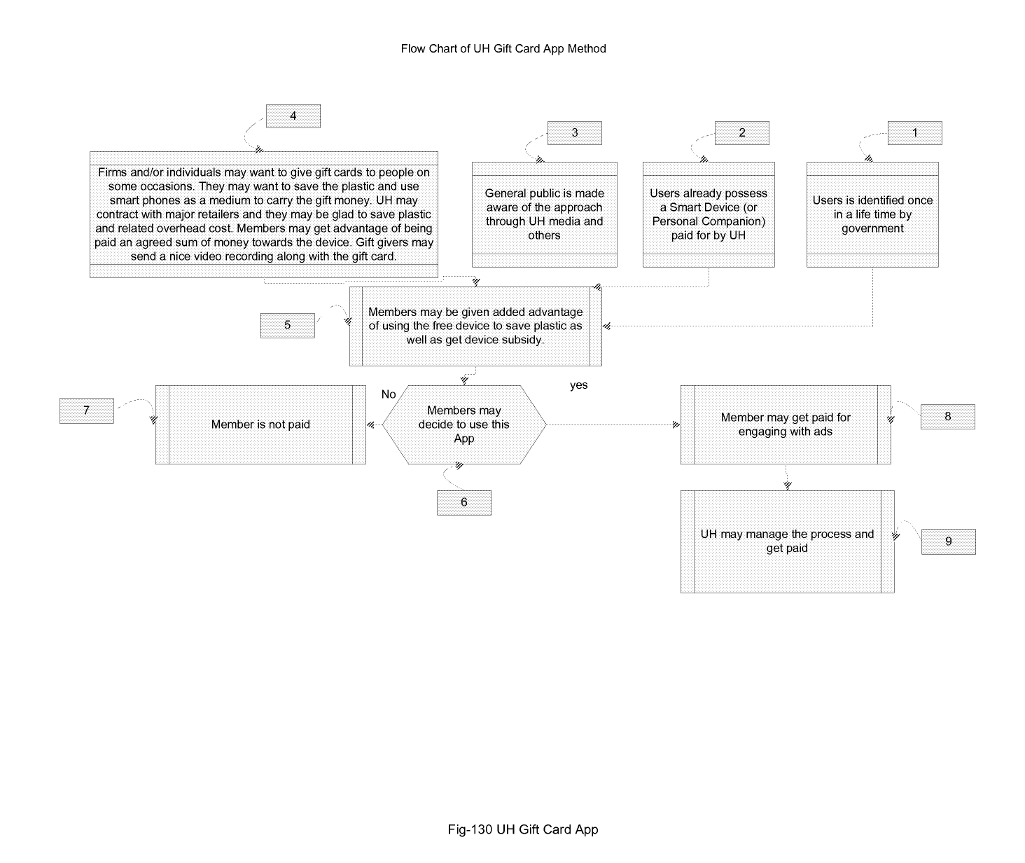

### FIG. 130 Illustrates Flow Chart of Gift Card App Method.

Steps 130.1, 130.2 and 130.3 are analogous to the correspondingly numbered steps described in reference to FIG. 6 above.

In Step 130.4, firms and/or individuals may want to give gift cards to people on some occasions. They may want to save the plastic and use smart phones as a medium to carry the gift money. UH may contract with major retailers and they may be glad to save plastic and related overhead cost. Members may get advantage of being paid an agreed sum of money towards the device. Gift givers may send a nice video recording along with the gift card.

In Step 130.5 members may be given added advantage of using the free device to save plastic as well as get device subsidy.

In Step 130.6 members may decide if they are interested in this App.

In Step 130.7 members are not paid if they opt out.

In Step 130.8 members may get paid for engaging with ads.

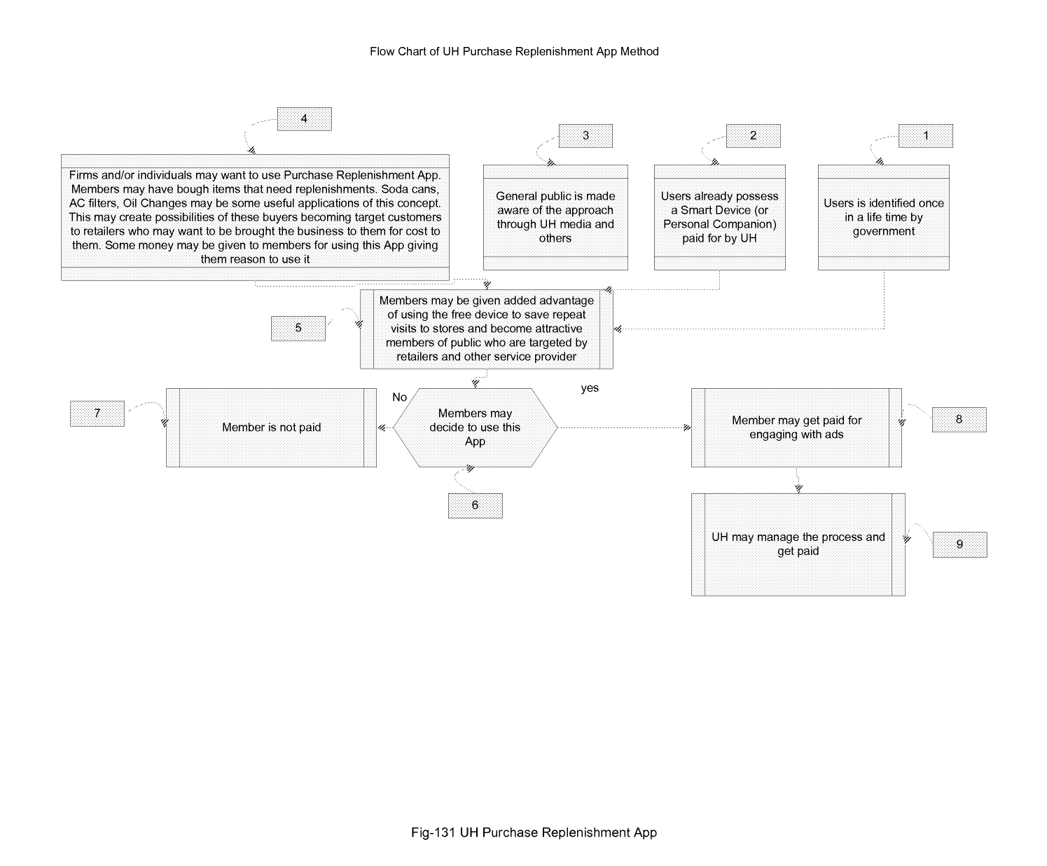

### FIG. 131 Illustrates Flow Chart of Purchase Replenishment App Method.

Steps 131.1, 131.2 and 131.3 are analogous to the correspondingly numbered steps described in reference to FIG. 6 above.

In Step 131.4, firms and/or individuals may want to use Purchase Replenishment App. Members may have bough items that need replenishments. Soda cans, AC filters, Oil Changes may be some useful applications of this concept. This may create possibilities of these buyers becoming target customers to retailers who may want to be brought the business to them for cost to them. Some money may be given to members for using this App giving them reason to use it.

In Step 131.5 members may be given added advantage of using the free device to save repeat visits to stores and become attractive members of public who are targeted by retailers and other service provider.

In Step 131.6 members may decide if they are interested in this App.

In Step 131.7 members are not paid if they opt out.

In Step 131.8 members may get paid for engaging with ads.

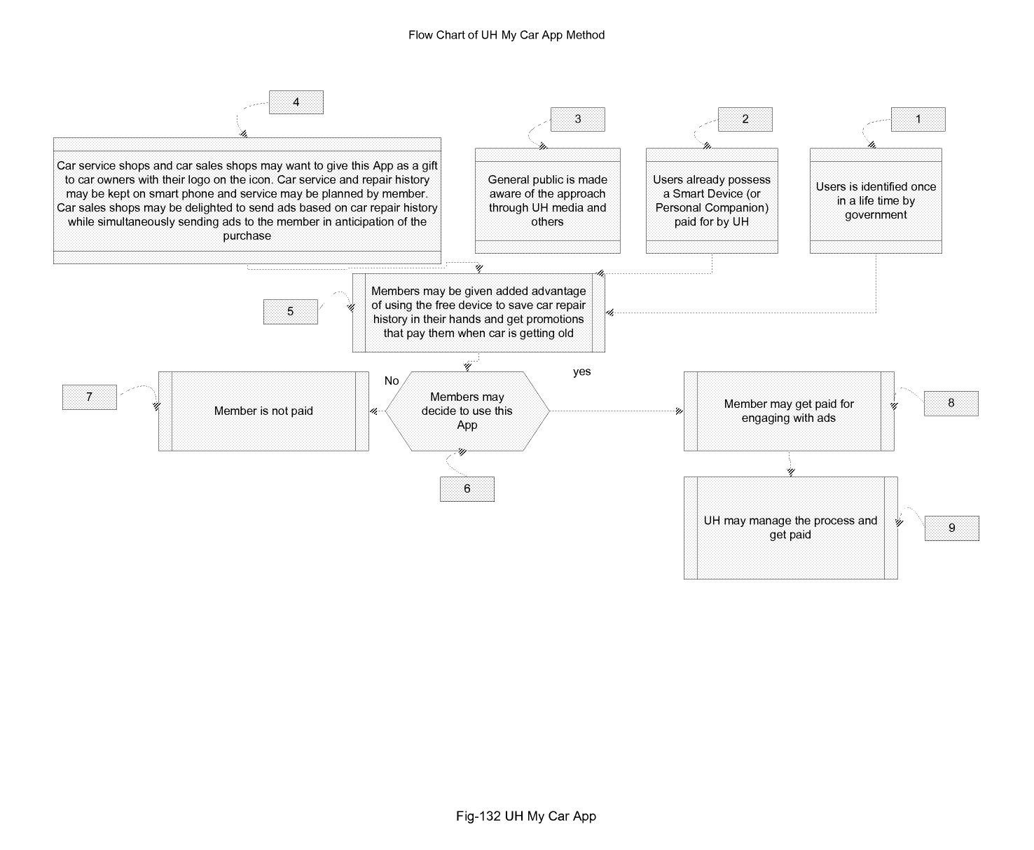

### FIG. 132 Illustrates Flow Chart of My Car App Method.

Steps 132.1, 132.2 and 132.3 are analogous to the correspondingly numbered steps described in reference to FIG. 6 above.

In Step 132.4, car service shops and car sales shops may want to give this App as a gift to car owners with their logo on the icon. Car service and repair history may be kept on smart phone and service may be planned by member. Car sales shops may be delighted to send ads based on car repair history while simultaneously sending ads to the member in anticipation of the purchase.

In Step 132.5 members may be given added advantage of using the free device to save car repair history in their hands and get promotions that pay them when car is getting old.

In Step 132.6 members may decide if they are interested in this App.

In Step 132.7 members are not paid if they opt out.

In Step 132.8 members may get paid for engaging with ads.

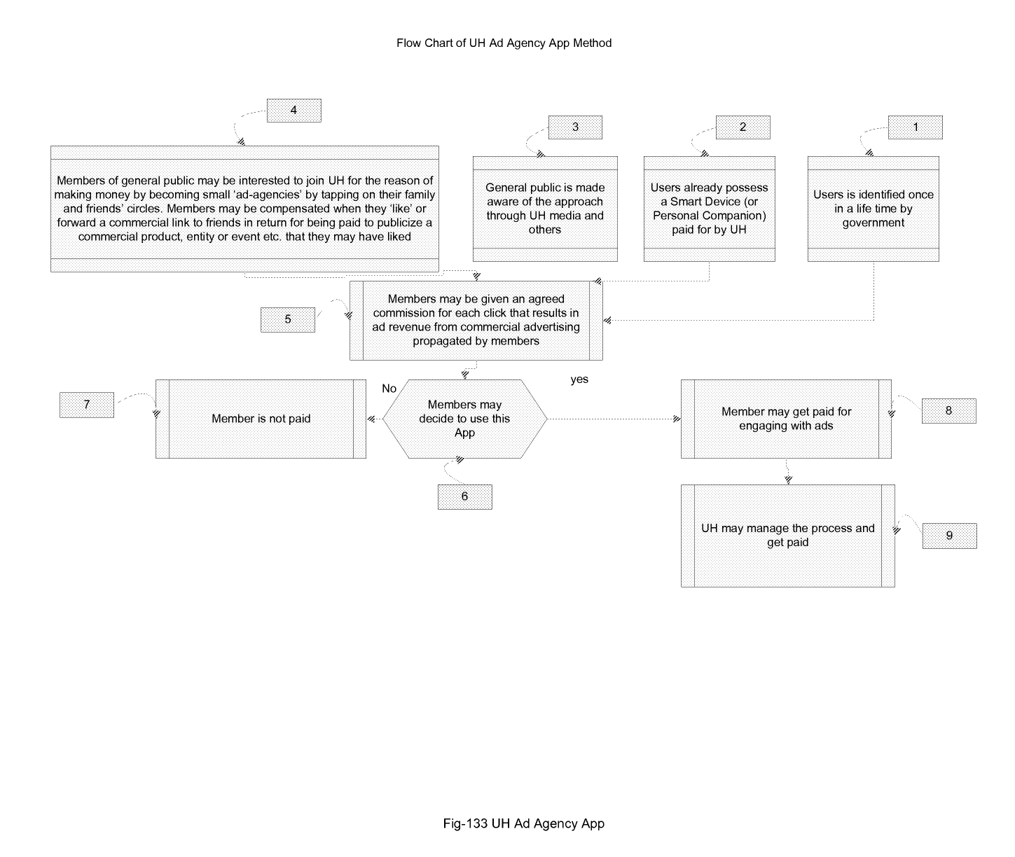

### FIG. 133 Illustrates Flow Chart of Ad Agency App Method.

Steps 133.1, 133.2 and 133.3 are analogous to the correspondingly numbered steps described in reference to FIG. 6 above.

In Step 133.4, members of general public may be interested to join UH for the reason of making money by becoming small ‘ad-agencies’ by tapping on their family and friends' circles. Members may be compensated when they ‘like’ or forward a commercial link to friends in return for being paid to publicize a commercial product, entity or event etc. that they may have liked.

In Step 133.5 members may be given an agreed commission for each click that results in ad revenue from commercial advertising propagated by members.

In Step 133.6 members may decide if they are interested in this App.

In Step 133.7 members are not paid if they opt out.

In Step 133.8 members may get paid for engaging with ads.

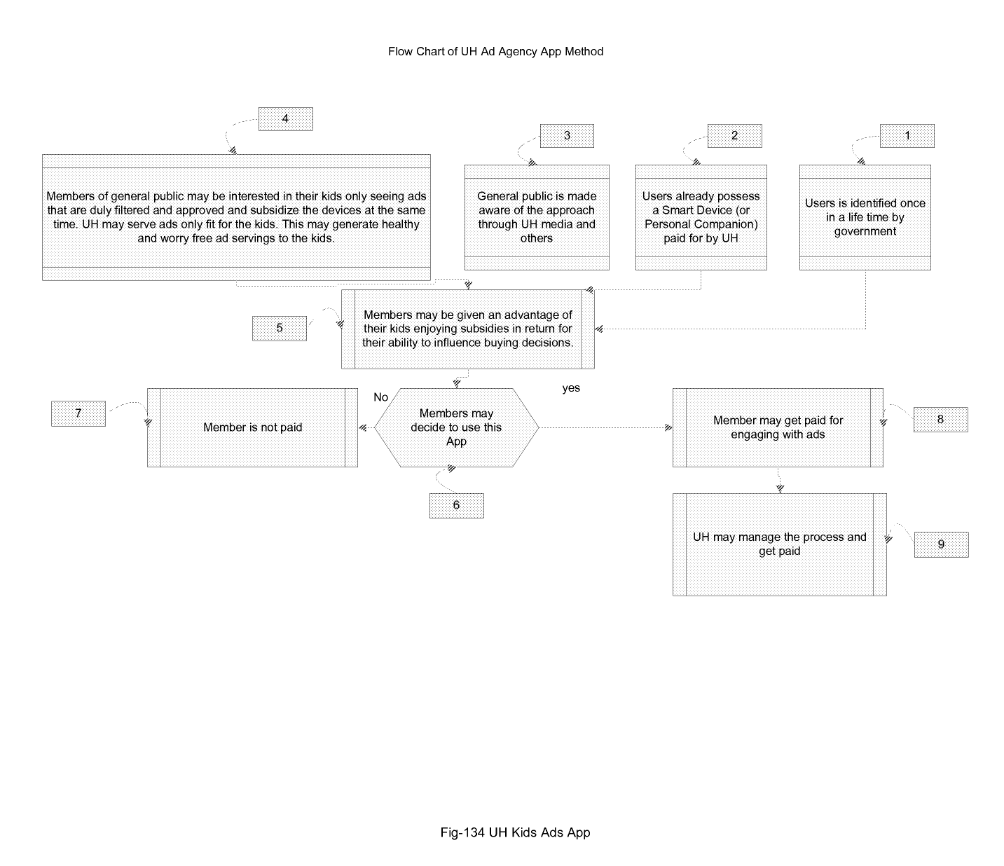

### FIG. 134 Illustrates Flow Chart of Kids Ads App Method.

Steps 134.1, 134.2 and 134.3 are analogous to the correspondingly numbered steps described in reference to FIG. 6 above.

In Step 134.4, members of general public may be interested in their kids only seeing ads that are duly filtered and approved and subsidize the devices at the same time. UH may serve ads only fit for the kids. This may generate healthy and worry free ad servings to the kids.

In Step 134.5 members may be given an advantage of their kids enjoying subsidies in return for their ability to influence buying decisions.

In Step 134.6 members may decide if they are interested in this App.

In Step 134.7 members are not paid if they opt out.

In Step 134.8 members may get paid for engaging with ads.

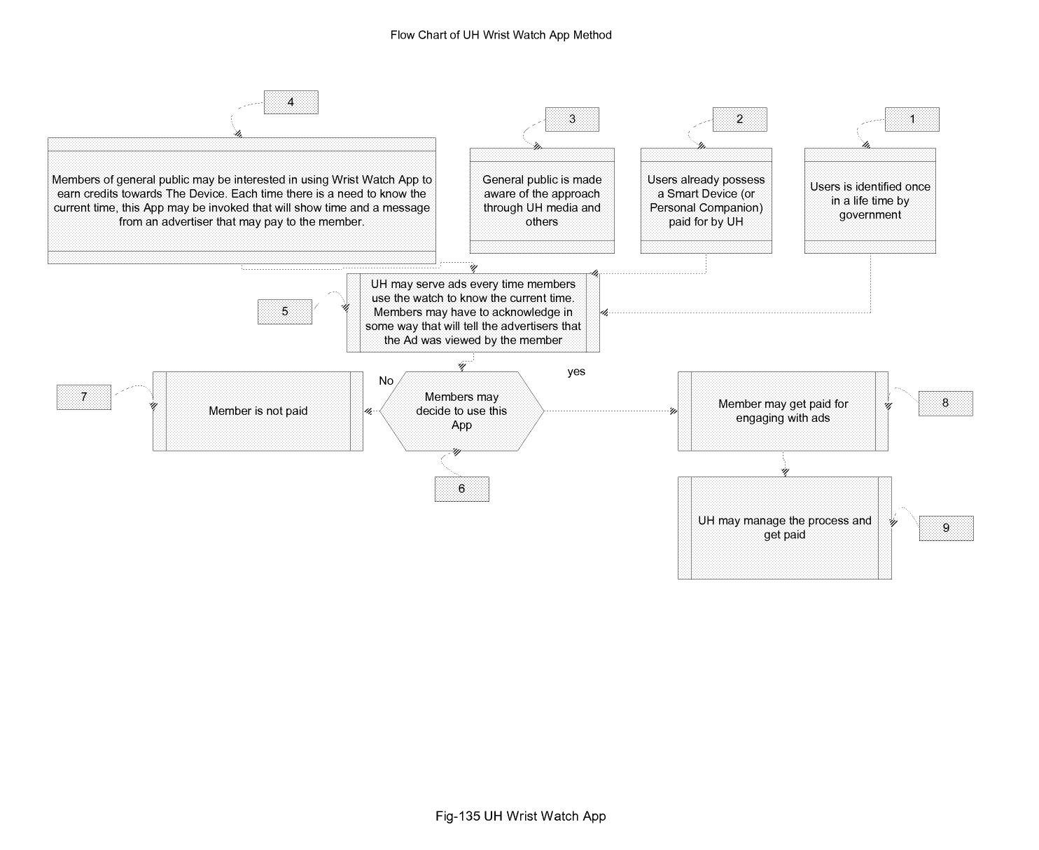

### FIG. 135 Illustrates Flow Chart of Wrist Watch App Method.

Steps 135.1, 135.2 and 135.3 are analogous to the correspondingly numbered steps described in reference to FIG. 6 above.

In Step 135.4, members of general public may be interested in using Wrist Watch App to earn credits towards The Device. Each time there is a need to know the current time, this App may be invoked that will show time and a message from an advertiser that may pay to the member.

In Step 135.5 UH may serve ads every time members use the watch to know the current time. Members may have to acknowledge in some way that will tell the advertisers that the Ad was viewed by the member.

In Step 135.6 members may decide if they are interested in this App.

In Step 135.7 members are not paid if they opt out.

In Step 135.8 members may get paid for engaging with ads.

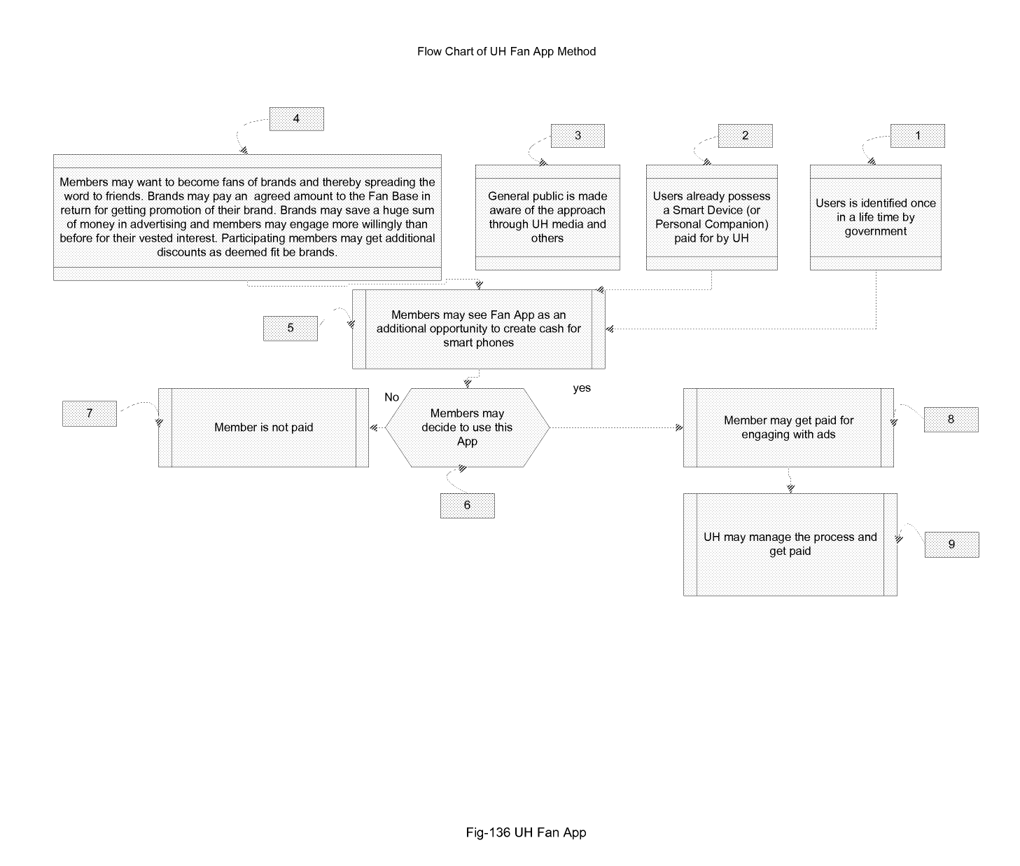

### FIG. 136 Illustrates Flow Chart of Fan App Method.

Steps 136.1, 136.2 and 136.3 are analogous to the correspondingly numbered steps described in reference to FIG. 6 above.

In Step 136.4, members may want to become fans of brands and thereby spreading the word to friends. Brands may pay an agreed amount to the Fan Base in return for getting promotion of their brand. Brands may save a huge sum of money in advertising and members may engage more willingly than before for their vested interest. Participating members may get additional discounts as deemed fit be brands.

In Step 136.5 members may see Fan App as an additional opportunity to create cash for smart phones.

In Step 136.6 members may decide if they are interested in this App.

In Step 136.7 members are not paid if they opt out.

In Step 136.8 members may get paid for engaging with ads.

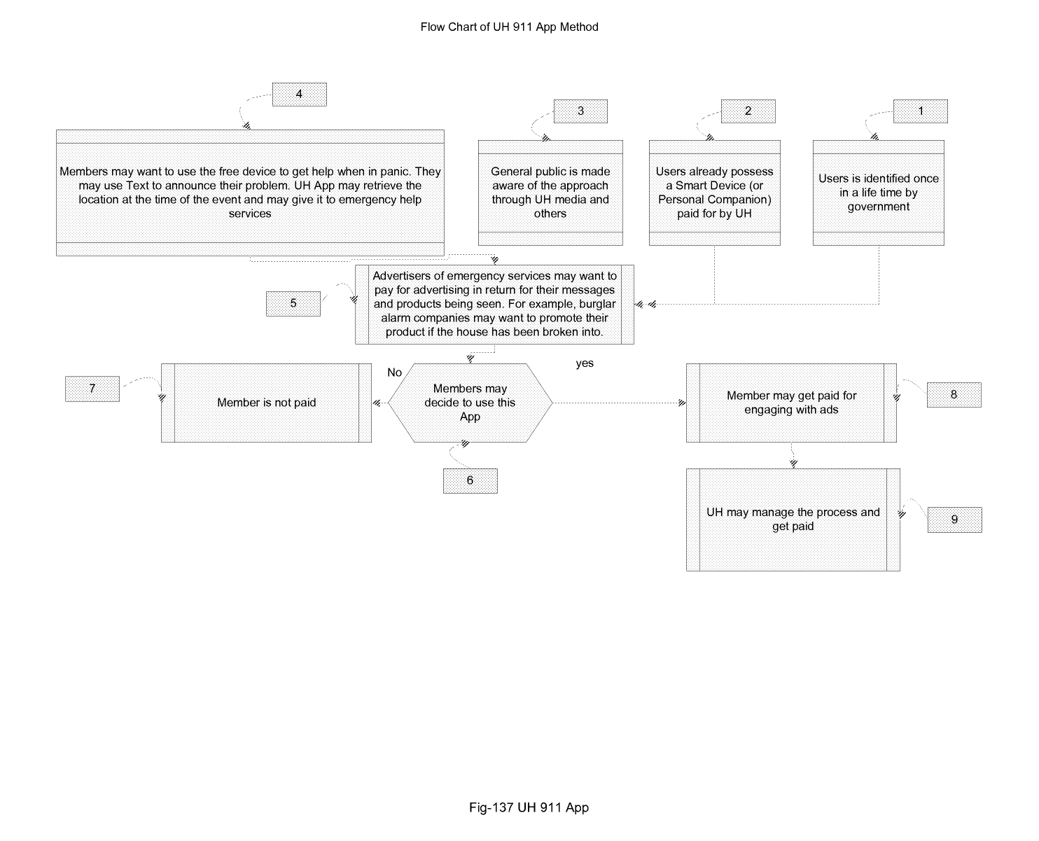

### FIG. 137 Illustrates Flow Chart of 911 App Method.

Steps 137.1, 137.2 and 137.3 are analogous to the correspondingly numbered steps described in reference to FIG. 6 above.

In Step 137.4, members may want to use the free device to get help when in panic. They may use Text to announce their problem. UH App may retrieve the location at the time of the event and may give it to emergency help services.

In Step 137.5 advertisers of emergency services may want to pay for advertising in return for their messages and products being seen. For example, burglar alarm companies may want to promote their product if the house has been broken into.

In Step 137.6 members may decide if they are interested in this App.

In Step 137.7 members are not paid if they opt out.

In Step 137.8 members may get paid for engaging with ads.

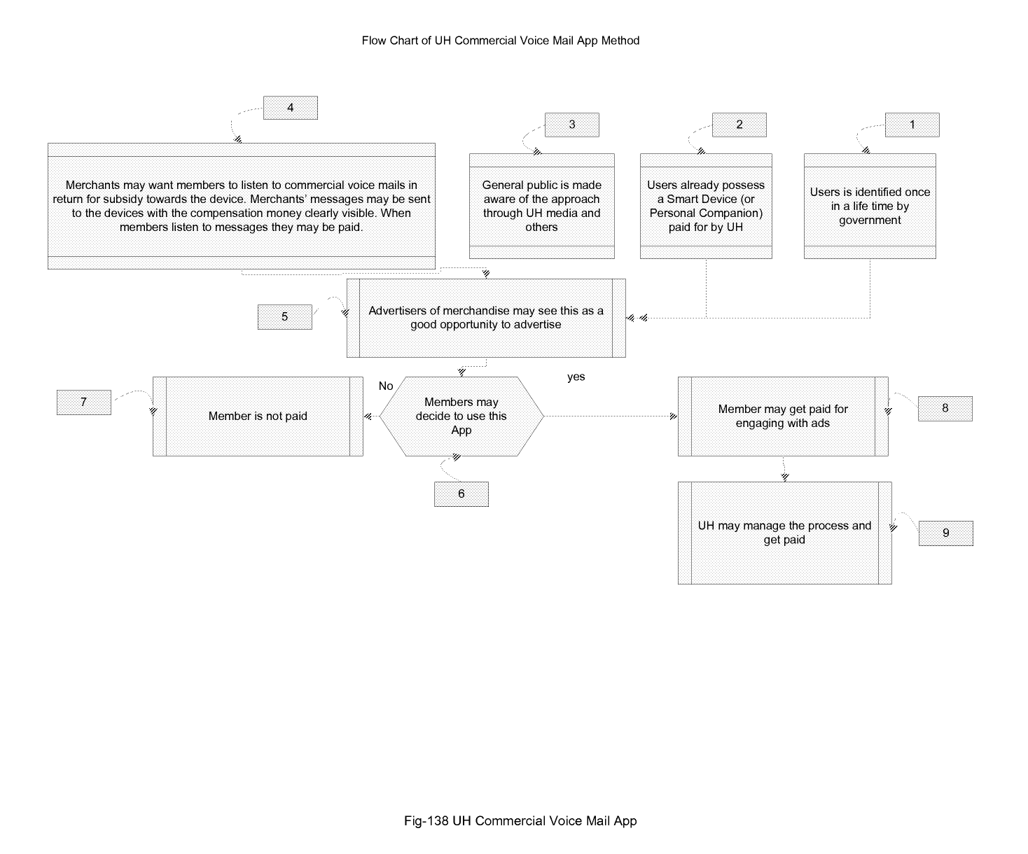

### FIG. 138 Illustrates Flow Chart of Commercial Voice Mail App Method.

Steps 138.1, 138.2 and 138.3 are analogous to the correspondingly numbered steps described in reference to FIG. 6 above.

In Step 138.4, merchants may want members to listen to commercial voice mails in return for subsidy towards the device. Merchants' messages may be sent to the devices with the compensation money clearly visible. When members listen to messages they may be paid.

In Step 138.5 advertisers of merchandise may see this as a good opportunity to advertise.

In Step 138.6 members may decide if they are interested in this App.

In Step 138.7 members are not paid if they opt out.

In Step 138.8 members may get paid for engaging with ads.

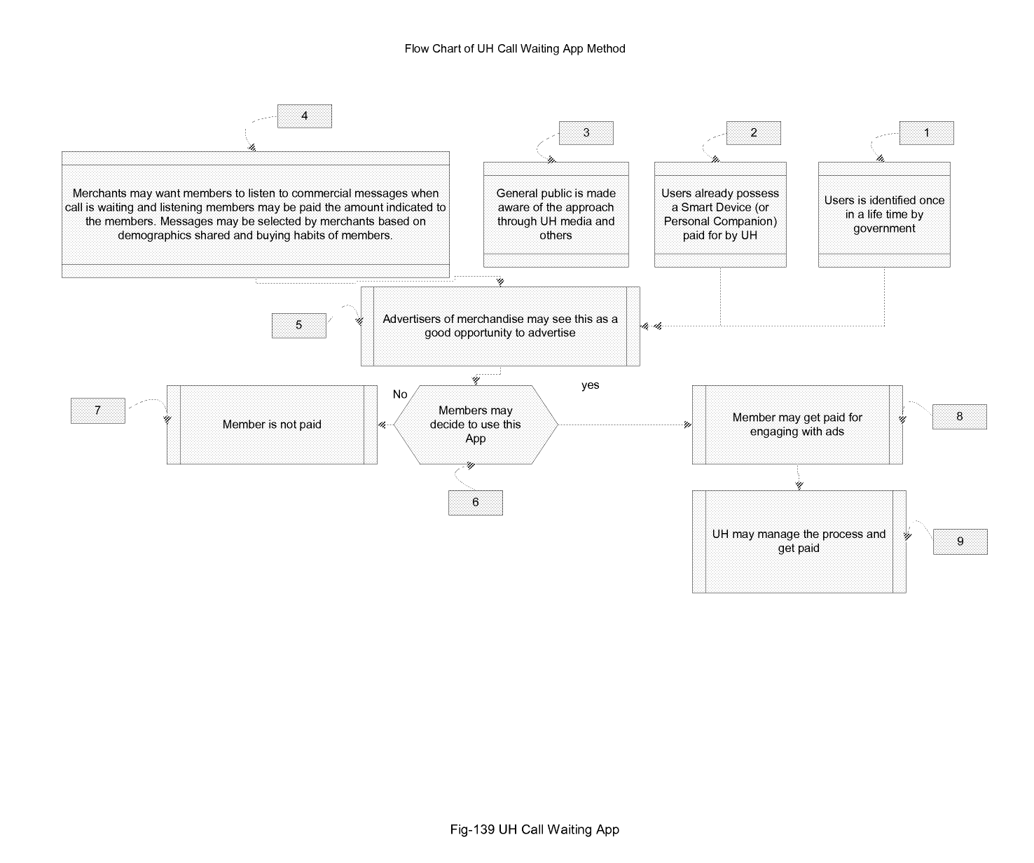

### FIG. 139 Illustrates Flow Chart of Call Waiting App Method.

Steps 139.1, 139.2 and 139.3 are analogous to the correspondingly numbered steps described in reference to FIG. 6 above.

In Step 139.4, merchants may want members to listen to commercial messages when call is waiting and listening members may be paid the amount indicated to the members. Messages may be selected by merchants based on demographics shared and buying habits of members.

In Step 139.5 advertisers of merchandise may see this as a good opportunity to advertise.

In Step 139.6 members may decide if they are interested in this App.

In Step 139.7 members are not paid if they opt out.

In Step 139.8 members may get paid for engaging with ads.

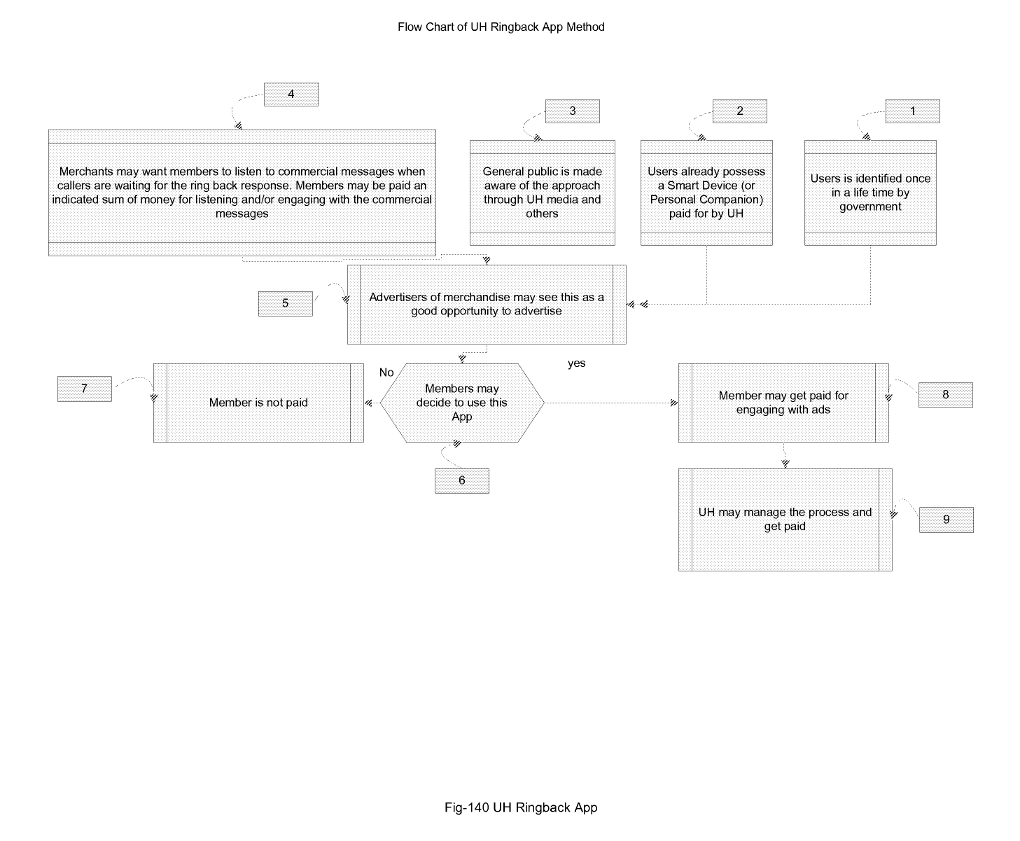

### FIG. 140 Illustrates Flow Chart of Ring Back App Method.

Steps 140.1, 140.2 and 140.3 are analogous to the correspondingly numbered steps described in reference to FIG. 6 above.

In Step 140.4, merchants may want members to listen to commercial messages when callers are waiting for the ring back response. Members may be paid an indicated sum of money for listening and/or engaging with the commercial messages.

In Step 140.5 advertisers of merchandise may see this as a good opportunity to advertise.

In Step 140.6 members may decide if they are interested in this App.

In Step 140.7 members are not paid if they opt out.

In Step 140.8 members may get paid for engaging with ads.

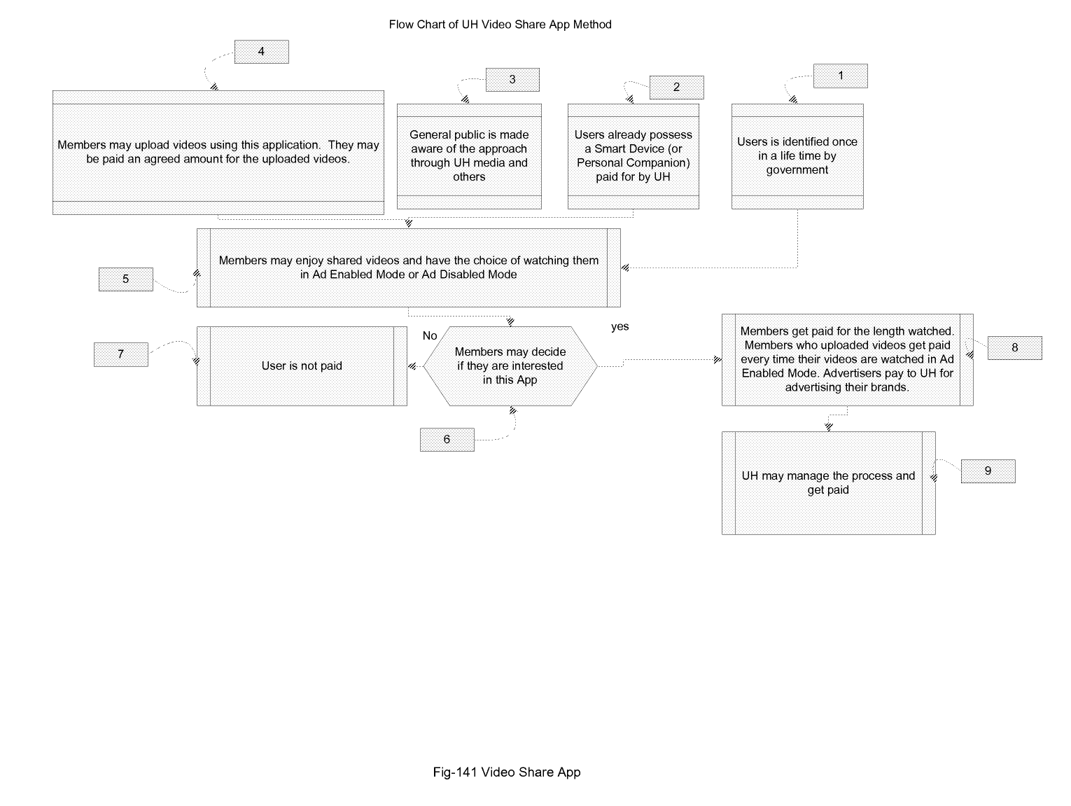

### FIG. 141 Illustrates Flow Chart of Video Share App Method.

Steps 141.1, 141.2 and 141.3 are analogous to the correspondingly numbered steps described in reference to FIG. 6 above.

In Step 141.4, members may upload videos using this application. They may be paid an agreed amount for the uploaded videos.

In Step 141.5 members may enjoy shared videos and have the choice of watching them in Ad Enabled Mode or Ad Disabled Mode.

In Step 141.6 members may decide if they are interested in this App.

In Step 141.7 members are not paid if they opt out.

In Step 141.8 members get paid for the length watched. Members who uploaded videos get paid every time their videos are watched in Ad Enabled Mode. Advertisers pay to UH for advertising their brands.

In Step 141.8 UH may manage the process and get paid.

Although the invention above has been described primarily in terms of advertising being the dominant funding source, one of ordinary skill in the art will readily appreciate that other sources may be used, such as, but not limited to, charity donations or carbon credit based funding.

For instance a user may be provided free of charge with a smart phone that may have modules and attachments such as, but not limited to, a GPS module, a digital camera and a camera operating module.

A user may then use the smart phone to send a server a request to operate an application, along with a user identifier.

The smart phone may then obtain relevant parts of the requested application from the server. The smart phone may then display an appropriate graphic related to the application, along with one or more reimbursable mode options. These reimbursable mode options may include options such as, but not limited to, a charity mode option, an advertising mode option and a carbon micro-credit mode option, or some combination thereof.

The user may then use the smart phone to select one of the reimbursable modes or they may select prefer to pay mode option.

If one of said reimbursable mode options is selected, the user may, on using the application, see an electronic notification of a monitory credit to an account associated with them, received and displayed by the smart phone.

In this way a user may receive compensation for using a smart-phone application.

The charitable mode reimbursement may, for instance, be part of a tax deductible charity donation made by an ordinary citizen in a more developed country to a person in a less developed country in return for using an educational application such as, but not limited to, a literary program, a math educational program, or merely for accessing information from, or providing information to, an educational source such as, but not limited to, the Wikipedia. A relatively small donation by a person in a developed country may be a considerable amount for a person in a developing country. A person in a developed country may, for instance, make a single donation that may then be split into a number of “micro” charity donations and distributed among a number of cell phone users.

The carbon credit mode reimbursement may, for instance, be applicable if the cell phone user is participating in some project, such as, but not limited to, accessing an electronic directory or service, thereby saving C02 emissions on the production of paper, or the act of distribution. The project may receive some or all of its funding via carbon credit trading with a developed nation corporation. As part of the carbon credit trade, all or part of that funding may be required to be shared with the participants in the project. This may, for instance, be done by providing micro-carbon credit rewards to each cell phone participant based on, for instance, their participation in the project.

When displaying the reimbursable mode options, the cell phone may also display a monetary value associated with each of said reimbursable mode options for using that service, or performing that activity.

The cell phone may also help provide user identification by, for instance, providing a current GPS location of the user and/or a current image obtained using the digital camera. That current image may be a biometric identifier such as, but not limited to, a picture of the user's face or a picture of a user's thumb print.

As seen from the perspective of the server, the method would appear as follows:

The server may receive a request to operate an application from a smart phone. The smart phone may be equipped with a module of an applications such as, but not limited to, a GPS module, a digital camera and a camera operating module.

Along with the request for an app, the server may receive a user identifier, that may be a current GPS location of the user and/or a current image obtained using the digital camera. That current image may be a biometric identifier such as, but not limited to, a picture of the user's face or a picture of a user's thumb print.

Based on information about the identified user such as, but not limited to, relevant demographic data and their current location, the user, and the requested application, may be qualified as to eligibility for a variety of reimbursable modes such as, but not limited to, a charity mode reimbursable option, an advertising mode reimbursable option, and a carbon micro-credit mode reimbursable option.

The server may then send an offer to select from one of the qualified reimbursable options to the user's cell phone.

If one of the reimbursable mode options is selected by the user, the server, on receiving notification of that selection from the smart phone, and of an appropriate level of use of the application by the user, the server may then identify at least one provider of funding for the selected reimbursable mode, and send to the user via the smart phone, a conditions of reimbursement statement. These conditions may, for instance, be spending a certain amount of time on an education application, or obtaining a certain grade on a testable educational module.

On receipt of notification that the conditions have been fulfilled, the server may then transfer a monetary credit from an account associated the funding provider to an account associated with the identified user. The server may also send an electronic notification of the monitory credit to the account associated with the identified user to the user's smart phone.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1: A method of receiving compensation for using an application on a computing device to pay fro the computing device, such as a desktop, a laptop, a smart phone, a tablet PC, or a two way internet connected TV, comprising:
receiving a computing device having a price without an initial payment,
the computing device having internet connections and being capable of displaying and getting feedback messages or pictures;
sending by said computing device to a server an identifier and a request to operate an application;
obtaining and displaying, by said computing device, messages and/or pictures generated by relevant parts of said application;
receiving and displaying by said computing device, electronic notification of a monetary credit to an account associated with said identifier, wherein
the monetary credit is applied to pay for the price of the computing device.

2: The method of claim 1, wherein said application involves distribution of advertisements and said message and/or pictures being displayed by the computing device are advertisements.

3: The method of claim 2, further comprising the step that a user of the computing device allowing said messages and/or pictures to be displayed by the computing device.

4: The method of claim 3, wherein the computing device has a GPS module/application that allows the server to pinpoint a location of the computing device.

5: The method of claim 4, wherein the application optimizes the messages and/or pictures being displayed by the computing device according to the location of the computing device.

6: the method of claim 3, wherein the computing device have a timer and an alarm and said program dictates that said message and/or pictures being displayed at a time set by the user of the computing device and the alarm being triggered simultaneously.

7: The method of claim 3, wherein the computing device is provided to the user for free. Or user is provided subsidies that may render the device and communications services free.

8: The method of claim 7, wherein the monetary credit is measured by a points scoring method and the user is offered another computing device after the monetary credit surpass a certain threshold.

9: The method of claim 1, wherein the monetary credit accumulates in the account after the price of the computing device is paid in full.

10: The method of claim 1, further comprising the step that a user of the computing device allowing said messages and/or pictures to be displayed by the device, wherein said application involves distribution of coupons and said message and/or pictures being displayed by the computing device are coupons.

11: The method of claim 10, wherein the computing device has a GPS module that allows the server to pinpoint a location of the computing device, and the application optimizes the messages and/or pictures being displayed by the computing device according to the location of the computing device.

12: The method of claim 1, further comprising the step that a user of the computing device allowing said messages and/or pictures to be displayed by the computing device, wherein said application involves conducting a survey and said message and/or pictures being displayed by the computing device are surveys.

13: The method of claim 12, further comprising a step that the user of the computing device filling out the survey.

14: The method of claim 1, further comprising a step that a user of the computing device allowing said messages and/or pictures to be displayed by the handheld computing device, wherein said application involves distributing product catalogs and said message and/or pictures being displayed by the computing device are product catalogs.

15: The method of claim 1, further comprising a step that a user of the computing device allowing said messages and/or pictures to be displayed by the computing device, wherein said application involves conducting a survey and said message and/or pictures being displayed by the computing device are surveys.

16: The method of claim 1, further comprising a step that a user of the computing device allowing said messages and/or pictures to be displayed by the handheld computing device, wherein said application involves distributing movies and said message and/or pictures being displayed by the computing device are movies.

17: The method of claim 1, further comprising a step that a user of the computing device allowing said messages and/or pictures to be displayed by the computing device, wherein said application involves distributing electronic royalty cards and said message and/or pictures being displayed by the computing device are electronic royalty cards.

18: The method of claim 1, further comprising two steps:
that a user of the computing device allowing said messages and/or pictures to be displayed by the handheld computing device; and the user upload a resume to the server with the computing device,
wherein said application involves collecting resumes and said message and/or pictures being displayed by the computing device are request for uploading resumes.

19: A method of receiving compensation for use of a computing device, comprising:
providing a user with a computing device having a price and internet connection without initial payment;
receiving from a computing device a request to operate an application and a user identifier;
qualifying said requested application and said identified user for eligibility for a receiving advertisements;
sending to said computing device an offer to display advertisements;
if said offer is accepted, on receiving notification from said computing device, of a use of said application, identifying at least one provider of funding, and sending to said computing device a condition of reimbursement;
on receipt of notification for a fulfillment of said conditions of reimbursement, transferring a monetary credit from an account associated with said provider of funding to an account associated with said identifier;
sending an electronic notification of said monetary credit to said account associated with said identifier, wherein
the monetary credit being applied to pay for the price of the computing device.

20: The method of claim 19, wherein the computing device has a GPS module/application that allows a server to pinpoint a location of the computing device, the identification of a provider of funding and the conditions of reimbursement being decided partly by the location of the computing device.
